(19) United States
(12) Patent Application Publication
(10) Pub. No.: US 2014/0297495 A1
(43) Pub. Date: Oct. 2, 2014

(54) Multidimensional risk analysis

(71) Applicants: Pankaj B. Dalal, South Ozone Park, NY (US); Surbhi P. Dalal, South Ozone Park, NY (US)

(72) Inventors: Pankaj B. Dalal, South Ozone Park, NY (US); Surbhi P. Dalal, South Ozone Park, NY (US)

(21) Appl. No.: 13/066,764

(22) Filed: Apr. 23, 2011

Related U.S. Application Data
(63) Continuation-in-part of application No. 12/727,195, filed on Mar. 18, 2010, now Pat. No. 8,214,277.
Application No. 12/727,195 is a continuation-in-part of application No. PCT/US2010/027920, filed on Mar. 19, 2010.
(60) Provisional application No. 61/343,120, filed on Apr. 23, 2010.

(51) Int. Cl. G06Q 40/04

(52) U.S. Cl. CPC G06Q 40/04
USPC 705/37

(57) ABSTRACT

Certain embodiments of the present invention relate to dynamically displaying multiple market risk categories for each of at least one time frames in real time, wherein, each of the multiple market risk categories comprises at least one market risk dimension, dynamically assessing within each of the various market risk categories based upon at least one or more of multiple risk dimensions, dynamically designating various aggregate combinations of market risks for each of at least one time frames in real time in response to said dynamically assessing within each of the various market risk categories, and dynamically forecasting possible Bullish Believer or Bearish Believer direction or Neutral Believer direction with an assigned category of risk in response to said dynamically designating the various aggregate combinations of market risks. Certain embodiments of these methods and systems can be applied to the financial markets, such as stocks, commodities, futures, options, foreign currencies, ETFs, ETNs, etc.

### RELATED APPLICATIONS

The present application is related to and claims priority from prior, provisional application Ser. No. 61/343,120, filed Apr. 23, 2010, entitled “Multidimensional Risk Analysis Systems”; and the present application is also a continuation-in-part of application Ser. No. 12/727,195, filed Mar. 18, 2010 entitled “Multidimensional Risk Analysis Systems”; and the present application is also a continuation-in-part of PCT application serial number PCT/US2010/02790, filed Mar. 19, 2010, entitled “Multidimensional Risk Analysis Systems”; and provisional application Ser. No. 61/276,305, filed Sep. 9, 2009; and provisional application No. 61/210,599, filed Mar. 20, 2009; and the present application is also related to the following applications: application Ser. No. 12/189,761, filed Aug. 11, 2008; PCT application serial number PCT/US/2008/072830, filed Aug. 11, 2008; and provisional application Ser. No. 60/954,978, filed Aug. 9, 2007; and U.S. Pat. No. 7,848,995 issued on Dec. 7, 2010; provisional patent application Ser. No. 60/717,962, filed Sep. 16, 2005, and 60/730,121, filed Oct. 24, 2005; and PCT International Application No. PCT/US2006/036281, filed Aug. 16, 2006. The contents of each of these references are incorporated herein by reference and are not admitted to be prior art with respect to the present invention by the mention in this cross-reference section

### FIELD OF THE INVENTION

Certain embodiments of this disclosure pertain generally to display of financial information.

### BACKGROUND OF THE INVENTION

This disclosure relates to providing methods and a system for improved, dynamic, real time, multidimensional risk recognition, including but not limited to dynamic assessment of various market risk categories and multiple independent risk factors, dynamic designation of various aggregate combinations of market risks, multiple confirmation of risk, dynamic forecasting, dynamic display of multiple market risk categories, and providing multidimensional risk analysis in single or multiple time frames, in market trading.

In trading any market vehicle, over a period of time, technicians and economists seek to identify risks as early as possible. However, early pin-point detection, optimal sequencing, categorization, multidimensional risk recognition, dynamic assessment of market risk, dynamic designation of market risk, multiple confirmation and dynamic forecasting are practically difficult in real-time (as they happen); this leads to delayed entry and exit in market trades. Further, multiple confirmations of risks delay entries and exits in market trades even longer.

Methods and a system are desirable to perform the functions described above.

### SUMMARY OF THE INVENTION

Certain aspects of this disclosure describe a multidimensional risk analyzer that can provide for multi dimensional, multi-confirmation risk assessment, risk recognition, risk allocation, and risk transfer system with minimum requirements of traditional technical analysis experience in real time for a number and variety of markets. Certain aspects of the multidimensional risk analyzer can limit a number of unnecessary efforts and produces to-the-point efficiency, pinpoint entries with risk recognition and risk designation and limit the cost and effort of learning, trading and also provides a better economical environment for the trading community.

Certain aspects of this disclosure describe a multidimensional risk analyzer that can dynamically display multiple market risk categories for each of at least one time frames in real time, wherein, each of the multiple market risk categories comprises at least one market risk dimension. Some aspects can dynamically assess within each of the various market risk categories based upon at least one or more of multiple risk dimensions. Some aspects can dynamically designate various aggregate combinations of market risks for each of at least one time frames in real time in response to said dynamically assessing within each of the various market risk categories. These can dynamically forecast possible Bullish Believer or Bearish Believer direction or Neutral Believer direction with an assigned category of risk in response to said dynamically designating the various aggregate combinations of market risks.

Certain aspects of the present disclosure relate to dynamic risk recognition of the at least one risk that has been dynamically assessed. Some of these aspects describe confirming at least one risk that has undergone dynamic risk recognition, wherein the dynamically designating various aggregate combinations of market risks is performed at least partially in response to the confirming the at least one risk.

Certain aspects of the present disclosure can dynamically calculate and display a specialized mid pivot of an at least one higher time frame. These can dynamically calculate and display vertical risk components of an at least one lower time frame. Certain of these embodiments can observe, in a real time, the formation of a Halved Hybrid Nozzlelism shape at least partially in response to the relationship between said dynamically calculating and displaying the specialized mid pivot of the at least one higher time frame as taken with respect to said dynamically calculating and displaying the vertical risk components of the at least one lower time frame.

Certain aspects of the present disclosure describe a trading method using a multi-dimensional risk analysis system, comprising dynamically calculating and displaying a precise timing for at least one super belief bullish pinpoint entries and exits, at least one super belief neutral pinpoint entries and exits, or at least one super belief bearish pinpoint entries and exits based on at least one of a various risk dimensions Certain of these can forecasts at least one of a precise targets, forecasts at least one earlier highs and at least one earlier lows, and reduces the number of trading errors, and assesses the developing risks or risk and multi-confirmation or risks, and also forecasts quick recognition combinations of market direction in one or more time frames as they develop.

Certain trading embodiments of the present disclosure display multidimensional financial information contained within multiple market risk categories that could be used to display at least one dynamic forecast of possible Bullish Believer, Neutral Believer, or Bearish Believer direction with an assigned category of risk.

### BRIEF DESCRIPTION OF THE DRAWINGS

FIG. 1 shows a schematic view, illustrating one embodiment of a multidimensional risk analysis systems;

FIG. 2 shows a schematic view, illustrating another embodiment of the multidimensional risk analysis systems;

FIG. 3 shows one embodiment of a display, showing an illustrative screenshot view which is displaying a Vertical Risk Dimension, as may be included within certain embodiments of the multidimensional risk analysis systems of FIGS. 1 and 2;

FIG. 4 shows one embodiment of a display, showing an illustrative screenshot view which is displaying a Horizontal Time Risk dimension, as may be included within certain embodiments of the multidimensional risk analysis systems of FIGS. 1 and 2;

FIG. 5 shows one embodiment of a display, showing an illustrative screenshot view which is displaying a health risk dimension component, as may be included within certain embodiments of the multidimensional risk analysis systems of FIGS. 1 and 2;

FIG. 6 shows one embodiment of a display, showing an illustrative screenshot view which is displaying a price perception indicator and internal movement indicator, as may be included within certain embodiments of the multidimensional risk analysis systems of FIGS. 1 and 2;

FIG. 7 shows one embodiment of a display, showing an illustrative screenshot view showing several screenshot sections, which together are displaying all eight risk dimensions, as may be included within certain embodiments of the multidimensional risk analysis systems of FIGS. 1 and 2;

FIG. 8 shows one embodiment of a display, showing an illustrative screenshot view which is displaying Halved Hybrid Nozzlelism phenomenon and Halved Hybrid Parallelism, as may be included within certain embodiments of the multidimensional risk analysis systems of FIGS. 1 and 2;

FIG. 9 shows one embodiment of a display, showing an illustrative screenshot view showing several screenshot sections, which together are displaying a Halved Hybrid Nozzlelism phenomenon along with a health risk indicator, as may be included within certain embodiments of the multidimensional risk analysis systems of FIGS. 1 and 2;

FIG. 10 shows one embodiment of a display, showing an illustrative screenshot view showing several screenshot sections, which together are displaying a colored Candlestick Spectrum chart showing the bearish effect of Halved Hybrid Nozzlelism along with a health risk indicator, as may be included within certain embodiments of the multidimensional risk analysis systems of FIGS. 1 and 2;

FIG. 11 shows one embodiment of a display, showing an illustrative screenshot view showing several screenshot sections, displaying a colored Candlestick Spectrum chart showing the bullish effect of Halved Hybrid Nozzlelism along with a health risk indicator, as may be included within certain embodiments of the multidimensional risk analysis systems of FIGS. 1 and 2;

FIG. 12 shows one embodiment of a display, showing an illustrative screenshot view displaying a colored Candlestick Spectrum chart showing the bullish preparation time, as may be included within certain embodiments of the multidimensional risk analysis systems of FIGS. 1 and 2;

FIG. 13 shows one embodiment of a display, showing an illustrative screenshot view showing several screenshot sections, displaying a colored Candlestick Spectrum chart showing hybrid confluence along with a health risk indicator, as may be included within certain embodiments of the multidimensional risk analysis systems of FIGS. 1 and 2;

FIG. 14 shows one embodiment of a display, showing an illustrative screenshot view showing several screenshot sections, displaying a colored Candlestick Spectrum chart showing a closed hybrid zone risk transfer area along with a health risk indicator, as may be included within certain embodiments of the multidimensional risk analysis systems of FIGS. 1 and 2;

FIG. 15 shows one embodiment of a display, showing an illustrative screenshot view showing several screenshot sections, displaying a colored Candlestick Spectrum chart showing an open-ended hybrid zone risk transfer area along with health risk indicator, as may be included within certain embodiments of the multidimensional risk analysis systems of FIGS. 1 and 2;

FIG. 16 shows one embodiment of a display, showing an illustrative screenshot view displaying a colored Candlestick Spectrum chart showing a Bullish Believers Trend Development and Recognition with Hybrid Zone Lines, as may be included within certain embodiments of the multidimensional risk analysis systems of FIGS. 1 and 2;

FIG. 17 shows one embodiment of a display, showing an illustrative screenshot view displaying a bullish scalp swing setup, as may be included within certain embodiments of the multidimensional risk analysis systems of FIGS. 1 and 2;

FIG. 18 shows one embodiment of a display, showing an illustrative screenshot view displaying a bearish mega scalp swing setup, as may be included within certain embodiments of the multidimensional risk analysis systems of FIGS. 1 and 2;

FIG. 19 shows one embodiment of a display, showing a supportive illustrative screenshot view displaying possible positions and exits, with respect to FIG. 18, as may be included within certain embodiments of the multidimensional risk analysis systems of FIGS. 1 and 2;

FIG. 20 shows one embodiment of a display, showing an illustrative screenshot view displaying a bullish scalp-swing setup based on an open-ended hybrid zone risk transfer area, as may be included within certain embodiments of the multidimensional risk analysis systems of FIGS. 1 and 2;

FIG. 21 shows one embodiment of a display, showing an illustrative multi-colored legend view displaying scalp-swing components, as may be included within certain embodiments of the multidimensional risk analysis systems of FIGS. 1 and 2;

FIG. 22 shows one embodiment of a display, showing an illustrative table and graphic representation displaying a sample breakeven analysis for actual percentage equity or margin used, as may be included within certain embodiments of the multidimensional risk analysis systems of FIGS. 1 and 2;

FIG. 23 shows one embodiment of a display, showing an illustrative risk control table displaying account, capital preservation, trade repair and scalp-swing trading information, as may be included within certain embodiments of the multidimensional risk analysis systems of FIGS. 1 and 2;

FIG. 24 shows one embodiment of an illustrative control table view that is operationally associated with the table illustrated in FIG. 23, showing an illustrative tabular view displaying quick repair parameters, scalp-swing trading, and broker platform control, as may be included within certain embodiments of the multidimensional risk analysis systems of FIGS. 1 and 2;

FIG. 25 shows one embodiment of a display, showing an illustrative flow diagram displaying one embodiment of a multidimensional risk analysis method with forecasting capabilities, as may be performed by certain embodiments of the multidimensional risk analysis systems of FIGS. 1 and 2;

FIG. 26 shows one embodiment of a display, showing an illustrative flow diagram displaying one embodiment of a Halved Hybrid Nozzlelism method with forecasting capabilities, as may be included within certain embodiments of the multidimensional risk analysis systems of FIGS. 1 and 2;

FIG. 27 shows one embodiment of a display, showing an illustrative flow diagram displaying one embodiment of a scalp-swing or mega scalp-swing method with forecasting capabilities, as may be included within certain embodiments of the multidimensional risk analysis systems of FIGS. 1 and 2;

FIG. 28 shows one embodiment of a display, showing an illustrative flow diagram displaying one embodiment of a method for using customizable risk control tables, as may be included within certain embodiments of the multidimensional risk analysis systems of FIGS. 1 and 2; and

FIG. 29 shows one embodiment of a display, showing an illustrative flow diagram displaying another embodiment of a multidimensional risk analysis method with forecasting capabilities, as may be performed by certain embodiments of the multidimensional risk analysis systems of FIGS. 1 and 2.

### DETAILED DESCRIPTION OF THE INVENTION

Certain embodiments of this disclosure relates to providing a system and associated method for improved risk assessment in market trading. More particularly, certain embodiments of this invention relate to providing a system, and associated method, for risk assessment from multiple independent risk factors across multiple time frames. Within the financial industry, by trading any market vehicle over a period of time, technicians and economists seek to identify risks as early as possible. However, early pin-point detection, optimal sequencing, categorization, multi-risk assessment, risk designation, dynamic forecasting, and multi-confirmation of the risks are difficult to detect in real-time (as they happen); this leads to delayed entry, exit, and possibly turns into capital losses in market trades. Further, manual multiple confirmations of risks may delay entries and exits in market trades even further.

A method and/or associated system would be of great use and significance that could reliably identify, assess, recognize, confirm, designate, and forecast risks in real-time, as the risks develop. Further, a system is needed that will identify, confirm, and control the risks in user-desired time frames and at perhaps all stages of a trend, as well as reduce errors associated with trading, by doing portfolio repairs and capital preservation.

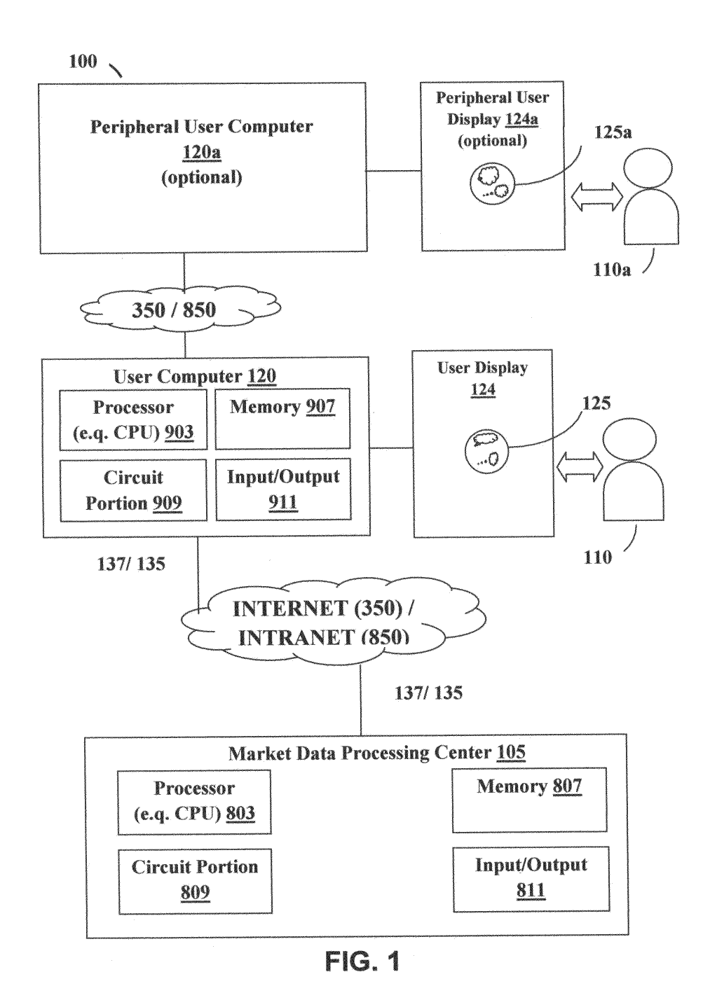

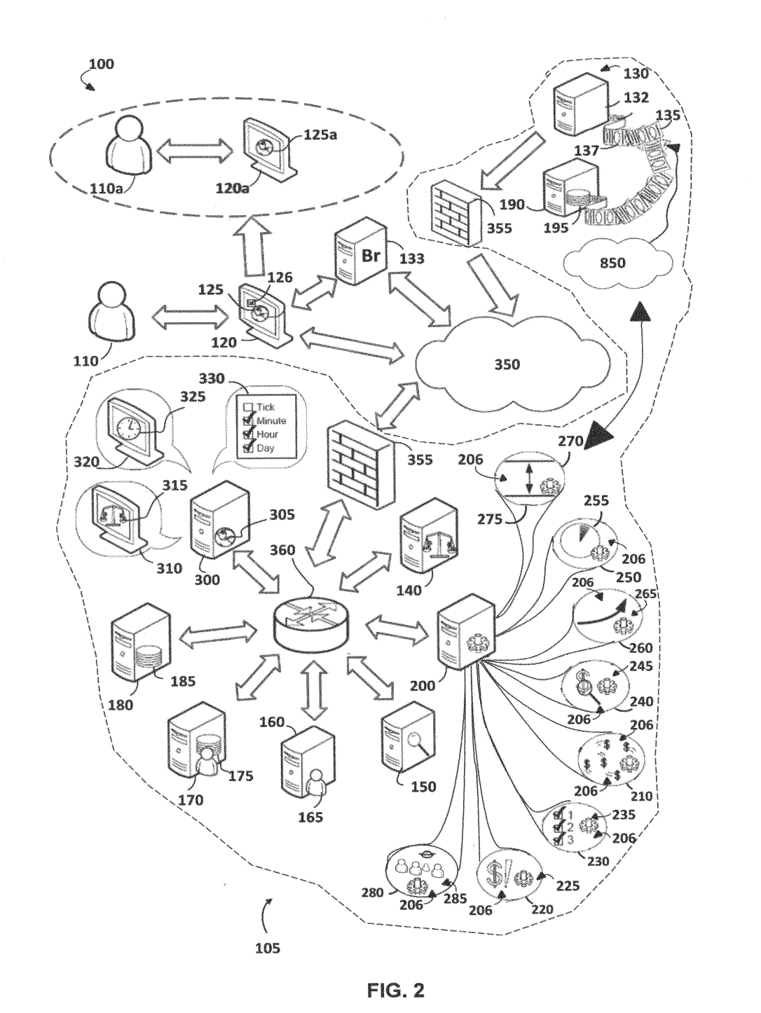

FIGS. 1 and 2 show schematic views, illustrating a number of embodiments of a multidimensional risk analysis systems 100 according to preferred embodiments of the present invention. Certain embodiments of the multidimensional risk analysis systems 100 can be configured to promote what is referred to in this specification as “Bullish Believers”, “Bearish Believers”, or “Neutral Believers”. These terms refer to how a user, or trader, would normally behave provided the information displayed or otherwise received from certain embodiments of the multidimensional risk analysis systems 100. The amount of information, data, colors, shapes, symbols, alphanumeric characters, numbers, etc. that are displayed in certain embodiments of the multidimensional risk analysis systems 100 are considerably more than that of observing traditional trend lines, markets indicators, etc. As such, the additional information is likely to clue a user or trader (whether experienced or not) as to what is likely to be a smart trade, or not. As such, with input as provided by certain embodiments of the multidimensional risk analysis systems 100, certain Bullish Believers are more likely to exhibit “Bullish Believeness”, and thereupon are more likely to make better and smarter decisions based on the provided information. By comparison, with input as provided by certain embodiments of the multidimensional risk analysis systems 100, certain Bearish Believers are more likely to exhibit “Bearish Believeness”, and thereupon are less likely to make poor decisions based on the provided information. By comparison, with input as provided by certain embodiments of the multidimensional risk analysis systems 100, certain Neutral Believers are more likely to exhibit “Neutral Believeness”, and thereupon are less likely to make poor decisions based on the provided information.

Traders with little or considerable experience could likely utilize certain embodiments of the multidimensional risk analysis systems 100 to likely participate to make better or smarter forecasts based on the resulting output. Such unskilled or untrained users could quickly learn to recognize a variety of embodiments of the symbols, shapes, levels, colors, alphabetic or numerical characters, recognizable distinguishable patterns, pinpoint entries and exits, risk recognition as it develops, or other visual and sound effects, etc. that might be expected to develop in real time on graphical user displays, or other displays, of certain embodiments of the multidimensional risk analysis systems 100. As such, skilled or long experienced traders may not necessarily hold the major advantage in success over relative trading neophytes that they are now likely to do. Using certain embodiments of the multidimensional risk analysis systems 100 might allow either skilled or unskilled traders or users to make their trading or financial market decisions with an increased probability of success with fewer traditional technical analysis skills, they too will be more likely to make the right choice to support those financial vehicles that show promise statistically, instead of picking stocks or other financial vehicles based on feel, gambling, or name recognition, etc.

A variety of embodiments of graphical user interfaces that can show the multidimensional risk analysis systems 100 are described with respect to a variety of illustrations and Figures within this disclosure. These illustrations are intended to be illustrative in nature but not limiting in scope, and do not include all potential symbols, colors, shapes, alphanumeric characters, etc. As such, one skilled in the art would well recognize how to provide a variety of similar embodiments of the multidimensional risk analysis systems 100, such as by changing shapes, patterns, colors, symbols, alphanumeric characters, etc., and such appearance but not substantial changes are within the intended scope of the present invention as described according to the present claims, drawings, and specification.

With multidimensional risk analysis systems 100, those financial Market Vehicles that show true promise will likely thereby be supported by increasing purchases and trades, and those that do not will not be as strongly supported. As such, the widespread use of certain embodiments of the multidimensional risk analysis systems 100 will help promote Bullish Believers to promote those financial vehicles that traders or users would be most benefitted by Bullish Believeness. By comparison, the widespread use of certain embodiments of the multidimensional risk analysis systems 100 will help promote Bearish Believers to stay away from those financial vehicles that traders or users would be least benefitted by Bearish Believeness. Additionally, the widespread use of certain embodiments of the multidimensional risk analysis systems 100 will help promote Neutral Believers to display neutral behavior relative to those financial vehicles that traders or users would be mutually benefitted by both bearish and Bullish Believeness. As such, purchasing and selling stocks and other financial vehicles will likely become more based upon real time merit of risk dimensions, where such risk dimensions might be either characterized as good risk dimensions as well as bad risk dimensions.

To recognize and calculate such Bullish Believeness, Neutral Believeness, and/or Bearish Believeness suitably, a number of embodiments of the multidimensional risk analysis systems 100 are now described that can range from operating on relatively complex networks such as the Internet or intranets to operating on much simpler computer systems. Certain embodiments of the multidimensional risk analysis systems 100 can thus be configured as a networked system such as running a number of distinctly interacting computers and processes. By comparison, certain embodiments of the multidimensional risk analysis systems 100 can be configured as a stand-alone computer such as a laptop computer, server, slate, or tablet computer, etc. that can also be running a number of distinct processes. FIGS. 1 and 2, in particular, show a variety of embodiments of network and/or Internet-based methods for obtaining market data 137.

Certain embodiments of multidimensional risk analysis systems 100, as described with respect to FIG. 2, may comprise at least one market-data processing center 105 that operationally includes at least one market-feed database server 190. Market-feed database server 190 preferably comprises at least one market-feed database 195. Market-feed database server 190 preferably receives at least one market data feed 135, from at least one market feed provider 130, preferably by communicating with at least one market feed server 132. In certain instances, market data feed 135 preferably comprises market data 137, relating generally to trade and financial markets. Market data 137 is preferably stored in market-feed database 195. Those skilled will understand that there may be other evolving or alternate configurations that may provide market data, such as, for example, direct connection, website extraction, etc.

Certain embodiments of the market data processing center 105 are described with respect to FIG. 1 embodiment, and can include, depending on context, a process provider 803 such as a processor, computer, server, or plurality thereof that can run one or a number of processes. Certain embodiments of the market data processing center 105 can also include a memory 807, a circuit or circuit portion 809, and an input output interface (I/O) 811 that may include a bus (not shown). Certain embodiments of the market data processing center 105 can include and/or be a portion of a server, a general-purpose computer, a specific-purpose computer, a microprocessor, a microcontroller, a personal display assistant (PDA), a cellular phone, a wireless communicating device, a hard-wired communication device, and/or any other known suitable type of communications device or phone, computer, and/or controller that can be implemented in hardware, software, electromechanical devices, and/or firmware.

Certain embodiments of the processor 803 can alternately run one or a number of processes depending upon design or users choices, as described with respect to FIG. 1, and can perform the processing and arithmetic operations for certain embodiments of the market data processing center 105. Certain embodiments of the market data processing center 105 can control the signal processing, database querying and response, computational, timing, data transfer, and other processes associated with multidimensional risk analysis systems 100 such as can be adjusted by and/or controlled by certain embodiments of the market data processing center 105.

Certain embodiments of the memory 807 of the market data processing center 105 can include a random access memory (RAM) and/or read only memory (ROM) that together can store the computer programs, operands, and other parameters that control the operation of certain embodiments of market data processing center 105. The memory 807 can be configurable to contain data, financial information, market feed data, images, visualizations, image information, etc. that can be obtained, retained, or captured by that particular financial system, as described in this disclosure.

In the embodiment of FIG. 1, certain embodiments of the bus can be configurable to provide for digital information transmissions between the processor 803 that can run one or a number of processes, circuits 809, memory 807, I/O 811, to perform the operation of the multidimensional risk analysis systems 100 (which may be integrated or removable). In this disclosure, the memory 807 can be configurable as RAM, ROM, flash memory, semiconductor-based memory, of any other type of memory that can be configurable to store data pertaining to the multidimensional risk analysis systems 100. Certain embodiments of the bus can also connect I/O 811 to the portions of certain embodiments of the market data processing center 105 of the multidimensional risk analysis systems 100 that can either receive digital, analog, and/or mixed information from, or transmit digital, analog, and/or mixed information to other portions of the multidimensional risk analysis systems 100, or other systems and/or networking components associated therewith.

Certain embodiments of the market data processing center 105 of the FIGS. 1 and 2 embodiment are configured to communicate via Internet/Intranet, wired-connection, wireless connection, optical media, or any other communication media to provide one way or two way communications to a user computer(s) 120. To provide a user interaction with the market data processing center 105, certain embodiments of the user computer 120, a user display 124, and a user 110, together comprise a variety of embodiments of a client/user interface 125. Different embodiments of the client/user interface 125 can occur directly with the market data processing center 105, or alternately may be configured as a peripheral/user/client interface 125a. In this disclosure, the suffix “a” applies to structurally similar or identical components of the peripheral client/user interface 125a as compared to the client/user interface 125. As such, the following descriptions that pertain to computer operations of the client/user interface 125 pertain identically to the peripheral client/user interface 125a. It might be envisioned, for example, that a service provider might utilize their client/user interface 125 to provide requested data, financial information, etc. to the peripheral client/user interface 125a. Certain embodiments of the user computer 120 comprised within the client/user interface 125 are now described.

As described with respect to both FIGS. 1 and 2, there are two users illustrated generally by 110 and 110a that are each associated with their respective user computers 120 and 120a. User 110 may be considered a primary user, while user 110a may be referred to as a projected or peripheral user. As such, with the proper authorization from the technology providers, the user computer 120 provides the associated information to the user display 124 that may be viewed by the user 110. In certain instances, at least some information, data, etc. may be controllably projected to the peripheral user computer 120a, which in turn can be displayed via the peripheral user display 124a to the peripheral user 110a. In this manner, a projection interface can be established between the user computer 120 and the peripheral user computer 120a that may be either direct or via networked connection such as the Internet 350 or Intranet 850 are generally understood in the art.

Certain embodiments of the user computer 120 are described with respect to FIG. 1, and can include, depending on context, a processor 903 such as a central processing unit (CPU), computers, workstations, servers, handhelds, wireless devices, general purpose or specific purpose computers, or a plurality thereof, that can run one or a number of processes. Certain embodiments of the market user computer 120 can also include a memory 907, a circuit or circuit portion 909, and an input output interface (I/O) 911 that may also include a bus (not shown).

Certain embodiments of the user computer 120 can include and/or be a portion of a server, a workstation, a mainframe, a general-purpose computer, a specific-purpose computer, a microprocessor, a microcontroller, a personal display assistant (PDA), a cellular phone, a wireless communicating device, a hard-wired communication device, and/or any other known suitable type of communications device or phone, computer, and/or controller that can be implemented in hardware, software, electromechanical devices, and/or firmware. Certain embodiments of the processor 903 that can alternately run one or a number of processes depending upon design or user choices, as described with respect to FIG. 1, can perform the processing and arithmetic operations for certain embodiments of the user computer 120. Certain embodiments of the user computer 120 can control the signal processing, database querying and response, computational, timing, data transfer, and other processes associated with the client/user interface 125.

Certain embodiments of the memory 907 of the user computer 120 can include a random access memory (RAM) and/or read only memory (ROM) that together can store the computer programs, operands, and other parameters that control the operation of certain embodiments of user computer 120. The memory 907 can be configurable to contain data, financial information, market feed data, images, visualizations, image information, etc. that can be obtained, retained, or captured by that particular financial system, as described in this disclosure, but can also include other types of data, information, images/programs, such as are typically known to be stored in memories of user computers.

Certain embodiments of the bus can be configurable to provide for digital information transmissions between the processor 903 that can run one or a number of processes, circuits 909, memory 907, I/O 911, to perform the operation of the client/user interface 125 (which may be integrated or removable). In this disclosure, the memory 907 of FIG. 1 can be configurable as RAM, ROM, flash memory, semiconductor-based memory, of any other type of memory that can be configurable to store data pertaining to the client/user interface 125. Certain embodiments of the bus can also connect I/O 911 to the portions of certain embodiments of the user computer 120 of the client/user interface 125 that can either receive digital, analog, and/or mixed information from, or transmit digital, analog, and/or mixed information to other portions of the client/user interface 125, or other systems and/or networking components associated therewith.

Because of the complexity of the processor computations associated with the calculations involving the number of multiple risk dimensions and sub categories of various risks, number of symbols, number of colors, and number of alphanumeric characters required per time frame (tick data to any higher time frame), user may require a very powerful or additional processor associated with the processor 903. The complexity and capabilities of the processor 903 should thereby be in similar scope to that provided by the market data processing center 105.

The FIG. 2 embodiment of the multidimensional risk analysis systems 100 is now described in further detail. Certain embodiments of the communication between the client/user interface 125 and the market data processing center 105 can be accomplished via certain embodiments of the market-feed database server 190 in combination with the market feed provider 130 and market feed server 132. This communication at least partially embodies at least one market feed computer process that might be configured to process at least one real time market feed to determine real-time market data; and at least embodying herein processing at least one real-time market feed to determine real-time market data. At least one real time market feed to determine real-time market data preferably is conducted through at least one network, preferably the Internet 350 or intranet 850.

At least one firewall 355 can effect secure communication with Internet 350, preferably to prevent unsanctioned access to market-data processing center 105. Under appropriate circumstances, considering such issues as future technologies, costs, etc., other communication securing methods, such as, for example, encryption, security gateways, etc., may suffice.

Communication within market-data processing center 105 is preferably handled through at least one communications router 360. Upon reading the teachings of this specification, considering such issues as future technologies, cost, etc., other communications devices, such as, for example, direct connections, wireless connections, etc., may be used.

Certain embodiments of the market-data processing center 105 preferably comprises at least one programmable market data software, such as, for example, Thomson-Reuter's Metastock® Pro (available from Equis.com), E-Signal®, TradeStation®, or Bloomberg®. The multidimensional risk analysis systems 100 may be utilized as a plug-in or as an add-on to such programmable market data software, preferably Thomson-Reuter's Metastock® Pro software. Such aforementioned financial software companies have given access to strategy creation, indicator building, system test creating, explorers, alerts, or built customized indicators, symbols, experts and they are an integral part of their software with limited or open access for writing logics without learning such computer programming languages such as C++ or Visual Basic, or others. These technologies are available from Thomson-Reuters, E-Signal®, or TradeStation® or similar software companies that would enable one skilled in the art to accomplish the invention without undue burden or efforts to create similar systems The available language from Thomson-Reuters' MetaStock® is called Formula Primer, for TradeStation® it is called EasyLanguage® and for E-Signal® it is called eSignal Formula Script. There is support available and many companies provide help to write any logics or custom indicators, etc. with or without charge, whichever is the company's policy. Market-data processing center 105, as shown in FIG. 2, preferably further comprises at least one risk processor 200, preferably at least one risk assessor 140, preferably at least one risk analyzer 150, and preferably at least one history database server 180.

Certain embodiments of a risk processor 200 (at least embodying herein at least one risk factor computer processor, can be structured and arranged to automatically calculate current values of each of a plurality of market risk factors from such real-time market data; and at least embodying herein automatically calculating current values of each of a plurality of market risk factors from such real-time market data) preferably processes market data 137. This preferably identifies portions of market data 137 related to at least one market risk 206. In discussing “market risk” herein, applicant is generally referring to the particular risks of performing a particular trade at a particular time. Risk analyzer 150, at least partially embodying herein at least one analysis computer processor configured to real-time analyze at least one combination of such market risk factors to quantify at least one market risk.

This at least partially embodies real-time analyzing of at least one combination of such market risk factors to quantify at least one market risk) preferably analyzes the identified portions of market data 137, preferably identifying risk attributes, preferably direction and severity, of market risk 206. Risk processor 200 and risk analyzer 150 preferably both operate in real-time (as, for example, market data 137 is received by market-feed database server), and process and analyze, respectively, preferably in multiple time frames 325. Upon reading the teachings of this specification, those skilled in the art will now appreciate that, under appropriate circumstances, considering such issues as future technologies, costs, resources, etc., other risk attribute identifications may suffice.

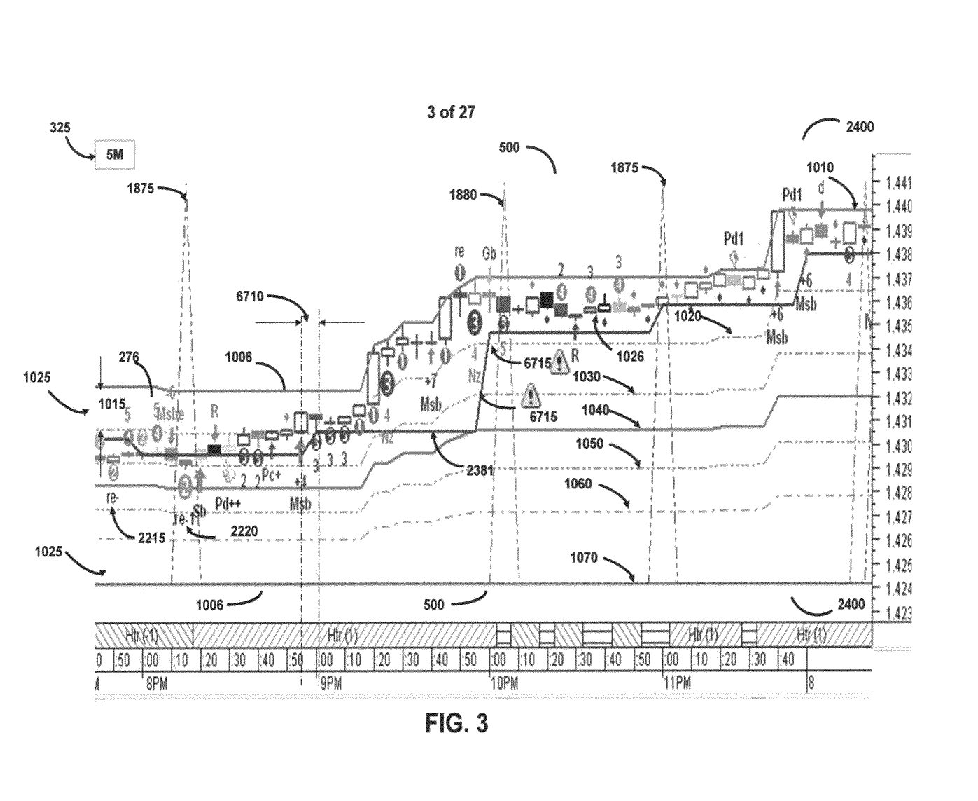

Certain embodiments of the risk assessor 140, at least embodying herein at least one risk assessing computer processor configured to assess relevance of each quantity of a plurality of such at least one market risks to determine when to display at least one risk indicator. This can also assess the relevance of each quantity of a plurality of such at least one market risks to determine when to display at least one risk indicator) preferably creating at least one risk assessment 315, preferably comprising at least one evaluation of at least one risk factor determining whether at least one level of risk is reached, preferably triggering at least one display of the at least one level of risk, preferably comprising at least one indicator 500 (see FIG. 3 through FIG. 24). Certain embodiments of the indicator 500 preferably indicate the identified direction and severity of market risk 206.

Risk assessment 315 of FIG. 2 can preferably comprise indicators 500 from multiple market risks 206, preferably in multiple time-frames 325, at least embodying herein at least one timeframe computer processor configured to calculate each of such plurality of market risk factors relating to each of a plurality of time frames ending at about current real-time; and at least embodying herein calculating each of such plurality of market risk factors relating to each of a plurality of time frames ending at about current real-time. The timing of the indicators 500 preferably end at about current time. Upon reading the teachings of this specification, there might be a variety of embodiments of other risk assessments, such as, for example, market vehicle interrelationship risks, common industry risks, company relationship risks, etc.

Certain embodiments of a history database server 180 preferably comprise at least one history database 185. Such a history database 185 can preferably store results from risk processor 200 and risk analyzer 150. In certain instances, risk assessor 140 preferably accesses history database 185, preferably to include indicators 500, referencing market risks 206 previously identified, in risk assessment 315. Upon reading the teachings of this specification, those skilled in the art will now appreciate that, under appropriate circumstances, considering such issues as future technologies, costs, etc., other data history storage, such as, for example, rotating buffers, flat files, period specific reports, etc., may suffice to provide the at least one history database 185.

Certain embodiments of market-data processing center 105 preferably further comprises at least one user server 160, at least one user database server 170, and at least one user interface server 300. At least one user 110 preferably may utilize user server 160, user database server 170 and user interface server 300 to interact with market-data processing center 105. Certain embodiments of user interface server 300 preferably provides at least one user interface 305 for use by user 110. User interface 305 preferably comprises at least one risk assessment, recognition, confirmation, designation, forecasting or identification display 310, at least one time frame display 320 and at least one display preference interface 330. Display preference interface 330 preferably allows user 110 to set preferences for display of time frames 325 and risk assessments 315.

Within this disclosure, certain embodiments of the risk analyzer 150, as described relative to FIG. 2, have the capabilities of performing such operations as risk analyzing, identifying, recognition, confirmation, designation, or forecasting. As such, the at least one risk analyzing, identifying, recognition, confirmation, designation, or forecasting display 310 displays to a user a displayed image that has undergone such operations as risk analyzing, identifying, recognition, confirmation, designation, or forecasting. In the FIG. 1 embodiment, for example, such risk analyzing, identifying, recognition, confirmation, designation, or forecasting operations can be performed within the market data processing center 105. Those skilled in the art would understand that such risk analyzing, identifying, recognition, confirmation, designation, or forecasting operations can be performed in a variety of stand-alone or networked configurations.

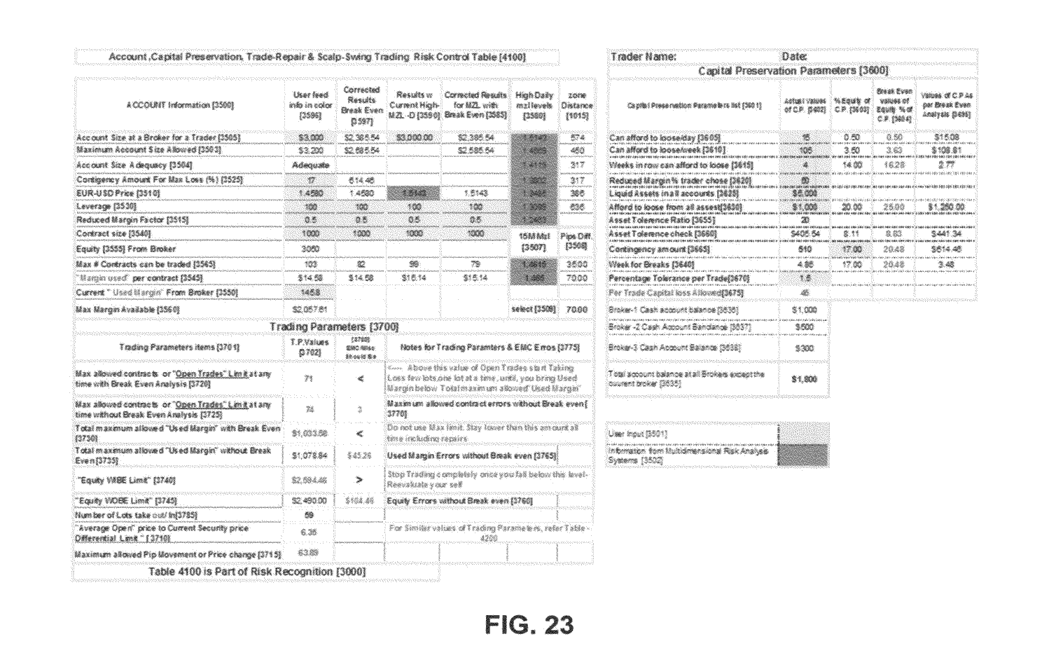

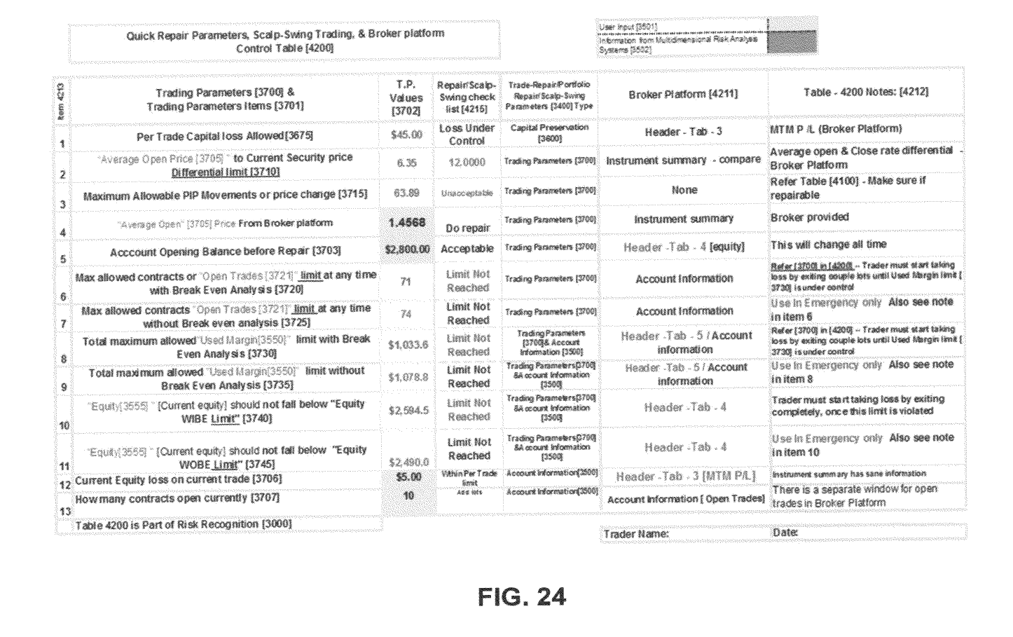

Certain embodiments of user 110 preferably uses at least one user computer 120, preferably having at least one client user interface 125, preferably a web browser, to connect to user interface 305 of FIG. 2. A user or trader may use at least one spreadsheet and/or database program such as Microsoft Excel® 126, and may have an interface with Broker server 133 in order to calculate a risk table 4100 (FIG. 23) and/or 4200 (FIG. 24). Upon reading the teachings of this specification, other software architectures, such as, for example, client server applications, stand-alone applications, etc., may be used.

Certain embodiments of one risk assessment, recognition, confirmation, designation, forecasting or identification display 310 (at least embodying herein at least one risk indicator computer display structured and arranged to display such at least one risk indicator; and at least embodying herein displaying such at least one risk indicator) and time frame display 320 preferably display risk assessment 315 and time frames 325, respectively, to user 110. Risk assessment, recognition, confirmation, designation, forecasting or identification display 310 preferably also displays at least some of the results from risk processor 200 (at least embodying herein at least one risk factor computer display can be structured and arranged to display at least some of such current values of such plurality of market risk factors; and at least embodying herein displaying at least some of such current values of such plurality of market risk factors).

Certain embodiments of the risk assessment, recognition, confirmation, designation, forecasting or identification display 310 and at least one time frame display 320 are preferably combined for comparison by user 110. There might be a variety of embodiments of processed data distribution methods, such as might use email alerts, outbound data feeds, instant messages, text messages, etc.

Certain embodiments of user server 160 preferably controls authentication to market-data processing center 105 preferably using at least one user account 165. User 110, having user account 165, may login to market-data processing center 105, using at least one username and password combination, through user server 160. Upon reading the teachings of this specification, those skilled in the art will now appreciate that, under appropriate circumstances, considering such issues as cost, future technologies, etc., other authentication methods, such as may use key-code, file authenticators, etc.

Certain embodiments of user database server 170 may comprise at least one user database 175. User database 175 preferably stores information for user account 165, including the preferences set by user 110 with display preference interface 330. There might be a variety of embodiments of other data storage methods, such as, for example, flat files, client-side storage, etc.

Certain embodiments of risk processor 200 preferably comprises at least one internal market moving risk processor 210, at least one economic event risk processor 220, at least one multiple conditions risk processor 230, at least one price perception risk processor 240, at least one time duration risk processor 250, at least one trend risk processor 260, at least one zone range risk processor 270 and at least one family and characteristic risk processor 280.

User may select a combination of at least some of the described risk processors; alternately preferably, each other combination of at least some of the described risk processors. There may be a variety of embodiments of risk processors, such as, for example, economic event risk processors, news-feed risk processors, industry-family risk processors, company-family risk processors, etc. Those skilled in the art will now appreciate that, under appropriate circumstances, considering such issues as future market influences, future technologies, available data, etc.

In use, certain embodiments of multidimensional risk analysis systems 100 can provide, in risk assessment 315 of FIG. 2, a representation of the travel of current market vehicle prices while demonstrating various market risks 206 in a multi-dimensional risk spectrum. Risk assessment 315 also preferably presents multiple confirmations of market risks 206, preferably in multiple time frames 325. Certain embodiments of the market data processing center 105, each market risk 206 has preferably no direct dependence on other market risks 206; while ideally this non-dependence is complete, market risks 206 may have indirect influences on one another. Movement of any market vehicle can be independently subject to various risk dimensions (market risks 206) that the applicant categorizes in eight major dimensions (eight market risks 206), namely: Vertical Risk Dimension (zone range risk 275 or Hybrid zone range risk 276); Horizontal Time Risk (time duration risk 255); Trend Health Risk 265; Dynamic Sectional Price Risk (price perception risk 245); Sudden Market Spot Change Risk (internal market moving risk 215); Special Conditional Risk (multiple conditions risk 235); Fundamental Risk (economic event risk 225) and family and characteristic risk 285.

Certain embodiments of zone range risk processor 270, at least herein embodies wherein said at least one risk factor computer processor comprises at least one bounded range risk computer processor structured and arranged to automatically calculate current values of at least one historic value range boundary risk factor. Certain embodiments of zone range risk processor 270 can at least partially embody herein wherein such step of automatically calculates current values of each of a plurality of market risk factors comprises the step of automatically calculating current values of at least one historic value range boundary risk factor that can preferably processes zone range risk 275 and/or Hybrid dynamic zone risk 276.

Certain embodiments of time duration risk processor 250 (at least herein embodying wherein said at least one risk factor computer processor comprises at least one time-duration risk computer processor configured to automatically calculate current values of at least one time-duration risk factor; and at least herein embodying wherein such step of automatically calculating current values of each of a plurality of market risk factors comprises the step of automatically calculating current values of at least one time-duration risk factor) preferably processes time duration risk 255.

Certain embodiments of trend risk processor 260 at least herein embodying wherein said at least one risk factor computer processor comprises at least one Trend Health Risk computer processor configured to automatically calculate current values of at least one Trend Health Risk factor. This at least partially herein embodies wherein such step of automatically calculating current values of each of a plurality of market risk factors comprises the step of automatically calculating current values of at least one Trend Health Risk factor that can preferably at least partially process Trend Health Risks 265.

Certain embodiments of price perception risk processor 240 at least herein embodying wherein said at least one risk factor computer processor comprises at least one price-perception risk computer processor structured and arranged to automatically calculate current values of at least one price-perception risk factor; and at least herein embodying wherein such step of automatically calculating current values of each of a plurality of market risk factors comprises the step of automatically calculating current values of at least one price-perception risk factor, and also thereby preferably processes price perception risk 245.

Certain embodiments of the risk processor 200 preferably independently process each market risk 206. Consequently, internal market moving risk processor 210 (at least herein embodying wherein said at least one risk factor computer processor comprises at least one internal-market-movement risk computer processor structured and arranged to automatically calculate current values of at least one internal-market-movement risk factor; and at least herein embodying wherein such step of automatically calculating current values of each of a plurality of market risk factors comprises the step of automatically calculating current values of at least one internal-market-movement risk factor) preferably processes internal market moving risk 215.

Certain embodiments of multiple conditions risk processor 230 (at least herein embodying wherein said at least one risk factor computer processor comprises at least one multiple-conditions risk computer processor structured and arranged to automatically calculate current values of at least one multiple condition risk factor; and at least herein embodying wherein such step of automatically calculating current values of each of a plurality of market risk factors comprises the step of automatically calculating current values of at least one multiple condition risk factor) preferably processes multiple conditions risk 235.

Certain embodiments of economic event risk processor 220 (at least herein embodying wherein said at least one risk factor computer processor comprises economic-event risk computer processor structured and arranged to automatically calculate current values of at least one economic-event risk factor; and at least herein embodying wherein such step of automatically calculating current values of each of a plurality of market risk factors comprises the step of automatically calculating current values of at least one economic-event risk factor) preferably processes economic event risk 225.

Certain embodiments of family and characteristic risk processor 280 (at least herein embodying wherein said at least one risk factor computer processor comprises at least one family and characteristic risk computer processor configured to automatically calculate current values of at least one family and characteristic risk factor. Certain embodiments of the family and characteristic risk processor 280 can at least partially herein embody wherein such step of automatically calculating current values of each of a plurality of market risk factors comprises the step of automatically calculating current values of at least one family and characteristic risk factor such as to preferably processes family and characteristic risk 285.

FIG. 3 shows one embodiment of a display, showing an illustrative screenshot view which is displaying a Vertical Risk Dimension, as may be included within certain embodiments of the multidimensional risk analysis systems 100 of FIGS. 1 and 2. In the Hybrid Vertical Risk Dimension, hybrid zone range risk 276, indicators 500 preferably comprise at least two Dynamic Zone Lines 1006, preferably at least seven Dynamic Zone Lines 1006 based on a lower time frame 325, for example 5 minutes, and at least one dynamically calculated mid pivot line 2381 (Blue Line or FXTA mid pivot or any user desired pivot type) of a higher time frame 325, for example 60 minutes, which may be scheduled to change over predetermined size of higher time frame 325, for example 60 minutes, as illustrated within FIG. 3.

As such, this indicator comprises of at least seven Dynamic Zone Lines 1006, based on a lower time frame 325, such as 5 minutes, and at least one dynamically calculated mid pivot line 2381 of a higher time frame 325, for example 60 minutes, which may be scheduled to change over predetermined size of higher time frame 325, for example 60 minutes, may be referred to as Hybrid Dynamic Zone Lines (8)-59-L 1006.

Upon reading the teachings of this specification, those skilled in the art will now appreciate that, under appropriate circumstances, considering such issues as cost, market dynamics, future statistical methods, etc. Other dynamic zone line quantities may be used, such as, for example, nine, twelve, twenty, and other dynamically changing pivot lines such as daily, weekly, monthly etc. Vertical distances (illustrated by distance 1015) between any two zone lines 1006 preferably comprises at least one risk zone 1025. However, one risk zone 1025 may comprise of at least one Blue Line 2381, as such may be referred to as hybrid dynamic risk zone 1026. It may be further understood that such vertical distances have dynamic distances and may not always be equal to the values of the other zones. Dynamic Zone Lines can be considered to be adaptive, horizontal, flexible lines that may dynamically travel, dynamically travel independently of one another and can have forecasting capabilities, allowing the possible indication of a possible change within the near future.

In Hybrid Dynamic Zone Lines (8)-59-L, eight Hybrid Dynamic Zone Lines 1006 may be created with the use of seven zone lines (1010, 1020, 1030, 1040, 1050, 1060, and 1070), comprising of higher high values and lower low values over a period of time for any market vehicle and may be interjected with one specially designed dynamically changing, over a designated period, Blue Line 2381. These interjections may be designated as hybrid dynamic zone levels. Thereupon, such concept of hybrid dynamic risk zones 1026 may tend to reduce reliance upon the traditional use of pivots and Fibonacci levels and their limitations in trading. In addition, Hybrid Dynamic Zone Lines 1006 may tend to reduce the use of such two indicators separately and may produce a better dynamic tool for traders or users. It may be understood that there has been great confusion for traders or users as to selecting which highs or lows in applying Fib levels and applicant's herein described embodiment eliminates that confusion. Applicant's embodiment preferably permits designing Hybrid Dynamic Zone Lines 1006 using different time periods such as may be provided to indicate higher high values and lower low values.

In this exemplary, as such illustrated, is the possible travel of current prices through various Hybrid Dynamic Zone Lines (8)-59-S, for shorter duration, or Hybrid dynamic zones 1026, along with Applicant's dynamic multi-colored candle collection and various dimensional risks, can create a multi-dimensional risk spectrum 2400. It may be further understood that Hybrid Dynamic Zone Lines 1006 may be designed for medium duration designated with hybrid zone lines (9)-D-M (“9” indicates: seven zone lines and two Blue Lines), which may be based on daily and weekly Blue Line 2381 and possible combination of seven zone lines; alternately a long term duration may be designed by hybrid zone lines (10)-D-L (“10” indicates: seven zone lines and three Blue Lines), which may be based on daily, weekly and monthly, Blue Line 2381 and possible combination of seven zone lines. It may also be understood that a super long duration can be designated by hybrid zone lines (10)-W-SL, which may be based on weekly, monthly and yearly Blue Line 2381 with possible combination of seven zone lines, as per choice of user. Separate indicators 500 are preferably designed for each type of choice.

In certain configurations, Hybrid Dynamic Zone Lines 1006 may preferably comprise zone line 1010, zone line 1020, zone line 1030, zone line 1040, zone line 1050, zone line 1060, zone line 1070 and Blue Line 2381, preferably determined in a statistical manner, preferably by applying a Fibonacci analysis and pivot levels. In consideration of traditional financial or market factors such as Fibonacci (Fib) levels, pivot levels or combination of both or some specialty levels, may be possible by mathematical formula, to derive Hybrid Dynamic Zone Lines 1006. In other words, the new methodology for Dimension #1 (zone range risk 275 or hybrid zone range risk 276) can be flexible and adaptable to existing methods for a smooth transition in future.

Upon reading the teachings of this specification, those skilled in the art will now appreciate that, under appropriate Circumstances other quantities of Dynamic Zone Lines may suffice, considering such issues as desired accuracy, future technologies, cost, etc.

In certain configurations, any market vehicle may comprise hybrid zone range risk 276 which may follow an upward or downward movement, when compared to a reference point, over a period of time. Preferably, hybrid zone range risk 276 moves dynamically as market conditions change and may be divided into multiple zones by Hybrid Dynamic Zone Lines 1006, depending upon the accuracy required. Hybrid zone range risk 276 preferably may be contained between an upper zone line 1010 and a lower zone line 1070. Hybrid zone range risk 276 can thereby preferably be dynamically adjusted, most likely indicating that market conditions are likely to change. With respect to the illustrative display in FIG. 3, it may be evident that in hybrid risk zone 1026, due to the Blue Line 2381 and its scheduled event of showing the dynamic change at every 60 minute, using Hybrid zone lines (8)-59-L (1006), at approximately 8:55 pm, the Blue Line was observed to be shifting to the upside constituting an upward movement of market vehicle prices above zone line 1020. Blue Line 2381 partially may contribute to the risk of Bearish Believers when zone lines 1020 and 1030 remain parallel during such process. Showing the dynamic changes occurring during the preselected time frame period, as for example 60 minutes, in Blue Line 2381, within the last segment of lower time frame period of Hybrid Dynamic Zone Lines 1006 at the completion of preselected time period of Blue Line 2381 may be referred to as Scheduled Event of Blue Line 6710. As such, it may repeat itself at the end of preselected time period of Blue Line 2381 and can contributes to the dynamic risks in trading.

In certain instances, formation of multiple scheduled events of Blue Line 6710 and continuous scheduled intersection 6715 with zone lines 1006, in one direction, may constitute steps in shape, which may further serve as an indication of trend development. Multiple intersections of the Blue Line 6715 with multiple zone lines 1006 can serve as a confirmation of a previously strong trend.

In certain other instances, hybrid zone range risk 276 preferably may identify the risk associated with any market vehicle, by determining its location between its highest recent position and its lowest position, preferably over designated periods, preferably in a dynamic motion. Hybrid zone range risk 276 preferably may be subdivided into two or more major dynamic zones lines 1006, as shown, for recent activities. Upon reading the teachings of this specification, those skilled in the art will now appreciate that, under appropriate circumstances, considering such issues as forecastive beliefs, cost, etc., other zone lines, such as, for example, higher zone lines, lower zone lines, subdividing zone lines, etc.

In certain instance, hybrid zone range risk 275 or dynamic zone range risk 276 areas may comprise of either a dotted or solid triangle shaped object, of user choice, which can be externally injected, and may be referred to as a spike in trading, for either a Bullish Believer's entries, Bearish Believer entries, or Neutral Believers entries, based on modified health indicator 1216.

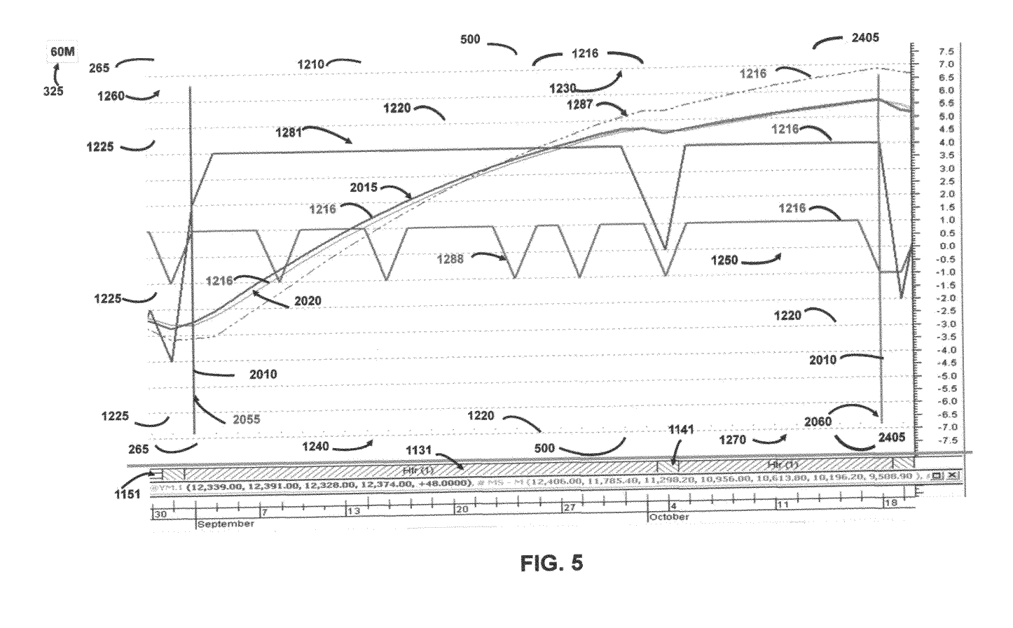

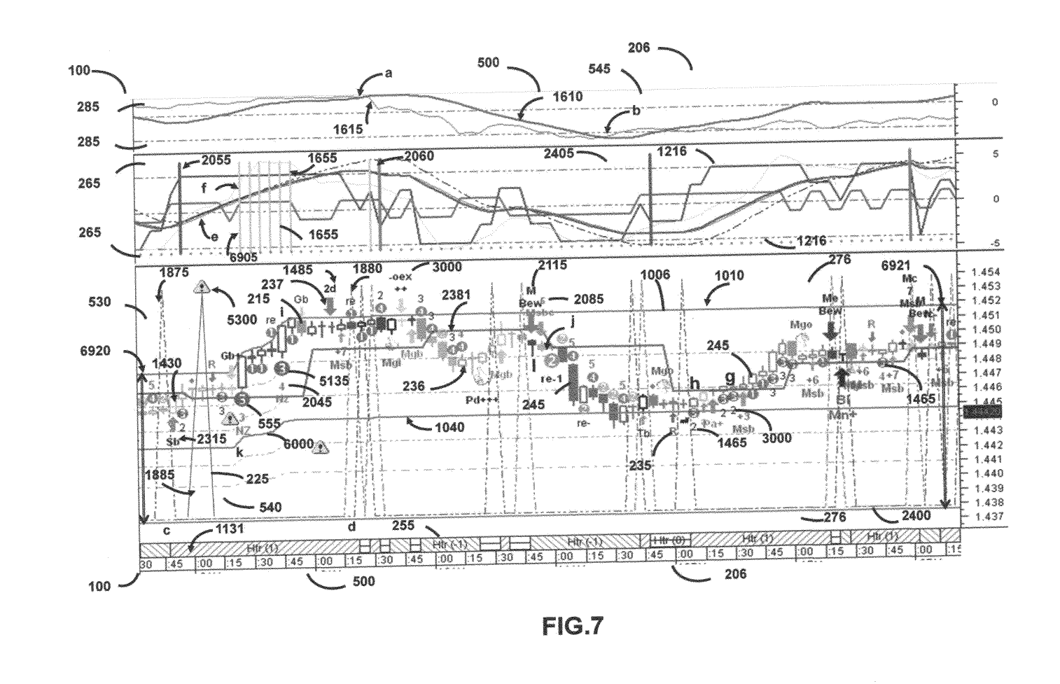

With respect to FIG. 3, certain embodiments may be designed for bear entry spike 1880, which can be understood as Spikes that can depend on multiple market risks or can be directional Spikes, based on forward looking intersection of Bearish Believers directional indicator component 2020 (FIG. 5) and Bullish Believers directional indicator component 2015 (FIG. 5) of health window 2405 (FIG. 7) to create such shape. There are certain types of bearish entry Spikes, which may include, but not limiting scope to, pre-entry Spikes for bears using multiple market risks, bear entry spike (directional), and entry Spikes for bears using multiple market risks. Certain embodiments may be designed for bullish entry spike 1875, which can be understood as Spikes that can depend on multiple market risks or can be directional Spikes, based on forward looking intersection of Bullish Believers directional indicator component 2015 and Bearish Believers directional indicator component 2020 of health window to create such shape by using Thomson-Reuters Metastock® Pro software, E-Signal®, TradeStation®, or similar financial software. There are certain types of bullish entry Spikes, which may include, but not limiting scope to, pre-entry Spikes for bulls using multiple market risks, bull entry spike (directional), and entry Spikes for bulls using multiple market risks.

In certain additional instances, the dynamic changes on any zone line 1006 can indicate possible changes in the near future, which may further serve as an indication of possible lower prices or higher prices for a market vehicle, depending upon the direction of the change. It should be understood that a key indication may be that one of either uppermost zone line 1010 or lowermost zone line 1070 must be steady and other zone lines vary to higher levels or lower levels compared to previous zone levels. After initial movement of the seven zone lines in one direction, while one of either uppermost or lowermost zone levels remain steady, one of the uppermost or lowermost zone lines may start moving and at one time, all seven levels will move in one direction and establish either new higher or new lower prices in the market. In many cases, zone lines 1006 may make a trough formation first, before possibly making such new higher prices or new lower prices compared to previous periods under consideration. The smaller the period selection, the more such events occur.

Due to dynamic nature of market, in certain instances, these zone levels 1006 or distances 1015 can be dynamically adjusted as changes occur, without the traditional limitations of Fib levels or pivot levels. In addition, zone lines 1006 preferably move independent of one another, showing true levels of risk areas from one to another. It is not necessary to have a constant distance between all zone levels. More zone lines 1006 may preferably be added by changing designated periods, preferably the mixing zones 1025 or 1026 to see earlier changes in market than even a fixed period for all zones 1025 or 1026, helping a user and/or trader with upcoming changes in a market vehicle prices, including directional changes.

In this manner, multiple factors can be dynamically displayed in certain instances, to assist in forecasting future market direction. Additionally, several calculations of zone lines 1006 may preferably be mixed to find an average zone level price, alternately preferably may be combined to derive additional zone lines 1006. An algorithm may also be used, preferably to bring the values of zone lines 1006 from other time frames 325, preferably superimposing other zone lines 1006 from other time frames 325, preferably to create an effect of multiple time frame zone lines for efficient trading.

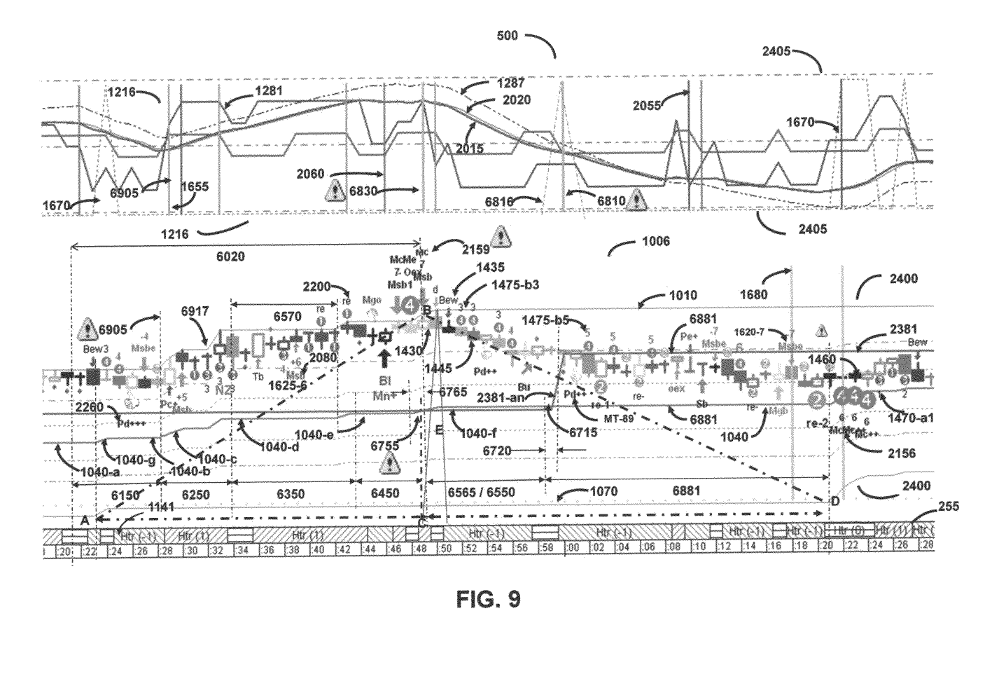

A trader or user may understand that Blue Continuation Spikes 1670 (FIG. 9) may occur due to the dynamic changes within a market over a period of time. As such changes are adapted by different Zone Lines such as 1020, 1030, 1040, 1050, 1060, and 1070, with the exception of 1010, a new series of shifting points may get created within all zone lines with the exception for 1010, to adapt to such recent market conditions. The comparison of the diminution of the immense value of the eminent value over a period of time detracting the nether value of the squat value over a period of time and the aggregation with the nether values of the squat value over a period of time, may help to find the shifting points of Zone Lines with the exception of 1010 under the shifting to reflect the dynamic changes. A trader or user may refer to FIG. 9 for some examples of Blue Continuation Spike 1670.

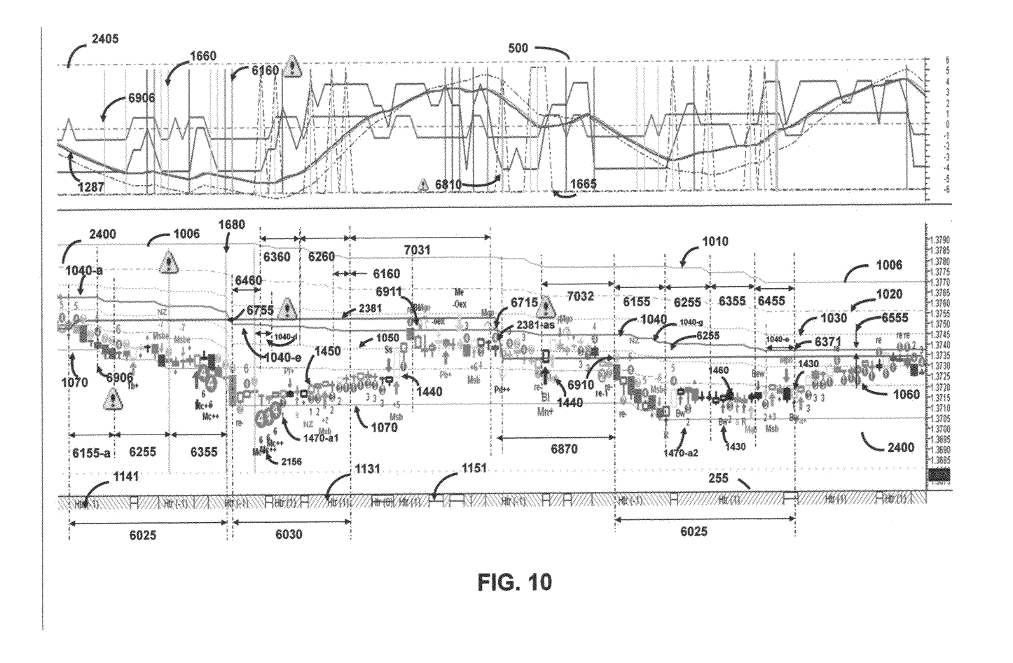

A trader or user may understand that Black Transition Spike 1665 (FIG. 10), can be considered a neutral spike, may occur due to the dynamic changes within the market over a period of time. As such changes are adapted by different Zone Lines such as 1010, 1020, 1030, 1040, 1050, and 1060, with the exception of 1070, a new series of shifting points may get created within all zone lines with the exception of 1070, to adapt to such recent market conditions. The comparison of the diminution of the immense value of the eminent value over a period of time detracting the nether value of the squat value over a period of time and the aggregation with the nether values of the squat value over a period of time, may help find the shifting points of Zone Lines with the exception of 1070 under the shifting to reflect the dynamic changes.

A trader or user may be alerted by all important events as illustrated by a yellow triangle or any trader or user desired colors or shapes. All important events selected by a trader or user can have alerts may be sent via electronic mail, PDA's, or by audio/visual alert on chart during trading.

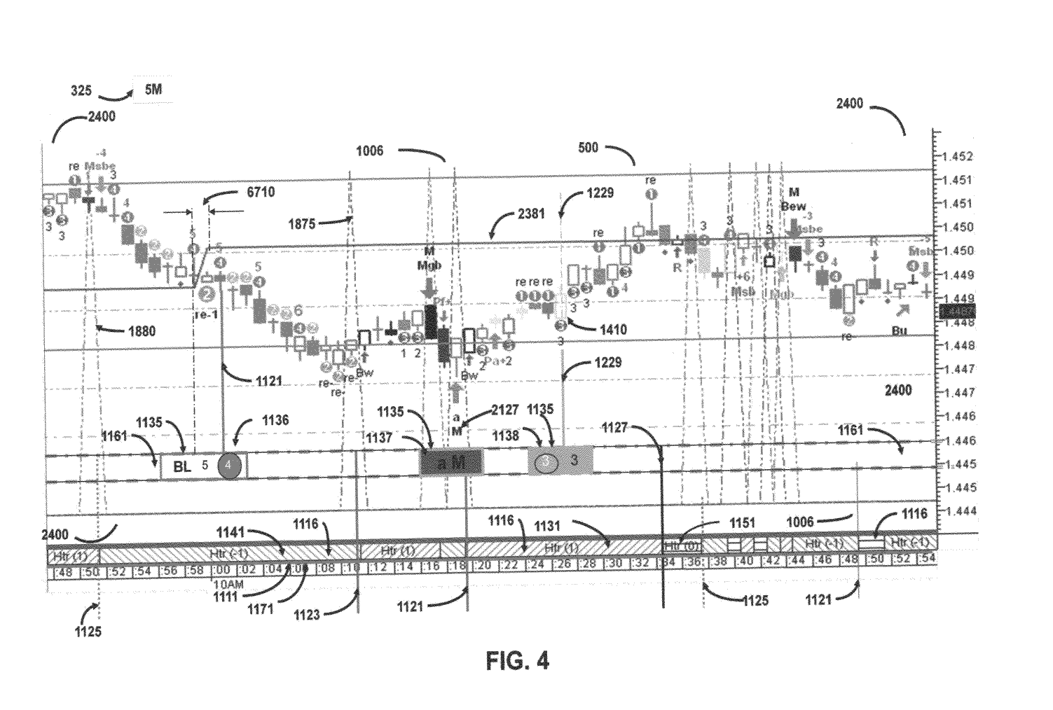

FIG. 4 shows one embodiment of a display, showing an illustrative screenshot view which is displaying a Horizontal Time Risk dimension 255 (FIG. 2), as may be included within certain embodiments of the multidimensional risk analysis systems 100 of FIGS. 1 and 2. In the Horizontal Time Risk dimension (time duration risk 255), indicators 500 preferably comprise at least one modified time spectrum ribbon 1111. In certain instances, modified time spectrum ribbon 1111 can preferably comprise at least one modified time spectrum segment 1116, preferably at least one modified bullish time spectrum segment 1131, comprising a concentration of Bullish Believers, alternately preferably at least one modified bearish time spectrum segment 1141, comprising a concentration of Bearish Believers, and alternately preferably at least one modified neutral time spectrum segment 1151, comprising the exchange between Bullish Believers to Bearish Believers or vice versa, as shown. Upon reading the teachings of this specification, those skilled in the art will now appreciate that, under appropriate circumstances, considering such issues as user preference, cost, etc., other There might be a variety of embodiments of time spectrum segments, such as, for example, partial bull time spectrum segments, partial bear time spectrum segments, etc. In certain embodiments, a distinct ribbon, and/or an indicator portion of an existing ribbon, or any indicator corresponding to market risks 205 (FIG. 2), or any portion thereof, can have its appearance, color, texture, shading, lining, etc., altered to indicate to a user a noteworthy event or minor event of user choices, such as may be used by the user and/or trader to assist in making financially related decisions.

In certain instances within trading, a trader or user can preferably find a confined location and a time spectrum, as indicated through modified time spectrum segment 1116, may be modified based on modified health risk indicator 1216 (FIG. 5) which may reduce time errors, in any time frame 325 (as shown with 5 minutes), in real time, where there is a maximum possibility of either Bullish Believers stepping desire or Bearish Believers stepping desire and there is possible mix of desire for Bullish Believers or Bearish Believers stepping/no stepping desire. There can be a Horizontal Time Risk dimension (time duration risk 255) associated in trading during the formation of a time spectrum, preferably with indicators 500 comprising modified bullish time spectrum segment 1131, modified bearish time spectrum segment 1141 and modified neutral time spectrum segment 1151, preferably indicating Bullish Believers desire, Bearish Believers desire, or a possible mix of desire for bullish or bearish situations, respectively. The longer the time spectrum segment forms, the greater the risk for any type of desire.

In certain other instances, time duration risk 255 preferably may be represented by multiple modified time spectrum ribbons 1111. At least one modified fixed time spectrum ribbon 1171 preferably represents time duration risk 255 of a time frame 325, currently displayed. Additionally, at least one modified floating time spectrum ribbon 1161 can be preferably used to represent at least one hybrid of time duration risk from other time frames 325 (at least embodying herein at least one time-frame computer display structured and arranged to display, relating to each of such plurality of time frames, at least some of such current values of such plurality of market risk factors; and at least embodying herein displaying, relating to each of such plurality of time frames, at least some of such current values of such plurality of market risk factors), alternately preferably from previous time frames 325. It should be understood that a modified floating time spectrum ribbon 1161 may be considered an event based ribbon.

Modified fixed time spectrum ribbon 1171 comprises at least one flashing segment 1135, preferably colored, which delivers messages for corresponding candle or bar color, symbols and its colors around candle or bar, identify Hybrid Dynamic Zone Lines 1006 or any user selected items of multidimensional risk systems 100. FIG. 4 provides an illustrative display of three types of flashing segments 1135, such as flashing segment 1136, flashing segment 1137 and flashing segment 1138. Flashing segment 1136 can indicate a Scheduled Event of Blue Line 6710 may be occurring, which can be messaged as “BL” and few minutes later, message “5 4” can be displayed stating number five risk and the market vehicle forecasting further low prices. Modified time risk hybrid line 1229 can preferably comprise a vertical line drawn thru a candle or a bar aids the user in recognize the risk in Bearish Believers favor forecasting further low prices based on “5 4” flashing segment 1137 indicates, type M scalp swing set up 2127 is forming indicated “a M”, the color indicates the type of price sectional risk named type “a”. Green spike 1875 can further confirms Bullish Believers entry, thereupon confirming the multi-confirmation of multiple risk dimensions and pin point entries with easy application of colors, symbols, numbers and alphabets.

In certain alternate instances, modified fixed time spectrum ribbon 1171 preferably comprises at least one modified time risk line 1121. Each modified time risk line 1121 preferably comprises a modified time risk bullish line 1123, alternately preferably a modified time risk bearish line 1125, alternately preferably a modified time risk neutral line 1127, or alternately preferably a modified time risk hybrid line 1229. Though not illustrated, modified time risk line 1121 preferably comprises at least one indicator color for distinguishing between modified time risk bullish line 1123, modified time risk bearish line 1125, modified time risk neutral line 1127, and a modified time risk hybrid line 1229.

For a bullish Horizontal Time Risk, modified time risk bullish line 1123 usually comprises a vertical line preferably drawn before the beginning of a bullish Horizontal Time Risk actual time frame either candle or bar, as shown. Modified time risk bullish line 1123 can preferably be followed by either modified bearish time spectrum segment 1141 or modified neutral time spectrum segment 1151.

For a bearish Horizontal Time Risk, modified time risk bearish line 1125 can comprise a vertical line preferably drawn before the beginning of a bearish Horizontal Time Risk actual time frame either candle or bar, as shown. Modified time risk bearish line 1125 can be followed by either Modified bullish time spectrum segment 1131 or Modified neutral time spectrum segment 1151.

For a modified neutral Horizontal Time Risk, modified time risk neutral line 1127 can comprise of a modified vertical line preferably drawn before the beginning of a modified neutral Horizontal Time Risk actual time frame either candle or bar, as illustrated. Modified time risk neutral line 1127 can be followed by either modified bullish time spectrum segment 1131 or modified bearish time spectrum segment 1141.

In certain instances, modified time risk hybrid line 1229 can preferably comprise a vertical line drawn thru a candle or a bar, when a sudden event occurs in the market, due to dimension risk #5 (internal market moving risk 215), in modified floating time spectrum ribbon 1161, as shown. Indicators 500 for time duration risk 255 can preferably pinpoint at least one location, when real increasing Bullish Believers stepping desire, real increasing Bearish Believers stepping desire or mix stepping/no stepping desires exist in the market, along with multiple confirmations represented by colored candles or bars representations. Flashing segment 1138 delivers a possible message of “3 3” inside turquoise colored segment with modified time risk line 1229 connecting to sudden market risk bullish candle 1410 with “3” forecasting further high prices of market vehicle with risk designation number 3. Modified time risk hybrid line 1229 can preferably comprise a vertical line drawn through a candle or a bar aids the user in recognize the risk in Bearish Believers favor forecasting further low prices based on “5 4”.

In certain instances, as shown in FIG. 4, by “a M” (bullish Dk yellow candle—type a (M) 2127), an algorithm can preferably be created using confirmed swing locations in either direction in trading, comparing higher stepping desire values with previous higher stepping desire values, comparing lower stepping desire values with previous stepping lower desire values, the number of bars since these events have occurred, the highest values of stepping swings, and the lowest values of stepping swings. Upon reading the teachings of this specification, those skilled in the art will now appreciate that, under appropriate circumstances, considering such issues as cost, user preference, etc., other indicators, such as, for example, PSSTOCH, moving averages, lag less averages, directional indicators, money flow, CCI, etc., may be injected.

FIG. 5 shows one embodiment of a display, showing an illustrative screenshot view which is displaying a health risk dimension component, as may be included within certain embodiments of the multidimensional risk analysis systems 100 of FIGS. 1 and 2. Trend Health Risk 265 (FIG. 7) preferably uses indicators 500, preferably comprising at least one oscillating risk indicator 1210, preferably representing a dynamic oscillating risk assessment of a trend movement of upward, downward or sideways in trading of any market vehicle. Oscillating risk indicator 1210, within a preferably created, preferably adjustable boundary (Boundary Lines 1220) preferably locates a risk tolerance at any given time, in any time frame 325 for any Market Vehicles. This concept can allow checking health of risk in the market on a variable adjustable scale.

Certain embodiments of oscillating risk indicator 1210 preferably comprises at least two Boundary Lines 1220, preferably at least eleven Boundary Lines 1220. Oscillating risk indicator 1210 preferably further comprises at least one oscillating risk indicator component 1216, preferably at least five oscillating risk indicator components 1216 and at least an optional two directional line Indicator component 2010, comprise of one Bullish Believers directional line Indicator component 2055 and one Bearish Believers directional line component 2060.

Certain embodiments of health risk directional indicator components 2010 for modified health risk indicator 1216 are based on debasing conventional progressing mean of prices and still keeping the integrity of all health risk components 1215 of previously submitted design to produce real dynamic, adaptive, true, much reliable direction either for Bullish Believers or for Bearish Believers. Two components herein referred to as Bullish Believers directional indicator component 2015 and Bearish Believers directional indicator component 2020, are integral part of modified health risk indicator components 1216.

One of the two optional directional line indicator component 2010 may comprise one Bullish Believers directional line Indicator component 2055, based on dynamic strength risk indicator 1287 and its mean values over a specified period and give priority to strength risk indicator 1287 over values mean values of dynamic strength risk indicator 1287. A trader or user may use more than one indicators of his/her choices and use delay free or lag less types of options to produce types of results wanted for accuracy. Bullish Believers directional line indicator component 2055 is late in nature, but provides general Bullish Believers confirmed direction.

Another of the two optional directional line indicator component 2010 comprise of one Bearish Believers directional line indicator component 2060, based on dynamic strength risk indicator 1287 and its mean values over a specified period and give priority to strength risk indicator 1287 over values mean values of dynamic strength risk indicator 1287 One may use more than one indicators of his/her choices and use delay free or lag less types of options to produce types of results wanted for accuracy. Bullish Believers directional line indicator component 2055 is late in nature, but provides general Bullish Believers confirmed direction

In certain instances, Boundary Lines 1220 can comprise an uppermost boundary line 1230, a lowermost boundary line 1240 and core Boundary Lines 1250 of the dynamic oscillating risk. The values may vary, depending upon the risk associated with a particular market vehicle. Typically, the approximate values observed are between −7 to +7 for Boundary Lines 1220 for various types of Market Vehicles. Boundary Lines 1220 preferably define at least one risk area 1225.

The values of Boundary Lines 1220 from +6 and exceeding +6 can, in certain configurations, represent uppermost risk areas for Bullish Believers and lowermost risk areas for Bearish Believers (risk areas 1260), when any of seven health risk indicator components 1216 are taken into consideration individually or combined. The values of Boundary Lines 1220 from −6 and less than −6 preferably represent corresponding uppermost risk areas for Bearish Believers and lowermost risk areas for Bullish Believers (risk areas 1270). Oscillating risk indicator 1210 in risk areas 1260 preferably can indicate a near peak risk for Bullish Believers and entry points for Bearish Believers. Likewise, oscillating risk indicator 1210 in risk areas 1270 preferably can indicate a near trough risk for Bearish Believers and entry points for Bullish Believers. In certain instances, oscillating risk indicator 1210 may be displayed for multiple time frames 325, preferably in real time. Boundary line 1220 values preferably vary depending upon market conditions, type of market vehicle, and preferably may be plotted on vertical scale in a horizontal line format, as shown. Upon reading the teachings of this specification, those skilled in the art will now appreciate that, under appropriate circumstances, considering such issues as user preference, cost, desired accuracy, etc., other quantities of Boundary Lines may suffice.

A trader or user skilled in the art may understand that the health risk indicator 1216 can allow a trader or user to determine the internal health of any particular market vehicle with the possible use of the various health risk indicator components. In certain instances, modified health risk indicator component 1216 can preferably comprise at least one modified positive/negative-indicator count 1281. Positive/negative-indicator count 1281 may preferably comprise a non-zero integer value. Modified positive/negative-indicator count 1281 preferably comprises at least one summation of counts of modified positive and/or negative indicators. Such modified positive and/or negative indicators 1281 preferably include traditional indicators, of trader or user choice, such as Percentage price Oscillator, percentage Volume Oscillator, Relative Strength Index, Stoch RSI, William % R, Difference of Two EMAs, open, close, High, or low values and its comparisons over a selected period of time, price health relative to past movements, rate at which Market vehicle prices are changing, alternately preferably modified indicators, alternately preferably specialty indicators, alternately preferably proprietary indicators or any numbers of Indicators as per a trader or user's choice. A trader or user may balance the selected Indicators, at least one summation of counts, for speed, in either traditional or proprietary Indicators, by making them slower, making a few of them faster than others or mixing and matching the speed, periods, and/or price change differentials.

Modified positive/negative-indicator count 1281 is slower than positive/negative-indicator count, which was submitted in previous design and requires less periods of selected time frame 325. Each indicator increases count of modified positive/negative-indicator count 1281 by one, when positive, or decreases count of modified positive/negative-indicator count 1281 by one, when negative. Count of modified positive/negative-indicator count 1281 preferably comprises a maximum value equal to the number of indicators used and a minimum value equal to the number of indicators used in the negative. When modified positive/negative-indicator count 1281 drops below zero, it is considered that the health risk for a bullish direction is very high. When modified positive/negative indicator count 1281 has a value equal to the minimum, it is considered that the market vehicle health risk for a bearish outlook is very good. Likewise, once Modified positive/negative-indicator count 1281 increases above zero value, it is considered that the health risk is very high for a bearish outlook for a market vehicle. Also, when Modified positive/negative-indicator count 1281 has a value equal to the maximum, it is considered that the market vehicle health risk for a bullish outlook is very good.

A further health risk indicator component 1216 preferably comprises at least one modified dynamic strength risk indicator 1287. Modified dynamic strength risk indicator 1287 preferably is designed similar to dynamic strength risk indicator 1286 in previous design of health risk indicator component, except preferably for lesser periods for the rate at which the market vehicle prices (open, high, low or close) are changing based on Bullish Believeness or Bearish Believeness. The independency preferably helps to avoid further lag errors in traditional or custom indictors used, as well as, earlier or later travel to extreme oscillating risk boundaries. Values of modified dynamic strength risk indicator 1287 preferably vary between about +7 and about −7, but may also vary from market vehicle to market vehicle depending upon behavioral patterns at the time of its life span.

Another health risk indicator component 1216 preferably comprises at least one internal health risk indicator 1288. Values of internal health risk indicator 1288 preferably vary between about +1 and about −1. If values of internal health risk indicator 1288 are about +1 and stays about +1, it preferably is an indication of a health risk that is likely to stay bullish. If values of internal health risk indicator 1288 fall from about +1 and stays below zero and reach to about −1 and then stays at a steady value of about −1, then values of internal health risk indicator 1288 are weak and preferably indicates the health risk for Bullish Believer has deteriorated and is confirmed. Likewise, if values of internal health risk indicator 1288 are about −1 and stays about −1, it preferably is an indication of a health risk that is likely to stay bearish. If values of internal health risk indicator 1288 rise from about −1 and stays above zero and reach to about +1 and then stays at a steady value of about +1, then values of internal health risk indicator 1288 are strong and preferably indicates the health risk for Bearish Believer has deteriorated and is confirmed. Internal health risk indicator 1288 may preferably be designed based on stepping desire values mixed with three different types of trend calculations.

Another modified health risk indicator component 1216, preferably comprises at least one Bullish Believers directional indicator component 2015. A trader or user may preferably select the number of indicators, preferably comprising traditional indicators, alternately preferably proprietary indicators, alternately preferably custom indicators, as desired, but keeping the basis of design of health risk directional indicator 2010 applicable to modified health risk indicator 1216. A trader or user may additionally preferably select the polarity, and modify such selected indicators for time delays errors. Further, Bullish Believers directional indicator component 2015 may preferably be customized to oscillate between and beyond a boundary, alternately preferably between boundaries to preferably measure the underlying strength. An extreme value of beyond or equal to about −6, using at least four indicators, preferably indicates possible extreme risk for bullish earlier entries and preferably indicates very high risk health for Bearish Believers. An extreme value of beyond or equal to about 6, using at least four indicators, may preferably indicates possible extreme risk for bearish earlier entries and preferably indicates very high risk health for Bullish Believers.

Yet another modified health risk indicator component 1216 preferably comprises at least one Bearish Believers directional indicator component 2020. Bearish Believers directional indicator component 2020 is preferably designed to oscillate between the maximum and minimum polarity values indicated in modified positive/negative-indicator count 1281. Bearish Believers directional Indicator component 2020 preferably comprises at least one algorithm written based on a set of traditional indicator methods, but derived from basis of design of health risk directional indicator 2010 applicable to modified health risk indicator 1216. In normal market conditions, the value of Bearish Believers directional Indicator component 2020 varies between about 4 and about −4. Any values greater than about 4, up to the maximum, indicate an extreme health risk issue for Bullish Believers entries, indicating possible reversals from a Bullish Believers to a Bearish Believers direction or profit takings. Any values less than about −4, down to the minimum, indicate an extreme health risk issue for Bearish Believers entries, indicating possible reversals from a bearish to a bullish direction or profit takings.

Two components may be referred to as Bullish Believers directional indicator component 2015 and Bearish Believers directional indicator component 2020, Modified Health risk indicator components 1216, preferably have an inherent nature of synchronization with each other either preferably partially or, alternately preferably fully, when desired and adjusted by a trader or user. Bullish Believers directional indicator component 2015 and Bearish Believers directional indicator component 2020, when synchronized and staying together in upward direction, preferably indicate a strong possibility of continuity of upward trend. In addition, when Bullish Believers directional indicator component 2015, Bearish Believers directional indicator component 2020 and modified dynamic strength risk indicator 1287 are synchronized together in an upward direction, it preferably indicates an even stronger upward strength possibility for bullish belief, until Modified dynamic strength risk indicator 1287 reaches a maximum.

The relation of Bearish Believers directional indicator component 2020, Bullish Believers directional indicator component 2015 and modified dynamic strength risk indicator 1287 for bearish belief exactly mirror bullish belief, as stated earlier. Once the polarity of modified positive/negative-indicator count 1281 and internal health risk indicator 1288 are equal, synchronization preferably occurs. If the polarity is positive for modified positive/negative-indicator count 1281 and internal health risk indicator 1288, then it preferably indicates a smooth strong bullish flow for believers. If the polarity is negative for modified positive/negative-indicator count 1281 and internal health risk indicator 1288, then it indicates a smooth strong bearish flow for believers.

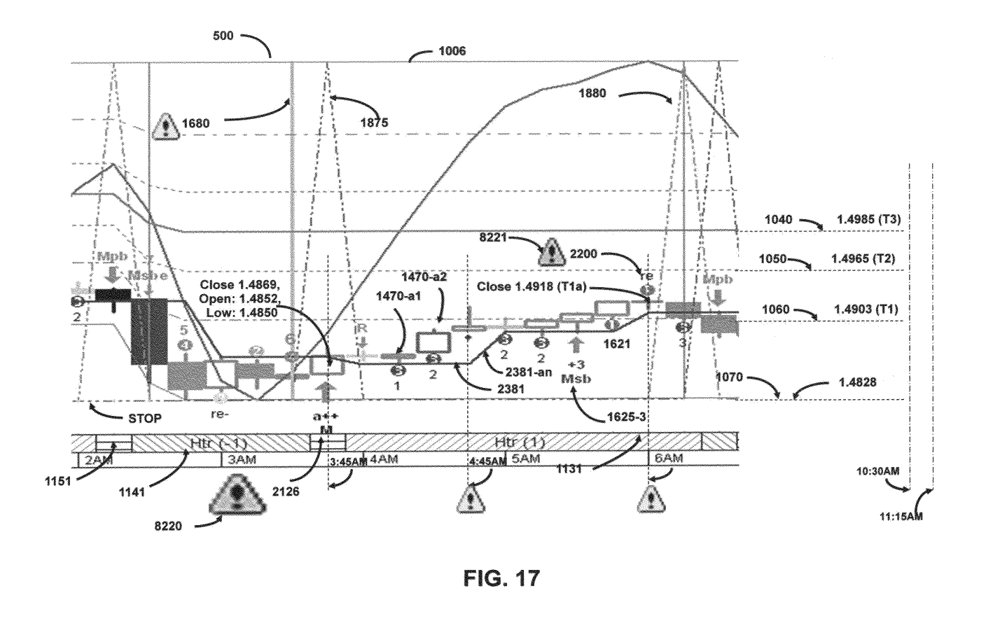

A trader or user may understand, with respect to pin point reversals named as, Super Bullish Belief Contra +Re 2200 (FIG. 17), that when the Trend Health 2405 of a market vehicle or a security looks optimistic for the Bullish Believers, it internally may be becoming offset by the development of its own weakness and may create a controversy to the Trend Health 2405 and to the Modified Bullish Time Segment 1131, and may possibly create a reversal of prices and possibly of the trend. A trader or user may refer to FIGS. 10, 11, 14, and 17 for some examples of Super Bullish Belief Contra +Re 2200.

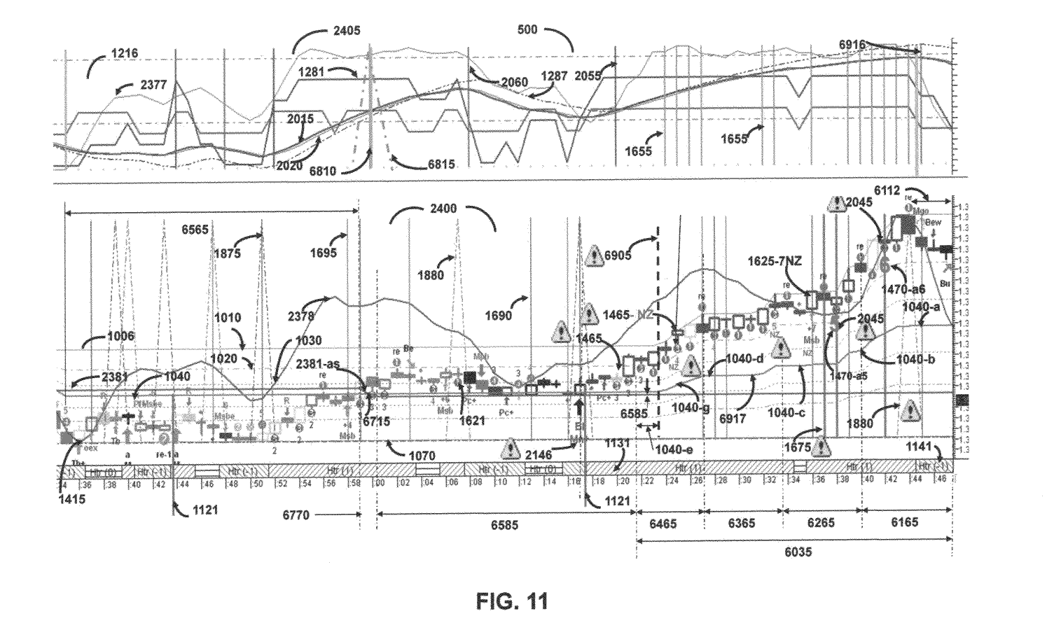

A trader or user may understand that, with respect to pin point reversals named as, Super Bullish Belief Contra +RE1 (not illustrated), when the Trend Health 2405 of a market vehicle or security looks optimistic for the Bullish Believers, it internally may be becoming offset by the development of Bear Entry Spike 1880 (FIG. 3) and Bear Spot Risk line 1695 (FIG. 11) and may create a controversy to the trend health 2405 and to the Modified Bullish Time Segment 1131 and may possibly create a reversal of the prices and possibly of the trend.

A trader or user may understand, with respect to pin point reversals named as, Super Bullish Belief Contra +RE2, that when the Trend Health 2405 of a market vehicle or security looks optimistic for the Bullish Believers, it internally may be becoming offset by the development of Bear Entry Spike 1880 (FIG. 3) and Bear Spot Risk line 1695 (FIG. 11) along with additional Bearish Risk Recognition factors from the User's Manual and may create a controversy to the trend health 2405 and to the modified bullish time segment 1131 and may possibly create a reversal of the prices and possibly of the trend. This can be more powerful than Super Bullish Belief Contra +RE1 2200 (FIG. 17).

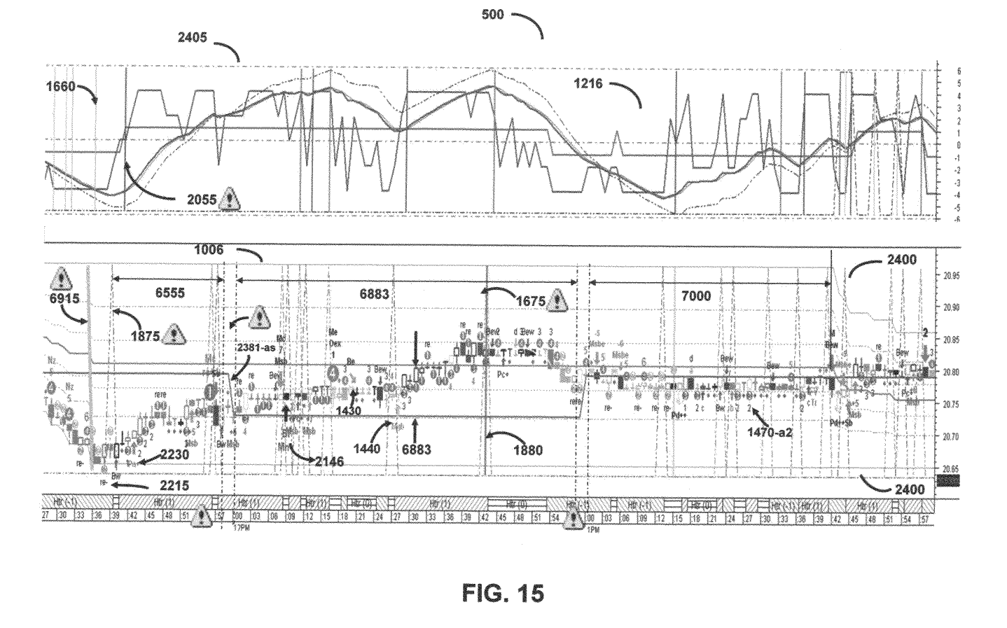

A trader or user may understand that, with respect to pin point reversals named as Super Bearish Belief Contra −RE-2215 (FIG. 3), when the Trend Health 2405 of a market vehicle or security appears optimistic for the Bearish Believers, it internally may be becoming offset by the development of its own weakness and may create a controversy to the Trend Health 2405 and to the Modified Bearish Time Segment 1141 and may possibly create a reversal of the prices and possibly of the trend. A trader or user may refer to FIG. 15 for some examples of Super Bearish Belief Contra −Re-2215.

A trader or user may understand that, with respect to pin point reversals named as Super Bearish Belief Contra −RE-1 2220 (FIG. 3), when the Trend Health 2405 of a market vehicle or security appears optimistic to the Bearish Believers, it internally may be becoming offset by the development of Bull Entry Spike 1875 (FIG. 3) and Bull Spot Risk line 1690 (FIG. 11) and may create a controversy to the trend health 2405 and to the Modified Bearish Time Segment 1141 and may possibly create a reversal of the prices and possibly of the trend. A trader or user may refer to FIGS. 11, 12 and 14 for some examples of Super Bearish Belief Contra −Re-1 2220.

A trader or user may understand that, with respect to pin point reversals named as Super Bearish Belief Contra −RE-2, when the Trend Health 2405 of a market vehicle or security appears optimistic for the Bearish Believers, it internally may be becoming offset by the development of Bull Entry Spike 1875 (FIG. 3) and Bull Spot Risk Line 1690 (FIG. 11) and may create a controversy to the Trend Health 2405 and to the Modified Bearish Time Segment 1141 and may possibly create a reversal of the prices and possibly of the trend. This can be more powerful than Super Bearish Belief Contra −Re-1 2220.

A trader or user may understand that a “Bullish Believer Condition” may develop in trading when the various components of Trend Health Risk 265 (FIG. 5), such as but not limiting scope to, internal health risk indicator 1288 (FIG. 5) and modified positive/negative indicator 1281 (FIG. 5) can be aligned above zero Boundary Lines 1250 (FIG. 5) with modified bullish time segment 1131 (FIG. 5) and price perception risk 245 (FIG. 7), which are preferably for sections “a”, “b” or “c”. As such may be for trading a market vehicle in any time frame that may comprise of tick to yearly or any combination of time frames.

A trader or user may understand that a “Bearish Believer Condition” may develop in trading when the various components of Trend Health Risk 265 (FIG. 5), such as, but not limiting scope to, internal health risk indicator 1288 (FIG. 5) and modified positive/negative indicator 1281 (FIG. 5) can be aligned below zero Boundary Lines 1250 (FIG. 5) with modified bearish time segment 1141 (FIG. 5) and price perception risk 245 (FIG. 7), which are preferably for sections “d”, “e” or “f”. As such may be for trading a market vehicle in any time frame that may comprise of tick to yearly or any combination of time frames.

A trader or user may understand that a “Neutral Believer Condition” may develop in trading when the various components of Trend Health Risk 265 (FIG. 5), such as, but not limiting scope to, internal health risk indicator 1288 (FIG. 5) and modified positive/negative indicator 1281 (FIG. 5) can be both aligned at the zero Boundary Lines 1250 at the same time or either one of them (FIG. 5) with modified neutral time segment 1151 (FIG. 5) and price perception risk 245 (FIG. 7), which are preferably for section “d”, As such may be for trading a market vehicle in any time frame that may comprise of tick to yearly or any combination of time frames.

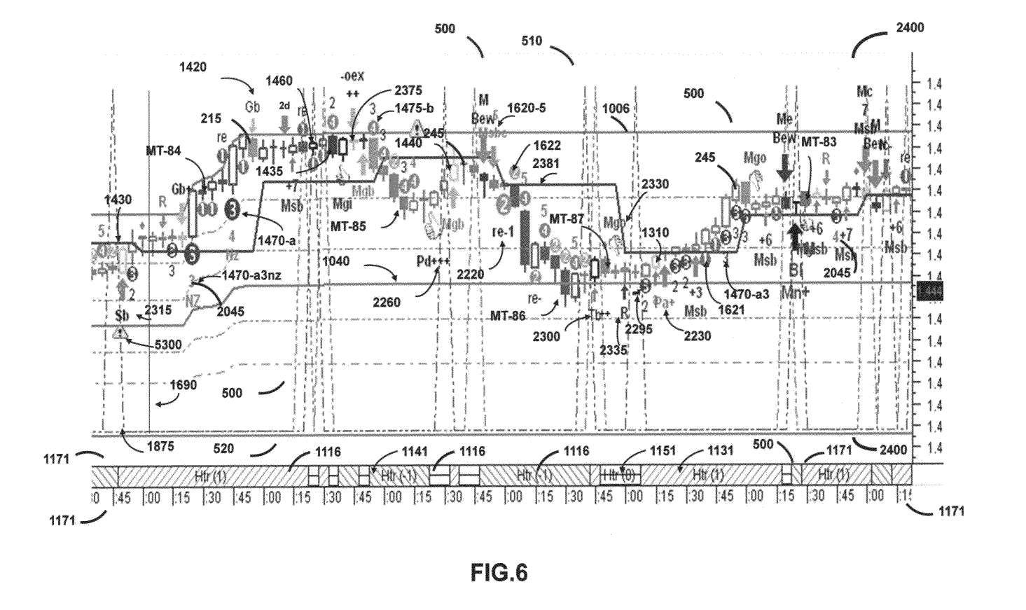

A trader or user may understand that a “Super Bullish Believer Entry” 1621 (FIG. 6) condition may develop in trading when the various components of Trend Health Risk 265 (FIG. 7) such as internal health risk indicator 1288 (FIG. 5) and modified positive/negative indicator 1281 (FIG. 5) have possibly aligned above the zero boundary line 1250 (FIG. 5) with modified bullish time segment 1131 (FIG. 5) and price perception risk 245 (FIG. 7), which are preferably for sections “a”, “b”, or “c”, but only as such when both modified positive/negative indicator 1281 (FIG. 5) and boundary line 1220 (FIG. 5) remain horizontal.

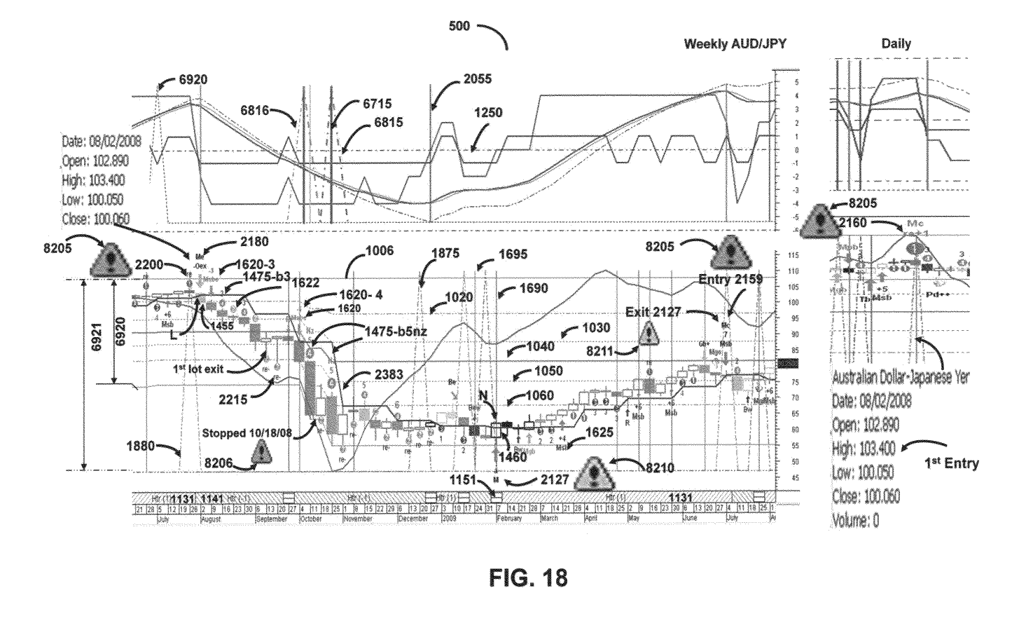

A trader or user may understand that “Super Bearish Believer Entry” 1622 (FIG. 18) condition may develop in trading when the various components of Trend Health Risk 265 (FIG. 5) such as internal health risk indicator 1288 (FIG. 5) and modified positive/negative indicator 1281 (FIG. 5) have possibly aligned below the zero Boundary Lines 1250 (FIG. 5) with modified bearish time segment 1141 (FIG. 5) and price perception risk 245 (FIG. 7), which are preferably for sections “d”, “e”, or “f”, but only as such when both modified positive/negative indicator 1281 (FIG. 5) and Boundary Lines 1220 (FIG. 5) remain horizontal.

A trader or user may understand that “Super Belief Neutral Pinpoint Entries (For Bullish Believers)” (FIG. 18) condition may develop in trading when the various components of Trend Health Risk 265 (FIG. 5) such as internal health risk indicator 1288 (FIG. 5) and modified positive/negative indicator 1281 (FIG. 5) are approaching the zero Boundary Lines 1250 (FIG. 18) from more negative to less negative within a short period of time, achieve a value of zero at the same time or within a very short period of time, and then become more positive. A trader or user may further understand that such events may be illustrated within either a modified neutral time segment 1151 (FIG. 18) or by two time segments side by side, such as modified bearish time segment 1141 next to modified bullish time segment 1131. A black neutral candle 1460 or subsequent black candles/bars over a period of time, may be observed during such events and price perception risk 245 (FIG. 18) which are preferably for sections “a”, “b”, or “c” are at the zero boundary line 1250 (FIG. 18). Such Super Belief Neutral Pinpoint Entries (For Bullish Believers) may be observed with, for example, bullish DK yellow candle type a(M) 2127 (FIG. 18), wherein “a” is the price perception risk defined with a black colored candle to possibly indicate an exchange from Bearish Believers to Bullish Believers within the specified candle/bar under observation, hereby referred to as point “N”, and thereupon can be considered a Super Belief Neutral Pinpoint Entries (For Bullish Believers).

A trader or user may understand that “Super Belief Neutral Pinpoint Entries (For Bearish Believers)” (FIG. 18) condition may develop in trading when the various components of Trend Health Risk 265 (FIG. 5) such as internal health risk indicator 1288 (FIG. 5) and modified positive/negative indicator 1281 (FIG. 5) are approaching the zero Boundary Lines 1250 (FIG. 18) from more positive to less positive within a short period of time, achieve a value of zero at the same time or within a very short period of time, and then become more negative. A trader or user may further understand that such events may be illustrated within either a modified neutral time segment or by two time segments side by side, such as modified bullish time segment 1131 next to modified bearish time segment 1141. A black neutral candle (overlaid by a tan colored candle 1455 for illustrative purposes), may be observed during such events and price perception risk 245 (FIG. 18) which are preferably for sections “e”, or “f” are at the zero boundary line 1250 (FIG. 18). Such Super Belief Neutral Pinpoint Entries (For Bearish Believers) may be observed with, for example, tan bearish entry −(Me) 2180 (FIG. 18), wherein “f” is the price perception risk defined within the tan bearish candle and “−oex” may serve as an indication that there is a possible extended previous bullish condition with a tan colored candle to possibly indicate an exchange from Bullish Believers to Bearish Believers within the specified candle/bar under observation, hereby referred to as point “L”, and thereupon can be considered a Super Belief Neutral Pinpoint Entries (For Bearish Believers).

A trader or user may understand that the term “Believeness” can be defined as when a majority of traders or users trading a particular market vehicle believe that they should either be going in the long (bullish), short (bearish) or are neutral about the market vehicle and as such may be classified as “Bullish Believeness”, “Bearish Believeness” or “Neutral Believeness”.

A trader or user may be alerted by all important events as illustrated by a yellow triangle or any trader or user desired colors or shapes. All important events selected by a trader or user can have alerts may be sent via electronic mail, PDA's, or by audio/visual alert on chart during trading.

Upon reading the teachings of this specification, those skilled in the art will now appreciate that, under appropriate circumstances, considering such issues as market vehicle cost, etc., other health risk components may suffice.

FIG. 6 shows one embodiment of a display, showing an illustrative screenshot view which is displaying a price perception indicator 510 and internal movement indicator 520, as may be included within certain embodiments of the multidimensional risk analysis systems 100 of FIGS. 1 and 2. Price perception risk 245 preferably comprises a perception of prices of a market vehicle. Price perception risk 245 preferably uses price perception indicators 510. Internal market moving risk 215 preferably may be displayed through internal movement indicator 520 (enhanced), which preferably show such conditions as they occur, alternately preferably to warn a trader or user well in advance of conditions happening, preferably working as a forecasting tools for possible future decision making in trading.

For the various bars, tags, indicators, etc., as illustrated in FIG. 6 are tended to be illustrative in nature, and not limiting in scope. The selection of the various colors, shapes, textures, symbols, numbers, sounds, alerts, an explorer, etc., are a design choice.

With certain instances of price perception risk 245, the perception of prices in the market may preferably be categorized into at least one sectional category of risk, preferably at least six sectional categories of risk, attributed to bullish, bearish and/or mixed prices, preferably using at least one analysis tool comprising algorithms, alternately preferably indicators either custom or traditional, or alternately preferably oscillators, preferably where the primary factors are either open, low, high or close prices in the dynamic motion against time. Price perception risk 245 preferably can be directly proportional to time, vertical movement of prices and repeating events. Price movements can follow a Dynamic Sectional Price Risk path, preferably following at least one sequence of sections. Any deviation from such at least one sequence in sections preferably may indicate sudden market changes, either adding more risk in trading or reducing risk in trading.

The price perception can be categorized based on its distance from a particular analysis tool. At least one bullish level preferably represents bullish belief above analysis tool and at least one bearish level preferably represents bearish belief below analysis tool. For descriptive purposes, such at least one bullish level can be designated as section “a”, section “b” and section “c”; likewise such at least one bearish level can be designated as section “d”, section “e” and section “f”.

For design purposes, section “a” as illustrated in FIG. 6 for example purposes with bullish Dk yellow candle type—a 1310, may comprise the furthest lowest price perception for a Bullish Believer from a selected analysis tool; section “b” as illustrated in FIG. 6 for example purposes with bullish bright green candle type—b MT-83, may comprise the reasonable price perceptions accepted by the Bullish Believer for a market vehicle from a selected analysis tool for a selected time period, and section “c” as illustrated in FIG. 6 for example purposes with bullish green candle type—c MT-84 may comprise the furthest highest price perception by a Bullish Believer, for a market vehicle, over a selected time period. Price perception risk 245 for Bullish Believer may preferably fall in to section “a”, section “b”, or section “c”. For ideal market behavior, the sequence has to follow section “a”, then section “b”, then section “c” for a Bullish Believer, making a bullish sequence, or it can indicate some disruption on sequential bullish sentiment.

Section “d” as illustrated in FIG. 6 for example purposes with Purple (C) Candle—type d MT-85, preferably comprises the furthest highest price perception below a selected analysis tool 1321 for a Bullish Believer, section “e” as illustrated in FIG. 6 for example purposes with Bearish Brown (C) Candle—Type e MT-86 comprises the nearest highest price perception values for a Bullish Believer for a market vehicle below a selected analysis tool, for a selected time period, and section “f” as illustrated in FIG. 6 for example purposes with Bearish Red Candle—type f MT-87, comprises the furthest lowest price perception values for a Bullish Believer, for a market vehicle below a selected analysis tool, over a selected time period. Price perception risk 245 for Bearish Believer may preferably fall in to section “d”, section “e”, or section “f”. For ideal market behavior, the sequence has to follow section “d”, then section “e”, then section “f” for a Bearish Believer, making a bearish sequence, or it can indicate some disruption on sequential bearish sentiment.

When a mix occurs of highest perception of prices and second lower perception of prices, prices can be magnetized towards the current values of a selected analysis tool, and prices may enter section “d” then returns to section “c” and repeats up to about 27 times, before prices can be completely attracted to current value of a selected analysis tool.

In section “e”, as illustrated in FIG. 6 for example purposes with Bearish Brown (C) Candle—Type e MT-86, trader's perceptions can be reasonably priced for taking risk to sell the market vehicle, as it is losing value suddenly. The trader's second perception would logically be that, he will lose more value of market vehicle, if he holds them longer. A Bullish Believer reacts to sell its own inventory, plus any other opportunist's inventory, who make a similar decision based on such observation established in section “e”. The time duration of section “e” may be shorter in most cases and does not often happen in general bullish belief for market vehicle, but may happen, if some bad news or other factors in market exists and is used for taking profit.

In section “f”, as illustrated in FIG. 6 for example purposes with Bearish Red Candle—type f MT-87, trader's perceptions are reasonably priced for eliminating risk by holding the market vehicle, as it loses value suddenly. The trader's second perception may logically be that, he may lose the value of market vehicle further and financial damage could be far beyond normal, if he holds them any longer. The reaction of a Bullish Believer is to sell his own inventory, plus other opportunist's inventory, who make similar decision based on such observation of success established in section “f”. The time duration of section “f” may be shorter in most cases and does not often happen in general bullish belief for market vehicle, but may happen, if some bad news or some other factors in market does exist and by losing faith in the market vehicle.

In certain instances, perception indicators 510 can preferably differentiate between sections, and preferably indicate confirmations. Perception indicators 510 preferably use colors for differentiation, so for illustrative purposes have been labeled on FIG. 6. Confirmations in perception indicators 510 preferably are indicated through the use of “+” signs. Perception indicators 510 may preferably also utilize arrows to differentiate directionality.

Definitions of meaning of section labeling in examples shown in FIG. 6:
“Bullish Dk Yellow Candle Type a” (indicator label 1310): There are no catalysts and the market vehicle is in section “a”.
“Bullish Dk Yellow Candle Type a+” (indicator label 2230): There is one catalysts and the market vehicle is in section “a”; this means a trader or user may want to take a risk to go long, as there is a very low risk and is double confirmed.
“Purple (C) Candle—Type d+++” (indicator label 2260): There are three catalysts and the market vehicle is in section “d”; this means a trader or user may want to take a risk to go long, as there is a very low risk, a big “thumbs up” symbol, and is quadruple confirmed, and may be understood as a pin point entry for Bullish Believers. An ordinary trader or user with minimal skills may understand how to recognize colors and symbols such as “Pd+++” and independently trade without having too much knowledge of technical skill in trading.

Upon reading the teachings of this specification, those skilled in the art will now appreciate that, under appropriate circumstances, considering such issues as clarity, cost, user preference, etc., other perception indicators, such as, for example, stars, numbers, letters, symbols, alerts, etc., may suffice. Price perception risk 245 may preferably be represented in real time using the following type of formula:

“Purple (C) Candle—Type d+++” where the purple color can indicate that the current prices may be in Dynamic Sectional Price Risk “d” (price perception risk 245). Type d indicates that the values of price perception risk 245 may be in category “d” for either a Bullish Believer or a Bearish Believer on a current bar, and there are three additional catalyst confirmations in support of price perception risk 245 and the risk to go bullish may be very low, if such symbol is located underneath the current candle/bar, as there is a triple confirmation for bullish belief; the risk to go bearish may be very low, if such symbol is located on top of the current candle/bar, as there is a triple confirmation for bearish belief. FIG. 6 illustrates a Bullish Believer Condition.

A trader or user may understand that, with respect to Risk Designators Numbers 2045, for all Price Perception Indicators 510, there are either a single risk or a multiple of risks that exist within trading. On a scale of 1 to 7, these numbers may be used to designate risk, where “1” illustrates lowest risk and “7” illustrates the highest risk. These Risk Designators 2045 may be used along with Earlier Highs 1470-a, @@@Earlier Lows 1475-b, Super Bullish Believer Entries 1621, Super Bearish Believer Entries 1622, Super Neutral Believer Entries, Super Belief Bull Pin Point Entries categories or Super Belief Neutral Pin Point Entries or Super Belief Bear Pin Point Entries categories. It should be further understood that such risk designators are produced by Risk Assessor 140 (FIG. 2) and displayed by risk assessment, recognition, confirmation, designation, forecasting or identification display 310 (FIG. 2). It is well known by those skilled in the computer/electronic/processor arts that computer and processor systems can often perform more than one function. For example, a processor-based device could perform multiple functions such as a Risk Assessor 140, Risk Designators 2045, etc. In brief, computers are not structured to perform one function, operation, or process, as is generally known in the art. A trader or user may refer to FIG. 11 for some examples of Risk Designators 2045.

A trader or user may understand that with respect to Risk Balancers, when Price Perception Indicators 510 along with Earlier Lows 1475-b or Earlier Highs 1470-a are designated by a Risk Designator Number 2045 with higher risk designations, such as for example Earlier Highs +3.6 1470-a6 (FIG. 11), and there is a possible existence of divider vertical warning lines, also known as Bull Spot Risk Lines 1690 or Turquoise PH Lines 1655 (FIG. 7), the severity of the risk designator, such as “6” can be reduced and a trader or user can use these events as a possible reason to remain within a position and possibly produce a profitable trade.

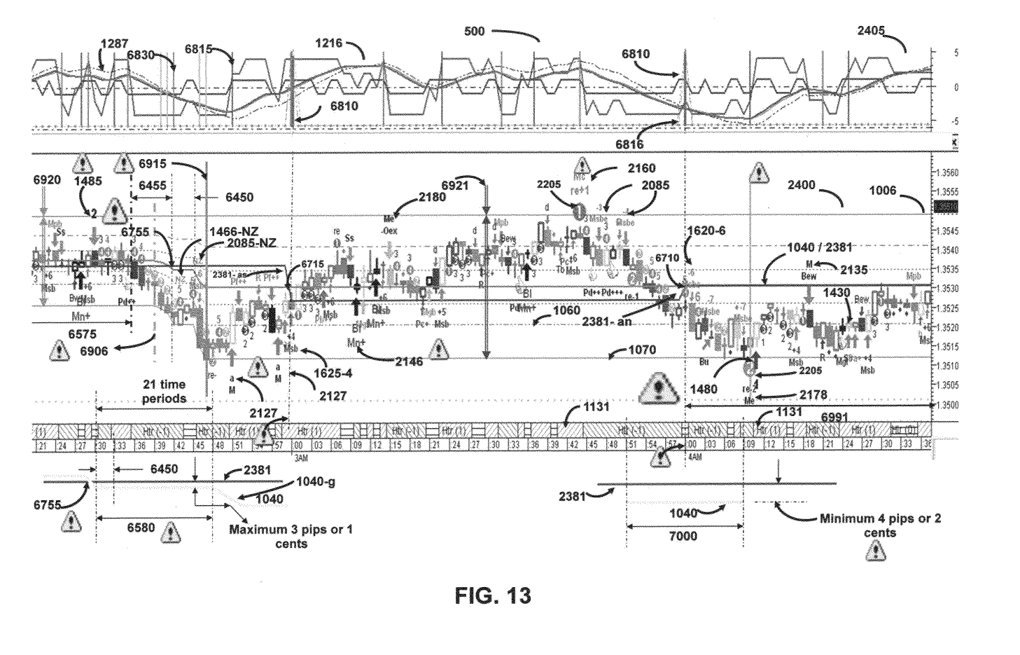

With respect to FIG. 6, such price perception indicators 510 may further be enhanced with the possible use of circles, numbers, arrows, symbols and audio/visual alerts, either on top or underneath a candle or bar in order to possibly recognize, but not limiting scope to, dynamic sectional risk transition candle/symbol, forecasting possible highs without risk assessments, forecasting possible lows without risk assessments, forecasting earlier highs with risk assessments 1465 (FIG. 7), forecasting earlier highs with risk assessments for Halved Hybrid Nozzlelism, forecasting earlier highs without risk assessments, forecasting earlier lows with risk assessments, forecasting earlier lows with risk assessments for Halved Hybrid Nozzlelism, forecasting earlier lows without risk assessments, super bullish pin point entries without risk assessments, super bearish pin point entries without risk assessments, super belief bull pin point entries categories with risk assessments, super belief bull pin point entries categories with risk assessment for Halved Hybrid Nozzlelism, super belief bull pin point entries categories without risk assessment, super belief bear pin point entries categories with risk assessment 2085 (FIG. 7), super belief bear pin point entries categories with risk assessment for Halved Hybrid Nozzlelism 2085-NZ (FIG. 13), super belief bear pin point entries categories without risk assessment, super belief pin point Reversals for Bulls to bears, super belief pin point Reversals for Bears to bulls, special market conditions for bullish entries, special market conditions for bearish entries, Reversals for Bulls, Reversals for Bears, further possible pre-high, and further possible pre-low, although a trader or user may refer to the user's manual for additional examples. All of the examples aforementioned may be programmed by a highly skilled individual in the art.

Within FIG. 6, dynamic sectional risk transition candle/symbol may be illustrated for example purposes with transition bull 2295. Additional examples of dynamic sectional risk transition candle/symbol may be selected by a trader or user. Formation of such symbols may occur when sectional “d” candles possibly allow for the continuation of bullish sectional price risk candles (“a”, “b”, or “c”). Such bullish sectional price risk candles may be seen after “d” candles, in a smooth market trend development and may be further understood that such transition occurs from sectional price “d” to “c” or sectional price “d” to “b”. A trader or user skilled in the art should understand that a transitional bull 2295, as thus illustrated within FIG. 6, can be the transition of sectional price “f” to “a”.

Although not illustrated within FIG. 6, it can be understood that forecasting possible highs without risk assessments and/or forecasting possible lows without risk assessments may be selected by a trader or user skilled in the art in order to possibly further enhance such price perception indicators 510. There are no risk numbers associated within such categories of forecasting possible highs without risk assessments and/or forecasting possible lows without risk assessments but rather a symbol may be used to indicate that a possible high or low in the future may occur.

A trader or user may understand that forecasting earlier highs with risk assessments, may be illustrated within FIG. 6, for example purposes, with earlier highs +3.3 1470-a3. Additional examples of forecasting earlier highs with risk assessments may be selected by a trader or user. As such, forecasting earlier highs with risk assessments may serve as an indication that there can be a uptrend and the possible formation of earlier highs. Risk numbers can be associated with such symbols, which may allow a trader to pin point the risk that are associated with a candle/bar. Such risk numbers can further allow a trader or user to understand how risky it may be to take a bullish or bearish position. A trader or user should understand that as the risk increases on a modified health risk 1216 (FIG. 5) on a scale of +1 to +6, it can be understood as a higher risk involved in taking a bullish position. As illustrated within FIG. 6, a trader or user can identify the color of the candle/bar, which as such can be seen as Dynamic Sectional Price Risk “a”, along with the symbol of a circled “3” indicates there is a possibility of forecasting an earlier high along with risk “3” out of a scale of +1 to +6. This can eliminate a lengthy technical analysis and an ordinary trader or user can instantly identify various risks on a visual observation, which may be taken advantage of. Forecasting earlier lows with risk assessments and forecasting earlier lows without risk assessments and its various examples may be selected by a trader or user.

A trader or user may understand that forecasting earlier highs with risk assessments for Halved Hybrid Nozzlelism, may be illustrated within FIG. 6, for example purposes, with earlier highs +3.3 for Halved Hybrid Nozzlelism 1470-a3nz. Additional examples of forecasting earlier highs with risk assessments for Halved Hybrid Nozzlelism may be selected by a trader or user. As such, forecasting earlier highs with risk assessments for Halved Hybrid Nozzlelism may serve as an indication that there can be a uptrend and the possible formation of earlier highs. Risk numbers can be associated with such symbols, which may allow a trader to pin point the risk that are associated with a candle/bar. Such risk numbers can further allow a trader or user to understand how risky it may be to take a bullish or bearish position. A trader or user should understand that as the risk increases on a modified health risk 1216 (FIG. 5) scale of +1 to +6, it can be understood as a higher risk involved in taking a bullish position and as such may occur during the formation of Halved Hybrid Nozzlelism. As illustrated within FIG. 6, a trader or user can identify the color of the candle/bar, which as such can be seen as Dynamic Sectional Price Risk “c”, along with the symbol of a circled “3” indicates there is a possibility of forecasting an earlier high 1470-a, along with risk “3” out of a scale of +1 to +6 and along with the symbol “NZ” to illustrate the occurrence of such during the phenomenon of Halved Hybrid Nozzlelism, which serves as a further indication of a strong movement for the Bullish Believers and may be used as a sign for a trader or user to stay within a trade. This can eliminate a lengthy technical analysis and an ordinary trader or user can instantly identify various risks on a visual observation, which may be taken advantage of. Forecasting earlier lows with risk assessments for Halved Hybrid Nozzlelism and its various examples may be selected by a trader or user.

A trader or user may understand that super bullish pin point entries without risk assessments, may be illustrated within FIG. 6, for example purposes, with super bullish belief entry 1621. As such, super bullish pin point entries without risk assessments may serve as an indication of a strong bullish pin point entry. As illustrated within FIG. 6, a trader or user can identify the color of the candle/bar, which as such can be seen as Dynamic Sectional Price Risk “a”, along with a circled “1” indicates there is a possibility of a super bullish belief entry. This can eliminate a lengthy technical analysis and an ordinary trader or user can instantly identify various risks on a visual observation, which may be taken advantage of. Super bearish pin point entries without risk assessments may be selected by a trader or user.

A trader or user may understand that super belief bear pin point entries categories with risk assessment 2085, may be illustrated within FIG. 6, for example purposes, with super belief bear pin point en−5* 1620-5. As such, super belief bear pin point entries categories with risk assessment 2085 (FIG. 7) may serve as an indication of bearish belief pin point entries. There can be risk numbers associated with these symbols, which can allow a trader or user to pin point the risk associated in a candle/bar. Risk numbers can be associated with such symbols, which may allow a trader or user to understand how risky it may be to take a bearish position. A trader or user should understand that as the risk increases on a modified health risk 1216 (FIG. 5) scale of −1 to −7, it can be understood as a higher risk involved in taking a bearish position. As illustrated within FIG. 6, a trader or user can identify the color of the candle/bar, which as such can be seen as Dynamic Sectional Price Risk “d”, along with risk “3” out of a scale of −1 to −7. This can eliminate a lengthy technical analysis and an ordinary trader or user can instantly identify various risks on a visual observation, which may be taken advantage of Super belief bull pin point entries categories with risk assessments, super belief bill pin point entries categories without risk assessment, super belief bear pin point entries categories without risk assessment and its various examples. Super belief bull pin point entries categories with risk assessment for Halved Hybrid Nozzlelism and super belief bear pin point entries categories with risk assessment for Halved Hybrid Nozzlelism and its various examples, in which super belief bull/bear pin point entries categories with risk assessment illustrates the occurrence of such during the phenomenon of Halved Hybrid Nozzlelism may be selected by a trader or user.

A trader or user may understand that super belief pin point Reversals for Bears to bulls, may be illustrated within FIG. 6, for example purposes, with super bearish belief contra −re-1 2220. As such, super belief pin point Reversals for Bears to bulls, in which there can be an alignment of the horizontal and health risk which can further reverse a bearish to bullish trend.

As illustrated within FIG. 6, a trader or user can identify the color of the candle/bar, which as such can be seen as Dynamic Sectional Price Risk “d”, along with super bearish belief contra −re-1 2220, which can be seen with a orange circled 2 with the words “re-1”, which may serve as a pinpoint reversal of a bearish to bullish trend. However, it can be observed that such example failed to reverse the trend, which a trader or user may understand was due to the newly added Hybrid Dynamic Zone Lines 1006, component Blue Line 2381 of the current design. The market vehicle was not able to close above the Blue Line 2381, which may be observed as the Bullish Believers not being able to overcome Bearish Believers. A trader or user should keep a visual eye on the previous sectional risk or setup an alert for as desired. Dynamic sectional price “d” serves as an indication that the market can go in either direction. This can eliminate a lengthy technical analysis and an ordinary trader or user can instantly identify various risks on a visual observation, which may be taken advantage of. Super belief pin point Reversals for Bulls to bears and its various examples may be selected by a trader or user.

A trader or user may understand that Reversals for Bulls, may be illustrated within FIG. 6, for example purposes, with bull reversal 2335. As such, Reversals for Bulls may be seen as reversal signal in which a bearish trend can possibly become a bullish trend due to the alignment of multiple risk changes and confirmations. It should be understood by a trader or user that reversal of such trends may not occur even with the appearance of such and other factors should be taken into consideration, such as, for example, the dynamic hybrid zone lines 1006. There are certain types of Reversals for Bulls, which may include, but not limiting scope to, bull reversal, Bottom Bull small or big, bear bottom, and excess bear to bull belief. As illustrated within FIG. 6, a trader or user can identify the color of the candle/bar, which as such can be seen as Dynamic Sectional Price Risk “f”, along with bull reversal 2335, which can be seen with a blue colored “R”. Although there was a Dynamic Sectional Price Risk “f”, it can be observed that in such example the trend shortly thereafter did reverse, which can be confirmed with the appearance of a transition bull 2295, the failure to break zone line 1040, as well as other indicators, which can allow the Bullish Believers to overcome the Bearish Believers. This can eliminate a lengthy technical analysis and an ordinary trader or user can instantly identify various risks on a visual observation, which may be taken advantage of. Reversals for Bears and its various examples may be selected by a trader or user.

Though not illustrated within FIG. 6, a trader or user can select further possible pre-high and further possible pre-low, which a trader or user may understand as a forecast of pre-high or pre-low within the possible future. A trader or user may select an alert for all of the aforementioned examples for price perception risk 245 and its components.

FIG. 6 also shows an exemplary screenshot view, illustrating at least one internal movement indicator 520 (enhanced), according to certain embodiments of FIGS. 1 and 2. Regardless, where the prices are, whether they are trending or not, or going sideways, there may be risks associated with sudden market conditions changes, which can be located in any time frame, by inventing proper tools. In order to identify them, in real-time, in a particular time frame, during any trend development, consolidation, retracement, they preferably need to be separated and highlighted or given special symbol. In addition, there are spots, where a well established trend looks great from outside on normal bar, candles, or line charts, but internally, the conditions are deteriorating, but they are not obvious by looking at traditional methods or charts. So due to their sudden occurrence, it may either cost the trader or cause missed opportunities.

In FIG. 6, for example purposes, a turquoise bullish candle can have additional market conditions to make them more efficient, such as the turquoise bullish candle ++ 2300 as shown. A plus sign [+] indicates one modification, a double plus [++] shows two modifications to normal types. The risk to go bullish may be low, if such symbol is located underneath the current candle/bar, as there is a triple confirmation for Bullish Believers.

For illustrative purposes, the following labels have been used in the drawings to distinguish differently colored bars:
Turquoise Bullish Candle ++: (Tb++) (indicator 2300)
Golden Bearish Candle: (GB) (indicator 1420)
Yellow Bull Warning Candle: (indicator 1430)
Indigo Bear Warning Candle (indicator 1435)
Gray (C) Bullish Candle Gray Bull: (Mgb) (indicator 1440): It can be observed that there are two risk conditions occurring at the same time, yellow bull warning candle and “Mgb” 1440, but the first priority is yellow bull warning candle for the trader or user to identify warnings that it may give possible control to Bullish Believers.
Tan Bearish Candle ++ (indicator 2375)
Black Neutral Candle (indicator 1460)
Special Buy (indicator 2315);

When a market vehicle has been sold or bought for a long time or a short time, some traders believe that it may be time to step into the trade or do a trial/small test trade, even though prices may be previously going against what they want to do. Alternately, institutions may make a decision that the Market Vehicles are reasonably priced to take a small amount of risk, or alternately, the institution's research department starts believing that, a particular market vehicle has a near term or medium term or long term potential in the direction research indicates, then the institution may try to test the market with the prices agreed in the research. In some cases, a technical department may also come with some recommendations, based on their analysis in one or multiple timer periods. Internal movement indicator 520 preferably shows events of internal movement of market, where an outside trading community has the least amount of warning. Yellow Bull Warning Candle (indicator 1430) and Indigo Bear Warning Candle (indicator 1435), in certain instances, indicate such warnings of a trend change, from Bearish Believer to Bullish Believer with respect to yellow bull warning candles and Bullish Believer to Bullish Believer with respect to indigo bear warning candles. Bull belief warning may serve as an indication of a possible confirmation of the trend change from Bearish Believers to Bullish Believers. Bear belief warning may serve as an indication of a possible confirmation of the trend change from Bullish Believers to Bearish Believers.

Typically after formation of Yellow Bull Warning Candle 1430, in many cases, many traders start observing some directional movement in a specific time frame or alternately in several time frames, indicating a directional bullish movement has started taking place and a flow of orders starts coming in. Gray (C) Bullish Candle (indicator 1440) conditions may be formed before, after, or together with the Yellow Bull Warning Candle 1430, which preferably is a low risk entry for the bullish direction, as the bullish belief gets converted into a bullish direction at first evidence. However, the enhanced design can provide a Bull Entry Spike 1875 ahead of these warnings due to enhanced design of modified health indicator 1216 (FIG. 5) and modified time spectrum segment 1116, which may provide to a trader or user an even earlier warning to enter a trade and await a Bullish Directional Line 2055 (FIG. 5) in the modified health.

Typically after formation of bear belief warning, in many cases, many traders starts observing some directional movement in a specific time frame or alternately in several time frames, indicating a directional bullish movement has started taking place and a flow of orders starts coming in. Pink (C) Bearish Candle (indicator 1445; refer to FIG. 9) conditions can be formed, which preferably is a low risk entry for bearish direction, as the bearish belief gets converted in to a bearish direction at first evidence.

Powder Blue (C) Bullish Candle (indicator 1450; refer to FIG. 10), may be considered to be a special bullish market condition risk earlier entry, and Tan Bearish Candle ++ (indicator 2375), may be considered to be a special bearish market condition risk earlier entry, are preferably created using various components of price perception risk 245, preferably providing better entries for Bullish Believers or Bearish Believers and per the location of those components. At least one indicator may be used to find an extended location with no time delays factors. Using internal market moving risk 215 preferably reduces risk for the entry either for Bullish Believers or Bearish Believers.

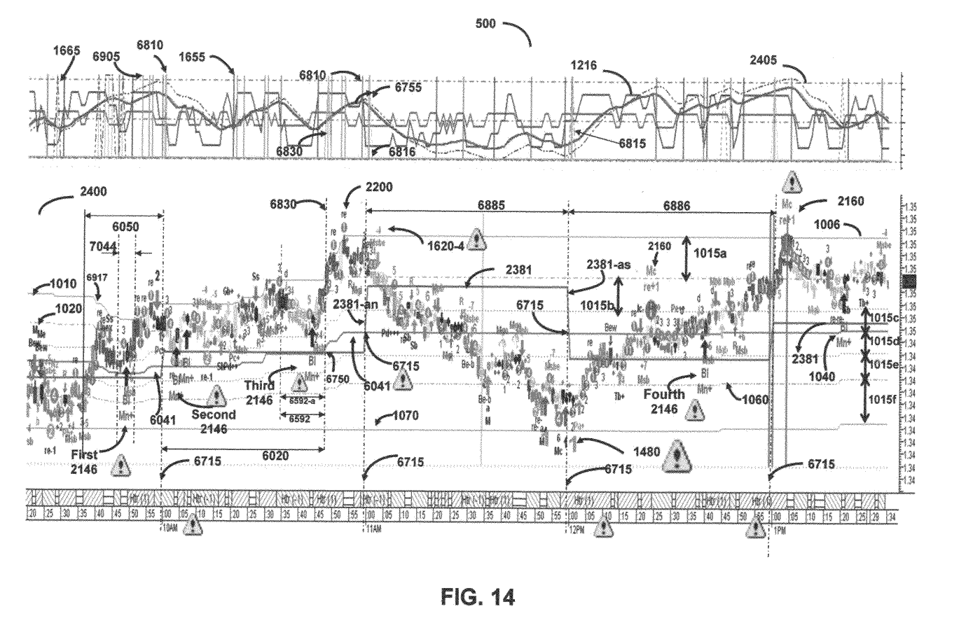

Internal market moving risk 215 preferably comprises multi-dimensional bull entry (indicator 1480; refer to FIG. 14) and multi-dimensional bear entry (indicator 1485; refer to FIG. 13), which preferably is based on multiple confirmations of multiple dimensions as per user selection in a design; this may preferably give user 110 an entry based on a risk assessed by risk assessor 140 (FIG. 2) overall based on many factors, not only on one particular component of a selected dimension or a single dimension.

Internal market moving risk 215 preferably additionally indicates when there is an equilibrium between Bullish Believers and Bearish Believers in a particular time frame, at a peculiar level or range of levels, using one or more dimensions, by utilizing a Black Neutral Candle (indicator 1460), which preferably indicates that the direction can go either way. Black Neutral Candle (indicator 1460) preferably shows an area of equilibrium, with a pinpoint neutral candle/bar location timing. This typically may indicate the exchange between Bullish Believers and Bearish Believers, creating a trading range until either Bullish Believers or Bearish Believers takes control of the direction. The combination of a black neutral candle 1460 and a modified neutral time spectrum segment 1151 may be considered to comprise the highest concentration of Neutral Believers. Typically, the previous direction is reversed after the formation of either one or several Black Neutral Candles 1460. This can pinpoint the locations of such events and enhance trading as well as reduces the risk in trading.

Using the components of multiple dimensions, as discussed in this application, earlier highs (indicator 1470-a) and earlier lows (indicator 1475-b), are preferably designated as “risk conditions are met” for extensions from that point. This can help a trader to stay within a trade and expect to meet higher or lower zone lines or breaking such zone lines.

FIG. 7 shows one embodiment of a display, showing an illustrative screenshot view showing several screenshot sections, which together are displaying all eight risk dimensions 206, as may be included within certain embodiments of the multidimensional risk analysis systems 100 of FIGS. 1 and 2. In FIG. 7, multi-dimensional, confirmations are shown along with risk recognition, risk designation, risk assessment, nozzlelism, by using multiple dimensions, hybrid zone range risk 276, time duration risk 255, Trend Health Risk 265, price perception risk 245, internal market moving risk 215, multiple conditions risk 235, economic event risk 225) together, a trader or user preferably receives real-time multi-dimensional confirmations, comprising multiple sources of market vehicle influences.

At least one multi-dimensional indication, as shown in FIG. 7, shows a combination of indicator label, internal movement indicator 520 and modified fixed time spectrum ribbon 1171; each are strong indications for Bullish Believers, and together provide multidimensional confirmation. Multi-dimensional indications are preferably applied to time frame charts starting from ticks to multiple-minute charts. Variables, such as last value, highest sum, and time frame location compared to bigger time frame, specific values of market vehicle on a specific selected time frame, values when specific conditions met, cumulative values, absolute values for cumulative specific conditions, combinations of cumulative values, and values at specific combinations and other user choice of conditions, may be used.

Multiple conditions risk 235 may preferably comprises an automatic sequencing and confirmation of multiple conditions, which may derive special meaning and indications for trading, in real-time. Indicators 530 for multiple conditions risk 235 may preferably take out the time consuming process of manual handling of special conditions and special conditional sequences. Some of these special conditions can be designed by using the various methods of analysis of market risks 206, as detailed within the teachings of this specification, using traditional indicators, patterns, oscillators, etc., to preferably develop Special Conditional Risk indicators.

There are many events in trading, which may occur due to the satisfaction of several conditions at the same time or series of conditions met on a sequential basis. Traders look at them happening, may confirm manually and then may make an informal decision to trade, but the manual process of confirming is insufficient in trading quickly and sequencing them manually is a difficult and time consuming process.

Multidimensional risk analysis systems 100 may reduce these difficulties and time consumption process. FIG. 7 illustrates one example of multiple conditions risk 235, such as the combination of Turquoise Bullish Candle ++ with Earlier Lows −4.4 and modified bullish time segment, hereby referenced with 236. The Bearish Believers were under control during the previous price perception sectional risk type “d”. Due to the visual verification of conflicts between multiple risks 236, a trader or user can be alerted that there are conflicts between various risks and sudden changes in the market direction may occur. Such sudden market changes may be identified with sudden market spot risks 215. Due to the simple recognition of colors and symbols, an ordinary trader or user with very minimal training may benefit from the multidimensional risk analysis systems 100 without exerting much effort into technical analysis and such trader or user has the ability to make quick decisions in trading. FIG. 7 also illustrates another example of multiple conditions risk 235, as such seen as the combination of Multidimensional Bear and price perception sectional risk type “c”, hereby referenced with 237. Price perception sectional risk type “c” is within the illustrative display of a 5 minute chart. Due to “2d” of a higher time frame, where “d” stands for Daily and “2” stands for Multidimensional Bear conflicting with price perception sectional risk type “c”, it can be evident that the Bearish Believers eventually took control over the Bullish Believers as illustrated with the price movement from zone line 1010 to zone line 1040. A trader or user may be alerted by all important events as illustrated by a yellow triangle or any trader or user desired colors or shapes. All important events selected by a trader or user can have alerts may be sent via electronic mail, PDA's, or by audio/visual alert on chart during trading.

A highly skilled trader or user in the art may be able to program such multiple conditions risk events such as 236 and 237, in a single or combination of time frames. An ordinary trader or user only requires learning to recognize colors, symbols and numbers without calculating or having to put together multiple risks to arrive with the same conclusion.

There are many types of fundamental economical risk (economic event risk 225) identified over the period of time preferably comprising interest rate risk, employment data risk, current accounts risks, payroll reports, trade balance, manufacturing numbers, PPI, CPI, home sales, GDP prices, construction spending, earning reports, inventories, and durable goods. FIG. 7 illustrates one example of an economic event risk 225, as seen with an economic risk indicator 540, referred to as Economical Single Event Spike 1885. A trader or user skilled in the art may understand that economical event Spikes can possibly indicate economical events that are occurring within a market vehicle.

Economic event risk 225 preferably addresses erratic movement in the market from related to the fundamental economical risks as they occur. As illustrated within FIG. 7, before the news, the prices were in a squeezing area of the zone lines 6920. The economical event was represented by Economical Single Event Spike 1885, which indicated a risk for the Bearish Believers or Bullish Believers and can alert 5300 the trader or user, while he/she was busy trading and pay attention without going onto the Internet and searching what time the news are coming. The Economical Single Event Spike 1885 allowed the trader or user to be pro-active in the market and allowed for more possible conservative behavior. Due to this alert, the trader or user who was on the bearish side, may have avoided the financial damage due to Expansion of Zone Lines 6921, Similar Spikes may be created for single or multiple events. A trader or user may preferably have an automatic notification on the software, preferably by alert, preferably at the time of it happens or alternately preferably pre-program and shown during normal trading. Additionally, economical event of the past may preferably be plotted preferably by having it programmed as an indicator and superimposing it to the price charts or, alternately preferably by making a separate fundamental health risk dimension.

Upon reading the teachings of this specification, those skilled in the art will now appreciate that, under appropriate circumstances, considering such issues as future economic reports, costs, etc., other fundamental economic risks, such as, for example, price rank, group rank, P/E Ratio, debt/equity ratio, date of earning, earning growth, projected earnings, earning estimate, growth ratio, rank of earning, accumulation and distributions, cash flow and its growth, insider trading, dividend, outstanding number of shares, dividend yields, may suffice.

Economic event risk 225 may preferably be represented in real time using the following type of formula:

7-[GDP-1]/[PPI-1]US 01/30/09 830 AMEST-Htr(1)D(3)

where 7 is indicating that the current prices (either open, close, high, low—user choice) are in economic event risk 225, GDP indicates that there is GDP economical number due at 8:30 AM EST for USA on 1/30/09, PPI producer price Index for USA will be announced at 8:30 AM EST on 1/30/09, Htr(1)D indicates that the current dimensional spectrum is bullish on a daily chart for last three days. FIG. 7 shows an illustration of a screenshot view, illustrating family and characteristic indicators 545, according to certain embodiments of FIGS. 1 and 2.

In certain instances of family and characteristic risk 285, there is a risk in a market vehicle due to the class or family that it belongs into. There may be more hidden risk within a market vehicle due to the characteristics that each market vehicle might have or due to the characteristics that a few members within a family of Market Vehicles might have. Each market vehicle may either follow a same set of Indexes or may be effected by other markets or factors differently. A particular family and characteristic risk processor 280 (FIG. 2) and an index may be created for a particular market vehicle in order to assess the risk and possible directional movement based upon the complex factors within real time trading. This can not only be based upon the industry these Market Vehicles might be in but also upon its family and its characteristics.

For example purposes, a trader or user may look at the stocks Merck and Pfizer, both of which are categorized into one family, the Drug Industry. If Pfizer received good or bad news, the entire family of stocks might become effected.

FIG. 7 illustrates two examples of the family and characteristic indicators 545 by Inner Market Family Risk Index 1610 and Inner Market Family Risk Composite Index 1615. With respect to Inner Market Family Risk Index 1610, one may need to find the closest family members in behavior out of all of the family members and the common factors and indexes they may follow and compare them to others. A trader or user may use either all components of the Horizontal Time Risk 255 or one or more components and a highly skilled trader may create an algorithm combining the peculiarities and the common indexes that may become effected and also with the other factors that may affect some family members. Such index may oscillate between a scale of −5 to +5. Such scale values may vary depending upon the selection of the time frame. FIG. 7 illustrates a 5 minute chart. When the index is near +5, the index can create Bearish Believers concentration whereas a −5 can create a Bullish Believers concentration. Inner Market Family Risk Composite Index 1615 may be similar in nature to Inner Market Family Index 1610 with the exception that the algorithm may be modified for the exclusion of any component within Trend Health Risk 265. Such index may oscillate approximately between 250 to 450, of which the range may depend upon the selection of the time frame. FIG. 7 illustrates a 5 minute chart. As illustrated within FIG. 7, before the point labeled “a”, the Inner Market Family Risk Composite Index 1615 remained almost flat. However, Inner Market Family Index 1610 started rising way before the Economic Event Spike 1885 was scheduled, which provides Bullish Believers an extra advantage that there might be a bullish trend development in the near future. The results were evident about this forecast until point “a” and the Inner Market Family Risk Composite Index 1615 started losing value, which gave Bullish Believers a heads-up that they may lose the control and this is evident by the current example between points “a” and “b”. After point “b” the Inner Market Family Index 1610 once again started increasing in value, which lead into further bullish trend development. Both indexes together provide a possible direction and entry/exit system. A highly skilled trader may program such indexes using multiple factors, such as components of modified health indicator 1216 and current values of family members.

FIG. 7 illustrates a screenshot view of a combination of the risk dimensions (market risks 206) that the applicant categorizes in eight major dimensions (eight market risks 206), namely: Vertical Risk Dimension (Hybrid zone range risk 276); Horizontal Time Risk (time duration risk 255); Trend Health Risk 265; Dynamic Sectional Price Risk (price perception risk 245); Sudden Market Spot Change Risk (internal, market moving risk 215); Special Conditional Risk (multiple conditions risk 235); Fundamental Risk (economic event risk 225) and family and characteristic risk 285. It also indicates a portion of multidimensional risk analysis systems 100, which comprises, multi-confirmation 555, multi-risk assessment 1465, risk recognition 3000, risk designation or assignment 2045, dynamically forecasting, pin point entries 2085, display of Halved Hybrid Nozzlelism 6000, Scalp-Swing Method Set Ups or Special Multi Low Risk Opportunity Set Ups 2115.

An ordinary trader or user may use multidimensional risk analysis systems 100 in a simplistic manner with the use of colored candles, symbols, numbers, arrows, alerts, and minimal use of technical analysis. The trader or user may take advantage of all of the features or may utilize portions of it, to benefit in trading, without the need for extensive training.

As illustrated within FIG. 7, there are certain instances, if a trader or user is bullish, and does not have extensive knowledge about the market, it is possible to teach him/her to recognize three components for a possible entry, such as a green ribbon 1131 location “c”, a green spike 1875 and a green vertical line 2055 and that a possible exit of such trade can be at the end of the green ribbon 1131 location “d”. With the simple recognition of such three components, the trader or user may be able to trade within the market. In another instance, such trader or user may be taught to recognize a yellow candle 1430, “Sb” symbol 2315, and a green spike 1875 and can enter the trade and possibly exit at the appearance of a red spike 1880. In certain instances, a trader or user may be taught to enter at the appearance of the green vertical line 2055 and exit at the appearance of the red vertical line 2060.

As illustrated within FIG. 7, if a trader or user want to only use a multi-confirmation 555 to enter, he/she may select an entry to go bullish such with 555 by recognizing a symbol which consists of a blue circled “3”, a pink colored risk of “+3” and a pink colored “NZ” and a green colored candle (price perception risk section type “c”) and observing a green ribbon 1131. A trader or user may also use an alert, which can notify such trader or user of the multi-confirmation 555 event and he/she may enter.

As illustrated within FIG. 7, if a trader or user would like to know whether he/she can stay within a trade or not, such as for example if a trader is in a trade at point “e”, he/she may use green vertical line 2055 in window 265 and verify the green ribbon 1131, which confirms the bullish direction and he/she can stay within a trade. At point “f”, a trader or user might question as to whether the market will continue further up or not. By recognizing the turquoise line 1655, which serves as an forecasting tool, which is dynamically forecasting, for possible further higher prices, a trader or user can stay in a trade and can exit by recognizing the risk of Multidimensional Bear 1485 or the appearance of a red vertical line 2060 or a red spike 1880. A trader or user may use a blue circled “3” as a forecasting tool which is dynamically forecasting, to stay within a trade.

As illustrated within FIG. 7, a trader or user would like to determine what the risk is at point “g” on a scale of 1 to 6 (1 being lowest, 6 being highest) for a bullish direction. By observing a “2” underneath the candle/bar, such trader or user can recognize the risk 3000, the trader or user can understand that it is a less riskier trade in the bullish direction.

As illustrated within FIG. 7, a trader or user observed a red colored candle at point “h” and feels that he/she should take a bearish position. However, with recognition of a blue circled “3” with a risk of “+2”, the trader or user had a multi-risk assessment 1465 and with the confirmation of a green ribbon 1131 and a green spike 1875 previously, he/she may decide to go in a long direction.

As illustrated within FIG. 7, a trader or user, at point “i”, would like to know what is the designated risk 2045 in a Halved Hybrid Nozzlelism shape in that particular time frame. By using the designation number as seen by a pink colored “4”, on a scale of 1 to 6. Number 4 indicates that the market vehicle has moved enough a possible pullback may occur in the near future.

As illustrated within FIG. 7, a trader or user, at point “j”, realized he/she was late and missed the “MBew” short entry and would like to determine if he/she can still enter into a trade without any extensive knowledge. By observing the orange colored “5, MSBE”, he/she can make a quick decision to possibly enter into a short trade. MSBE stands for super belief bear pin point entries with a risk of −5 on a scale of −1 to −7. It can be observed that the market vehicle went down so by simply using pin point entries 2085, a trader or user can focus on trading rather than on lengthy technical analysis.

As illustrated within FIG. 7, a trader or user, at point “k”, was in a short position, and an alert appeared for the formation of Halved Hybrid Nozzlelism 6000. By teaching an ordinary trader or user the symbol of “NZ” underneath the candle/bar, along with an alert, he/she can exit the short trade and avoid capital losses. Also, at the same token, the little knowledge about Halved Hybrid Nozzlelism shape, in this illustration, if he/she took a long position, he/she could of had a successful trade. The breakouts were confirmed by recognizing the symbol “NZ”.

As illustrated within FIG. 7, a trader or user was a scalper, and a point “l”, he/she wanted to do scalping in the market vehicle to earn a small profit, but due to the simple recognition for scalp-swing setup symbol 2115, he/she stayed longer into the trade, until zone line 1040, and was benefitted more.

As illustrated within FIG. 7, at point “e”, a trader or user was long in a position. He/She would like to determine what is occurring in the entire family of similar categories. By simply comparing the Blue Line 1610 to the red vertical line 2060 in the heath window 265, he/she can determine the answer without having to conduct a complicated analysis of all of the family members.

### Halved Hybrid Nozzlelism

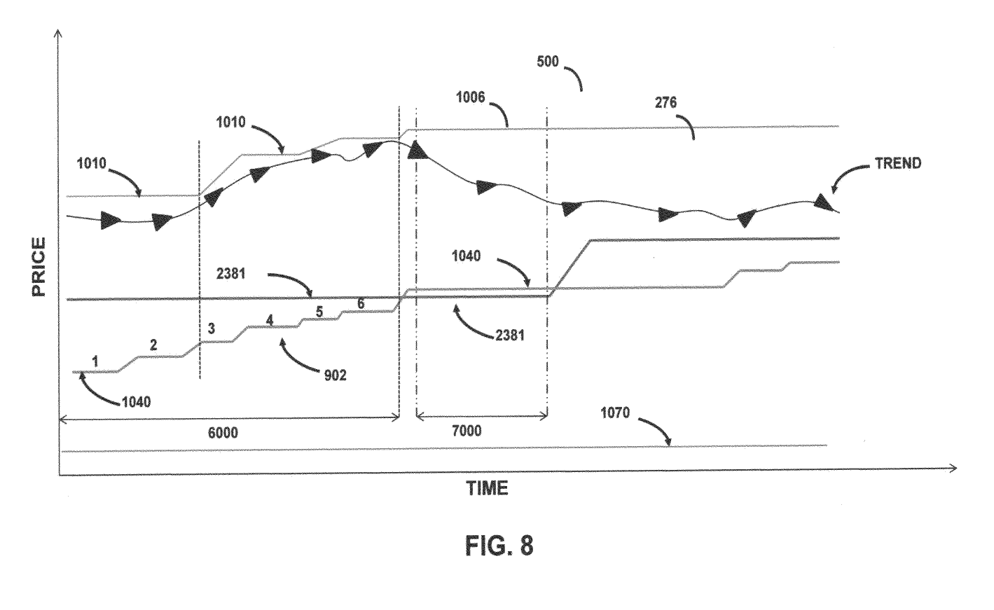

Within this disclosure, the term “Halved Hybrid Nozzlelism” 6000 (FIG. 8) may be utilized not to describe a physical nozzle, but to instead illustrate a general shape, (that may appear to be that of a nozzle cut in half) or pattern of a variety of indicator combinations, which may be utilized to help an ordinary skilled user or trader without extensive training to understand important events occurring within financial markets such as market trend changes, breakouts, retracements, new highs, new lows, directional forecastings, reversals, pullbacks, and many other such trading clues. Also, the various types and shapes of Halved Hybrid Nozzlelism tend to indicate and show the accumulation of Bullish Believers or Bearish Believers or the exchange between Bullish Believers and Bearish Believers. Due to increasing demand of Bullish Believers conditions, Neutral believers conditions, and Bearish believers conditions, the prices of any market vehicle, at one point, may break either upper zone level 1010 or lower zone level 1070 in any time frames, which may constitute either new highs, new lows for either intraday or on daily basis or for a particular time frame on zone levels 1006 basis. In such cases, the rest of zone levels 1020, 1030, 1040, 1050 and 1060 (FIG. 3) follow either upper zone level 1010 or lower zone level 1070. The phenomenon of the formation of Halved Hybrid Nozzlelism shape theory may be referred to as “Halved Hybrid Nozzlelism”.

When comparing the relative positions of mid zone level 1040 with respect to a Blue Line 2381 (FXTA Mid Pivot or any user desired pivot type), an area having a similar appearance as halved the nozzle shape, is formed either above or below the Blue Line 2381, or on left or right side of the end of the tip of the halved nozzle shape. These areas in trading are referred to in this disclosure as “Halved Hybrid Nozzlelism” 6000, which tends to follow a repeating pattern in trading and provides many trading clues, such as: forecasting of direction, forecasting of pullbacks, forecasting retracements, forecasting new or extended trends, reversals, break outs, new trends, etc. Indicators, Alerts and explorers can be designed for all parts of this concept as illustrated by these independently repeating patterns, in part or full.

FIG. 8 shows one embodiment of a display, showing an illustrative screenshot view which is displaying Halved Hybrid Nozzlelism 6000 phenomenon and Halved Hybrid Parallelism 7000, as may be included within certain embodiments of the multidimensional risk analysis systems of FIGS. 1 and 2. It also describes an illustrative display of one type of Halved Hybrid Nozzlelism 6000. As such, a person having ordinary skills might be able to recognize, with minimal training based on visualization of a variety of illustrative Halved Hybrid Nozzlelism 6000 shapes, as described subsequently, such as may develop in real time based on dynamic changes in the market. For instance, FIG. 8 illustrates a display of dynamically moving specialized mid pivot (also known as mid Blue Line 2381) of a higher time frame based on real time calculations, and illustrates a display of dynamically moving one of the vertical risk components 276 of a lower time frame based on real time calculations of mid zone level 1040. A trader or user skilled in the art may use traditional pivots instead of the Blue Line in order to create Halved Hybrid Nozzlelism.

Certain embodiments of the multidimensional risk analysis systems 100, as described above with respect to FIGS. 1 and 2, can be configured to perform the above calculation. Thereupon, the user interface 125 (FIG. 2) will project such a display the formation of Halved Hybrid Nozzlelism 6000 which may be observed, as illustrated in real time in FIG. 8. This Halved Hybrid Nozzlelism 6000 may be based at least partially in response to the relationship between said dynamically calculating and displaying specialized mid pivot of a higher time frame as taken with respect to said dynamically calculating and displaying vertical risk components of a lower time frame.

In FIG. 8, as the shape of Halved Hybrid Nozzlelism 6000 develops over the period of time in trading (in this case, converging), by observing upward steps 1 and 2, which are initial Components of Halved Hybrid Nozzlelism 6000, an ordinary skilled trader would be led to believe the amount of Bullish Believers are dominating compared to the amount of Bearish Believers. This shape would likely result in a possible breakout in such a market vehicle, and also likely result in establishing new higher prices of Market Vehicles.

As Halved Hybrid Nozzlelism 6000 further converges into additional upward steps 3, 4, 5 and 6, it becomes evident to market observers considering FIG. 8 that new higher market trend prices have been established. Observe the resulting upward trend direction as indicated and displayed by new upper zone levels 1010 that have been established in real time based on an illustrative dynamic change in the market. A trader or user may be alerted by all important events as illustrated by a yellow triangle or any trader or user desired colors or shapes. All important events selected by a trader or user can have alerts may be sent via electronic mail, PDA's, or by audio/visual alert on chart during trading. A variety of embodiments of Halved Hybrid Nozzlelism may be used. Upon read the teachings of this specification, those skilled in the art will now appreciate that, under appropriate circumstances, the concepts behind Halved Hybrid Nozzlelism.

### Components of Halved Hybrid Nozzlelism

FIG. 9 shows one embodiment of a display, showing an illustrative screenshot view showing several screenshot sections, which together are displaying a Halved Hybrid Nozzlelism phenomenon along with a health risk indicator 1216, as may be included within certain embodiments of the multidimensional risk analysis systems of FIGS. 1 and 2. It also illustrates one embodiment of certain illustrative Components of Halved Hybrid Nozzlelism. There may be a number of, for example, five, more, or fewer components for various embodiments of Halved Hybrid Nozzlelism. For illustrative purposes to show the various components, we are selecting one particular type of Halved Hybrid Nozzelism in FIG. 9, which is called “Lower Left Halved Hybrid Nozzlelism (also known as Lower Left Step Up Halved Hybrid Nozzlelism) 6020”.

As shown in FIG. 9, one component of Halved Hybrid Nozzlelism is Blue Line 2381. For the Halved Hybrid Nozzlelism concept to work, the selected time frame for the mid zone line 1040 must be lower than the time frame selected from the Blue Line 2381 (FXTA mid pivot or any user desired pivot type). A user may see a similar formation of Halved Hybrid Nozzlelism with the use of various other zone lines 1006 as taken in combination of such zone lines 1006. As also shown in FIG. 9, another component of certain embodiments of Halved Hybrid Nozzlelism is the mid Zone Line 1040. The middle zone line may be used for Lower Left Halved Hybrid Nozzlelism (also known as Lower Left Step Up Halved Hybrid Nozzlelism) 6020.

Zone Line 1040 may be broken up into several components, such as may be referenced within this disclosure as 1040-a, 1040-b, 1040-c, 1040-d, 1040-e, 1040-f, and 1040-g. Below, are a variety of sections, that may be taken together such that each may contribute to form Halved Hybrid Nozzlelism. Consider the following illustrative examples of a variety of sections partially contributing to form a variety of Components of Halved Hybrid Nozzlelism:
An illustrative halved convergence section 6150 may be formed with components 1040-a, 1040-b, Blue Line 2381 and 1040-g.
An illustrative Annularization section 6250 may be formed using components 1040-c, Blue Line 2381, and 1040-g.
An illustrative Halved Hybrid Nozzlelism Parallelism section 6350 may be formed using components 1040-d, Blue Line 2381, and 1040-g.
An illustrative Halved Hybrid Nozzlelism tipping section 6450 may be formed using components 1040-e and Blue Line 2381, and 1040-g.
An illustrative Post Halved Hybrid Nozzlelism confluence section 6565/6550 may be formed using components 1040-f, Blue Line 2381, and 1040-g.

A trader or user should be aware that component 1040-g at least partially forms a transition between the various components of zone line 1040. Such a component 1040-g is responsible for the shifting of the zone lines 1005 and connects the various components of the zone line 1040.

A trader or user may understand, with respect to Time Projection for Zone Shifting 6975, this indicator can be designed to approximately calculate the next shifting Zone Lines 1005, either fully or partially and may be based on the current movement and further based upon the current shifting locations. With basis upon the Unscheduled Intersection Of Zone Line 6755 with Blue Line 2381 with reference to either the upper or lower most zone, and further referencing the peaks and trough points of the upper and lower most zone lines, and with the application of the knowledge of symmetric triangles, a trader or user can calculate the time cycles of the next shifting. As illustrated within FIG. 9, “A” represents the shifting of the lowermost zone line, “B” represent the peak of the uppermost zone line, “E” represents the Unscheduled Intersection Of Zone Line 6755, “C” represents the reference point created based upon “B” and “E”. “A”, “B”, and “C” to make a triangle. Between “A” and “C”, it may be observed that there is a time duration of 27[49−22=27] so within approximately the next 30 minutes, (27×10% contingency for errors), the actual shifting of the lower zone line “D” was done after 31 minutes. A trader or user may predict the time cycles for the zone lines using simple mathematics.

Upon reading the teachings of this specification, those skilled in the art will now appreciate that, under appropriate circumstances, the descriptions of the Components of Halved Hybrid Nozzlelism, may suffice.

### Types of Halved Hybrid Nozzlelism

FIG. 9 shows one embodiment of a Lower Left Halved Hybrid Nozzlelism 6020 (also known as lower left step up Halved Hybrid Nozzlelism) such as may be utilized by certain embodiments of multidimensional risk analysis systems. This phenomenon would likely occur in a Bullish Believer's area. The area between the start of lower left Halved Hybrid Nozzlelism Convergence 6150 to the end of lower left Halved Hybrid Nozzle Tipping 6450 is thereby called Lower Left Halved Hybrid Nozzlelism 6020.

At the start of Lower Left Halved Hybrid Nozzlelism Convergence 6150, if Market vehicle prices are above Blue Line 2381 after the formation of first component 1040-a for lower left Halved Convergence 6150 forms, as a part of Lower left Halved Hybrid Nozzlelism 6020 and after formation of 6905, new higher prices for a market vehicle prices may commence due to increasing demand of Bullish Believers. Until all zone lines 1006 have stabilized, extended bullish trend is established, resulting in break outs, and creating intraday new highs.

For lower left Halved Hybrid Nozzlelism 6020 to exist, the corresponding components may be lower left Halved Hybrid Nozzlelism Convergence 6150, lower left Halved Hybrid Nozzlelism Annularization (convergence) 6250, lower left Halved Nozzlelism Hybrid Parallelism 6350, and lower left Halved Hybrid Nozzle Tipping 6450. In certain instances, lower left Halved Nozzlelism Hybrid Parallelism 6350 and lower left Halved Hybrid Nozzle Tipping 6450 may not exist due to the sudden intersection of zone line 1040 with Blue Line 2381 or due to the merging of zone line 1040 with Blue Line 2381. If all four components, lower left Halved Hybrid Nozzlelism 6020, the components may be lower left Halved Hybrid Nozzlelism Convergence 6150, lower left Halved Hybrid Nozzlelism Annularization (convergence) 6250, lower left Halved Nozzlelism Hybrid Parallelism 6350, and lower left Halved Hybrid Nozzle Tipping 6450, do not develop, then a skilled trader or user may recognize that there would likely be a pullback just after formation of completed parts. In certain instances, Halved Convergence 6150 may control the bearish direction of the trend. Modified bearish time segment 1141 would likely be bearish during most of the time during Lower Left Halved Hybrid Nozzlelism 6020.

FIG. 10 shows one embodiment of a display, showing an illustrative screenshot view showing several screenshot sections, which together are displaying a colored Candlestick Spectrum chart showing the bearish effect of Halved Hybrid Nozzlelism along with a health risk indicator 1216, as may be included within certain embodiments of the multidimensional risk analysis systems 100 of FIGS. 1 and 2. It also shows one illustrative embodiment of a Upper Left Halved Hybrid Nozzlelism (also called Upper left Step Down Halved Hybrid Nozzlelism) 6025, such as may occur to provide a Bearish Believers' area. The area between the start of upper left Halved Hybrid Nozzlelism Convergence 6155 to the end of upper left Halved Hybrid Nozzle Tipping 6455 is called Upper Left Halved Hybrid Nozzlelism. Usually, at the start of Upper Left Halved Hybrid Nozzlelism Convergence 6155, if Market vehicle prices are below Blue Line 2381, after the formation of first component 1040-a for upper left Halved Convergence 6155-a tends to form.

As a partial result of upper left Halved Hybrid Nozzlelism 6025 and after formation of Warning Spot for First Gold PL Line (Bull to Bear) 6906, new lower prices for a market vehicle prices may start due to increasing demand of Bearish believers, until all zone lines 1006 have stabilized thereby extending bearish trends. Subsequently, break down likely occurs and intraday new lows are likely created. On the left side of FIG. 10, illustrated are aspects for upper left Halved Hybrid Nozzlelism 6025, upper left Halved Hybrid Nozzlelism Convergence 6155-a, upper left Halved Hybrid Nozzlelism Annularization (convergence) 6255, upper left Halved Nozzlelism Hybrid Parallelism 6355, upper left Halved Hybrid Nozzle Tipping 6455.

In FIG. 10, certain embodiments of aspects including upper left Halved Nozzlelism Hybrid Parallelism 6355 as well as the upper left Halved Hybrid Nozzle Tipping 6455 were eliminated due to Unscheduled Intersection of zone line 6755 for left hand side example. Halved Convergence 6155-a dictates the bearish direction of trend. Modified bearish time segment 1141 may be bearish most time during formation of Upper Left Halved Hybrid Nozzlelism 6025.

FIG. 10 shows certain embodiments of Lower Right Halved Hybrid Nozzlelism (also called lower Right Step Down Halved Hybrid Nozzlelism) 6030, such as may occur to provide a preliminary Bullish trend. The area between the start of lower right Halved Hybrid Nozzle Tipping 6460 and end of lower right Halved Hybrid Nozzlelism Divergence 6160, is called Lower right Halved Hybrid Nozzlelism. Usually, at the start of Lower Left Halved Hybrid Nozzle Tipping if Market vehicle prices are below Blue Line 2381 and zone line 1040, after the formation of last component 1040-e for lower right Halved Hybrid Nozzle Tipping, area 6460 forms due to formation of unscheduled intersection of zone line 6755 as a part of lower right Halved Hybrid Nozzlelism 6030. After the formation of Warning Spot For First Gold PL Line (Bull To Bear) 6906, new higher prices for a market vehicle prices likely results due to increasing demand of Bullish Believers after all zone lines 1006 stabilized, and thereupon preliminary bullish trends are established, short covering does takes place, higher prices does establish temporarily from lowest levels of 1070, and test of nearest zone levels 1060, 1050, 1040 or sometimes Blue Line 2381 takes place.

Certain embodiments of lower right Halved Hybrid Nozzlelism 6030 are Lower Right Halved Hybrid Nozzle Tipping 6460, Lower Right Halved Nozzle Hybrid Parallelism 6360, Lower Right Halved Hybrid Nozzlelism Annularization (Divergence) 6260, and Lower Right Halved Hybrid Nozzlelism Divergence 6160. Halved Hybrid Nozzle Divergence 6160 may control the Preliminary Bullish direction of the trend. Modified bullish time segment 1131 may be bullish most of the time during lower right Halved Hybrid Nozzlelism 6030.

FIG. 10 illustrates a Nozzlelism to Hybrid Parallelism Transformation Point 6371. Such configuration may occur after the possible formation of halved hybrid nozzle, zone line 1040 may fail to intersect Blue Line 2381, which may cause it to form Hybrid Parallelism. A trader or user skilled in the art should understand that if Hybrid Parallelism forms after this point, it may become an attraction to those levels for zone line 1040 as well as Blue Line 2381, and within the Hybrid Parallelism phase, this may be possible. A trader or user skilled in the art should be aware that such configuration may serve as a forecasting tool and may cause a breakout from this point. This may provide the first evidence of pinpointing the area before the breakouts within the financial market for any market vehicle.

FIG. 11 shows one embodiment of a display, showing an illustrative screenshot view showing several screenshot sections, displaying a colored Candlestick Spectrum chart showing the bullish effect of Halved Hybrid Nozzlelism along with a health risk indicator 1216, as may be included within certain embodiments of the multidimensional risk analysis systems 100 of FIGS. 1 and 2. It also shows certain embodiments of Upper Right Halved Hybrid Nozzlelism (also known as Upper Right Step Up Halved Hybrid Nozzlelism) 6035, such as may occur during a strong break out in a bullish trend. The area between the start of upper right Halved Hybrid Nozzle Tipping 6465 and end of upper right Halved Hybrid Nozzlelism Divergence 6165 may be referred to as Upper right Halved Hybrid Nozzlelism. Usually, at the start of Upper Right Pre Halved Hybrid Nozzlelism Confluence 6585, if Market vehicle prices are above Blue Line 2381 and zone line 1040, after the formation of last component 1040-e for Upper right Halved Hybrid Nozzle Tipping area 6465 forms, due to formation of Upper right Pre Nozzlelism Hybrid Confluence 6585 after scheduled intersection of Blue Line 6715, as a part of Upper right Halved Hybrid Nozzlelism 6035.

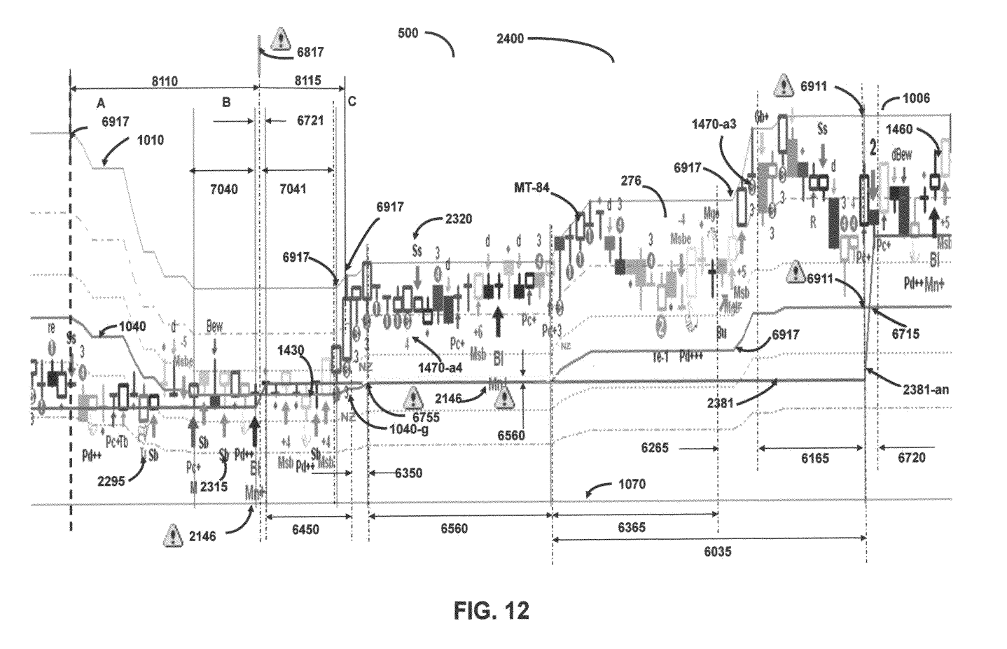

After formation of Warning Spot for First Turquoise PH Line (Bear to Bull) 6905, new higher prices for a market vehicle prices may start due to increasing demand of Bullish Believers, all zone lines 1006 may tend to start shifting to higher levels and extended bullish trend may establish. Nearest upper zone level 1010 in the current time frame establishes new levels as different parts of upper right Halved Hybrid Nozzlelism 6035 forms, until all zone levels 1006 stabilized. Usually, the stabilization comes when upper zone level equalize the values to nearest zone level 1010, 1020, 1030, 1040 etc. in bigger time frames higher than the current one. Certain embodiments of parts for upper right Halved Hybrid Nozzlelism 6035 are Upper Right Halved Hybrid Nozzle Tipping 6465, Upper Right Halved Nozzle Hybrid Parallelism 6365, Upper Right Halved Hybrid Nozzlelism Annularization (Divergence) 6265, and Upper Right Halved Hybrid Nozzlelism Divergence 6165. If Upper right Pre Nozzlelism Hybrid Confluence 6585 does not exists, an Unscheduled Intersection of zone line 6755 (FIG. 12) may take place, before formation of Upper Halved Hybrid Nozzle Tip 6585.

Though not illustrated, it would be understood by those skilled in the art that there are other types of Halved Hybrid Nozzlelism which may occur during trading. One example may be referred to as Partial Halved Hybrid Nozzlelism. Due to Scheduled Intersection of Blue Line 6715 for either Blue Line angle north 2381-an (FIG. 14) or Blue Line angle south 2381-as, all components of Hybrid Halved Hybrid Nozzlelism do not get completed and may form Partial Halved Hybrid Nozzlelism, which may help during pullback for Bullish Believers or Bearish Believers depending upon the locations of Blue Line angle north 2381-an or Blue Line angle south 2381-as.

FIG. 14 shows one embodiment of a display, showing an illustrative screenshot view showing several screenshot sections, displaying a colored Candlestick Spectrum chart showing a closed hybrid zone risk transfer area along with a health risk indicator 1216, as may be included within certain embodiments of the multidimensional risk analysis systems 100 of FIGS. 1 and 2. It also shows one embodiment of Partial Halved Hybrid Upper Nozzlelism 6041. This exemplary illustrative partial Halved Hybrid upper Nozzlelism 6041 was disturbed by scheduled Intersection of Blue Line 2381-an and had caused the prices of Market vehicle to come down to Blue Line level, after the scheduled Intersection 6715 was completed.

FIG. 14 shows one embodiment of Double Upper Halved Hybrid Nozzlelism 6050, such as may typically occur in a bullish trend for an ordinary skilled trader to consider entrance into a low risk scalp-swing entry area. For example, when upper left Halved Hybrid Nozzlelism 6025 is connected to Upper Right Halved Hybrid Nozzlelism 6035 by Prep-Pre Double Bullish Trend Hybrid Parallelism 7044 and zone line 1040 remains higher than Blue Line 2381, a Double Upper Halved Hybrid Nozzlelism 6050 may be created. This type of Halved Hybrid Nozzlelism may be used to create a short term trading opportunity for Bullish Believers, after a down trend, which was reversed by evidence of Sectional Price risk type b and Market vehicle managing to bring prices above Blue Line 2381 in lower zone lines such as 1070 or 1060.

FIG. 15 provides an illustrative display of Halved Hybrid Nozzlelism Shifting End Spike/Vertical Line (Bear To Bull) 6915. Such configuration may occur when all zone lines 1006 stop shifting to the downside and remain horizontal for Halved Hybrid Nozzlelism.

Though not illustrated, it would be understood by those skilled in the art that there are other types of Halved Hybrid Nozzlelism, which may occur during trading. One example may be referred to as Double Lower Halved Hybrid Nozzlelism, such as may typically occur in a bearish trend for an ordinary skilled trader to consider entrance into a lower risk scalp-swing entry area. When lower left Halved Hybrid Nozzlelism 6025 (FIG. 10) is connected to lower Right Halved Hybrid Nozzlelism 6035 (FIGS. 11 and 12) by Prep-Pre Double Bearish Trend Hybrid Parallelism and zone line 1040 remains lower than Blue Line 2381, a Double Lower Halved Hybrid Nozzlelism may be created. This type of Halved Hybrid Nozzlelism may be used for creating a short term trading opportunity for Bearish Believers, after an uptrend, which was reversed by evidence of Sectional Price risk type f and Market vehicle managing to bring prices below Blue Line 2381 in Upper zone lines such as 1010 or 1020. A trader or user may be alerted by all important events as illustrated by a yellow triangle or any trader or user desired colors or shapes. All important events selected by a trader or user can have alerts may be sent via electronic mail, PDA's, or by audio/visual alert on chart during trading.

With respect to FIG. 7, for example, a trader or user skilled in the art should be aware of Warning Spot For First Turquoise PH Line (Bear To Bull) 6905. Such configuration may occur where the post, where Halved Hybrid Nozzlelism Convergence may end and where halved Annularization may start. This may be referred to as a “break out” or the making of new highs for lower left Halved Hybrid Nozzlelism Convergence and upper right Halved Hybrid Nozzlelism Divergence (“PH” indicates possible higher prices of a market vehicle 1655).

Upon reading the teachings of this specification, those skilled in the art will now appreciate that, under appropriate circumstances, the various types and examples of Halved Hybrid Nozzlelism Annularization for convergence, may suffice.

### Halved Hybrid Nozzlelism Convergence/Divergence

It would be understood by those skilled in the art that such formation of Halved Hybrid Nozzlelism Convergence/divergence requires two zone line components; 1040-a and 1040-b. FIGS. 9 and/or 10 represents one embodiment of the multidimensional risk analysis systems 100 of FIGS. 1 and 2, with four types of Halved Hybrid Nozzlelism Convergence/divergence: Lower Left Halved Hybrid Nozzlelism Convergence 6150, Upper Left Halved Hybrid Nozzlelism Convergence 6155, Lower Right Halved Hybrid Nozzlelism Divergence 6160, and Upper Right Halved Hybrid Nozzlelism Divergence 6165. The variations of convergence and divergences within Halved Hybrid Nozzlelism mechanism may contribute to trend development for either a short or long term duration. Upon reading the teachings of this specification, those skilled in the art will now appreciate that, under appropriate circumstances, the concepts behind Halved Hybrid Nozzlelism Convergence/divergence, may suffice.

### Halved Hybrid Nozzlelism Convergence

Though it is not illustrated, it would be understood by a trader or user skilled in the art that Halved Hybrid Nozzlelism Convergence may be part of the upper or lower left side of Halved Hybrid Nozzlelism, in which where the prices may flow into this area first and then travel towards Halved Hybrid Nozzle Annularization or Halved Hybrid Nozzle Tipping area, which may be for either a bullish or Bearish Believers. The result of a halved hybrid convergence formation, can push prices away from convergence area and may create a bullish trend for lower left halved side and a bearish trend for upper halved side in the Halved Hybrid Nozzlelism. A trader or user should be aware that halved convergence may create an expansion of a current direction. The phenomenon of halved hybrid convergence occurs on left side of an unscheduled intersection of zone line. Upon reading the teachings of this specification, those skilled in the art will now appreciate that there might be a variety of embodiments of Halved Hybrid Nozzlelism Convergence.

### Types of Halved Hybrid Nozzlelism Convergence

FIG. 9 illustrates one embodiment of the various types of Halved Hybrid Nozzlelism Convergence, referred to as lower left Halved Hybrid Nozzlelism Convergence 6150, as such may occur during a buildup of a pre-bullish breakout. The area between the beginning of the first shifting of the zone lines including the area for at least three previous time frames before shifting and up to the formation of turquoise PH Line 6905 or the beginning of Annularization of lower left Halved Hybrid Nozzlelism may be called convergence area for lower left Halved Hybrid Nozzlelism. Initially, all zone lines 1006 may remain horizontal and then all zone lines may start to shift upwards with the exception of the upper most zone line 1010 up to a breakout point for the upper most level 6905 or with the formation of a warning spot for the first turquoise PH Line 6905. In certain instances, Bearish Believers are overpowered by Bullish Believers with the progression of Horizontal Time Risk 255 until turquoise PH Line 6905 occurs. In such an area, Bullish Believers may continue to build up their position at upper zone line 1010, despite the possibility of some Bearish Believers demand.

A trader or user skilled in the art should be aware of various indicators that may indicate a sign of controversy, such as yellow bar 1430, dynamic price risk type d, and Bew 1435 or other various bearish risk recognition factors. A trader or user skilled in the art should be aware of various indicators that may indicate a sign of a possible breakout of the higher zone line 1010 for newer intraday highs or new highs, such as with such as Yellow Bull Warning Candle 1430, Purple (C) Candle—Type d++ MT-89, Purple (C) Candle—Type d +++ 2260 or other various bullish risk recognition factors. Such indicators may be evident of warnings that can be located within an area of convergence and where consolidation at a resistance might have taken place.

FIG. 10 illustrates one embodiment of the various types of Halved Hybrid Nozzlelism Convergence, referred to as upper left Halved Hybrid Nozzlelism Convergence 6155, as such may occur during the early stages of Bearish Believeness or during the buildup of a pre-bearish breakdown. The area between the beginning of the first shifting of zone lines including the area for at least three previous time frames before shifting and up to the formation of Gold PH Line 6906 or the beginning of upper left halved Annularization of Nozzlelism may be called convergence area for upper Halved Hybrid Nozzlelism. Initially, all zone lines 1006 may remain horizontal and then all zone lines may start shifting downwards with the exception of the upper most zone line 1010 up to a point of break down for the lower most level 1070 or formation of a warning spot for first gold PH Line 6906. In certain instances, Bullish Believers are overpowered by Bearish Believers with the progression of Horizontal Time Risk 255 until gold PH Line 6906 occurs. In such an area, Bearish Believers may continue to build up their position at and below Blue Line 2381, despite the possibility of some Bullish Believers demand.

A trader or user skilled in the art should be aware of various indicators that may indicate a sign of a possible breakdown from the lower zone level 1070 to newer intraday lows or new lows, such as with dynamic price sectional risk type e, or type f, forecasting earlier lows with risk assessments or with some other various bearish risk recognition factors. Such indicators may be evident of warnings within an area of convergence and where consolidation at the zone line 1070 support might take place before a possible further breakdown. A trader or user should be aware that a Market Vehicles prices should remain below Blue Line 2381.

Upon reading the teachings of this specification, those skilled in the art will now appreciate that, under appropriate circumstances, the various types and examples of Halved Hybrid Nozzlelism Convergence, may suffice.

### Halved Hybrid Nozzlelism Divergence

Though it is not illustrated, it would be understood by a trader or user skilled in the art that Halved Hybrid Nozzlelism Divergence 6110, which may be part of the upper or lower left side of Halved Hybrid Nozzlelism, in which where the prices may flow into this area last and it travels from Halved Hybrid Nozzle Annularization/Halved Hybrid Nozzle Hybrid Parallelism area, which may be for either for a bullish or Bearish Believers.

The result of stabilization of all zone lines 1005, after a long duration of Horizontal Time Risk 255, may start from Halved Hybrid Nozzle Tipping area, which can push prices away from the upper most zone line 1010 or the lower most zone line 1070 within this area and can create a Bearish Believers controlled area for the upper right halved side and a Bullish Believers controlled area for the lower halved side in Halved Hybrid Nozzlelism. A trader or user should be aware that halved divergence can create a sign of exhaustion of the current trend. The phenomenon of halved divergence occurs on the right side on an unscheduled intersection of zone line 6755. A trader or user may be alerted by all important events as illustrated by a yellow triangle or any trader or user desired colors or shapes. All important events selected by a trader or user can have alerts may be sent via electronic mail, PDA's, or by audio/visual alert on chart during trading. A variety of embodiments of Halved Hybrid Nozzlelism Divergence are intended to be applied.

Upon reading the teachings of this specification, those skilled in the art will now appreciate that, under appropriate circumstances, the concepts behind Halved Hybrid Nozzlelism Divergence, may suffice.

### Types of Halved Hybrid Nozzlelism Divergence

FIG. 10 illustrates one embodiment of the various types of Halved Hybrid Nozzlelism Divergence, referred to as lower right Halved Hybrid Nozzlelism Divergence 6160, as such may occur during the transition of bearish to bullish, during a bear flag or during the pre-transfer area for bullish to bearish. Within this area, Bullish Believers may continue to build up their position at and below zone line 1040, despite some Bearish Believer's occasional demand. A trader or user skilled in the art should be aware of various indicators that may indicate a sign of a possible higher high prices from the lower zone level 1070 to a next zone level 1060 or 1050, such as with dynamic price sectional risk types a or b, Super Belief Bull Pin Point En+1**, Super Belief Bull Pin Point En+2* or other various bullish risk recognition factors. Such indicators may be evident of warnings within an area of divergence and where zone lines 1006 may have stabilized and where support might take placed before a further upside takes place. It may be evident that sectional price risk type b occurs often, which can lead to the testing of zone line 1040 and sometimes even to Blue Line 2381 from the lowest zone level 1070, which may also evident of pinpoint time and price location of the formation of a bear flag within trading, giving an allocation from a highest risk to lowest risk area.

FIG. 11 illustrates one embodiment of the various types of Halved Hybrid Nozzlelism Divergence, referred to as upper right Halved Hybrid Nozzlelism Divergence 6165, as such may occur during the pre-bearish break down exhaustion area 6112. The area between end of Halved Hybrid Nozzle Annularization 6265 (within the right side) and between either at least three time frames after the stabilization of all zone lines 1005 or within the scheduled intersection of Blue Line 6715 (to the upside), in upper right Halved Hybrid Nozzlelism may be called Upper right halved Divergence area 6165.

The Bullish Believers may experience exhaustion due to the possible over-expansion of all zone levels 1005 with the exception of the lower most zone level 1070. In certain instances, prices may pullback to at least to a nearest zone level 1020 or 1030 around the time of formation of Risk Transition Time Area for Scheduled Intersection of Blue Line 6720 (FIG. 9) or during the Scheduled intersection of Blue Line 2381. Upon reading the teachings of this specification, those skilled in the art will now appreciate that, under appropriate circumstances, the various types and examples of Halved Hybrid Nozzlelism Divergence, may suffice.

### Halved Hybrid Nozzlelism Annularization

Though it is not illustrated, it would be understood by a trader or user skilled in the art that Halved Hybrid Nozzlelism Annularization, is an intermediary portion of the Halved Hybrid Nozzlelism formation, which may occur between Halved Hybrid Nozzlelism parallelism and Halved Hybrid Nozzle Tipping area and halved convergence or halved divergence area. A user or trader should be aware that the formation of left Halved Hybrid Nozzlelism for convergence may occur on the upper or lower left side of the intersection of zone line 6755 (FIGS. 9, 10, 12, 13 and 14), while the formation of right Halved Hybrid Nozzlelism may occur on the upper or lower right side of the intersection of Blue Line 6755. A trader or user may be alerted by all important events as illustrated by a yellow triangle or any trader or user desired colors or shapes. All important events selected by a trader or user can have alerts may be sent via electronic mail, PDA's, or by audio/visual alert on chart during trading.

Upon reading the teachings of this specification, those skilled in the art will now appreciate that, under appropriate circumstances, the concepts behind Halved Hybrid Nozzlelism Annularization, may suffice.

### Halved Hybrid Nozzlelism Annularization for Convergence

Though not illustrated, a trader or user skilled in the art would understand that the function of the Halved Hybrid Nozzlelism Annularization for convergence, can be for the expansion of the trend to a new limit on either an intraday, daily, other time frame basis, or to reach a: nearest zone level in the higher time frames. Such a process may create new highs or new lows. A variety of embodiments of Halved Hybrid Nozzlelism Annularization for convergence are within the scope of the present disclosure

### Types of Halved Hybrid Nozzlelism Annularization (Convergence)

FIG. 9 illustrates one embodiment of the various types of Halved Hybrid Nozzlelism Annularization for convergence, referred to as lower left Halved Hybrid Nozzlelism Annularization (convergence) 6250.

Such configuration may occur after the formation of Warning Spot For First Turquoise PH Line (Bear To Bull) 6905, or a breakout of zone line 1010, and due to the possibility of extraordinary demand of numerous Bullish Believers, additional bullish risk recognition factors and/or Dynamic Sectional Price Risk types b or c may take place until the occurrence of lower left Halved Hybrid Nozzlelism Hybrid Parallelism 6350. A trader or user skilled in the art may expect higher prices within a market vehicle within the Halved Hybrid Nozzlelism Annularization (convergence) 6250 area. In certain instances, zone line 1040 may intersect with Blue Line 2381 to the upper side at the end of the portion and may form nozzlelism in the upper right part of Halved Hybrid Nozzlelism as an unscheduled event of a zone line 6755.

FIG. 10 illustrates one embodiment of the various types of Halved Hybrid Nozzlelism Annularization for convergence, referred to as upper left Halved Hybrid Nozzlelism Annularization (convergence) 6255, and may serve as an indication of the further expansion of a bearish trend. Such configuration may occur after the formation of Warning Spot for First Gold PL Line (Bull to Bear) 6906, or a breakdown of zone line 1070, and due to the possibility of extraordinary demand of numerous Bearish Believers, additional bearish risk recognition factors 3010 and/or Dynamic Sectional Price Risk 245 types e or f may take place until the occurrence of upper Halved Hybrid Nozzlelism parallelism 6355. A trader or user skilled in the art should be aware that zone line components such as 1040-b and 1040-g and horizontal Blue Line 2381 may be required. Such configuration may lead into the formation of Halved Hybrid Nozzlelism parallelism and the possibility of further new levels of zone line 1070. A trader or user may be alerted by all important events as illustrated by a yellow triangle or any trader or user desired colors or triangles. All important events selected by a trader or user can have alerts may be sent via electronic mail, PDA's, or by audio/visual alert on chart during trading. Upon reading the teachings of this specification, those skilled in the art will now appreciate that, under appropriate circumstances, the various types and examples of Halved Hybrid Nozzlelism Annularization for convergence, may suffice.

### Halved Hybrid Nozzlelism Annularization for Divergence

Though not illustrated, a trader or user skilled in the art would understand that the function of the Halved Hybrid Nozzlelism Annularization for divergence may be for the release of pressure that may occur from either the bullish or Bearish Believers in a previous trend and may help stop further losses in trading. During such formation, zone lines 1006 may become stabilized and the transformation of one type of believers to the other type of believers can occur.

Upon reading the teachings of this specification, those skilled in the art will now appreciate that, under appropriate circumstances, the concepts behind Halved Hybrid Nozzlelism Annularization for divergence, may suffice.

### Types of Halved Hybrid Nozzlelism Annularization (Divergence)

FIG. 10 illustrates one embodiment of the various types of Halved Hybrid Nozzlelism Annularization for divergence, referred to as lower right Halved Hybrid Nozzlelism Annularization (divergence) 6260. After the formation of Lower Right Halved Hybrid Nozzle Tipping 6460, a stabilized zone line 1070 may occur and the demand for Bearish Believers may diminish and Scalp-Swing set ups such as earlier lows −4.6(Mc)++ 2156, earlier lows −4.6(Mc)+, or earlier lows −4.6(Mc) and/or bullish risk recognition factors such as Dynamic Sectional Price Risk type a, Earlier Highs +3.1 1470-a1, or Earlier Highs +3.2 1470-a2 may take place until the formation of lower right Halved Hybrid Nozzlelism Divergence 6160. A trader or user may expect slightly higher prices or a small possible consolidation of a market vehicle, which may lead to higher prices for the next phase of lower right Halved Hybrid Nozzlelism Divergence 6160.

With respect to FIG. 10, for example, a trader or user skilled in the art should be aware of Warning Spot For First Gold PL Line (Bull To Bear) 6906. Such configuration may occur where the post, where Halved Hybrid Nozzlelism Divergence may end and where halved Annularization may start. This may be referred to as a “breakdown” or the making of new lows for upper left Halved Hybrid Nozzlelism Convergence and lower right Halved Hybrid Nozzlelism Divergence (“PL” indicates possible lower prices of a market vehicle 1660).

FIG. 11 illustrates one embodiment of the various types of Halved Hybrid Nozzlelism Annularization for divergence, referred to as Upper Right Halved Hybrid Nozzlelism Annularization (Divergence) 6265. After the formation of upper right Halved Hybrid Nozzlelism parallelism 6365, due to the possibility of increasing demand from Bullish Believers, all zone lines with the exception of the lowest zone line 1070 may shift to the upside, and may help form at least two zone line components 1040-c and 1040-g, wherein as 1040-c may be parallel to the Blue Line 2381. A trader or user skilled in the art may expect turquoise PH lines 1655 within the health risk indicator 1215/modified health risk indicator 1216 area and may also expect some pink ext bear warning lines 1675 and/or higher risk symbols such as “4” or “5”. A trader or user may be alerted by all important events as illustrated by a yellow triangle or any trader or user desired color or shapes. All important events selected by a trader or user can have alerts may be sent via electronic mail, PDA's, or by audio/visual alert on chart during trading.

Upon reading the teachings of this specification, those skilled in the art will now appreciate that, under appropriate circumstances, the various types and examples of Halved Hybrid Nozzlelism Annularization for divergence, may suffice.

### Halved Nozzle Hybrid Parallelism

FIG. 8 describes an illustrative display of one type of halved nozzle Hybrid Parallelism. As such, a person having ordinary skills might be able to recognize, with minimal training based on visualization of a variety of illustrative halved nozzle Hybrid Parallelism shapes, as described subsequently, such as may develop in real time based on dynamic changes in the market. For instance, FIG. 8 illustrates a display of dynamically moving specialized mid pivot (also known as mid Blue Line 2381) of a higher time frame based on real time calculations, and illustrates a display of dynamically moving one of the vertical risk components 276 of a lower time frame based on real time calculations of mid zone level 1040.

Certain embodiments of the multidimensional risk analysis systems 100, as described above with respect to FIGS. 1 and 2, can be configured to perform the above calculation. Thereupon, the user interface 125 (FIGS. 1 and 2) will project such a display the formation of halved nozzle Hybrid Parallelism 7000 which may be observed, as illustrated in real time in FIG. 8. This halved nozzle Hybrid Parallelism 7000 may be based at least partially in response to the relationship between said dynamically calculating and displaying specialized mid pivot of a higher time frame as taken with respect to said dynamically calculating and displaying vertical risk components of a lower time frame, but both components remain parallel.

In FIG. 8, halved nozzle Hybrid Parallelism 7000 shape develops over the period of time in trading, FIG. 8 illustrates one embodiment of halved nozzle Hybrid Parallelism 7000, which may serve as an indication of a bullish to bearish trend change and possible profit taking by the Bullish Believers and as a possible sign of retracement for the bulls. Such configuration may occur during the post and pre formation of Halved Hybrid Nozzlelism 6000, and after or before the intersection with Blue Line 2381. It may be observed that market vehicle prices lost its value due to the possible lack of Bullish Believers and taking profits and the possible empowerment of Bearish. Believers. Generally, a trader or user skilled in the art would understand that halved hybrid nozzle parallelism may occur after the formation of a tipping area on either the upper right or lower right side of the Halved Hybrid Nozzlelism and possibly after the formation of lower or upper left halved Annularization portion of the Halved Hybrid Nozzlelism. Such configuration may be comprised of zone line component 1040-d (FIGS. 9, 10, and 11) and requires 1040-g (FIGS. 9, 11, 12, and 13) to connect the other component. A trader or user skilled in the art should understand that the distance between Blue Line 2381 and zone line 1040 may be approximately 4 pips for currencies (FIG. 13) and may be approximately two cents for stocks/ETFs or any other market vehicle (FIG. 13) (being provided for reference purposes only). It should be further understood that both lines should be parallel. Upon reading the teachings of this specification, those skilled in the art will now appreciate that there might be a variety of embodiments of halved nozzle Hybrid Parallelism.

### Types of Halved Nozzle Hybrid Parallelism

FIG. 9 illustrates one embodiment of the various types of halved nozzle Hybrid Parallelism, referred to as lower left halved nozzle Hybrid Parallelism 6350. Within such area, the Bullish Believers may still be in control. However, the possibility of risk designators such as “4” or “5” can be observed and the possibility of a higher Msb 2080 such as 6 or 7 can be observed, which may state to a trader or user skilled in the art that there can be higher risk which may become evident by the Hybrid Parallelism of Blue Line 2381 and zone line 1040 within a very short distance, which may be approximately 5 pips for currencies and may be approximately fifty cents for stocks or other Market Vehicles. It may become evident that at the end of Hybrid Parallelism, the Bullish Believers may become exhausted within such area. A trader or user should be aware of bearish risk recognition factors, such as Super Bullish Belief Contra +Re 2200, Super Bullish Belief Contra +Re1 (not illustrated), and/or Super Bullish Belief Contra +Re2 (not illustrated).

FIG. 10 illustrates one embodiment of the various types of halved nozzle Hybrid Parallelism, referred to as upper left halved nozzle Hybrid Parallelism 6355. After the formation of Nozzlelism to Hybrid Parallelism Transformation Point 6371, both zone line 1040 and Blue Line 2381 may stay parallel to one another for a period of time until either the occurrence of a Scheduled Event of Blue Line or shifting of zone lines 1006. A trader or user should be aware that zone line 1040 might be higher than Blue Line 2381 and such distance may be approximately 5-7 pips for currencies and 50 cents for stocks or other Market Vehicles. The phenomenon of Hybrid Parallelism can be used as a forecasting tool and may cause zone line 1040 and Blue Line 2381 to attract Bullish Believers into testing these levels. A trader or user skilled in the art may want to be aware of dynamic price risk types a or b, BW 1430, yellow bar 1430, and/or other bullish risk recognition factors, which may support forecasting. It should be further made aware that zone lines 1006 should be parallel during this configuration.

FIG. 10 illustrates one embodiment of the various types of halved nozzle Hybrid Parallelism, referred to as lower right halved nozzle Hybrid Parallelism, which may serve as an indication of the transformation from bearish to bullish trend. Lower right halved nozzle Hybrid Parallelism may occur if after the formation of lower right Halved Hybrid Nozzle Tipping 6460, zone line 1040 continue to expand with Horizontal Time Risk 255, provided that the lowest zone line 1070 remain parallel to Blue Line 2381 and whereas component 1040-d should be parallel to Blue Line 2381 and should have a visible distance from the Blue Line and comprise of at least one component of 1040-g. A trader or user skilled in the art should be aware of factors such as Black Neutral Candle (also known as Neutral Bar) 1460, earlier lows −4.6(Mc)++ 2156, Earlier Highs +3.1 1470-a1, Powder Blue (C) Bullish Candle 1450 and/or other bullish risk recognition factors for the possible divergence of flow through the body of halved hybrid nozzle towards right lower Annularization 6260.

FIG. 11 illustrates one embodiment of the various types of halved nozzle Hybrid Parallelism, referred to as upper right halved nozzle. Hybrid Parallelism 6365. This configuration may occur between the upper right Halved Hybrid Nozzle Tipping 6465 and the upper right halved Annularization 6255, where in as at least two components 1040-d and 1040-g may exist 1040-d should be parallel, to Blue Line 2381, and may have a visible distance from Blue Line 2381. A trader or user should be aware that there may be a strong hold in the market vehicle prices due to the outperformance to the Bearish Believers by the Bullish Believers. In certain instances, super bullish belief entries 1621 may be created regardless of the possibility of higher risk designators such as “4” or “5”. A trader or user should further be aware that the existence of turquoise PH lines 1655 may serve as an indication of a further expansion of the uppermost zone lines, which may include zone line 1040 should zone line 1070 stay horizontal. A trader or user may be alerted by all important events as illustrated by a yellow triangle or any trader or user desired colors or shapes. All important events selected by a trader or user can have alerts may be sent via electronic mail, PDA's, or by audio/visual alert on chart during trading. Upon reading the teachings of this specification, those skilled in the art will now appreciate that there might be a variety of other types and examples of halved nozzle Hybrid Parallelism.

### Halved Hybrid Nozzle Tipping

Though not illustrated, a trader or user skilled in the art should understand that the front Hybrid Parallelism portion, which may be in variable length on a Horizontal Time Risk from one to several number of the same time frame and can connect at least two Components of Halved Hybrid Nozzlelism, such as 1040-e (FIGS. 9, 10, and 11) and 1040-g (FIGS. 9, 10, 11, 12, and 13) may be referred to as nozzle tipping area. The end of the tip may start with an unscheduled intersection of zone line 1040 or with the pre-nozzlelism hybrid confluence and the other end may be connected to halved nozzle Hybrid Parallelism. A trader or user skilled in the art should be aware that zone lines 1006 should remain parallel to Blue Line 2381 during the formation of 1040-e. This configuration may serve as an indication of a low risk area for an upcoming trend. Upon reading the teachings of this specification, those skilled in the art will now appreciate that there might be a variety of embodiments of Halved Hybrid Nozzle Tipping.

### Types of Halved Hybrid Nozzle Tipping

FIG. 9 illustrates one embodiment of the various types of Halved Hybrid Nozzle Tipping, referred to as lower left Halved Hybrid Nozzle Tipping 6450. After the formation of lower halved nozzlelism Hybrid Parallelism 6350, a trader or user skilled in the art should understand that if zone line 1040 has not penetrated Blue Line 2381, it may stay parallel to Blue Line 2381, but may be at a very minute visible distance, thus may create Halved Hybrid Nozzle Tipping shape over several times frames over an extended Horizontal Time Risk 255, since the formation of the scheduled or unscheduled risk transition line. In certain instances, during the tipping formation, Bullish Believers may become exhausted within this area. A trader or user skilled in the art may want to become aware of various factors such as Super Bullish Belief Contra +Re 2200, Super Bullish Belief Contra +Re1 (not illustrated), Super Bullish Belief Contra +Re2 (not illustrated), Black Neutral Candle (Neutral Bar) 1460, Magic: Out 2330 (FIG. 6), and/or other bearish risk recognition factors.

A trader or user should further be aware that a formal pullback may take place before the end of halved hybrid nozzle tip, which may serve as an indication as a possible sign of weakness from the Bullish Believers, which may be evident by factors, but not limiting in scope, such as Black Neutral Candle (Neutral Bar) 1460 (FIGS. 6, 9, and 10) or Super Bullish Belief Contra +Re 2200 (FIGS. 9, 17, and 18). It may be further noted that halved tipping should end with the intersection of zone line 1040 to Blue Line 2381.

FIG. 10 illustrates one embodiment of the various types of Halved Hybrid Nozzle Tipping, referred to as upper left Halved Hybrid Nozzle Tipping 6455. Such configuration may occur after the formation of Upper Left Halved Nozzlelism Hybrid Parallelism 6355, where Bullish Believer may have taken control from the Bearish Believers, which may be evidenced by modified bullish time segment 1131. Due to the possibility of an increasing demand from Bullish Believers, a nozzle-shape may occur within three to four time periods, instead of the possibility of zone line 1040 intersecting with blue 2381. This may further try to form a first evidence of transformation to hybrid confluence, which may occur at the end of the nozzle. A trader or user skilled in the art should be aware of factors such as Yellow Bull Warning Candle 1430, Gray (C) Bullish Candle 1440, Black Neutral Candle 1460, and/or other bullish risk recognition factors.

FIG. 10 illustrates one embodiment of the various types of Halved Hybrid Nozzle Tipping, referred to as lower right Halved Hybrid Nozzle Tipping 6460, which may serve as an indication of the Bearish Believers' last action. Such configuration may occur after the unscheduled intersection of zone line 6755, which may further lead to zone line component 1040-e making a confluence with Blue Line 2381 and may have component 1040-g on the lower right side of 6755. A trader or user skilled in the art should be aware that lower zone line 1070 should stay horizontal to blue 2381. This area may serve as the first evidence of the stabilization of market prices after a possible selloff, which may bring the attraction of Bullish Believers. A trader or user skilled in the art should be aware that the possibility of Lower Right Halved Nozzle Hybrid Parallelism 6360 may form.

FIG. 11 shows one embodiment of the various types of Halved Hybrid Nozzle Tipping, referred to as upper right Halved Hybrid Nozzle Tipping 6465, which may serve as an indication of a bullish trend to a more bullish trend and the possibility of a first breakout point. After the formation of upper right halved pre-nozzle hybrid confluence 6585, it is possible that most of the zone lines may remain parallel until the possible shifting point 6917 becomes established for upper zone line 1010. It is further possible that after such shifting point, component 1040-g occurs. Such configuration of upper right Halved Hybrid Nozzle Tipping may occur when there are three time period distances from upper right halved hybrid confluence 6585 up until the possible formation of Upper Right Pre Halved Hybrid Nozzlelism Confluence 6585, with the inclusion of 1040-e.

A trader or user skilled in the art should be aware that such area of this configuration may help Bullish Believers build up their position and to further possibly buildup more positions which may lead to the creation of shifting point 6917 for zone line 1040. It should further be aware that Warning Spot for First Turquoise PH Line 6905 may serve as a warning sign of Turquoise PH Line 1655 and that commitment from Bullish Believer might be possible even if there is the possibility of higher risk numbers such as “3” or “4”. A trader or user may be alerted by all important events as illustrated by a yellow triangle or any trader or user desired colors or shapes. All important events selected by a trader or user can have alerts may be sent via electronic mail, PDA's, or by audio/visual alert on chart during trading. Upon reading the teachings of this specification, those skilled in the art will now appreciate that there are a variety of types and examples of Halved Hybrid Nozzle Tipping.

Forecasting Earlier Highs and Earlier Lows for Halved Hybrid Nozzlelism with Risk Assessment

Though not illustrated, a trader or user skilled in the art should understand that in trading, it is possible to forecast with the use of risk assessment during the formation of Halved Hybrid Nozzlelism. It may be understood that as Halved Hybrid Nozzlelism process takes place, during the shifting of zone line 1010 or 1070, there may be a possible designation of numbers such as, but not limiting in scope, “1NZ”, “2NZ”, “3NZ”, “4NZ”, “5NZ” or “6NZ”, which may be referred to as risk designators of Halved Hybrid Nozzlelism. A trader or user skilled in the art may further categorize such risks as per his/her choice. Such risk designations may help a trader or user to possibly forecast earlier highs or lows with risk assessments during the formation of Halved Hybrid Nozzlelism.

A trader or user skilled in the art should understand that since Halved Hybrid Nozzlelism has the possible inheritance of additional support from the bullish or Bearish Believers, it becomes possible to take the upper risk designators for Halved Hybrid Nozzlelism, such as 3NZ, 4NZ or 5NZ, as possible safer entries compared to the risk designators 2045 (FIGS. 6, 7 and 11), such as “3”, “4”, “5” or “6”.

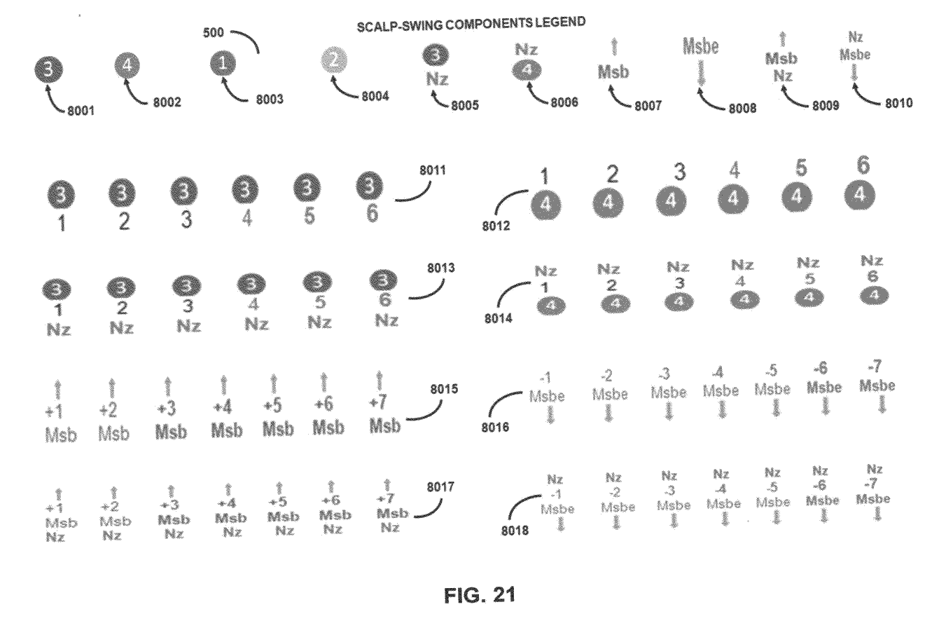

FIG. 21 illustrates one embodiment of forecasting earlier highs and earlier lows for Halved Hybrid Nozzlelism with risk assessment, which can be referred to as forecasting earlier highs with risk assessment for Halved Hybrid Nozzlelism 8013. A trader or user skilled in the art should understand that as the possibility of the Halved Hybrid Nozzlelism process takes places, during the possible shifting of zone 1010, designation of risk designators for Halved Hybrid Nozzlelism, such as, but not limiting in scope, “1NZ”, “2NZ”, “3NZ”, “4NZ”, “5NZ” or “6NZ” might take place if risk designators such as, but not limiting in scope, “1”, “2”, “3”, “4”, “5”, or “6” are available. With respect to FIG. 21, it can be further understood that the design may be the same as forecasting earlier highs with risk assessments 8011, with exception to the Halved Hybrid Nozzlelism process. A trader or user skilled in the art should understand that such risk designators can be further categorized as per a trader or user's choice. Reference to the User's Manual should be given attention to for various categories, of forecasting earlier high details.

FIG. 21 illustrates one embodiment of forecasting earlier highs and earlier lows for Halved Hybrid Nozzlelism with risk assessment, which can be referred to as forecasting earlier lows with risk assessment for Halved Hybrid Nozzlelism 8014. A trader or user skilled in the art should understand that as the possibility of the Halved Hybrid Nozzlelism process takes places, during the possible shifting of zone 1070, designation of risk designators for Halved Hybrid Nozzlelism such as, but not limiting in scope; “1NZ”, “2NZ”, “3NZ”, “4NZ”, “5NZ” or “6NZ” might take place if risk designators 2045 such as, but not limiting in scope, “1”, “2”, “3”, “4”, “5”, or “6” are available. A trader or user skilled in the art should understand that such risk designators can be further categorized as per a trader or user's choice. Reference to the User's Manual should be given attention to for various categories of forecasting earlier low details. With respect to FIG. 21 it can be further understood that the design may be the same as forecasting earlier low with risk assessments 8012, with exception to the Halved Hybrid Nozzlelism process. Upon reading the teachings of this specification, those skilled in the art will now appreciate that, under appropriate circumstances, there are a variety of types and examples behind forecasting earlier highs and earlier lows for Halved Hybrid Nozzlelism with risk assessment.

Super Belief Bull/Bear Pin Point Entries with Risk Assessment for Halved Hybrid Nozzlelism

Though not illustrated, a trader or user skilled in the art should understand due to the possible additional support from bullish or Bearish Believers in the Halved Hybrid Nozzlelism process, it may be possible, so long as the shifting of zone lines do not stop, to use super belief bear pin point entries categories with risk assessment or MSBE or higher risk designators such as, but not limiting in scope, “4NZ”, “5NZ”, or “6NZ instead of risk designators such as, but not limiting in scope, “4”, “5”, or “6”. A trader or user skilled in the art should understand that the same logic may apply to super belief bear pin point entries categories with risk assessment or MSB.

FIG. 21 illustrates one embodiment of super belief bull/bear pin point entries with risk assessment for Halved Hybrid Nozzlelism, which can be referred to as super belief bull pin point entries with risk assessment for Halved Hybrid Nozzlelism 8017. A trader or user skilled in the art should understand that as the possibility of Halved Hybrid Nozzlelism process takes place, during the possible shifting of zone line 1010, designation of risk designators designation of risk designators for Halved Hybrid Nozzlelism such as, but not limiting in scope; “1NZ”, “2NZ”, “3NZ”, “4NZ”, “5NZ”, “6NZ” or “7NZ” might take place if risk designators such as, but not limiting in scope, “1”, “2”, “3”, “4”, “5”, “6”, or “7” are available. A trader or user skilled in the art should understand that such risk designators can be further categorized as per a trader or user's choice. Reference to the User's Manual should be given attention to for various categories of super belief bull pin point entries with risk assessment for Halved Hybrid Nozzlelism details. With respect to FIG. 21, it can be further understood that they design may be the same as Super Belief Bull Pin Point Entries Categories w/Risk Assessment 8015, with exception to the Halved Hybrid Nozzlelism process.

FIG. 21 illustrates one embodiment of super belief bull/bear pin point entries with risk assessment for Halved Hybrid Nozzlelism, which can be referred to as super belief bear pin point entries with risk assessment for Halved Hybrid Nozzlelism 8018. Though not illustrated, a trader or user skilled in the art should understand that as the possibility of Halved Hybrid Nozzlelism 6000 process takes place, during the possible shifting of zone line 1070, designation of risk designators designation of risk designators for Halved Hybrid Nozzlelism such as, but not limiting in scope, “1NZ”, “2NZ”, “3NZ”, “4NZ”, “5NZ”, “6NZ” or “7NZ” might take place if risk designators such as, but not limiting in scope, “1”, “2”, “3”, “4”, “5”, “6”, or “7” are available. A trader or user skilled in the art should understand that such risk designators can be further categorized as per a trader or user's choice. Reference to the User's Manual should be given attention to for various categories of super belief bear pin point entries with risk assessment for Halved Hybrid Nozzlelism details. With respect to FIG. 21, it can be further understood that the design may be the same as Super Belief Bear Pin Point Entries Categories w/Risk Assessment 8016, with exception to the Halved Hybrid Nozzlelism process. A trader or user may be alerted by all important events as illustrated by a yellow triangle or any trader or user desired colors or shapes. All important events selected by a trader or user can have alerts may be sent via electronic mail, PDA's, or by audio/visual alert on chart during trading. Upon reading the teachings of this specification, those skilled in the art will now appreciate that there are various types and examples of super belief bull/bear pin point entries with risk assessment for Halved Hybrid Nozzlelism.

Scalp Swing Trading with Halved Hybrid Nozzlelism

Within this disclosure, the term “Scalp-Swing” may be utilized to demonstrate a unique trading style, which may be utilized to help an ordinary skilled trader to understand important events such as market trend change, breakouts, retracements, new highs, new lows, directional prediction, reversals, pullbacks, and many other trading clues. Though not illustrated, a trader or user skilled in the art should understand that due to the discovery of Halved Hybrid Nozzlelism, its stated details, and its components, the use of Scalp-Swing Trading has brought the possibility of accuracy in trading to new levels. A trader or user may be to trade with various types of Halved Hybrid Nozzlelism and can be able to trade any market vehicle in any time frame with possible high super levels of efficient trading. A trader or user can use forecasting earlier highs and earlier lows for Halved Hybrid Nozzlelism with risk assessment and/or, but not limiting in scope, super belief bull/bear pin point entries with risk assessment for Halved Hybrid Nozzlelism for the refinement of Scalp-Swing.

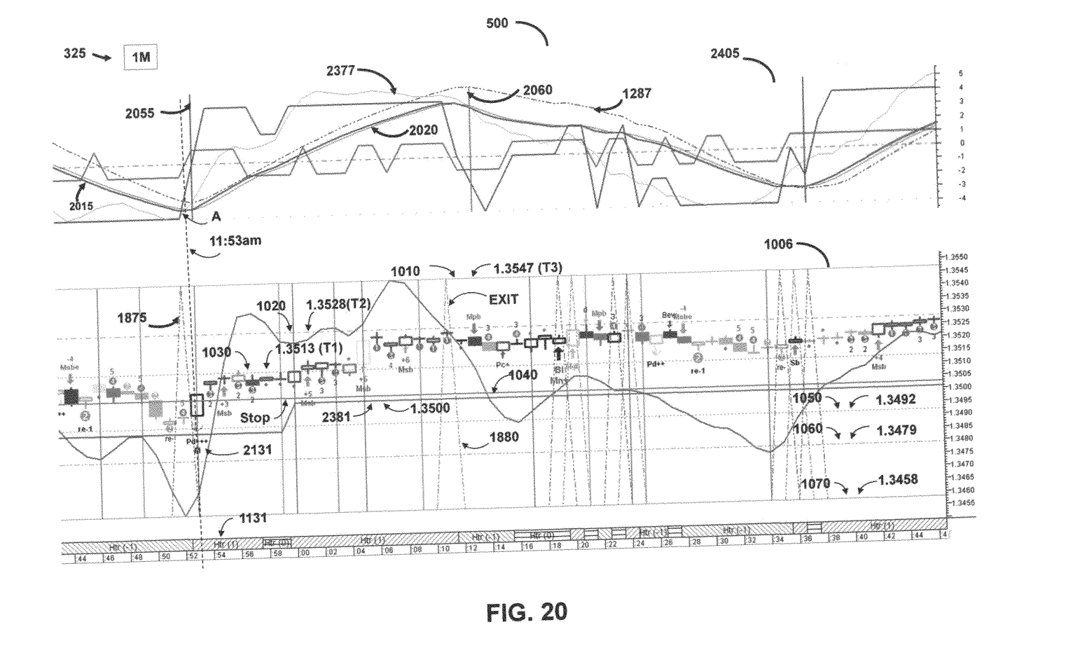

A trader or user should be aware that Scalp-Swing trading can be applied to various types or shapes of Halved Hybrid Nozzlelism but for example purposes, only one example shall be provided herein. FIG. 11 illustrates one embodiment of Scalp-Swing trading with Halved Hybrid Nozzlelism, referred to as scalp-swing trading with upper right Halved Hybrid Nozzlelism. A trader or user should look for a scalp-swing setup for bullish symbols such as, but not limiting in scope, Bullish Dk Yellow Candle—Type a ++ (M) 2126 (FIG. 17), Bullish Dk Yellow Candle—Type a (M) 2127 (FIG. 18), Bullish Bright Green Candle—Type b (M) (not illustrated), Bullish Green Candle—Type c + (M) Pc+ (not illustrated), Purple (C) Candle—Type d +++ (M) Pd 2131 (FIG. 20), Turquoise Bullish Candle + (M) (not illustrated), Gray (C) Bullish Candle (M) (not illustrated), Black Neutral Candle (Mn+) 2146 (FIGS. 11, 13, 14, and 15) Powder Blue (C) Bullish Entry(Me)+Oex (not illustrated), or SuperBearishBeliefContra −Re-2(Me) (FIG. 13).

Within FIG. 11, it can be seen that Black Neutral Candle (Mn+) 2146 occurred. A trader or user can use the beginning of modified bullish time segment 1131 and the formation of green spike 1875 to possibly enter a trade.

Upon further evaluation of such possible entry, a trader or user can put a tight stop after the possible formation of the first pink line 1675 and trail until the possible stabilization of zone lines 1006. Another possible exit can be with the possible appearance of red spike 1880 or modified bearish time segment 1141. Within such listed entry and exit, as portrayed in FIG. 11, it took approximately 29 minutes for such a trade to take place and created an 80 pip move from 1.3570 to 1.3650. A trader or user may use a vertical direction green line 2055 as another possible entry. The use of the modified dynamic strength risk indicator 1287 with values exceeding +6 may be used as a warning sign for the possible use of tightening stops and trail them. An aggressive trader may want to add additional lots or positions at each turquoise PH line 1655 for the first seven to nine/ten line appearances or until the third pink line 1675.

Typically, with reference to FIG. 11, a series of turquoise PH lines 1655 can take place, which can start at, but not limiting in scope, Warning Spot For First Turquoise PH Line (Bear To Bull) 6905, during upper right halved nozzle Hybrid Parallelism 6365, during upper right Halved Hybrid Nozzlelism Annularization (divergence) 6265, and during upper right Halved Hybrid Nozzlelism Divergence 6165. The appearance such lines may form in a total of approximately 12 to 14 counts for a very powerful trend, up to 9 for a medium breakout, up to 5 for a normal breakout, and sometimes a scattered of one or two to match upper time frame levels. Indicators such as earlier highs +3.4 1470-a4, earlier highs +3.5 1470-a5, or earlier highs +3.6 1470-a6, despite the use of higher risk warnings such as “4” or “5” may help predict higher prices and in helping to make intraday highs or new highs until the stabilization of zone levels 1006 and the establishment of modified bearish time segment 1141. The possible formation of a first few pink extended bear warning lines 1675 in upper right halved Annularization 6265 may serve as an indication of an upcoming exhaustion in the upper right halved hybrid nozzle divergence 6155 (FIG. 10). Halved hybrid nozzle divergence 6165 may control the completion of an extended bullish trend and may form exhaustion as shown with pink extended bear warning lines 1675. Modified bullish time segment 1131 may be most bullish during upper right Halved Hybrid Nozzlelism (upper right step up Halved Hybrid Nozzlelism) 6035.

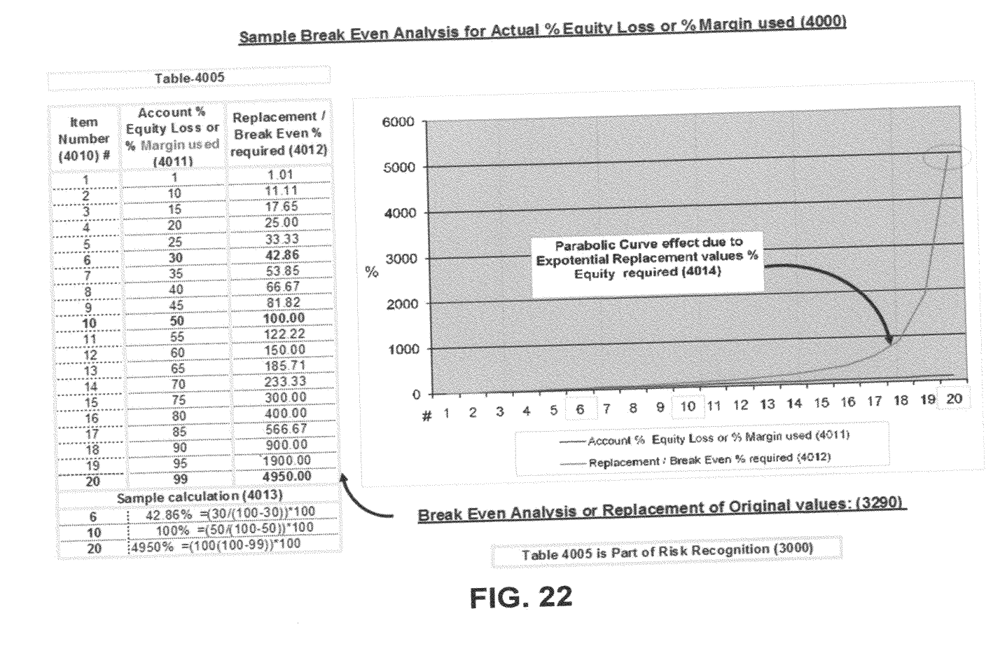

FIG. 22 shows one embodiment of a display, showing an illustrative table and graphic representation displaying a sample breakeven analysis for actual percentage equity or margin used, as may be included within certain embodiments of the multidimensional risk analysis systems 100 of FIGS. 1 and 2. A trader or user may use tables 4100 (FIG. 23), 4200 (FIG. 24), and/or 4005 (FIG. 22) for proper risk evaluation, risk control, capital preservation, trade repair/portfolio repairs for using scalp-swing setups. Those skilled in the art will now appreciate that there are a variety of concepts and examples behind scalp-swing trading with Halved Hybrid Nozzlelism and its various applications.

### Confluence in Hybrid Dynamic Zone Lines and Halved Hybrid Nozzlelism

Certain embodiments of the multidimensional risk analysis systems 100, as described above with respect to FIGS. 1 and 2, can be configured, though not illustrated, with Hybrid Dynamic Zone Lines 1006 to possibly create confluence. Hybrid confluence comprises two major components. One embodiment of hybrid confluence can be referred to as Hybrid Dynamic Zone Lines 1006, which can serve as vertical risk. As mentioned in Provisional Application Ser. Nos. 61/210,599 and 61/343,120 as part of vertical risk, such line may be characterized as dynamic, flexible, adaptive and can create a vertical distance amongst them. A trader or user skilled in the art should be aware that there are seven zone lines, and that when combined with FXTA Pivot lines (Blue Line or any user desired pivot type), form hybrid zone lines 1006. Another embodiment of hybrid confluence can be referred to as FXTA Pivots lines (Blue Line or any user desired pivot type). Several lines, although not limiting in scope, may be used in combination with zone lines 1006: Blue Line (FXTA −30 Minute Mid Pivot), Blue Line (FXTA −60 Minute Mid Pivot) 2381 (FIGS. 3, 4, 6, 7, 8, 9, 10, 11, 12, 13, 14, 16, etc), FXTA Daily Mid Pivot, FXTA Weekly Mid Pivot, FXTA Monthly Mid Pivot, or FXTA Yearly Mid Pivot. A trader or user skilled in the art should be aware that other pivot lines may be used instead of a Mid-Pivot; and the use of Blue Line 2381 and zone line 1040 are used to provide convenience. The phenomenon of the formation of hybrid confluence shape into the theory of “Halved Hybrid Nozzlelism” may be referred to as “Hybrid Confluence”.

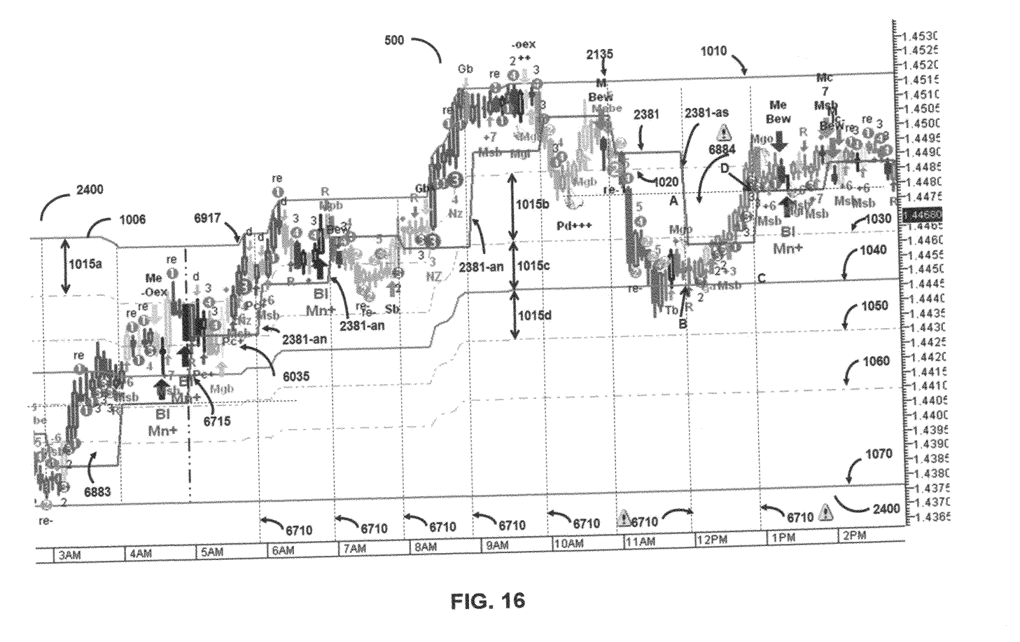

A trader or user skilled in the art should be aware that during its formation, Blue Line 2381 and zone line 1040 should stay parallel with very close visible distance on a chart, with an approximate maximum of 3 pips for currencies and approximately one cent for stock and/or other Market Vehicles. A trader or user should be further aware that over a period of time, this can end with either a scheduled event of the Blue Line 6710 (FIG. 16) or an unscheduled event of the zone line, or it can convert into Halved Hybrid Nozzlelism 6000 (FIG. 8) or Hybrid Parallelism 7000 (FIG. 8). The formation of such confluence can attract the Bullish Believers into taking profits, and if such Bullish Believers are within the upper zones or lower zones, the Bullish Believers may accumulate their positions within a market vehicle. The opposite may be applicable to Bearish Believers. A trader or user should further be aware that should confluence expand more in vertical distance, it may convert itself into Hybrid Parallelism 7000 (FIG. 8). A trader or user may be alerted by all important events as illustrated by a yellow triangle or any trader or user desired colors or shapes. All important events selected by a trader or user can have alerts may be sent via electronic mail, PDA's, or by audio/visual alert on chart during trading. Those skilled in the art will now appreciate that, under appropriate circumstances, there are a variety of concepts behind confluence in Hybrid Dynamic Zone Lines and Halved Hybrid Nozzlelism.

### Pre and Post Halved Hybrid Nozzlelism Confluence

Though not illustrated, a trader or user skilled in the art should understand that when hybrid confluence occurs before the formation of the various types of Halved Hybrid Nozzlelism, it may be referred to as pre-Halved Hybrid Nozzlelism confluence and when hybrid confluence occurs after the formation of the various types of Halved Hybrid Nozzlelism, it may be referred to as post-Halved Hybrid Nozzlelism confluence. There can be a variety of embodiments of post Halved Hybrid Nozzlelism confluence.

### Types of Post-Halved Hybrid Nozzlelism Confluence

FIG. 9 illustrates one embodiment of post-halved hybrid confluence, herein referred to as lower left post Halved Hybrid Nozzlelism confluence 6550, which may serve as an indication of a bullish to bearish trend change and possible profit taking by the Bullish Believers and as a possible sign of retracement for the bulls. Such configuration can occur after the completion of lower halved nozzlelism tipping area 6450, when zone line 1040 possibly intersects with Blue Line 2381, and after the completion of risk transition time area for unscheduled intersection of zone line 6765, it may travel to the upper right after the intersection and possibly form a Hybrid Parallelism that goes from left to right. It may be observed that market vehicle prices can lose its value due to the possible lack of Bullish Believers and taking profits and the possible empowerment of Bearish Believers. A trader or user skilled in the art should be aware of factors such as Indigo Bear Warning Candle 1435, Dynamic Sectional Price Risk types e or f and/or other bearish risk recognition factors. Such configuration may also be referred to upper right post-Halved Hybrid Nozzlelism confluence.

FIGS. 10 and 15 illustrate one embodiment of post-halved hybrid confluence, herein referred to as upper left post Halved Hybrid Nozzlelism confluence, which may serve as a first evidence of a preliminary development of a bullish trend. Such configuration may occur when Hybrid Parallelism forms after the failing of zone line 1040 to possibly create an unscheduled intersection of zone line with Blue Line 6755, but thus possibly creating Nozzlelism to Hybrid Parallelism Transformation Point 6371. A trader or user skilled in the art should be aware that such a confluence may attract Bullish Believers to possibly test either Blue Line 2381 or zone line 1040 from the lower zone levels 1060 and 1070 and thus may create a bullish trend within a market. To serve as a possible confirmation to a trader or user, factors such as Yellow Bull Warning Candle 1430, dynamic price risk type b, Gray (C) Bullish Candle 1440, and/or other bullish recognition factors. A trader or user should be further aware that if prices manage to stay above zone line 1040, it may serve as a confirmation that Bullish Believers have possibly taken control of the trend and that all of the Bearish Believers have become defeated.

FIG. 12 shows one embodiment of a display, showing an illustrative screenshot view displaying a colored Candlestick Spectrum chart showing the bullish preparation time, as may be included within certain embodiments of the multidimensional risk analysis systems 100 of FIGS. 1 and 2. It also illustrates one embodiment of post-halved hybrid confluence, referred to as lower right post Halved Hybrid Nozzlelism confluence 6560, which may serve as an indication of a pinpoint bullish consolidation area. Such configuration may occur when after the formation of Halved Hybrid Nozzlelism tipping 6350, if zone line 1040 possibly intersects Blue Line and remains a very close visible distance and parallel to the Blue Line, or may be close to merging, and up until all zone lines except the lower most zone line 1070 possibly shift to the upside, the parallel distance between unscheduled intersection of zone line 6755 and shifting point 6917. A trader or user skilled in the art should be aware that this can be a Bullish Believers controlled or breathing area, in which prices may be around the upper most zone 1010 area. It can further be understood that consolidation may occur with the evidence of Black Neutral Candle 1460, bullish green candle—type c MT-84, with earlier highs +3.3 1470-a3, earlier highs +3.4 1470-a4, and/or other indicators.

FIG. 9 illustrate one embodiment of post-halved hybrid confluence, referred to as upper right post-Halved Hybrid Nozzlelism confluence 6565, which may serve as an indication of bullish to bearish trend change and possible profit taking by the Bullish Believers and possible sign of retracement for the bulls. Such configuration can occur after the completion of lower halved nozzlelism tipping area 6450, when zone line 1040 possibly intersects with Blue Line 2381 after the completion of risk transition time area for unscheduled intersection of zone line 6765, it may travel to the upper right after the intersection and possibly form a Hybrid Parallelism that goes from left to right. It may be observed that market vehicle prices can lose its value due to the possible lack of Bullish Believers and taking profits and the possible empowerment of Bearish Believers. A trader or user skilled in the art should be aware of factors such as Indigo Bear Warning Candle 1435, Dynamic Sectional Price Risk types d, e, or f, and/or other bearish risk recognition factors. Such configuration may also be referred to lower left post-Halved Hybrid Nozzlelism confluence 6550. There are a variety of examples and embodiments of post-Halved Hybrid Nozzlelism confluence. A trader or user may be alerted by all important events as illustrated by a yellow triangle or any trader or user desired colors or shapes. All important events selected by a trader or user can have alerts may be sent via electronic mail, PDA's, or by audio/visual alert on chart during trading.

Upon reading the teachings of this specification, those skilled in the art will now appreciate that, under appropriate circumstances, the various types and examples of post-Halved Hybrid Nozzlelism confluence, may suffice.

### Types of Pre-Halved Hybrid Nozzlelism Confluence

FIG. 9 illustrates one embodiment of pre-halved hybrid confluence, herein referred to as lower left pre-Halved Hybrid Nozzlelism confluence 6570. After the formation of the lower halved Annularization portion of Halved Hybrid Nozzlelism, it is possible for all of the zone lines 1006 to remain stabilized and horizontal to each other with zone line 1040 and possibly remaining at a very close visible distance, approximately 5 pips in currencies and approximately fifty cents for stocks/ETFs and/or other Market Vehicles, for a number of periods of a particular user desired time frame along with the prolonged Horizontal Time Risk 255. Such configuration can be determined by the possible distance between the end of lower left Halved Hybrid Nozzlelism Annularization (convergence) 6250 until a new shifting point 6917 on the upper zone line 1010 possibly forms. A trader or user skilled in the art should be aware that Bullish Believers may be in control of this area, and possibly remaining close to the upper zone line 1010, and perhaps ready to move higher upon formation of 1040-g of the Halved Hybrid Nozzlelism.

FIG. 13 shows one embodiment of a display, showing an illustrative screenshot view showing several screenshot sections, displaying a colored Candlestick Spectrum chart showing hybrid confluence along with a health risk indicator 1216, as may be included within certain embodiments of the multidimensional risk analysis systems 100 of FIGS. 1 and 2. It also illustrates one embodiment of pre-halved hybrid confluence, herein referred to as upper left pre-Halved Hybrid Nozzlelism confluence 6575. Such configuration may occur if after the unscheduled intersection of zone line to Blue Line 6755 or scheduled intersection of Blue Line to zone line 6715, and if the zone line stays above the Blue Line, possibly keeping a very close visible distance and the possible formation of Hybrid Parallelism. This configuration may remain until the formation of upper left Halved Hybrid Nozzle Tipping area 6455. A trader or user skilled in the art should understand that typically all of the zone lines 1006 may squeeze during such an event. There may be a possibility of mixed signals occurring from bullish recognition factors and bearish recognition factors. It should be further understood that multi-confirmation signs such as Multi Dimensional Bear 1485 may serve as a sign that the trend direction may most likely be bearish.

FIG. 13 shows one embodiment of pre-halved hybrid confluence, referred to as lower right pre-Halved Hybrid Nozzlelism confluence 6580. Such configuration may occur after the unscheduled intersection of zone lines 6755, if the zone line component for the lower right Halved Hybrid Nozzlelism tipping area 6450 is extended over a number of times frames, usually more than three time periods, up until the formation of halved hybrid nozzle Hybrid Parallelism 6360 (FIG. 10). Halved Hybrid Nozzle Hybrid Parallelism 6360, as further illustrated within FIG. 10 may be understood as follows: a trader or user skilled in the art should be aware that Blue Line 2381 should have higher values than zone line 1040. Such area may be supported by a stabilized zone line 1070, which may constitute Bullish Believers relief and possibly generate short covering for the Bearish Believers, in which prices may move to the upper zone lines such as, but not limiting to, 1060 or 1050. A trader or user skilled in the art should be aware of factors such as earlier lows −4.6(Mc)++ 2156, yellow bull warning candle, Powder Blue (C) Bullish Candle 1450, and/or other bullish recognition factors. The possibility of more duration of the Horizontal Time Risk 255 can possibly assure consolidation within the market and a possible testing of the upper zone levels.

FIG. 13 illustrates a phenomenon of Expansion of Zone Lines 6921. After the possible Squeezing of Zone Lines 6920, at one point or another the unscheduled intersection of zone line 6755 may occur, due to the possible increased volatility and may create a shifting point either in the upward or downward direction, provided that one of the zone levels 1006, either 1010 or 1070 remain stable, which may create the Expansion of Zone Lines in either the upward or downward direction. As displayed within the left, the Squeezing of Zone Lines 6920 occurred, then the unscheduled intersection of zone lines 6755 created a downward movement for all the zone lines, with the exception of the upper most zone line 1010 and Halved Hybrid Nozzlelism Shifting End Spike/Vertical Line (Bear To Bull) allowed for stabilization. A trader or user skilled in the art should be aware that the first expansion confirmation point and subsequent expansion points of zone lines may be spotted by using, but not limiting scope to, Warning Spot For First Gold PL Line (Bull To Bear) 6906, then within FIG. 14 gold PL line 1660, and Shifting Point of Zone Lines 6917 for any possible bearish outlook and any warning sign for the first turquoise PH line 6905, Shifting Point of Zone Lines 6917 and subsequent black transition spike 1665. Though not illustrated, a trader or user skilled in the art should understand Trend Development and Recognition with Hybrid Zone Lines. Such concept may be applicable to Hybrid Dynamic Zone Lines, Hybrid Parallelism, hybrid zone risk transfer areas, hybrid confluence, and Halved Hybrid Nozzlelism. Many scalp-swing trade setups from the User's Manual, favorable bullish recognition factors and/or bearish recognition factors may be used for the enhancement of scalp-swing trading opportunities to conduct mega-scalp swing using trend development.

FIG. 11 shows one embodiment of pre-halved hybrid confluence, referred to as upper right pre-Halved Hybrid Nozzlelism confluence, which may serve as an indication of a pre-bullish move area and a possible first evidence of a pinpoint area of accumulation of Bullish Believers before a big upward move. Such configuration may occur after a scheduled intersection of Blue Line 6715 to the zone line 1040, if a Hybrid Parallelism is formed between the Blue Line 2381 and zone line 1040 with a very minute visible distance. Such configuration can last up until a scalp-swing setup 2146, a formation of modified bullish time segment 1131 or a bullish direction 2055 is possibly formed or until the upper right Halved Hybrid Nozzle Tipping point 6465 is possibly formed. A trader or user skilled in the art may understand that indicators such as, but not limiting in scope to, black neutral candle (Mn+) 2146, upper right Halved Hybrid Nozzle Tipping 6465 or health directional line-bullish 2055, may serve as an entry point for a huge possible upcoming surge in prices. It should be further understood that prices have to stay above zone line 1040 and Blue Line 2381 in order to qualify for a possibly further bigger upward move and possible breakouts. There are various types and examples of pre-Halved Hybrid Nozzlelism confluence.

Upon reading the teachings of this specification, those skilled in the art will now appreciate that, under appropriate circumstances, the various types and examples of pre-Halved Hybrid Nozzlelism confluence, may suffice.

Misc. Types of Hybrid Confluences

Though not illustrated, there are several embodiments of the types of hybrid confluence. Such confluences may be created due to either the shifting or non-shifting of zone lines 1006. Typically, during a less volatile period, zone line 1040 may come very close in distance to the Blue Line and may almost merge with one another.

FIG. 13 shows one embodiment of the misc. types of hybrid confluence, referred to as confluence zero after Hybrid Parallelism between two scheduled events of Blue Line. Such arrangement may occur when on the second scheduled event 6710 of the Blue Line possibly fails to intersect zone line 1040, but rather may become the same value of zone line 1040, and keeps such same value, either the Scheduled Event of Blue Line 6710 or Unscheduled Event of Zone Line 6755 may take place. A trader or user may be alerted by all important events as illustrated by a yellow triangle or any trader or user desired colors or shapes. All important events selected by a trader or user can have alerts may be sent via electronic mail, PDA's, or by audio/visual alert on chart during trading. There are various miscellaneous types and examples of hybrid confluence.

### Scalp-Swing Using Confluence

Though not illustrated, a trader or user skilled in the art may use Scheduled Risk Transition Spike/Line Bear Continue 6816 (FIGS. 9, 13, 14, and 18) or Super Belief Bear Pin Point En−6* 1620-6 (FIG. 13) and may scalp up to lower zone line 1060 or 1070, with the possible use of multiple lots/positions and using risk tables 4100 (FIG. 23)/4200 (FIG. 24) and may produce quicker results than the normal swing trading style. The use of scalp-swing setup Super Bearish Belief Contra −Re-2(Me) 2178 or Multi Dimensional Bull 1480 with the possible addition of multiple lots/positions and with the targets of zone lines 1060, 1050, 1040 or Blue Line 2381 and the adding of such lots upon the appearance of indicators such as, but not limiting scope to, every Yellow Bull Warning Candle 1430 (FIG. 6, 7, 9, 10, 13, or 15) or MSB with risk recognition indicators of “1”, “2”, “3”, or “4” may produce better results than normal swing trading. A trader or user skilled in the art should become aware that amount of time spent and money possibly earned, along with low risk, as hybrid confluence may provide for lower risk entries and attraction to their hybrid confluence levels, which may keep stops below zone line 1070. There are a variety of concepts behind Scalp-Swing using confluence.

Upon reading the teachings of this specification, those skilled in the art will now appreciate that, under appropriate circumstances, the concepts behind Scalp-Swing using confluence, may suffice.

Confluence Zero after Hybrid Nozzlelism Tipping Area

As shown in FIG. 14, such arrangement may occur when hybrid nozzlelism tipping area has both zone line 1040 and Blue Line 2381 within close or zero distance of one another. A trader or user skilled in the art should understand that as trading progresses, either an unscheduled event of the zone line 6755 or scheduled event of the Blue Line 6710 should occur after such arrangement. FIG. 14 shows one embodiment of the confluence zero after hybrid nozzlelism tipping area 6592, referred to as scalp-swing with confluence zero after hybrid nozzlelism tipping area 6592a. Due to the possible confluence of confluence zero after hybrid nozzlelism tipping area 6592, the previous higher prices may become attracted to both the Blue Line 2381 and zone line 1040. A trader or user skilled in the art may use Black Neutral Candle (Mn+) 2146 (following the third symbol on such figure), a bullish scalp-swing entry may be taken with stops below zone line 1040 and Blue Line 2381. A trader or user may use multiple lots and may use tables 4100 (FIG. 23)/4200 (FIG. 24), along with possible risk control methods and may expect at least a target of zone level 1030 and then possible 1020 and further possibly 1040. A trader or user may further at the shifting point 6917 or at Turquoise PH Line 1655, can trail the market vehicle until is possibly stopped out or may take profits at various indicator such as, Super Bullish Belief Contra +Re 2200, Super Bullish Belief Contra +Re1 (not illustrated), Super Bullish Belief Contra +Re2 (not illustrated) or other bearish risk recognition factors. A trader or user may be alerted by all important events as illustrated by a yellow triangle or any trader or user desired colors or shapes. All important events selected by a trader or user can have alerts may be sent via electronic mail, PDA's, or by audio/visual alert on chart during trading. Upon reading the teachings of this specification, there are a variety of concepts and applications of confluence zero after hybrid nozzlelism tipping area.

### Hybrid Parallelism

Within this disclosure, the term “Hybrid Parallelism” may be utilized to illustrate a general shape or pattern of a variety of indicator combinations, which may be utilized to help an ordinary skilled trader to understand important events such as market trend change, breakouts, retracements, new highs, new lows, directional prediction, reversals, pullbacks, and many other trading clues. Also, the various types and shapes of Hybrid Parallelism tends to indicate and show the accumulation of Bullish Believers or Bearish Believers or the exchange of Bullish Believers and Bearish Believers. The phenomenon of the formation of Hybrid Parallelism shape into the theory of “Halved Hybrid Nozzlelism” may be referred to as “Hybrid Parallelism”.

FIG. 13 illustrates one embodiment of Hybrid Parallelism. Within such concept, when the middle zone line 1040 possibly approaches Blue Line 2381 within an approximate 4 pips for currencies or within an approximate two cents for stocks/ETFs or other Market Vehicles, and when both zone line 1040 and Blue Line 2381 appear parallel to each other, it may be referred to as the development of zone level Hybrid Parallelism. Due to the Blue Line being a member of a separate family when made in comparison to zone line 1040, this may therefore be called Hybrid Parallelism 7000. Typically, Hybrid Parallelism may provide a trader or a user a warning sign that something may possibly occur to the current direction of a trade. This can possible turn into Halved Hybrid Nozzlelism or its different types or hybrid confluence or its different types, and as such may get effected by scheduled events of Blue Line 2381 and can produce various trading events and forecasting such as, but not limiting scope to, forecasting earlier highs with risk assessments 8011 (FIG. 21)/forecasting earlier highs with risk assessments for Halved Hybrid Nozzlelism 8013 (FIG. 21) or forecasting earlier lows with risk assessments 8012 (FIG. 21)/forecasting earlier lows with risk assessments for Halved Hybrid Nozzlelism 8014 (FIG. 21), various pin point entries such as, but not limiting scope to, super belief bull pin point entries categories w/risk assessment 8015 (FIG. 21)/super belief bull pin point entries categories w/risk assessment for Halved Hybrid Nozzlelism 8017 (FIG. 21) or super belief bear pin point entries categories w/risk assessment 8016 (FIG. 21)/super belief bear pin point entries categories w/risk assessment for Halved Hybrid Nozzlelism 8018 (FIG. 21), or scalp-swing trading or scalp-swing trading with Halved Hybrid Nozzlelism, as well as others. From such figure, a trader or user may understand the definition of this concept. There are a variety of embodiments and concepts of Hybrid Parallelism.

### Types of Hybrid Parallelism

There are certain embodiments of Hybrid Parallelism that may exist in trading and a trader or user may use the various types as a possible forecasting tool. FIG. 10 illustrates one embodiment of Hybrid Parallelism, herein referred to as bullish Hybrid Parallelism for lower right Halved Hybrid Nozzlelism 7031. Such configuration may form at the end of lower right Halved Hybrid Nozzlelism Divergence 6160 until either the formation of scheduled intersection of Blue Line 6715 with Blue Line angle south 2381-as or the closing/opening expansion at the particular point of intersection. A trader or user skilled in the art should be aware that Blue Line 2381 should be greater than zone line 1040 within such area and the Bullish Believers may be attracted to levels of Blue Line 2381 or zone line 1040.

FIG. 10 illustrates one embodiment of Hybrid Parallelism, herein referred to as bearish Hybrid Parallelism for upper left Halved Hybrid Nozzlelism 7032. Such arrangement may form after the scheduled intersection of Blue Line 6715 with Blue Line angle south 2381-as, once all zone lines 1006 have stabilized. A trader or user skilled in the art should understand that such configuration may be comprised of the area between the point of stabilization of all zone levels 1005 and the beginning of Upper Left Halved Hybrid Nozzlelism (Upper Left Step Down Halved Hybrid Nozzlelism) 6025. As illustrated within FIG. 10, prices may flow from the scheduled intersection of Blue Line 6715 to upper left Halved Hybrid Nozzlelism Convergence 6155 and may get transferred into bearish direction as the prices was not able to exceed zone level 1040. A trader or user skilled in the art should be aware that Blue Line 2381 should be lower than zone line 1040 within such area and that Bearish Believers may be in control below levels of Blue Line 2381 and zone line 1040.

FIG. 12 illustrates one embodiment of Hybrid Parallelism, hereby referred to as prep-bullish trend Hybrid Parallelism 7040. A trader or user skilled in the art should be aware that if all zone lines 1006 start shifting downwards at the same time, with the exception of 1070, and if zone line 1040 has a possibly higher value than Blue Line 2381 and the occurrence of Hybrid Parallelism does not take place shortly thereafter, it is most likely possible that a new bullish trend may develop within the near future, possibly after the formation of upper left Halved Hybrid Nozzlelism (upper left step down Halved Hybrid Nozzlelism) 6025. Such configuration may occur when the Blue Line 2381 is possibly between zone lines 1070 and 1060 or near zone line 1060, as such may constitute a possible bullish trend in the near future, so long as the prices can stay above Blue Line 2381. A trader or user skilled in the art should understand that the Blue Line 2381 should have a Blue Line angle-north 2381-an effect after this formation. A trader or user skilled in the art should further understand that factors such as, but not limiting in scope, transition bull 2295, Special Buy 2315, and/or other bullish risk recognition factors, may serve as a indication of such configuration.

FIG. 12 illustrates one embodiment of Hybrid Parallelism, referred to as pre-bullish trend Hybrid Parallelism 7041. Such configuration may occur after the formation of risk transition time area for scheduled intersection of Blue Line and Hybrid Parallelism 6721, possibly if all zone lines 1006 stop shifting downwards, instead remaining parallel at the same time and if zone line 1040 possibly has a lower value than Blue Line 2381 and pre-Hybrid Parallelism has not yet occurred, it is most likely that a new bullish trend can immediately develop. A trader or user skilled in the art may enter the bullish direction during the length of pre-bullish Hybrid Parallelism, considering the use of factors such as, but not limiting in scope, yellow bull warning candle 1430, turquoise bullish candle + (not illustrated), Special Buy 2315, and/or other bullish risk recognition factors. A trader or user skilled in the art should understand that after reference to risk tables 4100 (FIG. 23) and 4200 (FIG. 24), scalp-swing setups such as, but not limiting in scope, black neutral candle (Mn+) 2146, may provide a possible low risk bullish entry.

Though not illustrated, one embodiment of Hybrid Parallelism, may be hereby referred to as prep-bearish trend Hybrid Parallelism. A trader or user skilled in the art should be aware that if all zone lines 1006 start shifting upwards at the same time, with the exception of 1010, and if zone line 1040 has a possible lower value than Blue Line 2381 and the occurrence of Hybrid Parallelism does not take place shortly thereafter, it is most likely possible that a new bearish trend may develop within the near future, possibly after the formation of lower right Halved Hybrid Nozzlelism (lower right step down Halved Hybrid Nozzlelism) 6030 (FIG. 10). Such configuration may occur when the Blue Line 2381 is possibly between zone lines 1010 and 1020, as such may constitute a possible bearish trend in the near future, so long as the prices can stay below Blue Line 2381. A trader or user skilled in the art should understand that the Blue Line 2381 should have a Blue Line angle-south 2381-as effect after this formation. A trader or user skilled in the art should further understand that factors such as, but not limiting in scope, transition bear, special sell 2320, and/or other bearish risk recognition factors may serve as an indication of such configuration.

Though not illustrated, one embodiment of Hybrid Parallelism, may be referred to as pre-bearish trend Hybrid Parallelism. Such configuration may occur after the formation of risk transition time area for scheduled intersection of Blue Line and Hybrid Parallelism 6721 (FIG. 12), possibly if all zone lines 1006 stop shifting upwards, instead remaining parallel at the same time and if zone line 1040 has a higher value than Blue Line 2381 and pre-Hybrid Parallelism has not occurred first, it is most likely that a new bearish trend can immediately develop. A trader or user skilled in the art may enter the bearish direction during the length of pre-bearish Hybrid Parallelism, considering the use of factors such as, but not limiting in scope, indigo bear warning candle 1435 (FIGS. 6 and 9), golden bearish candle 1420 (FIG. 6), special sell 2320 (FIG. 12) and/or other bearish risk recognition factors.

FIG. 12 illustrates a Shifting Point of Zone Lines 6917. Such configuration may be the point where the zone lines start to shift, due to dynamic, adaptive changes within the market, due to changing market vertical risk 276.

FIG. 13 illustrates a Squeezing of Zone Lines 6920. A trader or user skilled in the art should understand that over a period of time, when the market has very low volatility, the distance between all zone lines may start to get smaller and smaller, thus possibly creating a situation where modified health risk indicator 1287 cannot reach the Boundary Lines. It should be further understood by a trader or user skilled in the art that the reduced distance between all zone lines may be referred to as squeezing and it may create breakouts or breakdowns.

FIG. 14 illustrates one embodiment of Hybrid Parallelism, referred to as prep-pre double bullish trend Hybrid Parallelism 7044, and as such may serve as an indication of an early, extremely bullish scalp-swing setup area. A trader or user skilled in the art should understand that such configuration has a pre-requisite, which as such, is the possibility of zone line 1040 having greater value than Blue Line 2381 at all time, it should have the forming of an upper left Halved Hybrid Nozzlelism on the left side and should have upper right Halved Hybrid Nozzlelism forming on the right side, of which should be before the scheduled intersection of Blue Line 2381. A trader or user skilled in the art should further understand that zone level 1010 should have a lower value on the right side of the prep-pre double bullish trend Hybrid Parallelism 7044 and should have a higher value on the left side of pre-bearish trend Hybrid Parallelism, which may serve as a confirmation of an upcoming bullish trend and further may serve as a forecasting tool for the second or third black neutral candle (Mn+) 2146.

Though not illustrated, one embodiment of Hybrid Parallelism, may be referred to as prep-pre double bearish trend Hybrid Parallelism, as such may serve as an indication of an early, extremely bearish scalp-swing setup area. A trader or user skilled in the art should understand that such configuration has a pre-requisite, which as such, is the possibility of zone line 1040 having lesser value than Blue Line 2381 at all time, it should have the forming of lower right Halved Hybrid Nozzlelism on the right side and should have lower left Halved Hybrid Nozzlelism forming on the left side, of which should be before the scheduled intersection of Blue Line 2381. A trader or user skilled in the art should further understand that zone level 1010 should have a higher value on the left side of prep-pre double bearish trend Hybrid Parallelism and should have a lower value than right side of prep-pre double bearish trend Hybrid Parallelism, which may serve as a confirmation of an upcoming bearish trend and further may serve as a forecasting tool for bearish scalp-swing setups.

FIG. 14 illustrates one embodiment of Hybrid Parallelism, referred to as Hybrid Parallelism for Bullish Believers 7046. Such configuration is possible if the Blue Line 2381 is below the gray line and should be in the lower zones such as in zones 1015d, 1015e, or 1015f, and if all zone lines are stabilized. A trader or user skilled in the art should understand that it is most likely that prices may reach those levels over or around the Scheduled Event of Blue Line if there is no unscheduled events of zone line 1040.

Though not illustrated, one embodiment of Hybrid Parallelism, may be referred to as Hybrid Parallelism for Bearish Believers. Such configuration is possible if the Blue Line 2381 is above the gray line and should be in the upper zones such as 1015a (FIG. 14), 1015b (FIG. 14), or 1015c (FIG. 14), and if all zone lines are stabilized. A trader or user skilled in the art should understand that it is most likely that prices may reach those levels over or around the Scheduled Event of Blue Line if there is no unscheduled events of zone line 1040. A trader or user may be alerted by all important events as illustrated by a yellow triangle or any trader or user desired colors or shapes. All important events selected by a trader or user can have alerts may be sent via electronic mail, PDA's, or by audio/visual alert on chart during trading. A variety of embodiments of Hybrid Parallelism may exist within this disclosure.

Upon reading the teachings of this specification, those skilled in the art will now appreciate that, under appropriate circumstances, the various types and examples of Hybrid Parallelism, may suffice.

### Risk Transition Due to Scheduled and Unscheduled Events

A trader or user skilled in the art most likely understands that within the history of trading, there may have been a desire to determine where the actual risk is being transferred from Bullish Believers to Bearish Believers or vice versa or as to finding a point of continuation of the same risk with pinpoint accuracy, using the scheduled events of Blue Line and unscheduled events of zone lines.

Though not illustrated, one embodiment of risk transition due to scheduled and unscheduled events, can be referred to as scheduled events of Blue Line. The calculation for the Blue Line have been based on the use of pre-selected time frames. It is as such that the Mid-Pivot line occurs on a scheduled time basis. For example purposes, if a trader or user were to take the 60 minute FXTA Pivot, the mid-pivot line would occur every 60 minutes and the use of a Daily FXTA Pivot would cause occurrence every 24 hours (or any user desired pivot type). A trader or user skilled in the art could therefore understand that the crossing of Blue Line 2381 with zone line 1040 or other zone lines, should occur on a scheduled time and are thereupon called scheduled events of Blue Line. A trader or user may understand that scheduled events of Blue Line can also occur without the crossing of the Blue Line with zone lines. The Blue Line should either go vertically up, referred to as Blue Line angle-north 2381-an, or vertically down, referred to as Blue Line angle-south 2381-as, both of which occur at some angle. A trader or user skilled in the art should understand that Blue Line angle-north 2381-an or Blue Line angle-south 2381-as may intersect either number of zone lines, 1020, 1030, 1040, 1050, 1060, or may confluence with such zone lines at any scheduled events of Blue Line. A trader or user may utilize traditional mid pivots or other custom pivots instead of the Blue Line, of a user desired time frame. Such configurations may allow to help possibly create, but not limiting scope to, hybrid confluence, Hybrid Parallelism, Halved Hybrid Nozzlelism, scheduled upper hybrid zone risk transfer area open ended, or scheduled upper close ended hybrid zone risk transfer area.

FIG. 10 provides an illustrative display of one embodiment of risk transition due to scheduled and unscheduled events, referred to as scheduled intersection of Blue Line 6715. A trader or user skilled in the art should understand that a scheduled intersection may occur when the there is a possible crossing of Blue Line 2381 to zone line 1040 as per the scheduled events of Blue Line. Such intersection may also occur with the other zone lines 1006. Such intersection may also occur due to the vertical shifting of Blue Line 2381 on a scheduled time and then possibly crossing either zone line 1040 or the other zone lines 1006. Such configuration may occur on a pre-scheduled basis during trading, before or after or at the same time during the unscheduled events of zone line. Within this illustrative display, Blue Line 2381 is illustrated as Blue Line angle south 2381-as.

Though not illustrated, one embodiment of risk transition due to scheduled and unscheduled events can be referred to as unscheduled events of zone lines. A trader or user skilled in the art should understand that zone lines 1006 are adaptive, dynamic, flexible, can incorporate changes within the market over a selected period of time and has no scheduled time for its occurrence. It should be further understood that zone line 1040, along with other zones, may shift up or down at any time within any market vehicle under review for a particular time frame.

FIGS. 10 and 12 provide illustrative displays of one embodiment of risk transition due to scheduled and unscheduled events, referred to as unscheduled intersection of zone line 6755. Such configuration may occur when there is a crossing of zone line 1040 to Blue Line 2381, as per the unscheduled events of zone lines. A trader or user skilled in the art should understand that such intersection can also happen for the other zone lines 1006 and that this may occur at any time during trading, before or after or at the same time during the scheduled events of Blue Line 6715. A trader or user skilled in the art should further understand that such intersection may occur due to the vertical shifting of zone line 1040 and then the crossing to Blue Line 2381.

Though not illustrated, one embodiment of risk transition due to scheduled and unscheduled events, referred to as risk transition time area for scheduled intersection of Blue Line 6720. Such configuration can be a risk transition formation area over a period of time, usually from 1 to 3 time frames, where the Blue Line 2381 may cross zone line 1040 or the other zone lines 1006.

FIG. 11 illustrates one embodiment of risk transition due to scheduled and unscheduled events, referred to as risk transition time area for scheduled intersection of Blue Line after Hybrid Parallelism 6770. Such configuration may be the area, where the Blue Line angle south 2381-as possibly crosses zone line 1040, on a scheduled time basis (within this illustration, every hour within 1 to 3 time frames), and as such where risk may be transferred from Bearish Believers to Bullish Believers and due to the possible exhaustion of the Bearish Believers or due to the possible empowerment of Bullish Believers. Within this illustration, a trader or user may observe that market vehicle prices may move upward around this area. A trader or user skilled in the art should look for factors such as, but not limiting in scope to, turquoise bullish candle, turquoise bullish candle + 1415, turquoise bullish candle ++, catalyst turquoise bullish candle, dynamic price risk types a or b before risk transition time area for scheduled intersection of Blue Line after Hybrid Parallelism 6770, modified bullish time segment 1131, earlier highs +3.1, or earlier highs +3.2. A trader or user should be aware of Risk transition line [scheduled and unscheduled] as a possible confirmation within the modified health indicator window 1216.

FIG. 12 represents one embodiment of risk transition due to scheduled and unscheduled events, may be referred to as risk transition time area for scheduled intersection of Blue Line and Hybrid Parallelism 6721. Such configuration may be a risk transition area, which may be over a time duration of about 1 to 3 time frames, that can be formed between pre-bullish Hybrid Parallelism 7040 and post-bullish Hybrid Parallelism 7041. A trader or user skilled in the art should understand that such area may occur only in the scheduled events of Blue Line 6715 and its intersection with zone line 1040.

FIG. 9 illustrates one embodiment of risk transition due to scheduled and unscheduled events, referred to as risk transition time area for unscheduled intersection of the 1040 zone line 1040 6765, which should occur after lower left Halved Hybrid Nozzle Tipping 6450. Such configuration may be the area where the zone line 1040 possibly crosses the Blue Line 2381, over an approximate time frame of 1 to 3, of which the risk may be transferred from Bullish Believers to Bearish Believers and due to possible exhaustion of the existing Bullish Believers or due to the possible empowerment of the Bearish Believers. A trader or user skilled in the art should be aware of factor such as, but not limiting scope to, tan bearish candle, tan bearish candle, tan bearish candle ++, tan bearish entry—type c (M1), tan bearish entry—type d(M) −oex, indigo bear warning candle (M), pink (C) bearish candle (M), Top Bear—small or big (Mn−), super belief bull pinpoint en+7* (Mc), or super bullish belief contra +re1 (Mc). A variety of embodiments of risk transition due to scheduled and unscheduled events may occur.

### Risk Transition Lines

Within this disclosure, “risk transition lines” may be understood as a possible indication of a possible change within the current trend of a market vehicle or that there can be a continuation of the market vehicle trend. Risk transition lines may be further described as the creation of a vertical line within the modified trend health window, every time there is a possible scheduled intersection of the Blue Line or an unscheduled intersection of the mid zone line within the Candlestick Spectrum window. A trader or user skilled in the art should understand that there can be at least twelve categories of risk transition lines that may exist in trading and they may occur due to the shifting of zone lines 1006, due to the possible scheduled events of Blue Line and the possibility of unscheduled events of zone lines. A trader or user skilled in the art may use the location relation between zone line 1040 and Blue Line 2381 to possible create forecasts of the direction in conjunction with the use of health risk directional indicator-bearish and the health risk directional indicator-bullish. Typically, risk transition lines may occur after the formation of the directional line-bear, which can serve as an indication within approximately five to seven time frames, that the bearish trend may change to either first consolidation and then possibly a bullish trend. Typically, risk transition lines may also occur after the formation of the directional line-bull, which can serve as an indication within approximately five to seven time frames, that the bullish trend may change to either first consolidation and then possibly a bearish trend. Risk transition lines may be located within the modified trend health window, which can be shown with a light purple color (r: 128 g: 128, b: 255), which a trader or user may further use the User's Manual for such risk transition lines for bullish and Bearish Believers.

Though not illustrated, one embodiment of risk transition lines, can be referred to as scheduled risk transition line, as such may be created in the Trend Health Risk or modified trend health window or within the spectrum of colored candlesticks, possibly with the occurrence of scheduled intersection of Blue Line. Though not illustrated, one embodiment of risk transition lines, may be referred to as unscheduled risk transition line, as such may be created in Trend Health Risk or modified trend health window or within the spectrum of colored candlesticks, possibly with the occurrence of unscheduled intersection of zone lines.

Though not illustrated, one embodiment of risk transition lines may be referred to as scheduled risk transition spike/line bull continue, which can serve as an indication of a bullish to more bullish trend. A trader or user skilled in the art should understand that such Spikes may occur when zone line 1040 on a scheduled time remains horizontal and Blue Line possibly decreases its value, and may have its level fall underneath zone line 1040, and a Hybrid Parallelism possibly created. A trader or user skilled in the art should be aware that the scheduled intersection of Blue Line should be created in order for the continuation of the previous bullish trend. Such a spike may help continue on the previous bullish direction. The previous bullish risk may have been transformed into more bullish risk. It should be further aware to a trader or user skilled in the art that a pullback at zone line may allow for the reduction of risk and may provide a low risk opportunity to Bullish Believers. Scheduled risk transition spike/line bull continue may be used for scalp-swing.

Though not illustrated, one embodiment of risk transition lines may be referred to as scheduled risk transition spike/line bear continue, which can serve as an indication of a bearish to a more bearish trend. A trader or user skilled in the art should understand that such Spikes may occur when zone line on a scheduled time remains horizontal and Blue Line possibly increases its value, and may have its level rise above zone line 1040, and a Hybrid Parallelism possibly created. A trader or user skilled in the art should be aware that the scheduled intersection of Blue Line should be created in order for the continuation of the previous bearish trend. Such a spike may help continue on the previous bearish direction. The previous bearish risk may have been transformed into a more bearish risk. It should be further aware to a trader or user skilled in the art that a pullback at Blue Line may allow for the reduction of risk and may provide a low risk opportunity to Bearish Believers. Scheduled risk transition spike/line bear continue may be used for scalp-swing.

FIG. 12 illustrates one embodiment of risk transition lines, referred to as scheduled risk transition spike/line prep to pre bull 6817, which can serve as an indication of a slightly bullish trend to a more bullish trend. Such configuration can occur when prep-bullish trend Hybrid Parallelism 7040 and pre-bullish trend Hybrid Parallelism 7041 are possibly created side by side at the possible scheduled intersection of Blue Line angle-north 2381-an, of which a risk transition should take place and can be shown by a vertical line/spike. Within this configuration, a trader or user skilled in the art should understand that the previous Bearish Believers risk most likely transformed into Bullish Believers risk.

Though not illustrated, one embodiment of risk transition lines, can be referred to as scheduled risk transition spike/line prep to pre bear, which can serve as an indication of a slightly bearish trend to a more bearish trend. Such configuration can occur when prep-bearish trend Hybrid Parallelism and pre-bearish trend Hybrid Parallelism are possibly created side by side at the possible scheduled intersection of Blue Line angle-south, of which a risk transition should take place and can be shown by a vertical line/spike. A trader or user may understand that Prep Bull or Transition time can be that in which, within the dynamic movement of zone lines, the time differential between the start point of shifting of at least zone line, preferably of the uppermost zone line to the downside, which may be referred to as the Squeezing of Zone Lines, and at the same time with the scheduled intersection of the Blue Line with the Blue Line angle north, so long as there is no possible shifting of the lower most zone line.

FIG. 12 represents one embodiment of the multidimensional risk analysis systems 100, which provide an illustrative display of Prep Bull or Transition Time 8110, which took place between points “A” and “B”. At such time, it may be observed that Bullish Believers were possibly prepared to hold their current position or possibly adding additional positions whereas the Bearish Believers may either close their current positions or follow what the Bullish Believers possibly do. It may be further observed that symbols such as, but not limiting scope to, “Sb”, yellow bar/candle, Pd++, neutral bar/candle, and transitional bull are possible signs of Transition Time. A trader or user may understand that Pre Bull or Transition Time 8115 can be that in which, within the dynamic movement of zone lines 1006, the time differential between the time at which the possible scheduled intersection of Blue Line 6917 with Blue Line angle north 2381-an and at least the first or second starting point for the shifting of at least one zone line to the upside, preferably the upper most zone line 1010 to the upside, which may be referred to as the Expansion of Zone Lines 6921, and so long as there is no possible shifting of the lower most zone line 1070. FIG. 12 provides an illustrative display of Pre Bull or Transition Time 8115, which took place between points “B” and “C”. At such time, it may be observed that the Bullish Believers were possibly prepared to hold their current position or possibly add additional positions whereas the Bearish Believers may either close their current positions or follow what the Bullish Believers possibly do. It may be further observed that symbols such as, but not limiting scope to, MSB, Pd++, yellow bar/candle, turquoise bar/candle, and bullish setups such as BL Mn+, are possible signs of Transition Time.

Though not illustrated, it may be understood by a trader or user that Prep Bear or Transition Time and Pre Bear Transition Time may be understood as the opposite of Prep Bull or Transition Time and Pre Bull Transition Time, respectively. A trader or user may be alerted by all important events as illustrated by a yellow triangle or any trader or user desired colors or shapes. All important events selected by a trader or user can have alerts may be sent via electronic mail, PDA's, or by audio/visual alert on chart during trading.

Within this configuration, a trader or user skilled in the art should understand that the previous Bullish Believers risk most likely transformed into Bearish Believers risk. Those skilled in the art will now appreciate that there are a variety of alternative aspects of risk transitions lines.

### Hybrid Zone Risk Transfer Areas

A trader or user skilled in the art should understand that such area may be the area in which there can be an exchange between Bullish Believers and Bearish Believers, of which can either be a one end open area (either on the left or right on the upper or bottom side) or can be closed on both sides of the Blue Line. Those skilled in the art will appreciate alternate hybrid zone risk transfer area configurations.

### Types of Hybrid Zone Risk Transfer Areas

FIG. 9 provides an illustrative display of one embodiment of the types of hybrid zone risk transfer areas, referred to as hybrid zone scheduled risk transfer areas. Such configuration may occur after the scheduled events of Blue Line 2381 and the possibly the formation of risk transition time area for scheduled intersection of Blue Line 6720, the distance between zone line 1040 and Blue Line 2381 may increase substantially, which can be supported by the intersection of the Blue Line (upper or lower) to at least one of the zone lines 1010, 1020, 1030, 1040, 1050, 1060 or 1070, and of which there may be an area forming until the zone lines 1006 shift again. Such configuration may be on the left or right side of Blue Line angle-north 2381-an or Blue Line angle south. A trader or user skilled in the art should be made aware that if the Blue Line is above zone line 1040, it may be referred to as an upper area while the Blue Line 2381 being below zone line 1040 can be referred to as a lower area. After the possible formation of risk transition time area for scheduled intersection of Blue Line 6720, the value of a market vehicle might remain within this area until the zone lines have shifted once again. A trader or user skilled in the art should be further aware that there may be conflict between the Bullish Believers and Bearish Believers within this area, which may be evidenced by the generation of possible mixed signals such as, but not limiting scope to, bearish risk recognition factors and bullish risk recognition factors. It may be observed that if prices remain below zone line 1040, it is most likely possible that the trend may move to the downside. It may also be observed that if prices remain above Blue Line 2381, it is most likely possible that there would be a resumption of the bullish trend. A trader or user may define the possible of leaving of market vehicle prices from the risk transfer area may be referred to as falling out of the risk transfer area.

FIG. 9 illustrates one embodiment of the hybrid zone scheduled risk transfer areas, which may be referred to as scheduled upper right hybrid zone one open ended (r) transfer area 6881, which may serve as an indication of a bearish trend. Such configuration may on the upper and right side of the Blue Line angle-north 2381-an. The possible formation of upper right post Halved Hybrid Nozzlelism confluence 6565, the prices of a market vehicle may lose its value; prices may bounce between Blue Line 2381 and zone line 1040 within this area. A trader or user skilled in the art should be aware that the formation of scheduled intersection of Blue Line 6715 and Blue Line angle-north on the left side is mandatory and that the open end at the completion of this area may allow for future trend on either side. The resumption of an uptrend in the near future, after leaving this area, may occur with the appearance of factors such as, but not limiting scope to, earlier lows −4.6(Mc)++ 2156, earlier lows −4.6(Mc)+, earlier lows −4.6(Mc), super bearish belief contra −re-2, yellow extended bull warning line 1680 and/or other bullish risk recognition factors.

FIG. 15 shows one embodiment of a display, showing an illustrative screenshot view showing several screenshot sections, displaying a colored Candlestick Spectrum chart showing an open-ended hybrid zone risk transfer area along with health risk indicator 1216, as may be included within certain embodiments of the multidimensional risk analysis systems 100 of FIGS. 1 and 2. It also illustrates one embodiment of the various types of hybrid zone scheduled risk transfer areas, which may be referred to as scheduled lower hybrid zone risk transfer area-open ended 6883. With respect to FIG. 15, a continuous sell off in the market led to zone levels 1006, with the exception of upper zone level 1010, to shift to the lower side and for Blue Line 2381 to also lower itself over a period of time. It can be observed that such zone lines once again become stabilized and the lowest zone line 1070 has also become stable, which has allowed for the possibility of Bearish Believers to close their positions and for some Bullish Believers to possibly commence participation into the market, which may be evidenced by certain factors, but not limiting in scope to, Dynamic Sectional Price Risk type a, earlier highs +3.1, earlier highs +3.2 1470-a2, etc. The occurrence of possible Scheduled Event of Blue Line, the possible intersection of Blue Line or the possible intersection of zone line 1010 may not take place. A trader or user skilled in the art may understand that this can form an open end for previously formed Hybrid Parallelism. It may be further observed that Blue Line 2381 may form Blue Line angle-south 2381-as; zone line 1040 and Blue Line 2381 may form Hybrid Parallelism, which can be separated by at least one zone line 1060 or 1050, until the possible occurrence of another Scheduled Event of Blue Line or Unscheduled Event of Zone Line. A trader or user skilled in the art should understand that if Unscheduled Event of Zone Line does not occur until and possibly including consecutive Scheduled Event of Blue Line, it is most likely possible that there is an open area between zone line 1040 and Blue Line 2381 may convert into either hybrid confluence or Hybrid Parallelism. It may be further understood that if market vehicle prices can manage to remain between zone line 1040 and Blue Line 2381, after the possible first Scheduled Event of Blue Line 6710 and can manage to remain above 1040, it is most likely possible that a new bullish trend may develop. However, it should be considered that at the second Scheduled Event of Blue Line, if there happens to be no intersection of Blue Line, it may end for the time being as either hybrid confluence or Hybrid Parallelism. A trader or user skilled in the art may want to implement a trading strategy, possibly trading from Blue Line 2381 to zone line 1040. If prices fail to progress to the zone lines higher than 1040, it is most likely possible that the risk may be transferred back to the bears within the risk transfer area, possibly causing a wick formation to occur within the candle, possibly due to the Scheduled Event of Blue Line. A trader or user skilled in the art would further understand that zone line 1040 may work as a line in the sand or as the territory between the Bullish Believers and Bearish Believers, and the possible falling out of Blue Line 2381, may allow control in the Bearish Believers' hands.

FIG. 15 represents one embodiment of the multidimensional risk analysis systems 100. A trader or user skilled in the art can apply scalp-swing for open ended transfer area. As illustrated within FIG. 15, a possible Scheduled Event of Blue Line, at the end of upper left post Halved Hybrid Nozzlelism confluence 6555 and it its possibly open ended, can possibly cause left post Halved Hybrid Nozzlelism confluence 6555 to turn into a scheduled lower hybrid zone risk transfer open end 6883. This may serve as a possible entry point for scalping at Blue Line angle-south 2381-as, so long as it is possible that prices remain above Blue Line 2381. A trader or user skilled in the art may set a potential for at least zone line 1040 and this may turn into scalp-swing trading, should prices stay above zone line 1040 and possibly move to upper zone levels. A trader or user may design an alert possibly for when the right open end of scheduled lower hybrid zone risk transfer area-open ended 6883 along with upper left post Halved Hybrid Nozzlelism confluence 6555 and on scheduled time, and possibly checking the scheduled lower hybrid zone risk transfer area-open ended 6883 may provide a trading opportunity, if there are setups in place such as, but not limiting in scope to, black neutral candle (Mn+) 2146. A trader or user may use Halved Hybrid Nozzlelism Shifting End Spike/Vertical Line (Bear To Bull) 6915 and either, but not limiting in scope to, bull entry spike 1875 or health directional line-bullish (directional bull) 2055 as a possible entry; may use, but not limiting in scope to, bullish dk yellow candle—type a+ 2230 or yellow bull warning candle (bull belief warning) 1430 as a possible entry during the process of upper left post Halved Hybrid Nozzlelism confluence 6555 as a possible scalp-swing trader and may exit at, but not limiting scope to, pink ext bear warning line 1675 or bear entry spike 1880.

FIG. 16 shows one embodiment of a display, showing an illustrative screenshot view displaying a colored Candlestick Spectrum chart showing a Bullish Believers Trend Development and Recognition with Hybrid Zone Lines, as may be included within certain embodiments of the multidimensional risk analysis systems 100 of FIGS. 1 and 2. It illustrates a Bullish Believers Trend Development and Recognition with Hybrid Zone Lines. After the possible occurrence of scheduled lower hybrid zone risk transfer area-open ended 6883, a scheduled intersection of Blue Line 6715 to the upside of zone line 1040 may occur, preferably in zone area 1015c, if there are a number of occurrences of scheduled events of Blue Line 6710, without any possible unscheduled intersection of zone line 6755, a Bullish Believers trend development may take place so long as there are a series of Blue Line angle north 2381-an forming and this may start slowing down once the Scheduled Event of Blue Line 2381-as starts occurring. A trader or user skilled in the art should understand that at the first formation of unscheduled intersection of zone line 1040, the trend may possibly reverse. Shifting of the upper zone line 1010 at shifting point 6917 and the formation of upper right Halved Hybrid Nozzlelism 6035 shape, may indicate further expansion of the bullish trend. Typically, the shifting of all zone lines over a period of time to the upside, with the exception of 1010, may provide an indication of a possible upcoming weakness within the trend. Within trend development, it is typical for the Blue Line 2381 to be higher than zone line 1040. It should be further understood that market vehicle prices should stay above zone line 1040 for a general bullish direction.

FIG. 16 also illustrates one embodiment of at least one type of hybrid zone scheduled risk transfer areas, which may be referred to as scheduled upper hybrid zone risk transfer area-open ended 6884. A trader or user skilled in the art may observe that such configuration may be similar to scheduled lower hybrid zone risk transfer area-open ended 6883, however in this configuration, the possible Scheduled Event of Blue Line 6710 may take place within the upper zones 1015a, 1015b, or 1015c. As illustrated within FIG. 16, the scheduled upper hybrid zone risk transfer area-open ended 6884 occurs between points “A”, “B”, “C” and “D”. Typically, market vehicle prices from zones 1015a or 1015b may come down to zone line 1040 and possibly create either profit taking opportunities or scalp-swing opportunities 2112, as illustrated in FIG. 16 with Indigo Bear Warning Candle (M) 2135, for the Bearish Believers and may use targets of zone lines 1020, 1030, or 1040 with possible stops at either the Blue Line 2381 or zone line 1050. Due to the recognition of scheduled upper hybrid zone risk transfer area-open ended 6884, a trader or user may benefit by closing bearish positions and may possibly take positions in a bullish direction, recognizing bullish indicators above Blue Line 2381 in the transfer area. An alert may be setup for this configuration.

Though not illustrated, a trader or user skilled in the art should understand Bearish Believers Trend Development and Recognition with Hybrid Zone Lines. After the possible scheduled intersection of Blue Line, to the downside of the mid zone line, preferably in zone area 1015d, if there are a number of occurrences of scheduled events of Blue Line, without any possible unscheduled intersection of zone line, a bearish trend development may take place so long as there are a series of Blue Line angle south forming and this may start slowing down once the Scheduled Event of Blue Line angle south starts occurring. A trader or user skilled in the art should understand that the first formation of unscheduled intersection of the mid zone line, the trend may possibly reverse. Shifting of the lower zone line at shifting point and the formation of Halved Hybrid Nozzlelism shape, may indicate further expansion of the bearish trend. Typically, the shifting of all zone lines over a period of time to the downside, with the exception of 1070, may provide an indication of a possible upcoming weakness in the trend. Within trend development, it is typical for the Blue Line to be lower than the mid zone line. It should be further understood that market vehicle prices should stay below the mid zone line for a general bearish direction.

FIG. 14 illustrates one embodiment of the various types of hybrid zone scheduled risk transfer areas, which can be referred to as scheduled upper close ended hybrid zone risk transfer area 6885, which may serve as an indication from a bullish to bearish trend. A trader or user skilled in the art should understand that such configuration has a pre-requisite for the Bullish Believers' risk to Bearish Believers' risk, which as such, the Blue Line 2381 should be greater in value than zone line 1040, of which both lines should be parallel to one another within this entire area, covered by two scheduled intersections of Blue Line 6715, one left for Blue Line angle north 2381-an and one right for Blue Line angle south 2381-as. A trader or user skilled in the art should be aware that the location of Blue Line 2381 should be in zones 1015a or 1015b. It should be further understood that after the unscheduled intersection of zone line 6755 and the possible formation of unscheduled risk transition line 6830 and scheduled intersection of Blue Line 6715, Bullish Believers may lose the appetite for more demand and the devaluation of prices may be possible and may create a scalp-swing bearish trading opportunity. A trader or user skilled in the art may want to observe for some scalp-swing setups or may want to use, but not limiting scope to, MSBE types of super bearish belief entries, if setups are not available.

FIG. 14 illustrates one embodiment of the various types of hybrid zone scheduled risk transfer areas, referred to as scheduled lower close ended hybrid zone risk transfer area 6886, which may serve as an indication from a bearish to bullish trend. A trader or user skilled in the art should understand that such configuration has a pre-requisite for the Bearish Believers' risk to Bullish Believers' risk, which as such, the Blue Line 2381 should be lesser in value than zone line 1040, of which both lines should be parallel to one another in this entire area, covered by two intersections of Blue Line 6715, one left for Blue Line angle south 2381-as and one right for Blue Line angle north 2381-an. A trader or user skilled in the art should be aware that the location of Blue Line 2381 should be in zones 1015e or 1015f. It should be further understood that after the scheduled intersection of Blue Line 6715 and the possible formation of scheduled risk transition spike/line bull continue 6815, Bearish Believers may lose the appetite for more demand and the prices may increase and may create a scalp-swing bullish trading opportunity. A trader or user skilled in the art may want to observe from some scalp-swing setups or may want to use, but not limiting scope to, MSB types of super bullish belief entries, if setups are not available. A trader or user may further use multi dimensional bull (multi dimensional bull entry) 1480 or earlier lows −4.6(Mc)++. Multidimensional Bull entry 1480 may be considered a Bullish Believers' entry and has an alert, as illustrated, and may be further be considered as a bull entry special market condition. A trader or user may be alerted by all important events as illustrated by a yellow triangle or any trader or user desired colors or shapes. All important events selected by a trader or user can have alerts may be sent via electronic mail, PDA's, or by audio/visual alert on chart during trading. There can be a variety of embodiments of hybrid zone risk transfer areas.

### Scalp Swing Trading

Within this disclosure, the term “scalp-swing trading” may be utilized to describe unique combination of the swing trading with scalp trading, designed especially to produce more efficient, more accurate, unique risk distributed, less riskier, pinpointed, precise targets, better timed, click and go methods and quick result oriented trading methods compared to both traditional individual scalping and swing trading methods. As such, scalp-swing trading can illustrate a general shape or pattern of a variety of indicator combinations, which may be utilized to help an ordinary skilled user or trader without extensive training to understand important events occurring within financial markets such as market trend changes, breakouts, retracements, new highs, new lows, directional forecastings, reversals, pullbacks, and many other such trading clues.

A trader or user skilled in the art should understand that traditional scalping is a trading style in which a trader or user may look to collect possible profits on their positions within very small price changes within the Market Vehicles or securities. Typically, such exit may occur after a trader has been entered into and appears profitable. A trader may place anywhere between 10 to a couple hundred trades within a single day, with the belief that being able to capture small moves within a market vehicle is easier than capturing larger moves. The apparent main goal of a trader might be to get into and out of a trade with a possible small amount of profit within a short period of time, and with the apparent belief that small profits can easily compound into larger gains if a strict exit strategy is followed in order to prevent large losses. A trader or user who implements such a strategy may be referred to as a scalper.

A trader or user skilled in the art should understand that traditional swing trading is a trading style in which a trader or user attempts to capture gains within a market vehicle by holding such market vehicle for a period of a day to four days. It should be further understood that swing is the fluctuation of the value of the market vehicle or any particular asset, liability or account over a short period of time, therefore referred to as short term trading. Such a particular trading style may be used by at-home and day traders. Such traders may use technical analysis to perform swing trading. As such, these trader may have no concern as to the fundamentals but rather may focus on price trends and patterns for their trading and most likely engage into short term trading strategies. A trader or user skilled in the art should understand that swing trading may be subject to large draw downs. The risks involved within swing trading are much higher than scalping, but lower than long-term trading. Such traders may forecast the changes in the prices of a market vehicle or security based upon the oscillations between its prices being bid up by optimism and alternately being bid down by pessimism over a period of one to four days.

Scalp-Swing trading uses proprietary tools such as, but not limiting scope to, earlier highs, earlier lows, with assigned risk recognition numbers, super belief bull, super belief bear entries, super belief bull pin point entries and/or super belief bear pin point entries with assigned risk recognition numbers, etc. A trader or user skilled in the art may understand that Dynamic Zone Lines possibly can assist with possibly entries and exits with scalp-swing setups.

Certain embodiments of the multidimensional risk analysis systems 100, as described with respect to FIGS. 1 and 2, may be configured to perform the above and thereupon, user interface 125 (FIG. 2) may be able to project such a display of scalp-swing trading. A trader or user may be alerted by all important events as illustrated by a yellow triangle or any trader or user desired colors or shapes. All important events selected by a trader or user can have alerts may be sent via electronic mail, PDA's, or by audio/visual alert on chart during trading. There may be a variety of embodiments of scalp-swing trading as compared to traditional swing and scalp trading.

### Advantages of Scalp-Swing

A trader or user skilled in the art should understand that scalp-swing trading has advantages over both traditional scalp trading and traditional swing trading. Scalp-swing trading may allow for more accuracy of entries and exits, with the possibility of lesser draw downs. It may be further observed that scalp-swing trading allows for the significant reduction of trading risk, as during every time period or ticker, a trader or user may be informed about the various risks that are associated within the market as well as the health of the security or market vehicle.

In certain instances, entries and exits may typically be two to five time frames earlier than traditional methods due to the possibility of pin pointing risks as well as entries and exits. Thereupon, this may allow for the reduction of errors made in entries and exits and may reduce the risks involved in trading, which therefore may provide help to a trader or user with their capital preservation. The possibility of reducing a trader or user's losses, that might have occurred using traditional swing and scalp methods, may allow a trader or user more flexibility in using their capital efficiently. The possibility of obtaining pre-determined targets from dynamic-adaptive zone lines of any market vehicle within any user selected time frame and the ability to get such targets well in advanced and have them self-adjust according to the dynamic changes within the market, may reduce or eliminate the labor involved in finding such adaptive-dynamic real time accurate real investment grade bullish or bearish beliefs supports and resistances, of which are institutional grade rather than those used within traditional methods. As such may in turn help a trader or user to set more realistic and achievable goals and may still adapt the dynamic changes after possible entries and exits. It may be observed that scalp-swing trading can allow for less time spent in trading, when trying to achieve the same results as on traditional swing and traditional scalp trading, with the use of horizontal time duration risk.

A trader or user skilled in the art may use various forecasting tools with risk designations such as, but not limiting scope to, earlier highs, earlier lows, with assigned risk recognition numbers, super belief bull, super belief bear entries, super belief bull pin point entries and/or super belief bear pin point entries with assigned risk recognition numbers, to possibly produce more accurate and better trading results within a shorter amount of time in comparison to traditional scalp or traditional swing methods.

Traditional swing trading time frame may be proven wrong with the use of scalp-swing trading. Scalp-swing trading can allow the trader, user or investor less market exposure and quicker results, due to the possibility of reducing the amount of time involved in trading to produce similar results as traditional swing and traditional scalp trading. For example purposes, when applying scalp-swing to Forex markets, it may help the trader or user experience a possible reduction in the overnight interest charges as the amount of time spent in a particular trade is less.

Upon reading the teachings of this specification, those skilled in the art will now appreciate that, under appropriate circumstances, the advantages of scalp-swing in comparison to traditional swing and traditional scalp trading along with the possible reduction in risk and time involved, may suffice.

### Major Components of Scalp-Swing Method

FIG. 21 shows one embodiment of a display, showing an illustrative multi-colored legend view displaying scalp-swing components, as may be included within certain embodiments of the multidimensional risk analysis systems 100 of FIGS. 1 and 2. FIG. 21 represents certain embodiments of the major components of scalp-swing method, which may include earlier highs 8001 and earlier lows 8002. A trader or user skilled in the art may forecast earlier highs with risk assessments 8011 and forecast earlier lows with risk assessments 8012. It may be understood that this may be a forecasting of either the bullish or bearish direction of a security with possible lower risk. A trader or user may categorize according to their choice, such risk assessment numbers, in forecasting earlier highs with +1 to +6 and earlier lows with −1 to −6. Earlier highs and earlier lows may self-adjust to the possible variations unusual of internal risk and may serve as a forecasting tool.

A trader or user skilled in the art may use the components modified health risk indicator 1216 (FIG. 5) individually or in combination of a few in order to possibly develop earlier possible highs 8001 and earlier possible lows 8002. In order for a trader or user to possibly develop an algorithm for earlier possible highs 8001, such trader or user may use the following indicators, which have been provided for example purposes and are not limiting in scope: health risk directional indicator—bullish 2015 (FIG. 5), health risk directional indicator—bearish 2020 (FIG. 5), and Boundary Lines 1220, 1230, 1240, 1250 (FIG. 5). Thereupon, with such listed indicators for example purposes, a trader or user may use the relation of health risk directional indicator—bullish 2015 in comparison to health risk directional indicator—bearish 2020, the relation of health risk directional indicator—bullish 2015 with its previous values and relation of health risk directional indicator—bearish 2020 with its previous values. A trader or use may also use the relation of health risk directional indicator—bullish 2015 and health risk directional indicator—bearish 2020 in comparison to Boundary Lines 1220, upper most Boundary Lines 1230, lower most Boundary Lines 1240, and core Boundary Lines 1250, or any other user defined values can be used in order to further categorize the possible assigned risk recognition numbers, including but not limiting the scope of, +1 to +6, −1 to −6, or other risk designators as per the trader or user's choice.

Within the multidimensional risk analysis systems 100, FIG. 21 includes earlier highs categories, may be classified with 8011. Certain embodiments of earlier highs 8011 can be categorized in the following manner, or may be classified according to a trader or user's choice: earlier highs +3.1 1470-a1 (FIGS. 9 and 13); earlier highs +3.2 1470-a2 (FIGS. 11, 13, and 14); earlier highs +3.3 1470-a3 (FIGS. 10, 11, and 13); earlier highs +3.4 1470-a4 (FIG. 11); earlier highs +3.5; and, earlier highs +3.6. Earlier highs may be used as a forecasting tool.

Within the multidimensional risk analysis systems 100, FIG. 21 includes earlier lows categories, may be classified with 8012. Certain embodiments of earlier lows categories 8012 can be categorized in the following manner, or may be classified according to a trader or user's choice: earlier lows −3.1; earlier lows −3.2 1475-b2 (FIG. 14); earlier lows −3.3 1475-b3 (FIGS. 9, 12, and 13); earlier lows −3.4 1475-b4 (FIGS. 13 and 14); earlier lows −3.5 1475-b5 (FIGS. 9, 11, 13, and 14); and, earlier lows −3.6 1475-b6 (FIG. 13). Earlier lows may be used as a forecasting tool.

Within the multidimensional risk analysis systems 100, FIG. 21 includes certain embodiments of the major components of scalp-swing method, may include magic super belief bull pin point entries 8007 and magic super belief bear pin point entries 8008. A trader or user skilled in the art may understand that magic super belief bull pin point entries 8007 and magic super belief bear pin point entries 8008 may be referred to as the readiness a trader or user may receive with pin point entries. It may be classified into seven categories of risk recognition number for either the Bullish Believers +1 to +7 or Bearish Believers −1 to −7. Within the multidimensional risk analysis systems 100, pin point bullish moves have been designated with 8007 and pin point bearish moves have been designated with 8008 and as such may be used as a forecasting tool.

Within the multidimensional risk analysis systems 100, FIG. 21 includes super belief bull pin point entries categories with risk assessment, may be classified with 8015. Certain embodiments of super belief bull pin point entries categories with risk assessment can be categorized in the following manner, or may be classified according to a trader or user's choice: super belief bull pin point en+1*; super belief bull pin point en+2*1625-2 (FIG. 10); super belief bull pin point en+3* 1625-3 (FIG. 10); super belief bull pin point en+4*1625-4 (FIGS. 11, 12, 13 and 14); super belief bull pin point en+5*1625-5 (FIGS. 10, 13, and 14); super belief bull pin point en+6*1625-6 (FIGS. 9, 12, and 13); and, super belief bull pin point en+7*1625-7 (FIG. 14). Super belief bear pin point entries categories with risk assessment, may be classified with the following retrospect as seen in Scalp-Swing Components Legend, FIG. 21 with 8016. Certain embodiments of super belief bear pin point entries categories with risk assessment can be categorized in the following manner, or may be classified according to a trader or user's choice: super belief bear pin point en−1*; super belief bear pin point en−2*; super belief bear pin point en−3*1620-3 (FIG. 13); super belief bear pin point en−4* 1620-4 (FIGS. 13 and 14); super belief bear pin point en−5* 1620-5; super belief bear pin point en−6* 1620-6 (FIGS. 10, 11, and 13); and, super belief bear pin point en−7* 1620-7 (FIGS. 9, 10, 13 and 14). FIG. 14 illustrates a super belief bear pin point en−4* 1620-4, which can be considered a Bearish Believers' entry and has a yellow triangle alert, as illustrated; which as such may be used as a forecasting tool.

Within the multidimensional risk analysis systems 100, certain embodiments of the major components of scalp-swing method, with respect to FIG. 21, may include super belief bull entries 8003 and super belief bear entries 8004. A trader or user skilled in the art may understand that magic super belief bull entries 8003 and magic super belief bear entries 8004 may be used in the absence of risk recognition number 2045. With respect to super bullish belief entry 8003 a trader or user skilled in the art may use FIGS. 10, 11 and 13 may be used for reference purposes while with respect to super bearish belief entry 8004, a trader or user skilled in the art may use FIGS. 10, 13, and 14 may be used for reference purposes. Super belief bull entries and super belief bear entries may be used as a possible forecasting tool.

Within the multidimensional risk analysis systems 100, FIG. 21 includes certain embodiments of the major components of scalp-swing method, may include forecasting earlier highs with risk assessments for Halved Hybrid Nozzlelism 8013 and forecasting earlier lows with risk assessments for Halved Hybrid Nozzlelism 8014. A trader or user skilled in the art may understand that this may be used for the possible forecasting of either the bullish or bearish direction of a market vehicle or security with low risk with applications to the phenomenon of Halved Hybrid Nozzlelism. A trader or user may categorize according to their choice, such risk assessment numbers, in forecasting earlier highs with +1 to +6 and earlier lows with −1 to −6. Within the multidimensional risk analysis systems 100, earlier highs has been designated with 8005 and earlier lows has been designated with 8006 for Halved Hybrid Nozzlelism. Earlier highs 8005 and earlier lows 8006 for Halved Hybrid Nozzlelism may self-adjust to the possible variations unusual of internal risk and as such may be used as a forecasting tool.

Within the multidimensional risk analysis systems 100, FIG. 21 allows a trader or user skilled in the art to possibly understand that forecasting earlier highs with risk assessments for Halved Hybrid Nozzlelism 8013 may be applicable to Bullish Believers. Such configuration may occur if during the possible Halved Hybrid Nozzlelism process and during the possible shifting of the upper most zone line, a possibility of risk designators becomes available such as, but not limiting in scope, “1”, “2”, “3”, “4”, “5” or “6”, such as which may be designated into the risk designators for Halved Hybrid Nozzlelism such as, but not limiting scope to, “1NZ”, “2NZ”, “3NZ”, “4NZ”, “5NZ” or “6NZ” or other such numbers as per a trader or user's choice if he/she would like to further categorized the risk. A trader or user skilled in the art may refer to the User's Manual for the various categories of forecasting earlier high details. A trader or user skilled in the art may further understand that such configuration has the same design as forecasting earlier highs with risk assessments 8011 but is also combined with Halved Hybrid Nozzlelism 8013 and as such may be used as a forecasting tool.

Within the multidimensional risk analysis systems 100, FIG. 21 allows a trader or user skilled in the art to possibly understand that forecasting earlier lows with risk assessments for Halved Hybrid Nozzlelism 8012 may be applicable to Bearish Believers. Such configuration may occur if during the possible Halved Hybrid Nozzlelism process and during the possible shifting of the lower most zone line, a possibility of risk designators become available such as, but not limiting in scope, “1”, “2”, “3”, “4”, “5” or “6”, such as which may be designated into the risk designators for Halved Hybrid Nozzlelism such as, but not limiting scope to, “1NZ”, “2NZ”, “3NZ”, “4NZ”, “5NZ” or “6NZ” or other such numbers as per a trader or user's choice if he/she would like to further categorized the risk. A trader or user skilled in the art may refer to the User's Manual for the various categories of forecasting earlier lows details. A trader or user skilled in the art may further understand that such configuration has the same design as forecasting earlier lows with risk assessments 8012 but is also combined with Halved Hybrid Nozzlelism 8014 and as such may be used as a forecasting tool.

Within the multidimensional risk analysis systems 100, FIG. 21 includes forecasting earlier highs with risk assessments for Halved Hybrid Nozzlelism, may be classified with 8013. Certain embodiments of forecasting earlier highs with risk assessments for Halved Hybrid Nozzlelism 8013 can be categorized in the following manner, or may be classified according to a trader or user's choice: magic trader earlier highs +3.1 for Halved Hybrid Nozzlelism 1470-a1nz (FIG. 10); magic trader earlier highs +3.2 for Halved Hybrid Nozzlelism; magic trader earlier highs +3.3 for Halved Hybrid Nozzlelism 1470-a3nz (FIGS. 9 and 13); magic trader earlier highs +3.4 for Halved Hybrid Nozzlelism 1470-a4nz (FIG. 11); magic trader earlier highs +3.5 for Halved Hybrid Nozzlelism 1470-a5nz (FIG. 11); and, magic trader earlier highs +3.6 for Halved Hybrid Nozzlelism. Forecasting earlier lows with risk assessments for Halved Hybrid Nozzlelism 8012, may be classified with 8014. Certain embodiments of forecasting earlier lows with risk assessments for Halved Hybrid Nozzlelism 8012 can be categorized in the following manner, or may be classified according to a trader or user's choice: magic trader earlier lows −3.1 for Halved Hybrid Nozzlelism; magic trader earlier lows −3.2 for Halved Hybrid Nozzlelism; magic trader earlier lows −3.3 for Halved Hybrid Nozzlelism; magic trader earlier lows −3.4 for Halved Hybrid Nozzlelism; magic trader earlier lows −3.5 for Halved Hybrid Nozzlelism 1475-b5nz (FIGS. 10 and 13); and, magic trader earlier lows −3.6 for Halved Hybrid Nozzlelism and as such may be used as a forecasting tool.

Within the multidimensional risk analysis systems 100, FIG. 21 contains certain embodiments of the major components of scalp-swing method, may include super belief bull pin point entries categories with risk assessment for Halved Hybrid Nozzlelism 8017 and super belief bear pin point entries categories with risk assessments for Halved Hybrid Nozzlelism 8018. A trader or user skilled in the art may understand that, 8008 may be used for super belief bear pin point entries (“Msb”) 8007 may be used for super belief bull pin point entries. A trader or user skilled in the art may understand that super belief bull pin point entries for Halved Hybrid Nozzlelism 8017 and super belief bear pin point entries for Halved Hybrid Nozzlelism 8018 may allow a trader to obtain pin point entries for either super belief bear pin point entries (“Msbe”) 8008 or super belief bullish pin point entries 8007. A trader or user skilled in the art may understand that super belief bull pin point entries for Halved Hybrid Nozzlelism 8017 and super belief bear pin point entries for Halved Hybrid Nozzlelism 8018 may be classified into seven categories of risk recognition numbers, for either the Bullish Believers +1 to +7 or Bearish Believers −1 to −7 and may be applicable to Halved Hybrid Nozzlelism. Within the multidimensional risk analysis systems 100, pinpoint bullish move for Halved Hybrid Nozzlelism has been designated with 8009 and pinpoint bearish move for Halved Hybrid Nozzlelism has been designated with 8010. As such, this may be applicable to Halved Hybrid Nozzlelism and as such may be used as a forecasting tool.

Within the multidimensional risk analysis systems 100, FIG. 21 allows a trader or user skilled in the art to possibly understand that super belief bull pin point entries for Halved Hybrid Nozzlelism 8017 may be applicable to Bullish Believers. Such configuration may occur if during the possible Halved Hybrid Nozzlelism process and during the possible shifting of the upper most zone line a possibility of risk designators becomes available such as, but not limiting in scope, “1”, “2”, “3”, “4”, “5” “6”, or “7”, such as which may be designated into the risk designators for Halved Hybrid Nozzlelism such as, but not limiting scope to, “1NZ”, “2NZ”, “3NZ”, “4NZ”, “5NZ”, “6NZ”, or “7NZ” or other such numbers as per a trader or user's choice if he/she would like to further categorized the risk. A trader or user skilled in the art may refer to the User's Manual for the various categories of super belief bull pin point entries with risk assessment for Halved Hybrid Nozzlelism. A trader or user skilled in the art may further understand that such configuration has the same design as super belief bull pin point entries categories w/risk assessment 8015 but is also combined with Halved Hybrid Nozzlelism and as such may be used as a forecasting tool.

Within the multidimensional risk analysis systems 100, FIG. 21 allows a trader or user skilled in the art to possibly understand that super belief bear pin point entries for Halved Hybrid Nozzlelism 8018 may be applicable to Bearish Believers. Such configuration may occur if during the possible Halved Hybrid Nozzlelism process and during the possible shifting of the lower most zone line, a possibility of risk designators becomes available such as, but not limiting in scope, “1”, “2”, “3”, “4”, “5” “6”, or “7”, such as which may be designated into the risk designators for Halved Hybrid Nozzlelism such as, but not limiting scope to, “1NZ”, “2NZ”, “3NZ”, “4NZ”, “5NZ”, “6NZ”, or “7NZ” or other such numbers as per a trader or user's choice if he/she would like to further categorized the risk. A trader or user skilled in the art may refer to the User's Manual for the various categories of super belief bear pin point entries with risk assessment for Halved Hybrid Nozzlelism. A trader or user skilled in the art may further understand that such configuration has the same design as super belief bear pin point entries categories w/risk assessment 8016 but is also combined with Halved Hybrid Nozzlelism and as such may be used as a forecasting tool.

Within the multidimensional risk analysis systems 100, FIG. 21 illustrates super belief bull pin point entries categories with risk assessment for Halved Hybrid Nozzlelism 8017. Certain embodiments of super belief bull pin point entries categories with risk assessment for Halved Hybrid Nozzlelism 8017 can be categorized in the following manner, or may be classified according to a trader or user's choice: super belief bull pin point en+1* for Halved Hybrid Nozzlelism; super belief bull pin point en+2* for Halved Hybrid Nozzlelism; super belief bull pin point en+3* for Halved Hybrid Nozzlelism; super belief bull pin point en+4* for Halved Hybrid Nozzlelism; super belief bull pin point en+5* for Halved Hybrid Nozzlelism; super belief bull pin point en+6* for Halved Hybrid Nozzlelism; and, super belief bull pin point en+7* for Halved Hybrid Nozzlelism 1625-7nz (FIG. 11) and all of which as such may be used as a forecasting tool.

Within the multidimensional risk analysis systems 100, FIG. 21 illustrates super belief bear pin point entries categories with risk assessment for Halved Hybrid Nozzlelism 8018. Certain embodiments of Super belief bear pin point entries categories with risk assessment for Halved Hybrid Nozzlelism 8018 can be categorized in the following manner, or may be classified according to a trader or user's choice: super belief bear pin point en−1* for Halved Hybrid Nozzlelism; super belief bear pin point en−2* for Halved Hybrid Nozzlelism; super belief bear pin point en−3* for Halved Hybrid Nozzlelism; super belief bear pin point en−4* for Halved Hybrid Nozzlelism; super belief bear pin point en−5* for Halved Hybrid Nozzlelism; super belief bear pin point en−6* for Halved Hybrid Nozzlelism 1620-6nz (FIG. 13); and, super belief bear pin point en−7* for Halved Hybrid Nozzlelism 1620-7nz (FIG. 10) and all of which as such may be used as a forecasting tool. A trader or user may be alerted by all important events as illustrated by a yellow triangle or any trader or user desired colors or shapes. All important events selected by a trader or user can have alerts may be sent via electronic mail, PDA's, or by audio/visual alert on chart during trading.

Upon reading the teachings of this specification, those skilled in the art will now appreciate that, under appropriate circumstances, the various components, examples and concepts of scalp-swing, may suffice.

### Scalp-Swing Method Setups or Special Multi-Low Risk Opportunity Setups

Certain embodiments of the multidimensional risk analysis systems 100, as described with respect to FIGS. 1 and 2, may be configured to perform scalp-swing method setups or special multi-low risk opportunity setups and thereupon, user interface 125 (FIG. 2) may be able to project such a display of scalp-swing method setups or special multi-low risk opportunity setups.

It may be understood by a trader or user skilled in the art that scalp-swing method setups and special multi-low risk opportunity setups may be considered unique in design and may provide low risk entries and exits and can be available for any time frame. When such are applied to 1 minute, it may provide scalp-swing opportunities, allowing for draw downs to be very close to none. When such are applied to 15 minutes, it may provide entries for the 60 minutes and/or daily time frames, and draw downs are significantly smaller than those draw downs within traditional methods, and may be used in conjunction with the 1 minute to allow for possible minimal draw downs close to zero. When such are applied to 60 minutes, it may provide entries for the daily time frame, and draw downs are smaller in comparison to traditional methods, and may be used in conjunction with 15 minutes and 1 minute to possibly produce minimal to close to zero draw downs.

A trader or user skilled in the art should be aware that this may be available for including, but not limiting scope to, all dynamic-adaptive sectional price perception risk dimensions indicators types a, b, c, d, e, f, and its deviations, various types of Sudden Market Spot Change Risk (internal market moving risk) 215 (FIG. 6), special conditions and for all risk dimensions (also known as market risks) 206 (FIG. 7). It should be further made aware that use of higher time frames for setups such as the possible use of daily, weekly, 60 minute, 15 minute, and 1 minute may possibly produce mega scalp-swing and possibly larger results. It should be understood that any combination of time frames may be applicable to this method and it may produce better pin point results.

A trader or user skilled in the art may want to refer to the Halved Hybrid Nozzlelism section for including, but not limiting scope to, scalp-swing trading with upper right Halved Hybrid Nozzlelism, scalp-swing trading with Halved Hybrid Nozzlelism, prep-pre double bullish trend Hybrid Parallelism 7044 (FIG. 14), prep-pre double bearish trend Hybrid Parallelism 7045 (FIG. 14), confluence zero after Hybrid Parallelism between two scheduled events of Blue Line, confluence zero after hybrid nozzlelism tipping area 6592 (FIG. 14), scheduled risk transition spike/line bull continue 6815 (FIG. 18), scheduled risk transition spike/line bear continue 6816 (FIGS. 9, 13, 14, and 18), scheduled lower hybrid zone transfer area, scheduled upper close ended hybrid zone risk transfer area 6885 (FIG. 14), scheduled lower close ended hybrid zone risk transfer area 6886 (FIG. 14), double upper Halved Hybrid Nozzlelism 6050 (FIG. 14), double lower Halved Hybrid Nozzlelism, and lower right Halved Hybrid Nozzlelism Annularization (divergence) 6260 (FIG. 10). There can be a variety of concepts and applications of scalp-swing and special multi-low risk opportunity setups.

### Mega Scalp-Swing

A trader or user skilled in the art may refer to scalp-swing trading and special multi-low risk opportunity setups for details on scalp-swing trading. It may be understood by a trader or user skilled in the art that there may be several setup types such as, but not limiting scope to, scalp-swing method set ups types M, scalp-swing method set ups types Mn, scalp-swing method set ups types Mc and scalp-swing method set ups types Me may be used to produce possibly large results for either the Bullish Believers or Bearish Believers over a period of time, most likely with the least amount of risk and maintenance.

Once a possible setup can be identified, such as, but not limiting scope to, earlier lows −4.6(Mc)++ 2156 (FIG. 9), earlier lows −4.6(Mc)+ 2157 (not illustrated), super belief bull pinpoint en+7* (Mc) 2159 (FIG. 9), earlier lows −4.1 tan(Me)−oex (not illustrated), powder blue (C) bullish entry(Me)+oex (not illustrated), or tan bearish entry −(Me) 2180 (FIG. 13), a trader or user skilled in the art may use alerts or may manually, on larger time frames such as daily, weekly, monthly, etc and may use smaller time frames such as 60 minutes, 15 minutes or 1 minute to identify scalp-swing method set ups or special multi low risk opportunity set ups, which may be used to refine entries in the direction of one of the possible setups aforementioned in this paragraph. A trader or user skilled in the art may understand that Dynamic Zone Lines possibly can assist with possibly entries and exits with mega scalp-swing setups. A trader or user may be alerted by all important events as illustrated by a yellow triangle or any trader or user desired colors or shapes. All important events selected by a trader or user can have alerts may be sent via electronic mail, PDA's, or by audio/visual alert on chart during trading.

A trader or user skilled in the art may understand that there may be a variety of mega scalp-swing setups and that it may be referred to as the possible use of entering scalp-swing on a lower time frame but following the scalp-swing setups of a bigger time frame may allow for large results within any market vehicle such as, but not limiting scope to, stocks, commodities, ETFs, options, derivatives, ETCs, or Forex.

### Examples of Mega Scalp-Swing

A trader or user skilled in the art should be aware that there are numerous types and examples that may be provided with mega scalp-swing. However, within this disclosure, two examples may be considered. FIG. 18 shows one embodiment of a display, showing an illustrative screenshot view displaying a bearish mega scalp swing setup, as may be included within certain embodiments of the multidimensional risk analysis systems 100 of FIGS. 1 and 2.

It also provides one illustrative display of mega scalp-swing short entry setup, tan bearish entry −(Me) 2180, which may be considered as special multi low risk bearish opportunity setups. A trader or user skilled in the art should understand that Me+/−Oex may be considered to be a special multi-low risk opportunity setup. “Me” can be defined as magic trader entry, while the “Oex” may be defined as extended movement and can either have a “+” or “−” before it. Thereupon, a “+Oex” may serve as an indication that there is a possible extended previous bearish condition within the market, while a “−Oex” may serve as an indication that there is a possible extended previous bullish condition within the market. It may be further understood that such setups may be considered special since they may have unique conditions within the market and that there are possibly several low risk factors that could be taking place at such particular time. A trader or user skilled in the art may want to take a setup position with Me+/−Oex and such setups may produce big results in trading. Typically, an Me+Oex precedes super belief bullish pin point entries 1625, whereas an Me−Oex precedes super belief bear pin point entries 1620. It can be observed that forecasting earlier highs with risk assessments may be combined with +Oex and forecasting earlier lows with risk assessments may be combined with −Oex. It should be understood that a large red colored alert symbol 8205 represents a Bearish Mega Scalp-Swing setup entry alert whereas a small red colored alert symbol 8206 represents a Bearish Mega Scalp-Swing setup exit. It should be understood that a large green colored alert symbol 8210 represents a Bullish Mega Scalp-Swing setup entry alert whereas a small green colored alert symbol 8211 represents a Bullish Mega Scalp-Swing setup exit.

Certain embodiments of the multidimensional risk analysis systems 100, as described with respect to FIGS. 1 and 2, may be configured, in respect with various risk processors 200 (FIG. 2), to allow a trader to utilize a risk management procedure. A trader or user skilled in the art may use risk tables 4005 (FIG. 22), 4100 (FIG. 23), and 4200 (FIG. 24) to possibly decide how many maximum allowed contracts with breakeven analysis 3720 (FIG. 23), maximum allowed used margin with breakeven analysis 3730 (FIG. 23) and the current equity WIBE limit 3740 (FIG. 23), with the incorporation of EMC errors elimination technique in capital preservation.

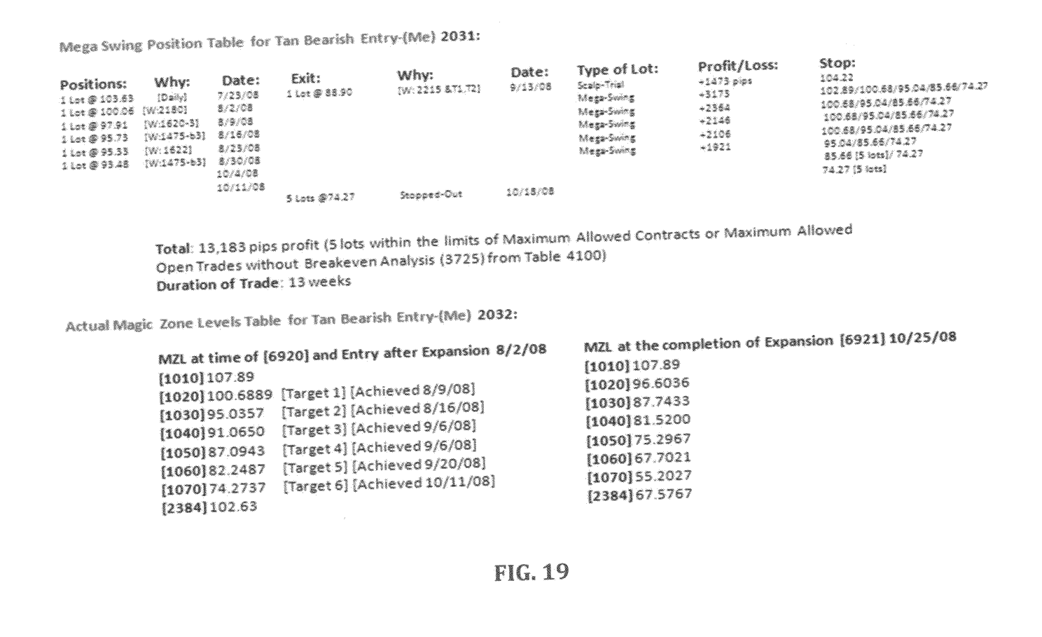

FIG. 19 shows one embodiment of a display, showing a supportive illustrative screenshot view displaying possible positions and exits, with respect to FIG. 18, as may be included within certain embodiments of the multidimensional risk analysis systems 100 of FIGS. 1 and 2. It also provides a supportive illustrative display of FIG. 18, in which a trader or user may then possibly enter into a trade with an alert for the following indicators, but not limiting scope to, on the daily time frame: bear magic entry spike 1880, super bearish belief contra −re-1 2200, and/or super bullish belief contra +re1 (Mc) 2160. A trader or user may enter mega scalp-swing setup, tan bearish entry −(Me) 2180, with or without the use of an alert, at a close price of 103.63 of the selected market vehicle to trade 3510 (FIG. 23), with a possible contract size 3540 (FIG. 23) of one lot, possibly taking into consideration various factors such as, but not limiting scope to, a reduced margin factor user selection from what broker offers 3515 (FIG. 23), a margin used per contract 3545 (FIG. 23), a contingency amount for max loss for a particular account 3525 (FIG. 23), a corrected results for breakeven analysis for zone levels used 3585 (FIG. 23), a per trade capital loss allowed 3675 (FIG. 23), a maximum allowable pip movements or price change 3715 (FIG. 23), and a pip difference between two nearest zone lines 3508 (FIG. 23).

FIG. 18 can be further analyzed in conjunction with FIG. 19 in order to understand a possible trade a trader or user may take using mega scalp-swing setup, tan bearish entry −(Me) 2180. An alert for super bullish belief contra +re 2200 can be seen within the AUD/JPY weekly chart and has also appeared within the explorer on 7/26/08. It can be observed that on 7/19/08, the left leg portion of bear entry spike 1880 started to form. Within the daily chart, a trader or user skilled in the art, may observe on 7/23/08, a setup, super bullish belief contra +re1 (Mc) 2160 along with several indicators such as, bear entry spike 1880 and bear spot risk line 1695, occurred. A trader or user may add a test scalp lot at this time, at the close of 103.63 based upon a 60 minute and 5 minute entry, placing a possible stop at 104.22, which a trader or user may observe as the open price. It may be further observed that the bear entry spike 1880 was completed on 8/2/08; within the week of 7/26/08, a modified bearish time segment 1141 can be observed and the Squeezing of Zone Lines 6920 can be visualized on the left. Thus far, it can be observed by a trader or user that a shorting opportunity is possible but there was no setup signal. On the week of 8/2/08, the setup tan bearish entry −(Me) 2180 can be observed. The high of 103.40 did not take out the possible stop of 104.22 that the trader or user had placed. At the end of such week, around the close of the market of 4:00 pm, a trader or user may add another lot and can refer FIG. 19 for subsequent details and results of such possible trade.

FIG. 18 provides an illustrative display of another mega scalp-swing long entry setup, bullish DK yellow candle—type a (M) 2127, which may be considered as special multi low risk bullish opportunity setups 2116. Certain embodiments of the multidimensional risk analysis systems 100, as described with respect to FIGS. 1 and 2, may be configured, in respect with various risk processors 200 (FIG. 2), to allow a trader to utilize a risk management procedure. A trader or user skilled in the art may use risk tables 4005 (FIG. 22), 4100 (FIG. 23), and 4200 (FIG. 24) to possibly decide how many maximum allowed contracts with breakeven analysis 3720 (FIG. 23), maximum allowed used margin with breakeven analysis 3730 (FIG. 23) and the current equity WIBE limit 3740 (FIG. 23), with the incorporation of EMC errors elimination technique in capital preservation.

A trader or user skilled in the art, referring to FIG. 18, may observe on the AUD/JPY weekly chart that on the week of 2/7/09, can observe a bullish DK yellow candle—type a (M) 2127 setup had taken place. At the open of 2/14/09, a modified bullish time segment 1131 may be observed, and therefore the trader or user may take a long entry at the close price of 60.33. A trader can then exit out of such trade at the appearance of a setup, super belief bull pinpoint en+7* (Mc) 2159 at the close price of 76.52 on 7/4/09. The conclusion of such trade may be that the trader or user may approximately earn 1619 pips profit for one lot within the limits of maximum allowed contracts or maximum allowed open trades without breakeven analysis 3725 from table 4200 (FIG. 24) for a duration of approximately 21 weeks.

A trader or user skilled in the art may conclude from such above examples that it can be relatively simple to trade with mega scalp-swing setups, as such is due to the possibility of being able to easily identify entries and exits, the possibility of reducing time involved in a trade, the possibility of pinpoint the accuracy of an entry or exit, the possibility of risk assessment and risk recognition at every stage, the ability to receive pre-determined targets that can be achievable and the ability of such being user friendly. Many configurations of mega scalp-swing may occur within the scope of the present disclosure.

### Multi-Confirmation Risk Assessment and Trading System Scalp-Swing Setup Table

A trader or user skilled in the art should understand that the multi-confirmation risk assessment and trading system scalp-swing setup table, as seen in the User's Manual, (also known as scalp-swing setups table) may provide all scalp-swing method setups, the various symbols for such setups, the various colors for scalp-swing setups, the various bullish symbols for scalp-swing setups, the various neutral symbols for scalp-swing setups, the various bearish symbols for scalp-swing setups, the color-coding for scalp-swing setups and the reference numbers that are associated with such scalp-swing setups. A trader or user may be alerted by all important events as illustrated by a yellow triangle or any trader or user desired colors or shapes. All important events selected by a trader or user can have alerts may be sent via electronic mail, PDA's, or by audio/visual alert on chart during trading. A variety of configurations of the scalp-swing setups table and its various components may occur.

### Types of Scalp-Swing Method Setups

Certain embodiments of the multidimensional risk analysis systems 100, as described with respect to FIGS. 1 and 2, may be configured, in order to determine the numerous types of scalp-swing setups. A trader or user skilled in the art may determine that such setups can be based upon multiple risk recognition and confirmation. A trader or user may not have to worry about the possible lining up of multiple indicators, about the short bullish or bearish risk recognition factors or the aligning the combination of eight major types of risk dimensions 206 (FIG. 2). Thereupon, it may be understood that such setups may be classified into four major categories.

One embodiment of the various types of scalp-swing setups can be referred to as scalp-swing methods setup type M. As such, these setups may be based on, but not limiting scope to, all price risks and spot risks and typically involves the color of candles/bars, Spikes, vertical lines, spot risk lines and warnings. A trader or user skilled in the art may use one mathematical function such as sum, subtraction, multiplication and division to create such scalp-swing setups. There are certain types of scalp-swing type M setups, which may include, but not limiting scope to, bullish DK yellow candle type a++ (M), bullish DK yellow candle type a (M), bullish bright green candle type b (M), bullish green candle type c+ (M) Pc+, tan bearish entry type c (M1), purple (C) candle type d+++(M) Pd, tan bearish entry type d (M)−oex, turquoise bullish candle +(M), gray (C) bullish candle (M), indigo bear warning candle (M), and pink (C) bearish candle (M).

Within the multidimensional risk analysis systems 100, with respect to FIG. 17, a trader or user skilled in the art may understand that one such possible scalp-swing type M setup may be referred to as bullish Dk yellow candle—type ++(M) 2126, which may be concluded from the possible combination of: bullish dk yellow candle—type a, Blue Line 2381, and bull entry spike 1875. Another possible scalp-swing type M setup may be referred to as bullish Dk yellow candle—type a (M) 2127, which may be derived from the possible combination of bullish dk yellow candle—type a, bull entry spike 1875 and bull spot risk line 1690, as such is illustrated in FIGS. 11, 13, 14 and 18. Yet another possible scalp-swing type M setup may be referred to as bullish bright green candle—type b (M), which can be concluded through the possible combination of bullish bright green candle—type b MT-83 (FIG. 6), bull entry spike, and bull spot risk line. Yet another possible type scalp-swing type M setup may be referred to as bullish green candle—type c+(M) Pc+, which may be derived from the possible combination of bullish green candle type c+, Blue Line, bull spot risk line, and bull entry spike. A further possible scalp-swing type M setup may be referred to as tan bearish entry—type c (M1), which may result from the possible combination of tan bearish entry, bear entry spike, and directional line bear. Another possible scalp-swing type M setup may be referred to as purple (C) candle—type d+++(M) Pd, which can be arrived from the possible combination of purple candle—type d+++, yellow bull warning candle and bull entry spike. A trader or user may recognize another possible scalp-swing type M setup which can be referred to as tan bearish entry—type d (M)−oex, which can be designed through a possible combination of purple (C) candle type d, bear entry spike, and be referred to as tan bearish entry—type c (M1), which may result from the possible combination of tan bearish entry. A trader or user may recognize another possible scalp-swing type M setup which can be referred to as turquoise bullish candle +(M), which can be concluded from the possible combination of turquoise bullish candle +, yellow ext bull warning line and bull entry spike. Yet another possible scalp-swing type M setup can be referred to as gray (C) bullish candle (M), which can be designed through the possible combination of yellow bull warning candle, gray (C) bullish, and bull entry spike. A trader or user may recognize another possible scalp-swing type M setup which can be referred to as indigo bear warning candle (M), which can be concluded from the possible combination of indigo bear warning candle, pink (C) bearish candle, and bear entry spike. A trader or user may recognize a final possible scalp-swing type M setup which can be referred to as pink (C) bearish candle (M) which can be derived from the possible combination of pink (C) bearish candle, black neutral candle (also known as neutral bar), and bear entry spike.

One embodiment of the various types of scalp-swing setups can be referred to as scalp-swing methods setup type Mn. As such, these setups may involve black neutral candle and bullish/bearish entry Spikes and also may be in the modified neutral time segment. Within such, it may be observed that the risk can get balanced from the previous trend and the first test run may take place in either the bullish or bearish direction, as such a trader may refer to the User' Manual for directional reference. There are certain types of scalp-swing type Mn setups, which may include, but not limiting scope to, black neutral candle (Mn+) and Top Bear small or big (Mn−).

A trader or user skilled in the art may understand that one such possible scalp-swing type Mn setup may be referred to as black neutral candle (Mn+) 2146, which may be concluded from the possible combination of: black neutral candle 1460, bull entry spike 1875 and Blue Line 2381, as such is illustrated in FIGS. 11, 13 and 14. Another possible scalp-swing type Mn setup may be referred to as Top Bear—small or big (Mn−), which can be derived from the possible combination of black neutral candle, Top Bear—small or big and bear entry spike. One embodiment of the various types of scalp-swing setups can be referred to as scalp-swing methods setup type Mc. As such, these setups may be created when the sudden previous direction has possibly changed but the previous direction risk recognition factors, such as favorable bullish risk recognition factors, favorable bearish risk recognition factors, and favorable neutral risk recognition factors, may still be in effect or the previous Horizontal Time Risk may still be in effect. Typically, such direction can be recognized by the directional entry Spikes, bull entry spike or bear entry spike. There are certain types of scalp-swing type Mc setups, which may include, but not limiting scope to, earlier lows 4.6 (Mc)++, earlier lows −4.6 (Mc)+, earlier lows 4.6 (Mc), super bullish bull pin point en+7*(Mc), super bullish belief contra +re1, bullish DK yellow candle type a+(Mc) Mgo, bullish DK yellow candle type a (Mc) Mgo, and bullish green candle type C (Mc) Mgo.

A trader or user skilled in the art may understand that one such possible scalp-swing type Mc setup 2155 may be referred to as earlier lows −4.6 (Mc)++, which may be created from the possible combination of earlier lows −4.6, bull entry spike and bull spot risk line. Another such possible scalp-swing type Mc setup may be referred to as earlier lows −4.6 (Mc)+, which may be concluded from the possible combination of earlier lows −4.6, bull entry spike, and bull spot risk line. Another such possible scalp-swing type Mc setup may be referred to as earlier lows −4.6 (Mc), which may be derived from the possible combination of earlier lows −4.6, bull entry spike, and bull spot risk line. Another such possible scalp-swing type Mc setup may be referred to as super belief bull pin point en+7* (Mc), which may be concluded from the possible combination of Super Bullish Believer Entry, dynamic strength risk indicator and bear entry spike, A possible entry for super belief bull pin point en+7* (Mc) 2159 can be illustrated in FIG. 18. Another such possible scalp-swing type Mc setup may be referred to as super bullish belief contra +re1 (Mc) 2160, which can be created by possible combination of super bullish belief contra +re1 (also known as super bullish belief en-R) 2205 and modified bullish time segment 1131 or bear spot risk line and bear entry spike, as such is illustrated in FIGS. 13 and 14. Yet another possible scalp-swing type Mc setup may be referred to as bullish Dk yellow candle—type a+(Mc) Mgo, which may be arrived from the possible combination of bullish Dk yellow candle—type a, bear spot risk line and bear entry spike. Yet another possible scalp-swing type Mc setup may be referred to as bullish Dk yellow candle—type a (Mc) Mgo, which may be arrived from the possible combination of bullish Dk yellow candle—type a, bear spot risk line, bear entry spike and magic: out. Another possible scalp-swing type Mc setup may be referred to as bullish green candle—type c (Mc) Mgo, which may be derived from the possible combination of bullish green candle type c (also known as MSDPR-C), strength risk indicator or upper values of Boundary Lines, bear entry spike and magic: out.

One embodiment of the various types of scalp-swing setups can be referred to as scalp-swing methods setup type Me. As such, these setups may be based upon earlier highs, earlier lows, super belief contra or warning candles and directional entry Spikes, bull entry spike or bear entry spike. There are certain types of scalp-swing type Me setups, which may include, but not limiting scope to, earlier lows −4.1 tan(Me)−Oex, powder blue (C) bullish entry(Me)+Oex, super bearish belief contra −re-2(Me), bear belief warning candle (Me) and tan bearish entry −(Me).

A trader or user skilled in the art may understand that one such possible scalp-swing type Me setup may be referred to as earlier lows −4.1 tan(Me)−Oex, which may be created from the possible combination of earlier lows −4.6, and tan bearish candle ++, and bear entry spike 1880 or directional line-bear. Another possible scalp-swing type Me setup may be referred to as powder blue (C) bullish entry (Me)+Oex, which may be derived from the possible combination of powder blue (C) bullish candle and bull entry spike or directional line-bull. Another possible scalp-swing type Me setup 2175 may be referred to as super bearish belief contra −re-2 (Me) 2178, which may be created from the possible combination of super bullish belief contra +re1 (also known as super bullish belief en-r) 2205 and modified bullish time segment 1131 or bear spot risk line and bear entry spike, as such is illustrated in FIG. 13.

Yet another possible scalp-swing type Me setup may be referred to as bear belief warning candle (Me), which may be arrived from the possible combination of indigo bear warning candle and bear entry spike. Another scalp-swing type Me setup may be referred to as tan bearish entry (Me) 2180, which may be created from the possible combination of tan bearish candle 1455 and bear entry spike 1880 or directional line-bear, as illustrated with FIG. 18. A trader or user may be alerted by all important events as illustrated by a yellow triangle or any trader or user desired colors or shapes. All important events selected by a trader or user can have alerts may be sent via electronic mail, PDA's, or by audio/visual alert on chart during trading. Various types and concepts behind scalp-swing setups may occur.

### Trading Examples Using Scalp-Swing

A trader or user skilled in the art should be aware that there are numerous types and examples that may be provided with scalp-swing trading. However, within this disclosure, three examples may be considered.

FIG. 17 shows one embodiment of a display, showing an illustrative screenshot view displaying a bullish scalp swing setup, as may be included within certain embodiments of the multidimensional risk analysis systems 100 of FIGS. 1 and 2. It also provides one illustrative display of a scalp-swing setup, bullish Dk yellow candle—type a++(M) 2126, which is a multi low risk opportunity setup up. Certain embodiments of the multidimensional risk analysis systems 100, as described with respect to FIGS. 1 and 2, may be configured, in respect with various risk processors 200 (FIG. 22), to allow a trader to utilize a risk management procedure. A trader or user skilled in the art may use risk tables 4005 (FIG. 22), 4100 (FIG. 23), and 4200 (FIG. 24) to possibly decide how many maximum allowed contracts with breakeven analysis 3720 (FIG. 23), maximum allowed used margin with breakeven analysis 3730 (FIG. 23) and the current equity WIBE limit 3740 (FIG. 23), with the incorporation of EMC errors elimination technique in capital preservation.

With respect to FIG. 17, a trader or user skilled in the art may enter into a trade with the alert 8220, for yellow ext bull warning line 1680 and may enter scalp-swing setup, bullish Dk yellow candle—type a++(M) 2126, with or without the use of an alert, at the close price of 1.4869 of the selected market vehicle to trade 3510 (FIG. 23), with a possible contract size 3540 (FIG. 23) of one lot, possibly taking into consideration various factors such as, but not limiting scope to, a reduced margin factor user selection from what broker offers 3515 (FIG. 23), a margin used per contract 3545 (FIG. 23), a contingency amount for max loss for a particular account 3525 (FIG. 23), a corrected results for breakeven analysis for zone levels used 3585 (FIG. 23), a per trade capital loss allowed 3675 (FIG. 23), a maximum allowable pip movements or price change 3715 (FIG. 23), and a pip difference between two nearest zone lines 3508 (FIG. 23).

With respect to FIG. 17, a trader or user skilled in the art may understand the following zone levels are available:

Zone Line 1040 (T3)—1.4985∥Exit here may allow for (1.4985-1.4869)=116 pips potential profit (prices reached zone line 1040 at 11:15 am); Zone Line 1050 (T2)—1.4965∥Exit here may allow for (1.4965-1.4869)=96 pips potential profit (prices reached zone line 1050 at 10:30 am); Zone Line 1060—1.4903∥Exit here may allow for (1.4903-1.4869)=34 pips potential profit; Zone Line 1070—1.4828∥A trader or user may put an initial stop here.

It may be possible to take such possible trade in another aspect, with reference to FIG. 17. A trader or user may enter such trade as a scalper, with the possible anticipation of a few pips at the close of 3:45 am on 11/27/09 at the close price of 1.4869 with one lot. At 4:15 am on 11/27/09, a trader or user may observe earlier highs +3.1 1470-a1, and as it is considered to be a forecasting of earlier highs with a risk assessment of 1, such trader or user may add another lot at the close price of 1.4870, with a potential target of zone line 1060 (T1). Such trader or user may add an additional lost at the possible first appearance of earlier highs +3.2 1470-a2, at the close price of 1.4890, as it still can be considered a low risk for forecasting earlier highs. Then, yet another lot may be added by the trader or user at 5:00 am at the second appearance of earlier highs +3.2 1470-a2, at the close price of 1.4894, as it is still considered to be a low risk for forecasting earlier highs. Yet another lot may be added at the third appearance of earlier highs +3.2 1470-a2 at 5:15 am, at the close price of 1.4901, still considering the possibility of a low risk for forecasting earlier highs. Such trader or user may observe super bullish belief entries 1621 at 5:45 am but may consider not adding another lot. The observation of super bullish belief contra +re 2200 may allow for the trader or user to close out his/her entire position of 5 lots at 1.4918. The duration of the trade was 2 hours and 15 minutes and an approximate of 172 pips potential profit could have been made with the 5 lots within the limits of maximum allowed contracts or maximum allowed open trades without breakeven analysis 3725 from table 4100 (FIG. 23). The following calculations may be considered on the basis of such trader or user's possible trade:

| Entry at close | Exit at close | |
|---|---|---|
| (initially at 3:45 am): | (all positions at 6:00 am): | Difference: |
| 1 lot @ 1.4869 | 1 lot @ 1.4918 (T1a) | +49 pips |
| 1 lot @ 1.4870 (due to 1470-a1) | 1 lot @ 1.4918 (T1a) | +47 pips |
| 1 lot @ 1.4890 (due to 1470-a2) | 1 lot @ 1.4918 (T1a) | +28 pips |
| 1 lot @ 1.4894 (due to 1470-a2) | 1 lot @ 1.4918 (T1a) | +24 pips |
| 1 lot @ 1.4894 (due to 1470-a2) | 1 lot @ 1.4918 (T1a) | +24 pips |

It may be possible to take yet another possible trade with respect to FIG. 17. A trader or user may skilled in the art should understand that such dynamic hybrid zone levels 1006 were forecasted at 2:45 am on 11/27/09. A possible yellow triangle alert for yellow ext bull warning line 1680 can be observed at 3:30 am with another green triangle alert 8220 for scalp-swing setup bullish Dk yellow candle—type a ++ (M) 2126 appeared at 3:45 am. A trader or user may enter into a trade as a scalper but with the observance of modified bullish time segment 1131 and Bull entry spike 1875, such trader or user can stay into a trade. Such trader or user may further observe several low risk earlier highs, of which he/she may add lots accordingly, knowing the potential targets due to the hybrid dynamic zone levels 1006 forecasted in advance. A trader or user may trail his/her stops under Blue Line 2381 and its possible scheduled events and its possible formation of Blue Line angle north 2381-an, which as observed on FIG. 17, occurs at 4:45 am and 5:45 am. Further observation of the possible formation of the first leg of Bear entry spike 1880 may be seen at 6:00 am. After making a possible entry at 3:45 am with the close price of 1.4869, a trader or user skilled in the art could have exited the trade at the high of 1.4873 at 4:00 am but instead may remain within such trade due to the observance of bull entry spike 1875, modified bullish time segment 1131 and low risk designators. If a trader or user did not add any additional lots and exited at the close of super bullish belief contra +re 2200 at 1.4918 (T1a), an approximate potential of 49 pips per lot (1.4918-1.4869) may still be made over 2.25 hours. In the above example, it can be observed that there was a 7 pips draw down possibility, (1.4869-1.4862).

It should be understood, in FIG. 17, that a large red colored alert symbol 8215 represents a Bearish Scalp-Swing setup entry alert whereas a small red colored alert symbol 8216 represents a Bearish Scalp-Swing setup exit. It should be understood that a large green colored alert symbol 8220 represents a Scalp-Swing setup entry alert whereas a small green colored alert symbol 8221 represents a Bullish Scalp-Swing setup exit.

A trader or user skilled in the art should understand that typically, swing trading can take approximately one to four days to produce such above mentioned results. However, the various components of multidimensional risk analysis systems 100 can allow a trader or user to possibly produce much superior, much faster, more accurate, lower risk entries, and the possibility of more confidence, risk recognition, use of colored candles, minimal use of traditional technical analysis and minimal draw downs.

FIG. 20 shows one embodiment of a display, showing an illustrative screenshot view displaying a bullish scalp-swing setup based on an open-ended hybrid zone risk transfer area, as may be included within certain embodiments of the multidimensional risk analysis systems 100 of FIGS. 1 and 2. It also provides one illustrative display of a scalp-swing setup, purple (C) candle—type d +++ (M) Pd 2131. A trader or user skilled in the art may enter into a trade with a long position. A trader or user takes a possible entry at 11:53 am on 3/1/10 at the close price of 1.3505, where such scalp-swing setup, purple (C) candle—type d +++ (M) Pd 2131, occurred and a modified bullish time segment 1131 was observed at the entry. It may be further observed that at point “A”, at 11:53 am, Orange Oscillator 2377 crossed Health Risk Directional Indicator Bullish 2015, Health Risk Directional Indicator Bearish 2020 and Modified Dynamic Strength Risk Indicator 1287. A trader or user may place a stop at 1.3502, which is observed to be the value of zone line 1040; if the trader or user decides not to place any stops, he/she may use trade-repairs. It may be further observed by a trader or user the following values:

Zone line 1010 (Target #3/T3): 1.3547; Zone line 1020: 1.3528 (Target #2/T2) prices reached zone line 1020 at 12:47 pm; Zone line 1030: 1.3513 (Target #1/T1) prices reached zone line 1030 at 12:00 pm; Zone line 1040: 1.3502 (Possible stop); Zone line 1050: 1.3492; Zone line 1060: 1.3479; Zone line 1070: 1.3458; Blue Line 2381: 1.3500.

With respect to FIG. 20, a trader or user skilled in the art may exit at the bear entry spike 1880 at 12:11 pm, with the close price of 1.3526 on 3/1/10. It may be observed that the duration of such trade was 18 minutes and an approximate possible gain of 21 pips per lot, which if it happened to be 5 lots as with the previous examples, would be an approximate possible gain of 105 pips. A trader or user skilled in the art may understand that scalp-swing can be very fast and easy and traditional swing trading may not be needed. There can be a variety of embodiments of scalp-swing setups.

### Risk Recognition for Scalp-Swing Trading, Trade-Repair and Portfolio Repair

Within this disclosure, “risk recognition” may be utilized to describe the unique method of discovering, sequentizing, prioritizing, recognizing and controlling the various risks that are associated in trading. As such, risk recognition can illustrate a general shape, pattern, color, or number of a variety of indicator combinations, which may be utilized to help an ordinary skilled user or trader without extensive training to understand important events occurring within financial markets such as market trend changes, breakouts, retracements, new highs, new lows, directional forecastings, reversals, pullbacks, and many other such trading clues.

It may be understood by a trader or user skilled in the art that in trading, it is typical for traders or users to be constantly anxious about the price of the particular market vehicle under observation and tend to generally ignore the multiple risks that are associated with such trading and the location of such with respect to the eight dimensional risks or combinations of eight dimensional risks. Within the financial industry, there have been discussions of risks involved, but there have been no tools that can recognize such risk as it occurs and can then tag them, prioritize them, sequence them, all of which controls the outcome of trading by every tick to every time frame or combination of time frames. Multidimensional risk analysis systems 100 was able to discover the actual number of risks involved in trading. Eight dimensional risks were discovered, Sequentized, prioritized and recognized with colors, alphabets, and symbols, and simplified into any user desired time frame and may still have the effect of multiple time frames and multi-confirmations of risk recognitions.

A trader or user skilled in the art, with the possible use the User's Manual, can possibly recognize and visualize the various types of risks involved in trading within any market vehicle. It may be understood by a trader or user that such various risks may be visualized by, but not limiting scope to, Trend Health Risk, modified trend health indicator, and magic spectrum of colored candlesticks (also known as multi-dimensional risk spectrum). A trader or user skilled in the art may further recognize bullish, bearish, or neutral risk within the User's Manual. Neutral symbols/candles may be used for neutral risk, bullish symbols/candles may be used for bullish risk and bearish symbols/candles may be used for bearish risk. Certain embodiments of the multidimensional risk analysis systems 100, as described with respect to FIGS. 1 and 2, may be configured to perform the above and thereupon, user interface 125 (FIG. 2) may be able to project such a display of risk recognition. A trader or user may be alerted by all important events as illustrated by a yellow triangle or any trader or user desired colors or shapes. All important events selected by a trader or user can have alerts may be sent via electronic mail, PDA's, or by audio/visual alert on chart during trading. Those skilled in the art will now understand that there are a variety of alternative methods and concepts behind risk recognition.

### Risk Recognition Factors

Certain embodiments of the multidimensional risk analysis systems 100, as described with respect to FIGS. 1 and 2, may be configured, with the user interface 125, to portray the various types of risk recognition factors within the market, which may be classified into one of three categories: favorable bullish risk recognition factors, favorable bearish risk recognition factors, and favorable neutral risk recognition factors. A trader or user skilled in the art may understand that when a trader or user has possibly taken a trade in the bullish direction, bullish symbols/candles within the User's Manual may be used to recognize bullish risk within, but not limiting scope to, trade repair, portfolio repair, or scalp-swing trading. Bullish symbols/candles within the User's Manual, may serve as an indication of bullishness and may be referred to as favorable bullish risk recognition factors, which may be indicated by symbols or colors.

A trader or user skilled in the art may understand that when a trader or user has possibly taken a trade in the bearish direction, bearish symbols/candles within the User's Manual may be used to recognize bearish risk within, but not limiting scope to, trade repair, portfolio repair, or scalp-swing trading. Bearish symbols/candles within the User's Manual, may serve as an indication of bearishness and may be referred to as favorable bearish risk recognition factors, which may be indicated by symbols or colors. A trader or user skilled in the art may understand that when a trader or user may possibly be within a neutral area, after taking either bullish or bearish trade, neutral symbols/candles within the User's Manual may serve as an indication of neutrality and may be referred to as favorable neutral risk recognition factors, which may be indicated by symbols or colors. A trader or user may be alerted by all important events as illustrated by a yellow triangle or any trader or user desired colors or shapes. All important events selected by a trader or user can have alerts may be sent via electronic mail, PDA's, or by audio/visual alert on chart during trading.

### Breakeven Analysis or Replacement of Original Values

FIG. 23 shows one embodiment of a display, showing an illustrative risk control table displaying account, capital preservation, trade repair and scalp-swing trading information, as may be included within certain embodiments of the multidimensional risk analysis systems 100 of FIGS. 1 and 2. A trader or user may understand that the replacement of original values, results may be exponential in nature for the original values, due to possible parabolic characteristics may be referred to as breakeven analysis within trading. It may be further understood that trading parameters 3700 may be adjusted in values, with respect to tables 4100 (FIG. 23) and 4200 (FIG. 24), in order to possibly conserve capital, by possibly reducing factors such as, but not limiting scope to, current equity falling limit 3740, maximum margin available 3560, and maximum allowed contracts or open trades limit at any given time with breakeven analysis 3720.

Capital Preservation Trading Parameters, with respect to table 4100 (FIG. 23), may make evident the following: with respect to what a trader can afford to lose per day 3605, if a trader or user states that he/she can afford to lose $15, it requires $15.08 to replace that $15.00, which is a 0.533% increase; with respect to what a trader can afford to lose per week 3610, if a trader or user states that he/she can afford to lose $105, it requires $108.81 to replace $105.00, which is a 3.628% increase; with respect to how much a trader can afford to lose of liquid assets 3630, if a trader or user states that he/she can afford to lose $1000, it requires $1250 to replace $1000, which is a 25% increase. It may be concluded from such that as the amount of dollars lost increases, the amount required to replace such original amount should increase exponentially, instead of proportionately, and produces a parabolic effect. A trader or user skilled in the art may understand that it becomes more difficult to replace the original amount as the trading percentage loss increases. It may be further understood that a 10% loss will require 11.11% to replace the loss, while a 50% loss requires 100% to replace the loss, and a 95% loss in equity may require 1900%, as seen with respect with table 4005 (FIG. 22). The same may be applicable on draw downs.

### EMC Errors Elimination Technique in Capital Preservation

FIGS. 23 and 24 represent certain embodiments of the multidimensional risk analysis systems 100 with respect to FIGS. 1 and 2. A trader or user skilled in the art may understand that upon application of breakeven analysis in trading, it reveals “equity errors” (also known as equity error without breakeven analysis) 3760, “used margin errors” (also known as used margin error without breakeven) 3765, and “maximum allowed contract errors” (also known as maximum allowed contract error without breakeven) 3770, all of which may contribute to the loss of capital before possible trades are done due to the lack of adjustments for such errors. It may be understood by a trader or user skilled in the art that such errors must be taken into consideration during repairs, trading, or before trading, and may control the risk before a trader or user is exposed to these unknowingly hidden additional risks. It may be further understood that the technique to eliminate errors such as equity error without breakeven analysis 3760, used margin error without breakeven 3765, and maximum allowed contract error without breakeven 3770, in trading, on the basis upon such method of breakeven analysis and its possible applications to equity, margin and maximum allowed of lots, as such may be based upon reduced margin trader satisfied percentage 3620, can be identified as EMC errors elimination technique in capital preservation 3285. It may be further understood that such technique may also be developed with respect to, but not limiting scope to, account size at broker for a trader 3505, contract size 3540, asset tolerance check 3660, how much a trader can afford to lose of liquid assets 3630, weeks to break 3640, etc. A trader or user may be alerted by all important events as illustrated by a yellow triangle or any trader or user desired colors or shapes. All important events selected by a trader or user can have alerts may be sent via electronic mail, PDA's, or by audio/visual alert on chart during trading. The development of such may help to reduce the additional risks that are associated with trading before a trader or user makes a possible trade. A trader or user skilled in the art may further understand that as such aforementioned may allow for the control of losses before such losses may occur and may help a trader or user conserve capital upfront rather than within the market. Those skilled in the art will now appreciate the variety of techniques associated with EMC errors elimination in capital preservation.

### Trade Repair and Portfolio Repair

Within this disclosure, “trade repair” and “portfolio repair” may be utilized to describe the unique methods, using various components of the multidimensional risk analysis systems 100, in which a trader or user skilled in the art may repair a particular trade for a given market vehicle or may repair a portfolio, containing various amounts of Market Vehicles, in order to possibly reduce losses, lead to possible breakeven, or in some instances possible gains, although it should be considered that not all trades may be 100% repairable.

With traditional methods in normal trading, traders most likely incur losses when they use stop losses. The possibility of taking losses when such losses cannot be tolerated, and they can possibly be forced to exit or liquidate due to possible margin calls. It should further understood by a trader or user skilled in the art that the possible identification of the various risk dimensions, which according to the multidimensional risk analysis systems 100 are eight risk dimensions, may serve as an important factor in repairing a particular trade or portfolio along with the use of several proprietary methods. Certain embodiments of the multidimensional risk analysis systems 100, as described with respect to FIGS. 1 and 2, may be utilized with risk recognition, risk assessment and multi-confirmation in order to possibly reduce losses in comparison to those losses experienced by traditional methods and for those possible trades which may be beyond normal tolerance limits, in such where accepting partial losses may result in a better repair situation.

A trader or user skilled in the art should understand that while conducting trade repairs or portfolio repairs with respect to either bullish, bearish or controversial trades, such trader or user should use, including but not limiting scope to, components from the User's Manual, Trend Health Risk, modified trend health, spectrum of colored candlesticks, and various methods and its applications within trading. Those skilled in the art will now appreciate that there may be a variety of techniques and methods associated with trade repair and portfolio repair.

### Bearish Trade Repair and Risk Recognition

A reasonable trader or user should understand that bearish trade repairs can be as such when a trader or user had taken a bearish position (short position) within a market vehicle and such as which the market travels in the opposite direction, thereupon causing such trader or user to desire to preserve capital and control/reduce trading losses and possibly breakeven or possibly gain from such trade with the possible use of the User's Manual. There may be various favorable bearish risk recognition factors that may be considered in bearish trade repairs, such as, but not limiting scope to: the dynamic zone line curling or shifting of levels, in which the upper most zone line may remain steady and the lower most zone line and/or other zone lines can be shifting up from the bottom; super bullish belief contra +re1 (Mc) 2160 (FIGS. 13 and 14) setup possibly occurs in the 1 minute, 15 minutes or 60 minutes time frames; golden bearish candle 1420 (FIG. 6) or golden bearish candle +; completed or half of bear entry spike 1880 (FIGS. 3, 4, 7, 11, 15, 17, etc.); at least one or preferably two pink (C) bearish candles 1445 (FIG. 9); super bullish belief contra +re 2200 (FIGS. 9, 14, 17 and 18), super bullish belief contra +re1 2205 (FIG. 13), or super bullish belief contra +re2, possibly occurring in the 1 minute, 15 minutes or 60 minutes time frames; black neutral candle 1460 (FIGS. 6, 9, 10, and 12) or modified neutral time segment 1151 (FIGS. 4, 6, 10, and 17) possibly occurring in the 1 minute, 15 minutes or 60 minutes time frames; stable hybrid dynamic horizontal zone lines 1006; Hybrid Parallelism; values of upper most Boundary Lines 1230 (FIG. 5) within modified magic health indicator 1216 (FIG. 5) around +6 or more; continuation Spikes; directional line-bear 2060 (FIGS. 5, 7, and 9); bear spot risk line 1695 (FIGS. 11 and 18); and/or, magic: out 2330 (FIG. 6).

One embodiment of bearish trade repair and risk recognition may be referred to as bearish trade repair procedure. It should be understood by a trader or user skilled in the art that during the possible reduction of market vehicle prices, bearish trade repairs may require a trader or user to recognize any of the bearish risk recognition factors and possibly utilize them according to their strength. A trader or user skilled in the art may further utilize the vertical distance between the nearest zone lines 1015 (FIGS. 3, 14, and 16), and may use Sudden Market Spot Change Risk (also known as internal market moving risk) 215 (FIG. 2) such as, but not limiting scope to, golden bearish candle 1420 (FIG. 6), golden bearish candle +, etc., and may add additional amounts of the same market vehicle according to tables 4100 (FIG. 23) and 4200 (FIG. 24). A trader or user should fill out all required information or user feed information 3501 and such information from the multidimensional risk analysis systems 100 for required high daily zone levels 3580. It may be assumed by a trader or user that the values displayed within table 4100 (FIG. 23) are the trader or user's information and have been provided for example purposes.

With respect to FIGS. 23 and 24, one embodiment of bearish trade repair and risk recognition may be referred to as bearish trade repair checklist and repair steps, as such may be understood with the following example:

(a) A trader or user supposedly has a $5.00 loss within a particular trade and he/she would like to repair it. Such trader or user can check the per trade capital loss allowed 3675 within table 4200 (FIG. 24), which allows a maximum value of $45.00 per day, in which produces acceptable results, of which trader or user can have programmed to be checked automatically;

(b) A trader or user should check as to whether the differential between the current market vehicle prices are the upper most zone line within 15 minute time frame is not more than 63.89 pips, as per the maximum allowable pip movements or price change 3715 within table 4200 (FIG. 24). If such differential is discovered to be more than 63.89 pips, it may become more difficult for the trader or user to repair such trade within a short period of time. A possible solution for such problem may be for the trader or user to control the amount of lots and possibly, at the Hybrid Dynamic Zone Lines on the 1 minute, add additional lots. It may be preferable to skip and await stronger favorable bearish risk recognition factors, such as, but not limiting scope to, directional line-bear and for modified dynamic strength risk indicator to be around +6;

(c) A trader to user possibly observes that the average open price to current security price differential limit 3710 within table 4200 (FIG. 24) is 12 pips, which produces unacceptable results. Such trader or user should bring the differential close to 6.35 as shown in table 4200 (FIG. 24). A possible solution may be that the trader or user add additional lots near upper zone levels in the 1 minute charts, in conjunction with additional favorable bearish risk recognition factors;

(d) A trader or user should check the account opening balance at a broker before trade repairs 3703, which in such example provided, is $2800.00. A possible goal is to increase such value to more than and preferably above $2805.00 with the use of trade-repair techniques;

(e) As assumed in such example, a trader or user may have a total of 10 open contracts at the time of repair. When taking such amount and comparing it to maximum allowed contracts or open trades limit at any given time with breakeven analysis 3720, within table 4200 (FIG. 24), it may provide the trader or user as to whether he/she is within the maximum amount of allowed contracts. Such trader or has a used margin of $145.80 according to current margin used from broker 3550 and allowed to add a maximum of 59 lots according to number of lots take out or in 3785. Such trader or user may be considered to have safe trading parameters 3700. He/she is also well within the limits of maximum allowed contracts or open trades limit at any given time with breakeven analysis 3720 as such trader or user has only 10 contracts when the maximum is 71;

(f) It may be observed by a trader or user that the total maximum allowed “used margin” limits are $1078.80, with the possibility of breakeven, and that current used margin from broker 3550 is $145.80, which may be concluded as $145.80 being less than $1078.80, thereupon appears possible to add additional lots; and

(g) A trader or user should compare the account opening balance at a broker before trade repairs 3703 to the current equity falling limit 3740, which is $2800.00 and $2594.50, respectively. Thereupon, it appears that there is an additional equity of $205.50.

With further respect to FIGS. 23 and 24, a trader or user skilled in the art should understand that the observance of turquoise PH lines should serve as an indication to not add additional lots at the upper most zone line until the possible appearance of a third pink ext bear warning line, until the upper most zone line possibly becomes parallel to the other zone lines, until the possible appearance of earlier highs +3.5/earlier highs +3.6, or the appearance of directional line-bear. It may be further understood that the concepts of, including but not limiting scope to, Hybrid Parallelism, Halved Hybrid Nozzlelism, and confluence in Hybrid Dynamic Zone Lines and Halved Hybrid Nozzlelism may be applied to bearish trade repairs and bearish portfolio repairs. A trader or user may be alerted by all important events as illustrated by a yellow triangle or any trader or user desired colors or shapes. All important events selected by a trader or user can have alerts may be sent via electronic mail, PDA's, or by audio/visual alert on chart during trading. There can be a variety of bearish trade repairs and risk recognition methods, examples and concepts.

### Bullish Trade Repair and Risk Recognition

Certain bullish trade repairs can occur when a trader or user had taken a bullish position (long position) within a market vehicle and such as which the market travels in the opposite direction, thereupon causing such trader or user to desire to preserve capital and control/reduce trading losses and possibly breakeven or possibly gain from such trade with the possible use of the User's Manual. There may be various favorable bullish risk recognition factors that may be considered in bullish trade repairs, such as: the dynamic zone line curling or shifting of levels, in which the lower most zone line may remain steady and the upper most zone line or other zone lines can be dropping from the top; super bearish belief contra −re-, super bearish belief contra −re-1, or super bearish belief contra −re-2; turquoise bullish candle, turquoise bullish candle +, or turquoise bullish candle ++; completed or half of bull entry spike; at least one or preferably two yellow bull warning candle; magic: in super bearish belief contra −re-2(Me) setup possibly occurs in the 1 minute, 15 minutes or 60 minutes time frames; black neutral candle or modified neutral time segment possibly occurring in the 1 minute, 15 minutes or 60 minutes time frames; stable horizontal zone lines; Hybrid Parallelism; values of lower most Boundary Lines within modified magic health indicator around −6 or more; continuation Spikes; bull spot risk line; directional line-bull; and/or gray (C) bullish candle.

A trader or user skilled in the art should understand that all bullish symbols within the User's Manual may be used to recognize bullishness and to possibly do either a trade repair with low risk entries for scalp-swing. Bearish trade repair procedures and bearish trade repair checklist and repair steps may be used for the bullish trade repair and bullish trade repair checklist and repair steps by possibly applying opposite parameters within tables 4100 (FIG. 23) and 4200 (FIG. 24). A trader or user skilled in the art should be aware that tables 4100 (FIG. 23) and 4200 (FIG. 24) should be used in order to properly conduct trade-repair, portfolio repair or perform conservative trading for capital preservation with the multidimensional risk analysis systems 100 based upon EMC error elimination techniques in capital preservation. Hybrid Parallelism, Halved Hybrid Nozzlelism, and confluence in Hybrid Dynamic Zone Lines and Halved Hybrid Nozzlelism concepts may be applied to bullish trade repairs and bullish portfolio repairs. There can be a variety of methods, examples and concepts behind bullish trade repairs and risk recognition.

### Account, Capital Preservation, Trade Repair and Scalp-Swing Trading Risk Control Table 4100 (FIG. 23) and Quick Repair Parameters, Scalp-Swing Trading and Broker Platform Control Table 4200 (FIG. 24)

A trader or user skilled in the art should understand that three major types of trade repair or portfolio repairs or scalp-swing parameters 3400 that can be used for, including but not limiting scope to, trade-repairs, portfolio repairs, or scalp-swing trading. Certain of the three major types of trade repair or portfolio repairs or scalp-swing parameters 3400 can include account information 3500, capital preservation 3600; and trading parameters 3700.

Account information 3500, which may be a trader or user's provided information and some calculated values, and as such comprises of several components (of which can be demonstrated with the examples set forth within tables 4100 (FIG. 23) and 4200 (FIG. 24)), which may be understood by a trader or user skilled in the art when considering the following:
(a) A trader or user may use user feed information 3501, in which such trader or user inputs information into tables 4100 (FIG. 23) and 4200 (FIG. 24), provided on a spreadsheet program such as Microsoft Excel®. Data to be inputted by a trader or user can be visualized as green;
(b) A trader or user may observe that the information from magic trader software 3502 is displayed as bright green;
(c) It may be understood that the maximum account size allowed 3503 may be calculated by taking the differential between liquid assets in all accounts 3625 and total cash account balance at all brokers 3635;
(d) It should be understood by a trader or user skilled in the art that Account Size Adequacy 3504 may be automatically checked and deemed either “Adequate”, when account size at broker for a trader 3505 is less than maximum account size allowed 3503 and “Inadequate” when maximum account size allowed 3503 is greater than account size at broker for a trader 3505;
(e) A trader or user may understand that account size at broker for a trader 3505 illustrates a trader or user's current account balance;
(f) With given respect to table 4100 (FIG. 23) and for example purposes, account size corrected for breakeven 3506 has a value of $2385.64 and such calculation may be determined with reference to table 4005 (FIG. 22);
(g) It may be understood that 15 m two nearest upper zone lines 3507 should be close to select market vehicle to trade 3510, with respect to bearish trade repair 3310:
(h) A trader or user skilled in the art may understand that the pip difference between two nearest zone lines 3508 takes into consideration zone lines and to select market vehicle to trade 3510:
(i) It should be understood that the high of pip differential for upper zone lines (bearish repair/scalp-swing) in the pip difference between two nearest zone lines 3508 can be based upon the 15 m two nearest upper zone lines 3507:
(j) As per the example aforementioned, it may be understood that the select market vehicle to trade 3510 is EUR/USD;
(k) It may be understood that 15 m two nearest lower zone lines 3511 should be close to select market vehicle to trade 3510, with respect to bullish trade repair 3305;
(l) The high of pip differential for lower zone lines (bullish repair/scalp-swing) in the pip difference between two nearest zone lines 3508 can be based upon the 15 m two nearest lower zone lines 3511:
(m) A trader or user skilled in the art may understand that the contingency amount for max loss for a particular account 3525, as per the trader's selection, can be for example 10% to 30%. Within table 4100 (FIG. 23), for example purposes, it may be observed that a value of 17% was provided;
(n) A trader or user may understand that the selection of leverage 3530, can vary according to current rules and regulations and on the select market vehicle to trade 3510:
(o) It can be understood that contract size 3540 can be different according to what a trader or user may select from the broker. In such understanding, a value of $1000 was selected for example purposes;
(p) It can be further understood that reduced margin factor user selection from what broker offers 3515 can be part of capital preservation;
(q) A trader or user skilled in the art should understand that margin used per contract 3545 may depend on what market vehicle is selected, as such within table 4100 (FIG. 23) may be either calculated or provided by a broker.
(r) It may be understood by a trader or user that current margin used from broker 3550 can depend on a trader or user's activity and may vary depending upon the amount of lots/contracts use, as such may be obtained from a broker platform;
(s) Possible values of maximum margin available 3560 may be calculated from account size at broker for a trader 3505 and margin used per contract 3545;
(t) It may be understood that equity is the current equity, which may include current profits/losses of any open positions, and can be provided on the broker platform. It should be further understood that equity 3555 should not fall below equity WIBE limit 3740, with breakeven analysis, stated as such in item “10” in table 4200 (FIG. 24). It should be also further understood that equity 3555 should not fall below equity WOBE limit 3745, without breakeven analysis, stated as such in item “11” in table 4200 (FIG. 24);
(u) A trader or user skilled in the art should understand that the maximum number of contracts can be traded 3565 may be calculated using the quotient of augmentation of account size at broker for a trader 3505 and selection of leverage 3530 and augmentation of select market vehicle to trade 3510 and reduced margin factor user selection from what broker offers 3515 and its relation with contract size 3540. As such may be corrected for breakeven analysis with the use of high daily zone levels 3580 or low daily zone levels 3581 and the corrected high daily zone levels 3580 and low daily zone levels 3581 (define) without breakeven analysis. It should be further understood that there can be various types of maximum number of contracts can be traded 3565, such as, but not limiting scope to, maximum number of contracts based on reduced margin factor 3566, maximum number of contracts based on reduced margin factor and breakeven 3567, maximum number of contracts based on highest zone level with breakeven analysis, maximum number of contracts based on lowest zone level with breakeven analysis 3569, maximum number of contracts based on highest zone level without breakeven analysis and maximum number of contracts based on lowest zone level 1 without breakeven analysis;
(v) It may be understood that, with respect to the examples aforementioned, in table 4100 (FIG. 23), the maximum number of contracts based on reduced margin factor 3566 value is 103;
(w) It may be understood that, with respect to the examples aforementioned, in table 4100 (FIG. 23), the maximum number of contracts based on reduced margin factor and breakeven 3567 value is 82;
(x) It may be understood that, with respect to the examples aforementioned, in table 4100 (FIG. 23), the maximum number of contracts based on highest zone level with breakeven analysis, with the use of the upper most zone line and margin factor in table 4100 (FIG. 23) is 79, which are for the daily levels for bears. A trader or user has the choice to use levels from any user desired time frame;
(y) It may be understood that, with respect to the examples aforementioned, in table 4100 (FIG. 23), the maximum number of contracts based on lowest zone level with breakeven analysis, can be determined with the use of lowest zone line and margin factor in table 4100 (FIG. 23). A trader or user has the choice to use levels from any user desired time frame;
(z) It may be understood that, with respect to the examples aforementioned, in table 4100 (FIG. 23), the maximum number of contracts based on highest zone level without breakeven analysis, with the use of the upper most zone line and margin factor without breakeven analysis in table 4100 (FIG. 23), is 99;
(aa) It may be understood that, with respect to the examples aforementioned, in table 4100 (FIG. 23), the maximum number of contracts based on lowest zone level without breakeven analysis, can be determined with the use of the lowest zone line and margin factor without breakeven analysis;
(ab) It may be understood that with respect to the lowest of maximum number of contracts can be traded, the lowest of maximum number of contracts based on reduced margin factor, maximum number of contracts based on reduced margin factor and breakeven, maximum number of contracts based on highest zone level with breakeven analysis and maximum number of contracts based on highest zone level without breakeven analysis may be the maximum number of contracts can be traded 3565;
(ac) It may be understood that, with respect to high daily zone levels 3580 and as stated within the example provided in tables 4100 (FIG. 23) and 4200 (FIG. 24), daily zone lines can be used for bearish trade repair. A trader or user skilled in the art may utilize and possibly select one of the nearest high daily zone levels 3580 for short trade/portfolio repairs and the nearest low daily zone levels or long trade/portfolio repairs, with respect to trade repairs and portfolio repairs and for a trader or user with very tight equity issues. It may be understood by a trader or user skilled in the art that a rule should be followed in the sense that a trader or user may take the three nearest minimum nearest zone levels from the current prices, with respect to 1 minute, 15 minutes and 60 minute time frames. A trader or user may then take maximum zone differentials from the selected three time frame zone levels. A trader or user should understand that the maximum zone differential should be less than the maximum allowable pip movements 3715, with respect to table 4100 (FIG. 23). A trader or user skilled in the art may assume that if he/she selects the upper most zone line that there may be an upward price risk if a user or trader is short in a trade whereas in selecting the lower most zone line there may be a downward price risk if a user or trader is long in a trade. High daily zone levels 3580 may be used for the uppermost zone level when considering a bearish trade repair, which according to the example within tables 4100 (FIG. 23) and 4200 (FIG. 24), is 1.5143. With respect to a bullish trade repair, a trader or user may use 1.2463, as such listed within the aforementioned tables;
(ad) A trader or user skilled in the art may understand that with respect to table 4100 (FIG. 23), that the possible zone distance between zone lines, with such aforementioned examples, may be 574, 450, 317, 386, and 636;
(ae) It may be understood by a trader or user skilled in the art that the corrected results for breakeven analysis for zone levels used 3585, with respect to the examples provided in tables 4100 (FIG. 23), table 4200 (FIG. 24), and table 4005 (FIG. 22) may be used as a possible reference in order to calculate values such as $2385.54 and maximum number of contracts can be traded 3565;
(af) It may be understood by a trader or user skilled in the art that with respect to the results with current high zone lines (daily) 3590, values of, but not limiting scope to, account size at broker for a trader 3505, selection of leverage 3530, reduced margin factor user selection from what broker offers 3515, and contract size 3540 may remain in the column user feed info in color 3596 and may be considered user feed information 3501. Within such example, a trader or user may be bearish and the trade went in the bullish direction, of which, the value of the chosen market vehicle, EURUSD, is the highest price of high daily zone levels 3580. A trader or user skilled in the art may understand that the value of margin used per contract 3545 may be explained as to how it may be derived in maximum number of contracts can be traded 3565 it may be further understood that margin used per contract 3545 may be adjusted according to the selected market vehicle to trade 3510, in this case is EURUSD, for the value of 1.5143;
(ag) It may be understood by a trader or user skilled in the art with respect to the results with results with current low zone lines (daily) 3595, the column highest price of high daily zone levels 3580 and possibly insert the lowest price if 1.2463, in the possibility that a trader or user skilled in the art went bullish and market vehicle prices keep dropping. A trader or user skilled in the art may understand that the value of margin used per contract 3545 may be adjusted for 1.2463; and
(ai) It may be understood by a trader or user skilled in the art that factors such as, but not limiting scope to, account size at broker for a trader 3505, maximum account size allowed 3503, contingency amount for max loss for a particular account 3525, and maximum number of contracts can be traded 3565 may be adjusted in user feed info in color 3596 by possibly using the breakeven analysis within table 4005 (FIG. 22). It may be further understood that the calculation methods of such factors such as, but not limiting scope to, account size at broker for a trader 3505, maximum account size allowed 3503, contingency amount for max loss for a particular account 3525, and maximum number of contracts can be traded 3565 can be seen in their respective explanations for account information 3500 “a-ag”.

With respect to FIGS. 23 and 24, capital preservation parameters 3600, which may take a trader or user's input and breakeven analysis can be used, which may incorporate exponential accumulation of losses with the use of EMC error elimination technique in capital preservation, and which may reduce the parabolic effect as seen in table 4005 (FIG. 22). Several components, of which may be subject to breakeven analysis 3290, and to user feed information 3501, before the possible commencement of breakeven analysis results, may be demonstrated with the examples set forth within tables 4100 (FIG. 23) and 4200 (FIG. 24), may be understood by a trader or user skilled in the art as per and including the following:
(a) A trader or user skilled in the art may understand that the capital preservation parameters list 3601, may include, but not limiting scope to, what trader can afford to lose per day 3605, what trader can afford to lose per week 3610, how many weeks in a row trader can afford to lose 3615, reduced margin trader satisfied 3620, liquid assets in all accounts 3625, how much a trader can afford to lose of liquid assets 3630, contingency amount for max loss for a particular account 3665, and percentage tolerance per trade 3670. It may also include the calculated factors such as, but not limiting scope to, asset tolerance ratio 3655, asset tolerance check 3660, per trade capital loss allowed 3675, and weeks to break 3640;
(b) It may be understood by a trader or user skilled in the art that the actual value of capital preservation parameters 3602 can include user feed information 3501, but not limiting scope to, what trader can afford to lose per day 3605, what trader can afford to lose per week 3610, how many weeks in a row trader can afford to lose 3615, reduced margin trader satisfied 3620, liquid assets in all accounts 3625, how much a trader can afford to lose of liquid assets 3630, contingency amount for max loss for a particular account 3665, and percentage tolerance per trade 3670. It may also include the calculated factors such as, but not limiting scope to, asset tolerance ratio 3655, asset tolerance check 3660, per trade capital loss allowed 3675, and weeks to break 3640, of which a trader or user skilled in the art may read upon within the capital preservation parameters 3600 points “a-1”;
(c) A trader or user skilled in the art may understand that with respect to percentage equity values of capital preservation parameters 3603, may involve comparing the actual account size at broker for a trader 3505 for items such as, but not limiting scope to, what trader can afford to lose per day 3605, what trader can afford to lose per week 3610, how many weeks in a row trader can afford to lose 3615, reduced margin trader satisfied 3620, liquid assets in all accounts 3625, how much a trader can afford to lose of liquid assets 3630, asset tolerance check 3660, contingency amount for max loss for a particular account 3665 and weeks to break 3640. It may be observed that the value of what trader can afford to lose per day 3605, within column percentage equity values of capital preservation parameters 3603 may, for example purposes, equal 0.50% ((15/3000)*100);
(d) With continued respect to FIGS. 23 and 24 it may be understood by a trader or user skilled in the art that with respect to breakeven values of equity percentage of capital preservation parameters 3604, values of items such as, but not limiting scope to, what trader can afford to lose per day 3605, what trader can afford to lose per week 3610, how many weeks in a row trader can afford to lose 3615, how much a trader can afford to lose of liquid assets 3630, asset tolerance check 3660, contingency amount for max loss for a particular account 3665 and weeks to break 3640, may be calculated in the same way as calculated within table 4005 (FIG. 22) and such respective items within column of percentage equity values of capital preservation parameters 3603. Such values within breakeven values of equity percentage of capital preservation parameters 3604 can be the basis for breakeven analysis values of actual capital preservation parameters 3695;
(e) A trader or user understood by a trader or user skilled in the art, with respect to breakeven analysis values of actual capital preservation parameters 3695, may provide the values of each of the items within the breakeven analysis in table 4100 (FIG. 23), under capital preservation 3600, the possible use of breakeven values of equity percentage of capital preservation parameters 3604, as a potential basis of calculating items such as what trader can afford to lose per day 3605, what trader can afford to lose per week 3610, how many weeks in a row trader can afford to lose 3615, reduced margin trader satisfied 3620, liquid assets in all accounts 3625, how much a trader can afford to lose of liquid assets 3630, asset tolerance check 3660, contingency amount for max loss for a particular account 3665 and weeks to break 3640. A trader or user skilled in the art may calculate the values in the same manner as done in table 4005 (FIG. 22) with respective items within column breakeven values of equity percentage of capital preservation parameters 3604. For instance, a trader or user may skilled in the art may understand that the weeks to break 3640 within breakeven analysis values of actual capital preservation parameters 3695 may be calculated in the following respect: ((5000*25)/100) which is equivalent to $1250. As such, it may be observed that $1250 can replace how much a trader can afford to lose of liquid assets 3630 within column actual value of capital preservation parameters 3602, which can be observed as $1000. It should be further understood by a trader or user skilled in the art that according to the EMC error theory, such calculations should be taken into consideration, even possibly before trading. As such, this logic may be applied to all items such as, but not limiting scope to, what trader can afford to lose per day 3605, what trader can afford to lose per week 3610, how many weeks in a row trader can afford to lose 3615, reduced margin trader satisfied 3620, liquid assets in all accounts 3625, how much a trader can afford to lose of liquid assets 3630, asset tolerance check 3660, contingency amount for max loss for a particular account 3665 and weeks to break 3640;
(f) It may be understood by a trader or user skilled in the art that what trader can afford to lose per day 3605, can be understood by a scenario in which a trader or user starts to drop currency bills into the street with no promise of retrieving any of those dropped bills, starting with $5, $10, $15, etc and should continue to drop such currency bills until the trader or user can no longer tolerate or no longer drop anymore bills. As such should be done for at least 5 days and thereupon, the average of such last five days may be considered what a trader or user can afford to lose per day;
(g) With continued respect to FIGS. 23 and 24, a trader or user skilled in the art may understand that what trader can afford to lose per week 3610, may be understood by a similar scenario as what trader can afford to lose per day 3605, but only for several weeks. Such average of the amount dropped in all of the weeks may be referred to as what a trader or user can afford to lose per week;
(h) It may be further understood by a trader or user skilled in the art that how many weeks in a row trader can afford to lose 3615, can be understood with reference to what a trader can afford to lose per week 3610, taking into account a possible consecutive number of weeks, of which thereupon may be referred to as weeks in a row trader or user can afford to lose;
(i) A trader or user skilled in the art may understand that the liquid assets in all accounts 3625, should only include liquid cash within such trader or user's bank accounts and CDs. It should be further understood that the value of stock certificates, mutual funds, etc may not be included as they are considered to be vehicles that may lose value possibly overnight. The basis of such calculations, as a capital preservation method, may include the liquid money within a bank minus at least two months worth of day to day expenses;
(j) A trader or user skilled in the art may understand that how much a trader can afford to lose of liquid assets 3630 can be user provided information 3501. It may be further understood that if a trader or user had a possible previous highest trading loss within a day or a possible biggest loss of any asset, it may be used as a reference;
(k) It may be understood by a trader or user skilled in the art that calculation of contingency amount for max loss for a particular account 3665 may possibly be done with the ratio of account size at broker for a trader 3505 and contingency amount for max loss for a particular account 3525. A trader or user skilled in the art may should understand that he/she should stop trading once such trading losses have reached this calculated limit and possibly continue with paper trading. It may be further understood that such value should be less than how much a trader can afford to lose of liquid assets 3630. It should be observed by a trader or user skilled in the art that contingency amount for max loss for a particular account 3665 does not include breakeven analysis conducted for actual value of capital preservation parameters 3602. However, it may be understood by a trader or user skilled in the art that values in column breakeven analysis values of actual capital preservation parameters 3695 may include breakeven analysis adjusted for errors; and
(l) a trader or user skilled in the art may understand that with respect to contingency amount for max loss for a particular account 3665 without breakeven analysis, the number of weeks to reach or break or exceed contingency amount for max loss for a particular account 3665 within column actual value of capital preservation parameters 3602 may be calculated using the possible ratio of contingency amount for max loss for a particular account 3665 and what trader can afford to lose per week 3610 and such calculated value should be approximately equal to how many weeks in a row trader can afford to lose 3615. Should how many weeks in a row trader can afford to lose 3615 exceed weeks to break 3640, the trader or user may be considered to be over-aggressive and should consider slowing down with his/her trading. It should be further understood that a conservative trader or user should use the values of how many weeks in a row trader can afford to lose 3615 on the basis of breakeven analysis values of actual capital preservation parameters 3695, with breakeven analysis, as illustrated in table 4100 (FIG. 23) under capital preservation parameters 3600. As such displayed within table 4100 (FIG. 23), the value of 3.48 weeks, taking into consideration the adjustment of EMC errors using breakeven analysis, possibly allowed the trader to stop losing money in 3.48 weeks instead of in 4.85 weeks, which the latter may have occurred with the possible user of traditional methods without breakeven analysis and its adjustments and possibly even his own test of 4 weeks as illustrated within the column actual value of capital preservation parameters 3602.

With respect to FIGS. 23 and 24, it should be understood by a trader or user skilled in the art that there are certain capital preservation parameters that may not go under breakeven analysis, but can however be applied to the following:
i. The percentage tolerance per trade 3670 may be understood by a trader or user skilled in the art to be as, the possible decision as to how much percentage of losses of the account size, such trader or user may be willing to take per trade. Typically, such value may be 1.5% maximum, although it may vary;
ii. It may be understood by a trader or user skilled in the art that with respect to reduced margin the trader is satisfied with 3620, with further respect to capital preservation, a trader or user should not user the maximum percentage of margin offered by a broker. As illustrated within table 4005 (FIG. 22), it may be observed that when 50% margin is possibly used, with respect to account percent equity loss or percent margin used 4011, the amount of required replacement would be 100%, due to the parabolic curve effect due to exponential replacement values percentage equity required 4014. It may be further evident, as stated within replacement/breakeven percent required 4012, that the replacement amounts may be extraordinary; and
iii. A trader or user skilled in the art should understand that the total cash account balance at all brokers 3635, can be the sum of broker one account balance 3636, broker two account balance 3637, and broker three account balance 3638, which are considered to be cash balances at such brokers, with the exception of the current broker account size 3505. It should be taken into account that the total cash account balance at all brokers 3635, as previously mentioned, may include additional brokers. A trader or user skilled in the art should avoid using the values of stocks, ETFs, options within the calculations and as a measure of capital preservation.

With respect to FIGS. 23 and 24, it should be further understood by a trader or user skilled in the art that there are certain capital preservation checklists that should be calculated separately:
i. A trader or user skilled in the art should understand that the calculation of asset tolerance ratio 3655 may be derived using the ratio of how much a trader can afford to lose of liquid assets 3630 and liquid assets in all accounts 3625 and such calculated value should not be more than 25% or any other value of a trader or user's choice;
ii. A trader or user skilled in the art should understand that the calculation of asset tolerance check 3660 may be derived using account size at broker for a trader 3505 and current equity falling limit (equity WIBE limit) 3740. Such differential should not be more than how much a trader can afford to lose of liquid assets 3630, which is possibly subject to breakeven analysis as illustrated within the column breakeven analysis values of actual capital preservation parameters 3695; and
iii. It should be understood by a trader or user skilled in the art that the calculation of per trade capital loss allowed 3675 may be derived from the possible multiplication of account size at broker for a trader 3505 and percentage tolerance per trade 3670.

A trader or user skilled in the art that it is possible to use capital preservation parameters without breakeven analysis, but should be aware that doing so may result in higher risks in trading as well as the possible production of inferior trade repairs or portfolio repairs. Trading parameters 3700, which may include the risk control table and broker platform, and as such comprises of several components (of which can be demonstrated with the examples set forth within tables 4100 (FIG. 23) and 4200 (FIG. 24)), which may be understood by a trader or user skilled in the art as per and including the following:
(1) A trader or user may understand that there are a few items may be included within the trading parameters 3701: maximum allowed contracts or open trades limit at any given time with breakeven analysis 3720; maximum allowed contracts or maximum allowed open trades without breakeven analysis 3725; total maximum allowed “used margin” limit with breakeven analysis 3730; total maximum allowed “used margin” limit without breakeven analysis 3735; current equity falling limit (equity WIBE limit) 3740; current equity falling limit (equity WOBE limit) 3745; number of lots take out or in 3785; average open price to current security price differential limit 3710; maximum allowable pip movements or price change 3715; average open price 3705; current equity loss on current trade 3706; how many contracts open currently 3707; and account opening balance at a broker before trade repairs;
(2) A trader or user should understand that those parameters aforementioned have numerical values, which may be referred to as trading parameter values 3702. It may be further understood that there are 13 parameters that may be applicable to, but not limiting scope to, trade repair, portfolio repair or scalp-swing;
(3) With respect to table 4200 (FIG. 24), the account opening balance at a broker before trade repair 3703 may be observed in item 5 of such table;
(4) With respect to table 4200 (FIG. 24), the average open price 3705 may be obtained from the broker platform and may depend on a trader or user's activity, and may be observed in item 4 of such table;
(5) A trader or user should understand that the current equity loss on the current trade 3706 may be found within the broker platform and such user information 3501 is needed;
(6) A trader or user should understand that how many contracts open currently 3707 may be found in the broker platform and such user information 3501 is needed;
(7) With respect to table 4200 (FIG. 24), a trader or user should understand that the average open price to current security price differential limit 3710 can vary for all traders or users, as such may be seen in item 2 within this table. Such information may be calculated based upon the possible ratio of per trade capital loss allowed 3675 and maximum allowed contracts or open trades limit at any given time with breakeven analysis 3720 along with the possible use of a multiplier of a trader or user's choice;
(8) It may be further understood with respect to table 4200 (FIG. 24) that the maximum allowable pip movements or price change 3715 may be the differential of account size at broker for a trader 3505 and equity falling limit (equity WIBE limit) 3740 along with the ratio of average open price to current security price differential limit 3710;
(9) A trader or user should understand that the value of the maximum allowed contracts or maximum allowed open trades limit with breakeven analysis 3720 should be the limit that the open trades 3271 should not exceed, as illustrated with respect to item 6 within table 4200 (FIG. 24). The maximum allowed contracts or maximum allowed open trades limit with breakeven analysis 3720 may be calculated by taking a possible minimum for the maximum number of contracts can be traded 3565 and consider a factor of safety, such as for example 20;
(10) A trader or user should understand that the value of the maximum allowed contracts or maximum allowed open trades limit without breakeven analysis 3725 should be the limit that the open trades 3271 should not exceed, as illustrated with respect to item 7 within table 4200 (FIG. 24). The maximum allowed contracts or maximum allowed open trades limit without breakeven analysis 3725 may be calculated by taking a possible minimum for the maximum number of contracts can be traded 3565 without breakeven analysis and consider a factor of safety, such as for example 20. A trader or user skilled in the art may do calculations similar to the maximum number of contracts can be traded 3565 but may need to still consider contingency amount for max loss for a particular account 3525 into the calculation;
(11) With respect to item 8 in table 4200 (FIG. 24), a trader or user may understand that the total maximum allowed “used margin” limit with breakeven analysis 3730 may be calculated with the possible augmentation of margin used per contract 3545 and the maximum allowed contracts or maximum allowed open trades limit with breakeven analysis 3270;
(12) With respect to item 9 in table 4200 (FIG. 24), a trader or user may understand that the total maximum allowed “used margin” limit without breakeven analysis 3735 may be calculated with the possible augmentation of margin used per contract 3545 and the maximum allowed contracts or maximum allowed open trades limit without breakeven analysis 3275;
(13) With respect to item 10 in table 4200 (FIG. 24), the current equity falling limit (also known as equity WIBE limit” 3740, it may be understood by a trader or user skilled in the art that equity (also may be referred to as current equity) 3555 should not fall below a certain limit in order to possibly conserve capital, possibly based upon breakeven analysis, as such thereupon may be calculated by a rectified adjusted account size for contingency for maximum loss percentage 3755 adjoining equity error without breakeven analysis 3760 or possibly using corrected account size for breakeven analysis 3750 and equity error without breakeven analysis 3760. Typically, it may be understood by a trader or user skilled in the art that, current equity falling limit (equity WOBE limit) 3745 should be lower than current equity falling limit (equity WIBE limit) 3740, which can serve as an indication to a trader or user that such trader or user should stop trading before the possible loss of more money, which may be illustrated using, current equity falling limit (equity WOBE limit) 3745. This may help to preserve more capital and can be done earlier in comparison to traditional methods;
(14) With respect to item 11 in table 4200 (FIG. 24), the current equity falling limit (also known as equity WIBE limit” 3740, it may be understood by a trader or user skilled in the art that equity (also may be referred to as current equity) 3555 should not fall below a certain limit in order to possibly conserve capital, possibly without breakeven analysis, as such thereupon may be calculated by a rectified adjusted account size for contingency for maximum loss percentage 3755 without adjoining equity error without breakeven analysis 3760 or possibly using corrected account size for breakeven analysis 3750 and equity error without breakeven analysis 3760;
(15) It may be understood by a trader or user skilled in the art that used margin error without breakeven 3765 can be the difference between total maximum allowed “used margin” limit without breakeven analysis 3735 and total maximum allowed “used margin” limit with breakeven analysis 3730;
(16) It may be understood by a trader or user skilled in the art that the maximum allowed contract error without breakeven 3770 can be the difference between that maximum allowed contracts or maximum allowed open trades without breakeven analysis 3725 and maximum allowed contracts or open trades limit at any given time with breakeven analysis 3720;
(17) A trader or user skilled in the art should understand that notes for trading parameters and EMC errors 3775 should provide the names of the EMC errors, such as three main errors, maximum allowed contract error without breakeven 3770, used margin error without breakeven 3765, and equity error without breakeven analysis 3760. As such, it may be further understood that notes with a red color are for maximum allowed contracts or open trades limit at any given time with breakeven analysis 3720, total maximum allowed “used margin” limit with breakeven analysis 3730 and current equity falling limit (equity WIBE limit) 3740;
(18) It should be understood by a trader or user skilled in the art that the values of EMC errors and misc. 3780 can provide the values such as maximum allowed contract error without breakeven 3770, used margin error without breakeven 3765, and equity error without breakeven analysis 3760 for maximum allowed contracts or maximum allowed open trades without breakeven analysis 3725, total maximum allowed “used margin” limit without breakeven analysis 3735, and current equity falling limit (equity WOBE limit) 3745 respectively within the column values of EMC errors and misc. should be 3780. A trader or user skilled in the art should be aware that the less than (“<”) symbol can be used for maximum allowed contracts or open trades limit at any given time with breakeven analysis 3720 and total maximum allowed “used margin” limit with breakeven analysis 3730, whereas the greater than (“>”) symbol can be used for current equity falling limit (equity WIBE Limit) 3740. This may serve as an indication that the actual value of the equity 3555 should be greater than the values of current equity falling limit (equity WIBE Limit) 3740 as illustrated in trading parameter values 3702 for trade repair, portfolio repair or scalp-swing. As such may be applicable to maximum allowed contracts or open trades limit at any given time with breakeven analysis 3720 and total maximum allowed “used margin” limit with breakeven analysis 3730 for lesser values using possible EMC error values; and
(19) A trader or user skilled in the art should understand that the number or lots to take out or in 3785 can be calculated based upon the current margin used from broker 3550, the total maximum allowed “used margin” limit with breakeven analysis 3730 on a differential basis and divide the previous calculation with margin used per contract 3545 making possible adjustments for the daily highest zone line or daily lowest zone line. The possible concluded value may serve as an indication as to how many contracts that may be required to close a position (red values) or how many lots that may need to be added for trade repair, portfolio repair or scalp-swing. As such, this can be programmed by a trader or user skilled in the art for any market vehicle such as stocks, commodities, ETFs, etc.

FIG. 24 shows one embodiment of an illustrative control table view that is operationally associated with the table illustrated in FIG. 23, showing an illustrative tabular view displaying quick repair parameters, scalp-swing trading, and broker platform control, as may be included within certain embodiments of the multidimensional risk analysis systems 100 of FIGS. 1 and 2. A trader or user skilled in the art may further understand the following factors with respect to tables 4100 (FIG. 23) and 4200 (FIG. 24).
(1) For example purposes, within such tables 4100 (FIG. 23), 4200 (FIG. 24) and 4005 (FIG. 22), a broker platform 4211 may be used, although a trader or user skilled in the art may use any broker platform of their choice. A trader or user may use the trading parameters 3700 and can compare such parameters to his/her broker trading platform;
(2) Table 4200 (FIG. 24) notes 4212 can contain the notes for trading parameters 3700 and possibly notes from the broker platform 4211 applications;
(3) The repair/scalp-swing checklist details and applications 4215 should be strictly followed either before taking a position or before attempting to repair a trade and as a part of capital conservation. The use of breakeven analysis and parameters of those stated within item 4213 should be evaluated properly and a proper conclusion should be made. A trader or user skilled in the art should check for a total of ten items with respect to doing repairs or scalp-swing, such are items 1, 2, 3, 4, 5, 6, 8, 10, 12 and 13 under the column 4213 for table 4200 (FIG. 24) and such respective values under column repair/scalp-swing checklist details and applications 4215;

(4) The average open 3705 may be understood with the example provided in item 4 of column 4213 of table 4200 (FIG. 24). As thus illustrated, item 4 can be observed to have within trading parameter values 3702 of $1.4568. It may be further observed that within column, repair/scalp-swing checklist details and applications 4215 (item 2 within table 4200 (FIG. 24)) has a value of 12 pips, which can be more than the average open price to current security price differential limit 3710 of 6.35. This can serve as an indication to “do a repair”, which may be programmed by a trader or user skilled in the art. If, for example, the values of average open price to current security price differential limit 3710 were possibly less than the values of trading parameter values 3702, it can serve as an indication of “no repairs”, which may be programmed by a trader or user skilled in the art. A trader or user skilled in the art should first make this observation before attempting to do a possible repair;
(5) The average open price to current security price differential limit 3710 can be considered the second most important item within the repair/scalp-swing checklist details and applications 4215. As such, this value should be less than the values within column trading parameter values 3702. It can be further understood that if the values in the repair/scalp-swing checklist details and applications 4215 exceeds trading parameter values 3702, for item 2, a trader or user skilled in the art can consider to repair such trade and reduce the value, possibly closer to the values in trading parameter values 3702;
(6) The current equity loss on current trade 3706, with respect to item 12 within table 4200 (FIG. 24), has a value of $5 within trading parameter values 3702, and may be considered to be third most important item within repair/scalp-swing checklist details and applications 4215. It can be observed that such $5 is within the per trade capital loss allowed 3675 limit, which can be observed as $45.00. As such, it may be programmed to provide a response such as “within per trade limit” as illustrated within item 12 and the column repair/scalp-swing checklist details and applications 4215. It should be further understood that should current equity loss on current trade 3706 exceed per trade capital loss allowed 3675 limit, it may be programmed to provide a response such as “exceeded per trade limit” within the column repair/scalp-swing checklist details and applications 4215. A trader or user skilled in the art should conclude that if he/she is possibly within the per trade limit, they can consider doing a repair, whereas if he/she is not within the per trade limit, such trader or user may consider the removal of some positions/lots to possibly reduce exposure;
(7) With respect to item 1 within table 4200 (FIG. 24), it may be understood by a trader or user skilled in the art that if the value of current equity loss on current trade 3706 is possibly less than the per trade capital loss allowed 3675, it may be referred to as “loss under control” where the opposite may be referred to as “loss out of control”;
(8) A trader or user skilled in the art, with respect to the maximum allowable pip movements or price change 3715, can observe that the limits within trading parameter values 3702 are 63.89 and less than the values in high of pip differential for upper zone lines (bearish repair/scalp-swing) in pip difference between two nearest zone lines 3509, which may be deemed as unacceptable. A trader or user skilled in the art may understand that he/she may take precaution when adding additional lots within a repair until the current prices are possibly between the first and second zone line on 15 minutes, or any other user desired time frame. It should be further understood that a trader or user may not be able to repair a trade 100%;
(9) With respect to the account opening balance before repair 3703, a trader or should understand that the values in trading parameter values 3702 should be more than the values within item 11 of column 4213 of table 4200 (FIG. 24), in order to possibly consider such as acceptable. If the opposite were true, it can be deemed unacceptable, in which the trader may want to consider paper trading. A possible alternative might be that if such trade may be repairable, the trader or user skilled in the art should consider a repair, otherwise may want to consider returning the account opening balance at a broker before trade repairs 3703 to “acceptable”;
(10) With respect to how many contracts currently open 3707, a trader or user skilled in the art may want to review items 1, 2, 3, 4, 5 and 12 in within column 4213 of table 4200 (FIG. 24) when possibly deciding to make a trade and then possibly evaluate how many contracts currently open 3707. It may be observed that if the values in trading parameter values 3702 for how many contracts currently open 3707 is less than the values of maximum allowed contracts or open trades limit at any given time with breakeven analysis 3720 in trading parameter values 3702; it may be programmed by a trader or user skilled in the art to prompt “add lots”, in which a trader or user may add lots to reduce the average open price to current security price differential limit 3710 in repair/scalp-swing checklist details and applications 4215 possibly closer to the values in trading parameter values 3702;
(11) With respect to the max allowed contracts or open trades limit at any given time with breakeven analysis 3720, a trader or user skilled in the art could note that the values within trading parameter values 3702 for how many contracts open currently 3707, is possibly lower than the values of maximum allowed contracts or open trades limit at any given time with breakeven analysis 3720 in trading parameter values 3702, it may be programmed by a trader or user skilled in the art to produce “limits not reached”. It may also be further understood that if the values of how many contracts open currently 3707 is possibly higher than max allowed contracts or open trades limit at any given time with breakeven analysis 3720, it may be programmed by a trader or user skilled in the art to produce “limits reached”. It should be further understood that if the limits are reached, additional lots should not be added or trades should not be repaired. A possible solution may be if a trader or user skilled in the art is possibly bullish, at the next higher zone level, such trader or user may want to reduce some lots to possibly return to “limits not reached” whereas if it was a bearish position, the next lower zone level 1005 may be used;
(12) With respect to the max allowed used margin limit at any given time with breakeven analysis 3730, the values in user feed info in color 3596 for current margin used from broker 3550 is possibly lower than the values of the total maximum allowed “used margin” limit with breakeven analysis 3730 in trading parameter values 3702. It may be programmed by a trader or user to produce “limits not reached”. It should be further understood that if the values of user feed info in color 3596 is possibly higher than the total maximum allowed “used margin” limit with breakeven analysis 3730, it may be programmed by a trader or user skilled in the art to produce “limits reached”. It should be further understood that if the limits are reached, additional lots should not be added or trades should not be repaired. A possible solution may be if a trader or user skilled in the art is possibly bullish, at the next higher zone level, such trader or user may want to reduce some lots to possibly return to “limits not reached” whereas if it was a bearish position, the next lower zone level may be used;
(13) With respect to the WIBE limit at any given time with breakeven analysis 3740, it may be understood that the values in trading parameter values 3702 for account opening balance at a broker before trade repairs 3703 is possibly higher than the values of current equity falling limit (equity WIBE limit) 3740 in trading parameter values 3702, it may be programmed to produce “limits not reached” by a trader or user skilled in the art. It should be further understood that if the values of trading parameter values 3702 is possibly lower than the values of current equity falling limit (equity WIBE limit) 3740, it may be programmed by a trader or user skilled in the art to produce “limits reached”. It should be further understood that if the limits are reached, additional lots should not be added or trades should not be repaired. A possible solution may be if a trader or user skilled in the art is possibly bullish, at the next higher zone level, such trader or user may want to reduce some lots to possibly return to “limits not reached” whereas if it was a bearish position, the next lower zone level 1005 may be used;
(14) With respect to the max allowed contracts or open trades limit at any given time without breakeven analysis 3725, it may be understood that if the value of how many contracts open currently 3707 is prodigious than the values of the max allowed contracts or open trades limit at any given time without breakeven analysis 3725, it may be programmed by a trader or user skilled in the art to produce “limits not reached”. It may also be further understood that if the value of how many contracts open currently 3707 is not prodigious than the values of the max allowed contracts or open trades limit at any given time without breakeven analysis 3725, it may be programmed to produce “limits not reached”. It should be further understood that once a trader or user reaches “limits reached”. Such broker should not add any additional lots or possibly conduct any scalp-swing trades and may consider the possible control of total maximum allowed “used margin” limit with breakeven analysis 3730 and current equity falling limit (equity WIBE limit) 3740. If considering repairs, he/she can consider the reduction of how many contracts open currently until the total maximum allowed “used margin” limit with breakeven analysis 3730 and current equity falling limit (equity WIBE limit) 3740 are possibly under control;
(15) With respect to the max total maximum allowed “used margin” limit without breakeven analysis 3735, it may be understood by a trader or user that if the value of current margin used from broker 3550 is prodigious than the values of the total maximum allowed “used margin” limit without breakeven analysis 3735, it may be programmed by a trader or user skilled in the art to produce “limits not reached”. It may also be further understood that if the value of current margin used from broker 3550 is not prodigious than the values of the total maximum allowed “used margin” limit without breakeven analysis 3735, it may be programmed by a trader or user skilled in the art to produce “limits reached”. It should be further understood that once a trader or user reaches “limits reached”, such trader should not use more maximum allowed “used margin” limit without breakeven analysis 3735 and may consider the possible control current equity falling limit (equity WIBE limit) 3740 and maximum allowed contracts or open trades limit at any given time with breakeven analysis 3720 for possible scalp-swing and trade repairs; and
(16) With respect to the WOBE limit at any given time without breakeven analysis 3745, it may be understood by a trader or user skilled the art that if the value of current equity falling limit (equity WOBE limit) 3745 is prodigious than the values of account opening balance at a broker before trade repairs 3703, it may be programmed by a trader or user skilled in the art to produce “limits not reached”. If the value of current equity falling limit (equity WOBE limit) 3745 is not prodigious than the values of account opening balance at a broker before trade repairs 3703, it may be programmed by a trader or user skilled in the art to produce “limits reached”. It should be further understood that if the limits are reached, additional lots should not use any more of current equity falling limit (equity WOBE limit) 3745 and may consider to possibly control or adjust the total maximum allowed “used margin” limit with breakeven analysis 3730 and maximum allowed contracts or open trades limit at any given time with breakeven analysis 3720 for possible scalp-swing and trade-repairs.

A trader or user skilled in the art should understand that he/she may refer to, but not limiting scope to, the risk transition due to unscheduled and scheduled events, risk transition lines, and hybrid zone risk transfer area for additional risk recognition. It also may be further understood that a trader or user skilled in the art may refer to the User's Manual, and scalp-swing section for the following, but not limiting scope to, risk assessments and risk recognition: forecasting earlier highs with risk assessments; forecasting earlier highs with risk assessment for Halved Hybrid Nozzlelism; forecasting earlier lows with risk assessments; forecasting earlier lows with risk assessments for Halved Hybrid Nozzlelism; super belief bull pin point entries w/risk assessments; super belief bull pin point entries w/risk assessments for Halved Hybrid Nozzlelism; super belief bear pin point entries w/risk assessments; super belief bear pin point entries w/risk assessments for Halved Hybrid Nozzlelism; earlier lows −4.6(Mc)++; earlier lows −4.6(Mc)+; earlier lows −4.6(Mc) and, earlier lows −4.1 Tan(Me)−Oex.

There can be a variety of embodiments of components, parameters, calculations, and examples for risk, account, capital preservation, trade repair and scalp-swing trading control table 4100 (FIG. 23) and quick repair parameters and scalp-swing trading broker platform friendly control table 4200 (FIG. 24). A trader or user may be alerted by all important events as illustrated by a yellow triangle or any trader or user desired colors or shapes. All important events selected by a trader or user can have alerts may be sent via electronic mail, PDA's, or by audio/visual alert on chart during trading. A trader or user skilled in the art may use an explorer or system tester to explore the various parts or components of the multidimensional risk analysis systems 100. A trader or user may refer to the User's Manual within Appendix A of the U.S. Provisional Filing Ser. No. 61/343,120, filed Apr. 23, 2010, entitled “Multidimensional Risk Analysis Systems” for a complete list of symbols, indicators, experts, etc. All Figures within this specification represent, in general, a portion of the multidimensional risk analysis systems 100, however a trader or user may utilize a single or multiple portions of the multidimensional risk analysis systems 100 with trading in financial markets.

### Computer Flow Diagram Description

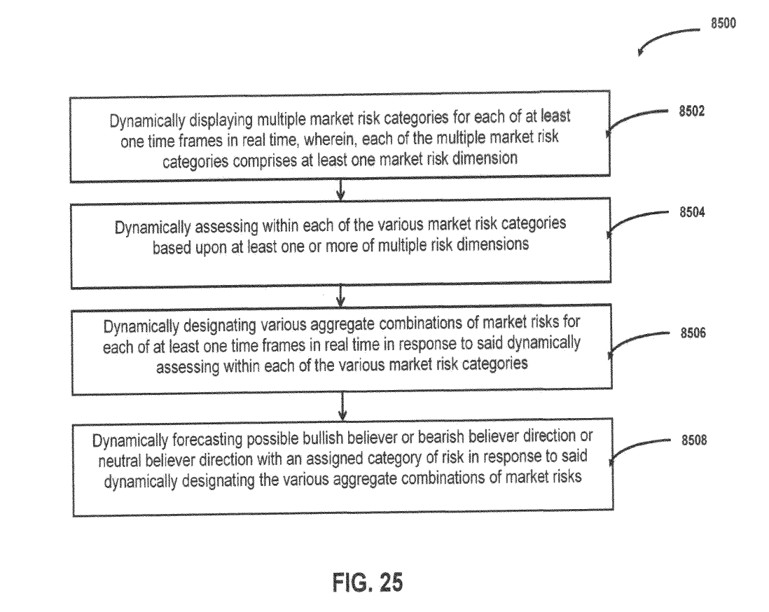

FIGS. 25 to 29 show a number of embodiments of illustrative flow diagrams that can be performed on a number of embodiments of the multidimensional risk analysis systems 100 and thereupon displayed upon a number of displays including: the risk assessment, recognition, confirmation, designation, forecasting or identification display 310; the user display 124; or the peripheral user display 124a. Each of these different flow diagrams are now described in order with respect to FIGS. 25 to 29. It would be expected, therefore, that such embodiments of the multidimensional risk analysis systems and methods can be performed utilizing relatively complex computers or alternately on more simplified or less complex computers such as laptops, stand alone computers, servers, workstations, mainframes, PDAs, etc.

FIG. 25 shows one embodiment showing an illustrative flow diagram displaying one embodiment of a multidimensional risk analysis method 8500 with forecasting capabilities, as may be performed by certain embodiments of the multidimensional risk analysis systems 100 of FIGS. 1 and 2. It would be expected, therefore, that certain embodiments of the multidimensional risk analysis method 8500 can be performed on relatively complex computers or more simplified or less complex computers.

The FIG. 25 embodiment of the multidimensional risk analysis method 8500 performs a dynamically displaying multiple market risk categories for each of at least one time frames step 8502 in real time, wherein each of the multiple market risk categories comprise at least one market risk dimension. For example, as illustrated relative to FIG. 7, certain embodiments of the risk processor 200, the risk assessor 140 and the risk analyzer 150 of FIGS. 1 and 2 can dynamically display multiple risk categories such as by analyzing data, information, symbols, etc. such as can be further displayed on a risk assessment, recognition, confirmation, designation, forecasting or identification display 310; the user display 124; or the peripheral user display 124a.

The FIG. 25 embodiment of the multidimensional risk analysis method 8500 continues with dynamically assessing within each of the multiple market risk categories based upon at least one or more of multiple risk dimensions step 8504 in real time. For example, as illustrated relative to FIG. 7, certain embodiments of the risk processor 200, the risk assessor 140 and the risk analyzer 150 of FIGS. 1 and 2 can dynamically assess within each of the multiple market risk categories to assess data, information, symbols, etc. such as can be displayed on a risk assessment, recognition, confirmation, designation, forecasting or identification display 310; the user display 124; or the peripheral user display 124a.

The FIG. 25 embodiment of a multidimensional risk analysis method 8500 performs a dynamically designating various aggregate combinations of market risks for each of at least one time frames in real time in response to said dynamically assessing within each of the various market risk categories step 8506 in real time. For example, as illustrated relative to FIG. 7, certain embodiments of the risk processor 200, the risk assessor 140 and the risk analyzer 150 of FIGS. 1 and 2 can designate various aggregate combinations of market risks for each of at least one time frame in real time, etc. such as can be displayed on a risk assessment, recognition, confirmation, designation, forecasting or identification display 310; the user display 124; or the peripheral user display 124a.

FIG. 25 shows one embodiment of a dynamically forecasting possible Bullish Believer or Bearish Believer direction or Neutral Believer direction with an assigned category of risk in response to said dynamically designating the various aggregate combinations of market risks step 8508 in real time. For example, as illustrated relative to FIG. 7, certain embodiments of the risk processor 200, the risk assessor 140 and the risk analyzer 150 of FIGS. 1 and 2 can dynamically forecasting possible Bullish Believer or Bearish Believer direction or Neutral Believer direction with an assigned category of risk such as can be displayed on a risk assessment, recognition, confirmation, designation, forecasting or identification display 310; the user display 124; or the peripheral user display 124a.

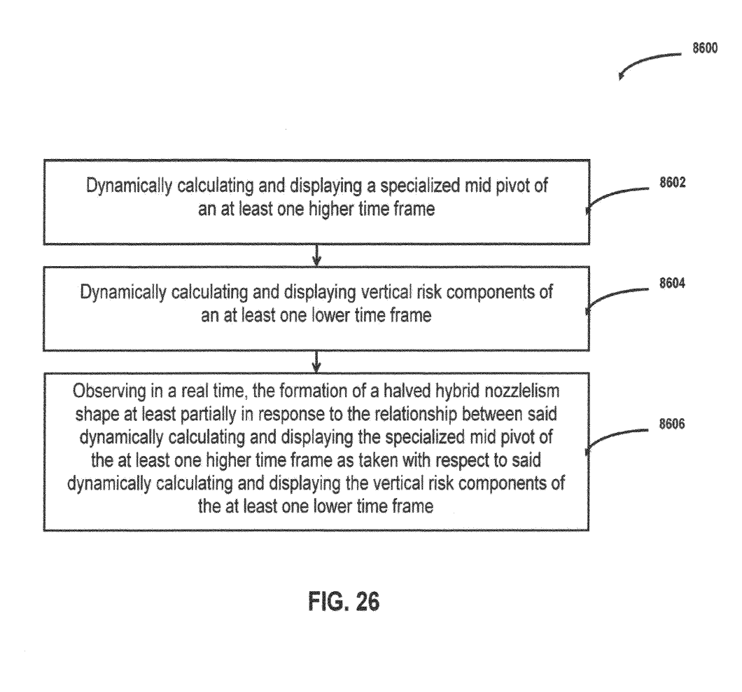

FIG. 26 shows one embodiment showing an illustrative flow diagram displaying a Halved Hybrid Nozzlelism method 8600 with inherent forecasting capabilities, as may be included within certain embodiments of the multidimensional risk analysis systems 100 of FIGS. 1 and 2. It would be expected, therefore, that certain embodiments of the multidimensional risk analysis method 8600 can perform Halved Hybrid Nozzlelism method 8600 with inherent forecasting capabilities on relatively complex computers or more simplified computers.

The Halved Hybrid Nozzlelism method 8600 with inherent forecasting capabilities of FIG. 26 may be performed using certain embodiments of the multidimensional risk analysis systems 100 of FIGS. 1 and 2. For example, as illustrated relative to the illustrative display shown in FIG. 9, certain embodiments of the risk processor 200, the risk assessor 140, and the risk analyzer 150 of FIGS. 1 and 2 at least partially perform the Halved Hybrid Nozzlelism method 8600 comprising dynamically calculating and displaying a specialized mid pivot of an at least one higher time frame step 8602 in real time. FIGS. 1 and 2 can dynamically calculate and display a specialized mid pivot of an at least one higher time frame such as by analyzing data, information, symbols, etc. such as can be further displayed on a risk assessment, recognition, confirmation, designation, forecasting or identification display 310; the user display 124; or the peripheral user display 124a.

The Halved Hybrid Nozzlelism method 8600 with inherent forecasting capabilities of FIG. 26 may be performed using certain embodiments of the multidimensional risk analysis systems 100 of FIGS. 1 and 2. For example, as illustrated relative to the illustrative display shown in FIG. 9, certain embodiments of the risk processor 200, the risk assessor 140, and the risk analyzer 150 of FIGS. 1 and 2 at least partially perform the Halved Hybrid Nozzlelism method 8600 comprising dynamically calculating and displaying vertical risk components of an at least one lower time frame step 8604 in real time. FIGS. 1 and 2 can dynamically calculate and display vertical risk components of an at least one lower time frame such as by analyzing data, information, symbols, etc. such as can be further displayed on a risk assessment, recognition, confirmation, designation, forecasting or identification display 310; the user display 124; or the peripheral user display 124a.

The Halved Hybrid Nozzlelism method 8600 with inherent forecasting capabilities of FIG. 26 may be performed using certain embodiments of the multidimensional risk analysis systems 100 of FIGS. 1 and 2. For example, as illustrated relative to the illustrative display shown in FIG. 9, certain embodiments of the risk processor 200, the risk assessor 140, and the risk analyzer 150 of FIGS. 1 and 2 at least partially perform the Halved Hybrid Nozzlelism method 8600 comprising an observing in a real time, the formation of a Halved Hybrid Nozzlelism shape step 8606 in real time at least partially in response to the relationship between said steps 8602 and 8604 in real time as described in the above two paragraphs. FIGS. 1 and 2 can observing in a real time, the formation of a Halved Hybrid Nozzlelism shape at least partially in response to the relationship between said dynamically calculating and displaying the specialized mid pivot of the at least one higher time frame as taken with respect to said dynamically calculating and displaying the vertical risk components of the at least one lower time frame, such as by analyzing data, information, symbols, etc. such as can be displayed on a risk assessment, recognition, confirmation, designation, forecasting or identification display 310; the user display 124; or the peripheral user display 124a.

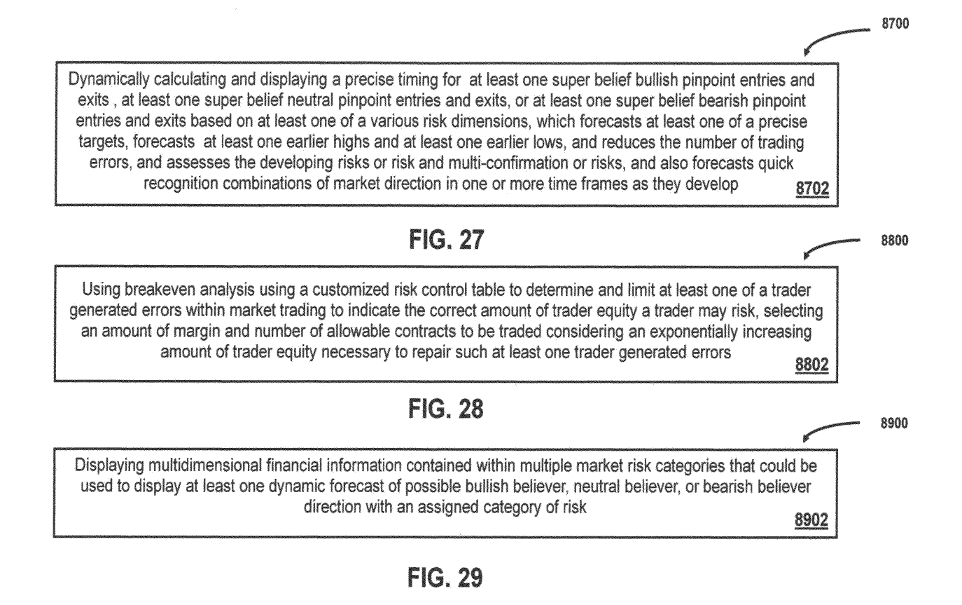

FIG. 27 shows one embodiment of a display, showing an illustrative flow diagram displaying one embodiment of a scalp-swing or mega scalp-swing method 8700 with forecasting capabilities, as may be included within certain embodiments of the multidimensional risk analysis systems 100 of FIGS. 1 and 2. It would be expected, therefore, that certain embodiments of the multidimensional risk analysis method 8700 can be performed on relatively complex computers or more simplified or less complex computers.

The FIG. 27 embodiment of the multidimensional risk analysis method 8700 performs a dynamically calculating and displaying a precise timing for at least one super belief bullish pinpoint entries and exits, at least one super belief neutral pinpoint entries and exits, or at least one super belief bearish pinpoint entries and exits based on at least one of a various risk dimensions, which forecasts at least one of a precise targets step 8702 in real time. Certain embodiments of the step 8702 in real time further can be used to forecast at least one earlier highs and at least one earlier lows, and reduces the number of trading errors, and assess the developing risks or risk and multi-confirmation or risks, and also forecasts quick recognition combinations of market direction in one or more time frames as they develop. For example, as illustrated relative to FIGS. 4, 7, 10, 12, 13, 16, and 21 certain embodiments of the risk processor 200, the risk assessor 140 and the risk analyzer 150 of FIGS. 1 and 2 can dynamically calculate and display a precise timing for at least one super belief bullish pinpoint entries and exits, at least one super belief neutral pinpoint entries and exits, or at least one super belief bearish pinpoint entries and exits based on at least one of a various risk dimensions, which forecasts at least one of a precise targets. This can be performed such as by analyzing data, information, symbols, etc. such as can be further displayed on a risk assessment, recognition, confirmation, designation, forecasting or identification display 310; the user display 124; or the peripheral user display 124a.

FIG. 28 shows one embodiment of a display, showing an illustrative flow diagram displaying one embodiment of a method for using customizable risk control tables 8800, as may be included within certain embodiments of the multidimensional risk analysis systems 100 of FIGS. 1 and 2. It would be expected, therefore, that certain embodiments of the multidimensional risk analysis method 8800 can be performed on relatively complex computers or more simplified or less complex computers.

The FIG. 28 embodiment of the multidimensional risk analysis method 8800 performs a breakeven analysis using a customized risk control table to determine and limit at least one of a trader generated errors within market trading to indicate the correct amount of trader equity a trader may risk step 8802 in real time. Certain embodiments of the step 8802 in real time continue by selecting an amount of margin and number of allowable contracts to be traded considering an exponentially increasing amount of trader equity necessary to repair such at least one trader generated errors. For example, as illustrated relative to FIGS. 22, 23, and 24, certain embodiments of the risk processor 200, the risk assessor 140 and the risk analyzer 150 of FIGS. 1 and 2 can performs a breakeven analysis using a customized risk control table to determine and limit at least one of a trader generated errors within market trading to indicate the correct amount of trader equity a trader may risk such as by analyzing data, information, symbols, etc. such as can be further displayed on a risk assessment, recognition, confirmation, designation, forecasting or identification display 310; the user display 124; or the peripheral user display 124a.

FIG. 29 shows one embodiment showing an illustrative flow diagram displaying one embodiment of a multidimensional risk analysis method 8900 that can be performed using one embodiment of the multidimensional risk analysis systems 100 of FIGS. 1 and 2. It would be expected, therefore, that certain embodiments of the multidimensional risk analysis method 8900 can be performed on relatively complex computers or more simplified or less complex computers.

The FIG. 29 embodiment of the multidimensional risk analysis method 8900 can perform the display of multidimensional financial information contained within multiple market risk categories that could be used to display at least one dynamic forecast of possible Bullish Believer, Neutral Believer, or Bearish Believer direction with an assigned category of risk step 8902 in real time. For example, as illustrated relative to FIGS. 7, 14, and 16, certain embodiments of the risk processor 200, the risk assessor 140 and the risk analyzer 150 of FIGS. 1 and 2 can perform the display of multidimensional financial information contained within multiple market risk categories that could be used to display at least one dynamic forecast of possible Bullish Believer, Neutral Believer, or Bearish Believer direction with an assigned category of risk step 8902 in real time, such as by analyzing data, information, symbols, etc. such as can be further displayed on a risk assessment, recognition, confirmation, designation, forecasting or identification display 310; the user display 124; or the peripheral user display 124a.

### Sequencing of Risks

A trader or user skilled in the art may understand that “sequencing of risks” in multidimensional risk analysis systems may be that in which there is a possible development of multidimensional risks and its subcategories of risks at the same time, either in favor of Bullish Believers, Bearish Believers, or Neutral Believers or at the same time during the transition or exchange between Bullish Believers and Bearish Believers and may be referred to as “sequentizing” or “Sequentized”. An importance should be given to prioritizing and selection of risks and its subcategories of risks and its combinations, in order to possibly create a sequence, which may produce nearly optimal performance in trading. A trader or user skilled in the art may create a sequence, which may provide optimal performance, with the use of software such as Thomson-Reuters Metastock® Pro software, E-Signal®, TradeStation®, or similar financial software. Such financial software may provide system tests and/or experts that may allow for such sequences. Trial and error testing may allow a trader or user skilled in the art to establish a sequence of his/her choice. Various components of the multidimensional risk analysis systems, in part or full, may be combined to create several results as per a trader or user's choice. For illustrative purposes, the following sequence may be used by a trader or user skilled in the art:

1) Earlier Highs with Nozzlelism; 2) Earlier Lows with Nozzlelism; 3) Earlier Highs; Earlier Lows; 4) Super Belief Bull Pin Point Entries; 5) Super Belief Bull Pin Point Entries; 6) Super Bullish Belief Contra; 7) Super Bearish Belief Contra; 8) Top Bear; Bottom Bull; 9) Tan Bearish Candle; 10) Black Neutral Candle; 11) Yellow Candle; 12) Bullish DK Yellow Candle type a; 13) Bullish Bright Green Candle type b; 14) Bullish Green Candle type c; 15) Purple Candle type d; 16) Bearish Brown Candle type e; 17) Bearish Red Candle type f; 18) Gray Bullish Candle; 19) Pink Bearish Candle; 20) Turquoise Bullish Candle; 21) Golden Bearish Candle; 22) Bull Warnings; 23) Bear Warnings; 24) Bull Reversal; 25) Bear Reversal; 26) Magic In; and 27) Magic Out.

A trader or user skilled in the art should understand that the risk designators on a scale of +1 to +6, −1 to −6, +1 to +7, or −1 to −7 or of any user desired choice, may be used in conjunction with Super Belief Bull/Bear Pin Point Entries and Earlier Highs/Lows with or without utilizing Halved Hybrid Nozzlelism.

Upon reading the teachings of this specification, those skilled in the art will now appreciate that, under appropriate circumstances, the concept of sequencing, may suffice.

### DEFINITION OF TERMS

Below are definitions of certain terms used herein.

“Bearish Believeness” is a state of mind with input as provided by certain embodiments of the multidimensional risk analysis systems, which certain Bearish Believers are more likely to exhibit. Such believers are less likely to make poor decisions based on the provided information. With multidimensional risk analysis systems, those financial Market Vehicles that show true promise will likely thereby be supported by increasing purchases and trades, and those that do not will not be as strongly supported. As such, the widespread use of certain embodiments of the multidimensional risk analysis systems will help promote Bearish Believers to stay away from those financial vehicles that traders or users would be least benefitted by Bearish Believeness.

“Bearish Believer Condition” is a condition that may develop in trading when the various components of Trend Health Risk, such as, but not limiting scope to, internal health risk indicator and modified positive/negative indicator, can be aligned below zero Boundary Lines with modified bearish time segment and price perception risk, which are preferably for sections “d”, “e” or “f”. As such may be for trading a market vehicle in any time frame that may comprise of tick to yearly or any combination of time frames.

“Bearish Vertical Lines” may serve as an indication of bearishness within a market vehicle and can possibly be indicated with bearish spot risk lines, warning lines, directional lines, possibly lows, or transition lines. Bearish Vertical Lines may comprise of, but not limiting scope to, bear spot risk lines, pink ext bear warning lines, bear directional line, and gold PL line.

“Believeness” is defined as a situation in which a majority of traders or users trading a particular market vehicle believe that they should either be going in the long (bullish), short (bearish) or are neutral about the market vehicle and as such may be classified as “Bullish Believeness”, “Bearish Believeness” or “Neutral Believeness”, respectively.

“Believers” is defined as a situation when a majority of the traders or users trading a particular market vehicle have the “Believeness” to go trade in either the bullish, bearish, or are neutral about the market vehicle and as such may be classified as “Bullish Believers”, “Bearish Believers”, or “Neutral Believers”, respectively.

“Big Scale Buy Candles” may occur typically after the possible formation of bullish trend change warning candles. It may be observed by traders or users that a trend change and/or order flows may commence. It may be considered to be a low risk bullish entry as bullish belief can be possibly converting to bullish direction. It should be understood that in a bearish trend, the formation of Big Scale Buy Candles would not last as long but within a bullish trend, it may continue the bullish trend. Big Scale Buy Candles may comprise of gray (C) bullish candle.

“Big Scale Sell Candles” may occur typically after the possible formation of bearish trend change warning candle. It may be observed by traders or users that a trend change and/or order flows may commence. It may be considered a low risk bearish entry as bearish belief can be possibly converting to bearish direction. It should be understood that in a bullish trend, the formation of Big Scale Sell Candles would not last as long but within a bearish trend, it may continue the bearish trend. Big Scale Sell Candles may comprise of pink (C) bearish candle.

“Black Candle” may occur when there is a high concentration of Neutral Believers for a particular time frame.

“Blue Line Angle North” is the movement of the Blue Line in an upward direction at an angle, facing north, prior to the time of a scheduled event, on a scale of vertical risk dimensions versus horizontal risk dimensions.

“Blue Line Angle South” is the movement of the Blue Line in a downward direction at an angle, facing south, prior to the time of a scheduled event, on a scale of vertical risk dimensions versus horizontal risk dimensions.

“Blue Line (FXTA Mid Pivot)” is based on a product named “FXTA” or “Forex Traders Advantage”. The Blue Line refers to the mid pivot level and may be shown with different colors and the values can be different with different time frames, such as daily, weekly, 60 minutes, etc.

“Bottom Bull” can be considered to be the opposite of “Top Bear”. “Bottom Bull” may comprise of the variations of trough bars and stochastic values of relative strength index may be approximately near one hundred between to three to five periods.

“Boundary Lines” are the horizontal lines which are a component of the health indicator, which is a part of the multidimensional risk analysis systems.

“Bullish Believeness” is a state of mind with input as provided by certain embodiments of the multidimensional risk analysis systems. Bullish Believers are more likely to make better and smarter decisions based on the provided information. With multidimensional risk analysis systems, those financial Market Vehicles that show true promise will likely thereby be supported by increasing purchases and trades, and those that do not will not be as strongly supported. As such, the widespread use of certain embodiments of the multidimensional risk analysis systems will help promote Bullish Believers to promote those financial vehicles that traders or users would be most benefited by Bullish Believeness.

“Bullish Believer Condition” may develop in trading when the various components of Trend Health Risk, such as but not limiting scope to, internal health risk indicator, and modified positive/negative indicator can be aligned above zero Boundary Lines with modified bullish time segment and price perception risk, which are preferably for sections “a”, “b” or “c”. As such may be for trading a market vehicle in any time frame that may comprise of tick to yearly or any combination of time frames.

“Bullish Vertical Lines” may serve as an indication of bullishness within a market vehicle and can possibly be indicated with bullish spot risk lines, warning lines, directional lines, possible highs or transition lines. Bullish Vertical Lines may comprise of, but not limiting scope to, bull spot risk line, yellow ext bull warning line, bull directional line and turquoise PH lines.

“Candlestick Spectrum” may be a band of colors, symbols, numbers, indicators, and alpha-numeric characters that are produced by multi-dimensional risk and may be seen in a candlestick chart or other types of financial charts.

“Components of Halved Hybrid Nozzlelism” are various types of Halved Hybrid Nozzlelism shapes which may be formed with zone line (mid zone line or user selected zone line), and Blue Line (mid pivot or any user desired pivot),

“Dual Spikes” may be understood as Spikes that can indicate bullishness or bearishness within a market vehicle and also can indicate a possible continuation of the trend of the market vehicle. Dual Spikes may comprise of blue continuation Spikes.

“Dynamic Sectional Price Risk” is also known as price perception risk. It is one of the eight dimensional risks in the multidimensional risk analysis systems. It may be categorized into Sections ‘a’, ‘b’, ‘c’, ‘d’, ‘e’, and ‘f’; “a”, “b”, and “c” may be used to define price perception risk for Bullish Believers; “d” may be used to define profit taking for Bullish Believers; “e” and “f” may be used to define price perception risk for Bearish Believers.

“Dynamic Zone Lines” are the horizontal lines which show the vertical risk in the multidimensional risk analysis systems. Dynamic Zone Lines can be considered to be adaptive, horizontal, flexible lines that may dynamically travel, dynamically travel independently of one another and can have forecasting capabilities, allowing the possible indication of a possible change within the near future.

“Expansion of Zone Lines” is the increase in distance between the upper most and lower most zone lines. After the possible Squeezing of Zone Lines, at one point or another the unscheduled intersection of zone line may occur, due to the possible increased volatility and may create a shifting point either in the upward or downward direction, provided that one of the zone levels, either the upper most zone line or the lower most zone line remain stable, which may create the Expansion of Zone Lines in either the upward or downward direction. When the Squeezing of Zone Lines occurs, the unscheduled intersection of zone lines may create a downward movement for all the zone lines, with the exception of the upper most zone line and Halved Hybrid Nozzlelism Shifting End Spike/Vertical Line (Bear To Bull) allowed for stabilization. The first expansion confirmation point and subsequent expansion points of zone lines may be spotted by using, but not limiting scope to, Warning Spot For First Gold PL Line (Bull To Bear), gold PL line, and Shifting Point of Zone Lines for any possible bearish outlook and any warning sign for the first turquoise PH line, Shifting Point of Zone Lines and subsequent black transition spike.

“Family and Characteristics Risk” is one of the eight dimensional risks in the multidimensional risk analysis systems and can be formulated separately for subject market vehicle and compared with its peers or within its own family or type.

“Fundamental Risk” is also known as economic events risk and is one of the eight dimensional risks in the multidimensional risk analysis systems.

“FXTA Mid Pivot (Blue Line)” is based on a product named “FXTA” or “Forex Traders Advantage.” The FXTA mid pivot refers to the mid pivot level and may be shown with different colors and the values can be different with different time frames, such as daily, weekly, 60 minutes, etc.

“Halved Hybrid Nozzlelism” is the phenomenon of the formation of Halved Hybrid Nozzlelism shape theory. Halved Hybrid Nozzlelism may be utilized not to describe a physical nozzle, but to instead illustrate a general shape (that may appear to be that of a nozzle cut in half) or pattern of a variety of indicator combinations, which may be utilized to help an ordinary skilled user or trader without extensive training to understand important events occurring within financial markets such as market trend changes, breakouts, retracements, new highs, new lows, directional forecasting, reversals, pullbacks, and many other such trading clues. Also, the various types and shapes of Halved Hybrid Nozzlelism tend to indicate and show the accumulation of Bullish Believers or Bearish Believers or the exchange between Bullish Believers and Bearish Believers. Due to increasing demand of Bullish Believers conditions, Neutral believers conditions, and Bearish Believers conditions, the prices of any market vehicle, at one point, may break either upper zone level or lower zone level in any time frames, which may constitute either new highs, new lows for either intraday or on daily basis or for a particular time frame on zone levels basis. In such cases, the rest of zone levels follow either upper zone level or lower zone level. When comparing the relative positions of mid zone level with respect to a mid pivot or custom pivots, an area having a similar appearance as halved the nozzle shape, is formed either above or below the mid pivot or custom pivots, or on left or right side of the end of the tip of the halved nozzle shape. These areas in trading are referred to in this disclosure as “Halved Hybrid Nozzlelism”, which tends to follow a repeating pattern in trading and provides many trading clues, such as: forecasting of direction, forecasting of pullbacks, forecasting retracements, forecasting new or extended trends, reversals, break outs, new trends, etc. Indicators, Alerts and explorers can be designed for all parts of this concept by these independently repeating patterns, in part or full.

“Halved Hybrid Nozzlelism Annularization” is an intermediary portion of the Halved Hybrid Nozzlelism formation, which may occur between Halved Hybrid Nozzlelism parallelism and Halved Hybrid Nozzle Tipping area and halved convergence or halved divergence area.

“Halved Hybrid Nozzlelism Convergence” may be part of the upper or lower left side of halved Hybrid Nozzlelism, in which where the prices may flow into this area first and then travel towards Halved Hybrid Nozzle Annularization or Halved Hybrid Nozzle Tipping area, which may be for either a bullish or Bearish Believers.

“Halved Hybrid Nozzlelism Convergence Separation Point” may be a point where Halved Hybrid Nozzlelism Convergence may start for either the upper or lower halved. Separation may be either due to Hybrid Parallelism or from hybrid zone risk transfer area. For upper left Halved Hybrid Nozzlelism Convergence from this point, market prices may get rejected from the Blue Line towards the lower most zone line and may eventually put pressure on it to possibly form Halved Hybrid Nozzlelism Convergence for upper right Halved Hybrid Nozzlelism. Typically, the direction is opposite the previous direction of the left side of the separation point area.

“Halved Hybrid Nozzlelism Divergence” may be part of the upper or lower left side of Halved Hybrid Nozzlelism, in which where the prices may flow into this area last and it travels from Halved Hybrid Nozzle Annularization/Halved Hybrid Nozzle Hybrid Parallelism area, which may be for either for a bullish or Bearish Believers.

“Halved Hybrid Nozzlelism Divergence Separation Point” may be a point where Halved Hybrid Nozzlelism Divergence may start for either the upper or lower halved. Separations may be either due to Hybrid Parallelism or from hybrid zone risk transfer area. For lower right Halved Hybrid Nozzlelism Divergence from this point, market prices may get rejected from the mid zone line towards lowest zone line and may eventually put pressure on it. Typically, the direction is opposite to the previous direction on the left side of this separation point area. If Hybrid Parallelism forms from this point, there can be a possible sideways movement until a scheduled intersection of Blue Line or pivot lines.

“Halved Hybrid Nozzlelism Shifting End Spike/Vertical Line (Bear To Bull)” is a configuration that may occur when all zone lines stop shifting to the downside and remain horizontal for Halved Hybrid Nozzlelism.

“Halved Hybrid Nozzlelism Shifting End Spike/Vertical Line (Bull To Bear)” is a configuration that may occur when all zone lines stop shifting to the upside and remain horizontal for Halved Hybrid Nozzlelism.

“Halved Hybrid Nozzle Tipping” is a front Hybrid Parallelism portion, which may be in variable length on a Horizontal Time Risk from one to several number of the same time frame and can connect at least two Components of Halved Hybrid Nozzlelism, may be referred to as nozzle tipping area.

“Horizontal Time Risk” is also known as time duration risk and is one of the eight dimensional risks in the multidimensional risk analysis systems.

“Hybrid Dynamic Zone Lines” are Dynamic Zone Lines with the combination of a Blue Line or pivot line.

“Hybrid Parallelism” is a term that may be utilized to illustrate a general shape or pattern of a variety of indicator combinations, which may be utilized to help an ordinary skilled trader to understand important events such as market trend change, breakouts, retracements, new highs, new lows, directional prediction, reversals, pullbacks, and many other trading clues. Also, the various types and shapes of Hybrid Parallelism tends to indicate and show the accumulation of Bullish Believers or Bearish Believers or the exchange of Bullish Believers and Bearish Believers. The phenomenon of the formation of Hybrid Parallelism shape into the theory of “Halved Hybrid Nozzlelism” may be referred to as “Hybrid Parallelism”.

“Inner Market Family Risk Composite Index” may be similar in nature to Inner Market Family Index with the exception that the algorithm may be modified for the exclusion of any component within Trend Health Risk.

“Inner Market Family Risk Index” is a measure to find the closest family members in behavior, out of all of the family members, and to find the common factors, indexes they may follow, and compare them to others.

“Magic In” is comprised of the intersection of the tertiary sum of utmost, minor and ceased prices of the market vehicle over a user desired time period and the advance modal of the tertiary sum of utmost, minor and ceased prices of the market vehicle over a user desired time period. “Magic in” can be considered a bull entry special market condition.

“Magic Out” is comprised of the advance modal of the tertiary sum of utmost, minor and ceased prices of the market vehicle over a user desired time period and the intersection of the tertiary sum of utmost, minor and ceased prices of the market vehicle over a user desired time period.

“Market Vehicles” are trading instruments such as stocks, commodities, bonds, interests rates, ETFs, ETNs, ETCs, foreign currencies, etc.

“Multidimensional Bear” may occur when at least four of the eight risk dimensions, preferably at least five, Vertical Risk Dimension (hybrid zone range risk), Horizontal Time Risk (time duration risk), Trend Health Risk, Dynamic Sectional Price Risk (price perception risk), Sudden Market Spot Change Risk (internal market moving risk), Special Conditional Risk (multiple conditions risk), Fundamental Risk (economic event risk) and/or family and characteristic risk possibly occur at the same time.

“Multidimensional Bull” may occur when at least four of the eight risk dimensions, preferably at least five, Vertical Risk Dimension (hybrid zone range risk), Horizontal Time Risk (time duration risk), Trend Health Risk, Dynamic Sectional Price Risk (price perception risk), Sudden Market Spot Change Risk (internal market moving risk), Special Conditional Risk (multiple conditions risk), Fundamental Risk (economic event risk) and/or family and characteristic risk possibly occur at the same time.

“Neutral Believeness” is a state of mind with input as provided by certain embodiments of the multidimensional risk analysis systems, certain Neutral Believers are more likely to exhibit “Neutral Believeness”, and thereupon are less likely to make poor decisions based on the provided information. With multidimensional risk analysis systems, those financial Market Vehicles that show true promise will likely thereby be supported by increasing purchases and trades, and those that do not will not be as strongly supported. As such, the widespread use of certain embodiments of the multidimensional risk analysis systems will help promote Neutral Believers to display neutral behavior relative to those financial vehicles that traders or users would be mutually benefitted by both bearish and Bullish Believeness.

“Neutral Believer Condition” is a state of mind that may develop in trading when the various components of Trend Health Risk, such as, but not limiting scope to, internal health risk indicator and modified positive/negative indicator can be both aligned at the zero Boundary Lines at the same time or either one of them with modified neutral time segment and price perception risk, which are preferably for section “d”, As such may be for trading a market vehicle in any time frame that may comprise of tick to yearly or any combination of time frames.

“Neutral Spikes” may be understood as Spikes that do not indicate either bullishness or bearishness within a market vehicle but rather a possible transition within a trend of a market vehicle. Neutral Spikes may comprise of black transition Spikes.

“Nozzlelism to Hybrid Parallelism Transformation Point” is a configuration that may occur after the possible formation of halved hybrid nozzle, the mid zone line may fail to intersect Blue Line or pivot lines, which may cause it to form Hybrid Parallelism. If Hybrid Parallelism forms after this point, it may become an attraction to those levels for the mid zone line as well as Blue Line or pivot line, and within the Hybrid Parallelism phase, this may be possible. Such configuration may serve as a forecasting tool and may cause a breakout from this point. This may provide the first evidence of pinpointing the area before the breakouts within the financial market for any market vehicle.

“Orange Oscillator” is an indicator that can be used in conjunction with the trend health. The Orange Oscillator may be based on the quotient of the aggregation of the current and historical strength or the weakness of a market based on either the open, high, low or close prices of the diminution of the nether value of the current and historical strength or weakness of a market based on either open, high, low or close prices to the aggregation of the immense value of the current and historical strength or weakness of a market based upon either the open, high, low, or close prices of the diminution of the nether value of the current and historical strength or weakness of a market based upon either the open, high, low, or close prices for the user selected time period. The Orange Oscillator may be plotted onto its owns scale but can also be overlaid without a scale or may be merged with a scale on either the right or left. When such indicator possibly crosses, Modified dynamic strength risk indicator, the bullish health risk directional indicator or bearish health risk directional indicator around the values of −4 to −6, a possibly new bullish trend can establish. A trader or user should be aware of bullish directional line, possible scalp-swing trade setups or bullish recognition factors for possible entries. When the Orange Oscillator possibly crosses modified dynamic strength risk indicator, the bullish health risk directional indicator or bearish health risk directional indicator around +4 to +6, a possibly new bearish trend can be established and look for bearish directional line, possible scalp-swing trade setups, or bearish recognition factors for possible entries.

“Reversals for Bears” is a reversal signal in which a bullish trend can possibly become a bearish trend due to the alignment of multiple risk changes and confirmations. Reversal of such trends may not occur even with the appearance of such and other factors should be taken into consideration, such as, for example, the dynamic hybrid zone lines. There are certain types of Reversals for Bears, which may include, but not limiting scope to, bear reversal, Top Bear small or big, bull top, and excess bull to bear belief.

“Reversals for Bulls” is a reversal signal in which a bearish trend can possibly become a bullish trend due to the alignment of multiple risk changes and confirmations. Reversal of such trends may not occur even with the appearance of such and other factors should be taken into consideration, such as, for example, the dynamic hybrid zone lines. There are certain types of Reversals for Bears, which may include, but not limiting scope to, bull reversal, Bottom Bull small or big, bear bottom, and excess bear to bull belief.

“Scheduled Event of Blue Line” is an event which occurs when a selected pivot type (for example, 60 minutes, daily, weekly, etc) either moves up or down on a vertical price scale or remains the same at the end of the selected time period for the selected pivot.

“Scheduled Event of Zone Line” is an event which occurs when the scheduled Blue Line event intersects (or remains within the zone) with a zone line.

“Sections ‘a’, ‘b’, ‘c’, ‘d’, ‘e’, and ‘f” are various types of price perception risk Sections “a”, “b”, and “c” may be used to define price perception risk for Bullish Believers; Section “d” may be used to define profit taking for Bullish Believers; Sections “e” and “f” may be used to define price perception risk for Bearish Believers.

“Sections of Halved Hybrid Nozzlelism” include, but are not limited to, Annularization section, halved convergence section, Halved hybrid nozzlelism parallelism section, Halved Hybrid Nozzlelism tipping section, post Halved Hybrid Nozzlelism confluence section, depending upon the types of Halved Hybrid Nozzlelism.

“Sequentized” is a status of risks which have undergone the process of sequentizing. When applied to multidimensional risk analysis, it is considered that the multidimensional risks and subcategories of risk have been Sequentized.

“Sequentizing (Sequencing of Risks)” is a process of sequencing multidimensional risks, in multidimensional risk analysis systems.

“Shifting Point of Zone Lines” is a point from which zone lines start to shift upwards or downwards, due to dynamic, adaptive changes within the market, as a result of changing in vertical market risk.

“Special Buy” is a signal which may occur when all of the components or a portion of the major components of the modified health indicator align properly and may be considered a bull entry special market condition.

“Special Bearish Market Conditions Risks” is special condition where the Bearish Believers take control from the Bullish Believers. It can be further identified by observing a tan bearish candle, tan bearish candle + or tan bearish candle ++ in the observed timeframe and having a “wick formation” effect on higher time frame for the market vehicle under assessment. Tan bearish candle is an earlier entry indication for Bearish Believers at a reduced risk.

“Special Bullish Market Conditions Risks” is special condition where the Bullish Believers take control from the Bearish Believers. It can be further identified by observing a powder blue bearish candle, powder blue bearish candle + or powder blue bullish candle ++ in the observed timeframe and having a “wick formation” effect on higher time frame for the market vehicle under assessment. Powder blue bullish candle is an earlier entry indication for Bullish Believers at a reduced risk.

“Special Conditional Risk” is also known as multiple conditions risk and is one of the eight dimensional risks in the multidimensional risk analysis systems. This conditional risk is based upon many special dynamic conditions that may occur within a market vehicle.

“Special Market Conditions for Bull and Bear Entries” are conditions for bull entries and bear entries, in which multidimensional, multi-confirmation risk assessment is taken into consideration. There are certain types of bull entries for special market conditions, which may include, but not limiting scope to, Special Buy, Magic In and Multidimensional Bull. There are certain types of bear entries for special market conditions, which may include, but not limiting scope to, special sell, Magic Out and Multidimensional Bear.

“Spikes” are either a dotted or solid triangle shaped object, of user choice, which can be externally injected. It can be observed in segments or in full and may develop and show the dynamic changes within the market vehicle. It may also be used as an entries, exits or events, to possibly obtain the trader or user's attention.

“Squeezing of Zone Lines” is the decrease in distance between the upper most and lower most zone lines. Over a period of time, when the market has very low volatility, the distance between all zone lines may start to get smaller and smaller, thus possibly creating a situation where modified health risk indicator cannot reach the Boundary Lines. The reduced distance between all zone lines may be referred to as squeezing and it may create breakouts or breakdowns.

“Super Bearish Believer Entry” is a condition which may develop in trading when the various components of Trend Health Risk such as internal health risk indicator and modified positive/negative indicator have possibly aligned below the zero Boundary Lines with modified bearish time segment and price perception risk, which are preferably for Sections “d”, “e”, or “f”, but only as such when both modified positive/negative indicator and Boundary Lines remain horizontal.

“Super Belief Neutral Pinpoint Entries (For Bearish Believers)” is a condition which may develop in trading when the various components of Trend Health Risk such as internal health risk indicator and modified positive/negative indicator are approaching the zero Boundary Lines from more positive to less positive within a short period of time, achieve a value of zero at the same time or within a very short period of time, and then become more negative. Such events may be within either a modified neutral time segment or by two time segments side by side, such as modified bullish time segment next to modified bearish time segment. For example, a black neutral candle (overlaid by a tan colored candle for illustrative purposes), may be observed during such events and price perception risk which are preferably for sections “e”, or “f” are at the zero boundary line. Such Super Belief Neutral Pinpoint Entries (For Bearish Believers) may be observed with, for example, a tan bearish entry −(Me), wherein “f” is the price perception risk defined within the tan bearish candle and “−oex” may serve as an indication that there is a possible extended previous bullish condition with a tan colored candle to possibly indicate an exchange from Bullish Believers to Bearish Believers within the specified candle/bar under observation, hereby referred to as point “L”, and thereupon can be considered a Super Belief Neutral Pinpoint Entries (For Bearish Believers).

“Super Belief Neutral Pinpoint Entries (For Bullish Believers)” is a condition which may develop in trading when the various components of Trend Health Risk such as internal health risk indicator and modified positive/negative indicator are approaching the zero Boundary Lines from more negative to less negative within a short period of time, achieve a value of zero at the same time or within a very short period of time, and then become more positive. Such events may be within either a modified neutral time segment or by two time segments side by side, such as modified bearish time segment next to modified bullish time segment. For example, a black neutral candle or subsequent black candles/bars over a period of time, may be observed during such events and price perception risk which are preferably for sections “a”, “b”, or “c” are at the zero boundary line. Such Super Belief Neutral Pinpoint Entries (For Bullish Believers) may be observed with, for example, bullish DK yellow candle type a(M), wherein “a” is the price perception risk defined with a black colored candle to possibly indicate an exchange from Bearish Believers to Bullish Believers within the specified candle/bar under observation, hereby referred to as point “N”, and thereupon can be considered a Super Belief Neutral Pinpoint Entries (For Bullish Believers).

“Sudden Market Bearish Spot Risks” may occur when a trend possibly changes suddenly from bullish to bearish. Such candles may either show the changes within a market as they occur or may provide an advanced warning. Such candles may be used as a forecasting tool for possible future decision making. There are certain types of sudden market bearish spot risk candles, which may include, but not limiting scope to, golden bearish candle and golden bearish candle +.

“Sudden Market Bullish Spot Risk” may occur when a trend possibly changes suddenly from bearish to bullish. Such candles may either show the changes within a market as they occur or may provide an advanced warning. Such candles may be used as a forecasting tool for possible future decision making. There are certain types of Sudden Market Bullish Spot Risk candles, which may include, but not limiting scope to, turquoise bullish candle, turquoise bullish candle + turquoise bullish candle ++ and catalyst turquoise bullish candle.

“Sudden Market Spot Change Risk” is also known as internal market moving risk and is one of the eight dimensional risks in the multidimensional risk analysis systems. It indicates sudden dynamic changes within a market vehicle, in a candle or bar observation for a particular selected time period.

“Super Bullish Believer Entry” is a condition which may develop in trading when the various components of Trend Health Risk such as internal health risk indicator and modified positive/negative indicator have possibly aligned above the zero boundary line with modified bullish time segment and price perception risk, which are preferably for sections “a”, “b”, or “c”, but only as such when both modified positive/negative indicator and boundary line remain horizontal.

“Super Neutral Believer Entries” is a condition which may develop in trading when the various components of Trend Health Risk such as internal health risk indicator and modified positive/negative indicator have possibly aligned at the zero boundary line with modified neutral time segment and price perception risk, which are preferably for neutral candles, but only as such when both modified positive/negative indicator and boundary line remain at zero for a time period under observation.

“Top Bear” can be considered to be the opposite of “Bottom Bull”. “Top Bear” may comprise of the variations of trough bars and stochastic values of relative strength index may be approximately near zero between to three to five periods.

“Trend Development and Recognition with Hybrid Zone Lines” is a concept that may be applicable to Hybrid Dynamic Zone Lines, Hybrid Parallelism, hybrid zone risk transfer areas, hybrid confluence, and Halved Hybrid Nozzlelism. Many scalp-swing trade setups, favorable bullish recognition factors and/or bearish recognition factors may be used for the enhancement of scalp-swing trading opportunities to conduct mega-scalp swing using trend development.

“Trend Health Risk” is one of the eight dimensional risks in the multidimensional risk analysis systems.

“Unscheduled Event of Zone Line” is an event when a selected zone line either moves above or below a Blue Line (pivot line) on a vertical price scale. The zone line movement in this case does not wait for the end of the selected time period of the Blue Line (pivot line).

“Vertical Risk Dimension” is also known as the zone range risk or hybrid zone range risk and it is one of the eight dimensional risks in the multidimensional risk analysis systems.

“Warning Spot For First Turquoise PH Line (Bear To Bull)” is a configuration which may occur where the post, where Halved Hybrid Nozzlelism Convergence may end and where halved Annularization may start. This may be referred to as a “break out” or the making of new highs for lower left Halved Hybrid Nozzlelism Convergence and upper right Halved Hybrid Nozzlelism Divergence. “PH” indicates possible higher prices of a market vehicle.

“Warning Spot For First Gold PL Line (Bull To Bear)” is a configuration which may occur where the post, where Halved Hybrid Nozzlelism Divergence may end and where halved Annularization may start. This may be referred to as a “breakdown” or the making of new lows for upper left Halved Hybrid Nozzlelism Convergence and lower right Halved Hybrid Nozzlelism Divergence. “PL” indicates possible lower prices of a market vehicle.

### Symbology

A trader or user may understand the following designations, which can be further referenced with the User's Manual:

“Bear Bottom”: Shown by a blue colored diamond, indicating that bottoming is possibly approaching but with a different type of risk analysis, comprising of different indicators.

“Bear Entry Spike”: Shown by a red dotted spike in the multicolored Candlestick Spectrum, indicating a possible directional bearish pinpoint entries.

“Bear Reversal”: Shown by a pink colored “R” and a pink colored arrow underneath such “R”, indicating a possible reversal from bullish to Bearish Believer Condition.

“Bear Spot Risk Line”: Shown by a vertical red line in the multicolored Candlestick Spectrum, indicating a possible bearish spot risk.

“Bear Warning: : Shown by either an indigo colored candle and/or with a brown colored arrow with “Bew” symbol.

“Big Scale Bearish Candle”: Shown by a pink colored candle and/or a pink colored arrow with a “Mph” symbol.

“Big Scale Bullish Candle”: Shown by a gray colored candle and/or a gray colored arrow with “Mgb” symbol.

“Blue Continuation Spikes”: Shown by a blue dotted spike in the trend health window, indicating a possible continuation of the current trend, either in the bullish or bearish direction.

“Bottom Bull Small or Big”: Shown by a dark yellow northeast arrow with a “Bu” symbol underneath such arrow, indicating that bottoming is possibly reaching within a market vehicle and a reversal of the previous bearish trend is possible.

“Bull Entry Spike”: Shown by a green dotted spike in the multicolored Candlestick Spectrum, indicating a possible directional bullish pinpoint entries.

“Bull Reversal”: Shown by a blue colored “R” and a blue colored arrow on top of such “R”, indicating a possible reversal from bearish to Bullish Believer Condition.

“Bull Spot Risk Line”: Shown by a vertical green line in the multicolored Candlestick Spectrum, indicating a possible bullish spot risk.

“Bull Top”: Shown by a red colored diamond, indicating that possible topping out is approaching but with a different type of risk analysis, comprising of different indicators.

“Bull Warning”: Shown by either a yellow colored candle and/or a with blue colored arrow with “Bw” symbol.

“Core Boundary Lines”: Shown by horizontal dashed gray lines in the trend health window.

“Directional Line Bear”: Shown by a thick vertical red line in the trend health window, indicating a possibly strong Bearish Believers trend direction.

“Directional Line Bull”: Shown by a thick vertical green line in the trend health window, indicating a possibly strong Bullish Believers trend direction.

“Economic Event Spikes”: Shown by a blue lined spike in the multicolored Candlestick Spectrum, indicating an economic event, either single or multiple, has taken place during the time of trading. Multiple economic events can be seen with a thicker blue lined spike.

“Excess Bear to Bull Belief”: Shown by a purple colored thumbs up on top of a “Be-b” symbol, indicating bottoming is possibly becoming established and possible bullish direction or retracement may take place.

“Excess Bull to Bear Belief”: Shown by a dark green colored thumbs down underneath a “B-be” symbol, indicating possible topping out is becoming established and possible bearish direction or retracement may take place.

“f”: Dynamic Sectional Price Risk type “f”; no additional catalysts; possible bearish direction shown by an arrow with red color.

“Gb”: Golden colored candle; possible bearish direction shown by a golden colored arrow.

“Gold PL Line”: Shown by a goldish colored vertical line in the trend health window, indicating a possible low (forecasting lower levels of a market vehicle in the next time period).

“Health Risk Directional Indicator-Bearish”: Shown by a red colored line in the trend health window.

“Health Risk Directional Indicator-Bullish”: Shown by a green colored line in the trend health window.

“Internal Health Risk Indicator”: Shown by a blue colored line in the trend health window.

“Inner Market Family Risk Composite Index”: Shown by a red colored line in the family and characteristics risk window.

“Inner Market Family Risk Index”: Shown by a blue colored line in the family and characteristic risk window.

“Lower Most Boundary Lines”: Shown by horizontal dashed gray lines in the trend health window.

“Magic In”: Shown by a blue colored thumbs up on top of a blue colored “Mgi” symbol, indicating a possible bull entry based on special market conditions risk.

“Magic Out”: Shown by a redish-brown colored thumbs down underneath a redish-brown colored “Mgo” symbol, indicating a possible bear entry based on special market conditions risk.

“Magic Wave”: Shown by a thick dark gray colored line in the multicolored Candlestick Spectrum.

“Modified Dynamic Strength Risk Indicator”: Shown by a dotted black colored line in the trend health window.

“Modified Positive/Negative Indicator”: Shown by a purple colored line in the trend health window.

“Multi Dimensional Bear” Shown by a black colored number “2” on top of a thick, large red colored arrow, indicating an alignment of at least four of the eight risk dimensions occurring at the same time.

“Multi Dimensional Bull” Shown by a black colored number “1” underneath a thick, large blue colored arrow on top, indicating an alignment of at least four of the eight risk dimensions occurring at the same time.

“Neutral Candle”: Shown with a black color.

“Orange Oscillator”: Shown by a orange colored line in the trend health window.

“Pa”: Dynamic Sectional Price Risk type “a”; “p” for the inventor's signature; possible bullish direction shown by an arrow with dark yellow color.

“Pb++”: Dynamic Sectional Price Risk type “b”; “++” represent additional two catalysts; “p” for the inventor's signature; possible bullish direction shown by an arrow with bright green color (Note: Three plus signs shows three additional catalysts).

“Pc”: Dynamic Sectional Price Risk type “c”; “p” for the inventor's signature; no additional catalysts; possible bullish direction shown by an arrow with dark green color.

“Pd++ with purple thumbs up”: Dynamic Sectional Price Risk type “d”; “p” for inventor's signature; purple thumbs up shows possible upward direction; “++” shows two additional catalysts (NOTE: Bigger the thumb, the more possible catalysts involved, indicating possibly more bullish believers entering into trades. Thumbs down represents possibly more Bearish Believers entering into trades).

“Pe+”: Dynamic Sectional Price Risk type “e”; “p” for the inventor's signature; “+” for one additional catalyst; possible bearish direction shown by an arrow with brown color.

“Powder Blue (C) Bullish Candle” (Special Bullish Market Condition Risk Earlier Entries): Shown by a powder blue colored candle and/or a blue colored arrow with “oex” which may serve as an indication that there is a possible extended previous bearish condition; no additional catalysts.

“Risk Transition Lines”: Shown by a purple-blue vertical line in the trend health window, indicating scheduled and unscheduled events of the Blue Line, indicating risk in transition.

“Special Buy”: Shown by a dark yellow colored arrow with a “Sb” symbol underneath such arrow, indicating a possible pinpoint bull entry based on special market conditions risk.

“Special Sell”: Shown by a pink colored arrow with a “SS” symbol on top of such arrow, indicating a possible pinpoint bear entry based on special market conditions risk.

“Super Bearish Belief Contra −Re-” (Super Belief Pin Point Reversals for Bears to Bulls): Shown by a circled orange colored number “2” symbol with “re-” noted below such orange circle, which possibly indicates pinpoint reversals of Bearish Believers to take some profits and may turn into possible retracements; −re1 indicates an additional strong reversal risk involved; −re2 indicates at least two additional reversal risks involved in analysis.

“Super Bullish Belief Contra +Re” (Super Belief Pin Point Reversals for Bulls to Bears): Shown by a circled green colored number “1” symbol with “re” noted above such green circle, which indicates possible pin point reversals of Bullish Believers to take some profits and may possibly turn into retracements; +re1 indicates an additional strong reversal risk involved; +re2 indicates at least two additional reversal risks involved in analysis.

“Tan Bearish Candle ++” (Special Bearish Market Condition Risk Earlier Entries): Shown by a tan colored candle and/or a light brown colored arrow with an “−oex” which may serve as an indication that there is a possible extended previous bullish condition with two additional catalysts.

“Tb+”: Turquoise colored candle with one additional catalyst; possible bullish direction shown by a bluish colored arrow.

“Top Bear Small or Big”: Shown by a orange southeast arrow with a “Be” symbol on top of such arrow, indicating that possible topping out is reaching within a market vehicle and a reversal of the previous bullish trend is possible.

“Transition Bull”: Shown by a bull symbol.

“Transition Spikes”: Shown by a black dotted spike in the trend health window, indicating a possible transition between Bullish Believer direction to Bearish Believer direction or vice versa.

“Turquoise PH Line”: Shown by a turquoise colored vertical line in the trend health window, indicating a possible high (forecasting higher levels of a market vehicle in the next time period).

“Upper Most Boundary Lines”: Shown by horizontal dashed gray lines in the trend health window.

“Yellow Ext Bull Warning Line”: Shown by a thick vertical yellow line in the multicolored candlestick spectrum, indicating a warning from extended Bearish Believers to possibly convert into Bullish Believers and may have a possible retracement or change in direction.

“Yellow Ext Bear Warning Line”: Shown by a thick vertical pink line in the multicolored candlestick spectrum, indicating a warning from extended Bullish Believers to possibly convert into bearish believers and may have a possible retracement or change in direction.

A trader or user may be alerted by all important events as illustrated by a yellow triangle or any trader or user desired colors or shapes. All important events selected by a trader or user can have alerts may be sent via electronic mail, PDA's, or by audio/visual alert on chart during trading.

Any components or combination of components of multidimensional risk systems may be automated by a trader or user through the use of robots, or any other automation methods and apparatus.

A trader or user may use historical data and end of the day data with the multidimensional risk analysis systems, however the results may be subject to variation in comparison with using real time data.

A trader or user should understand that the learning of the multidimensional risk analysis systems and methods is best learned by use of colored drawings within this disclosure.

A trader or user skilled in the art may create their own market data software that would enable one skilled in the art to accomplish the invention.

Although applicant has described applicant's preferred embodiments of this invention, it will be understood that the broadest scope of this invention includes modifications such as diverse shapes, sizes, and materials. Such scope is limited only by the below claims as read in connection with the above specification. Further, many other advantages of applicant's invention will be apparent to those skilled in the art from the above descriptions and the below claims.

What is claimed is:

1. A method, comprising:
dynamically displaying multiple market risk categories for each of at least one time frames in real time, wherein, each of the multiple market risk categories comprises at least one market risk dimension;
dynamically assessing within each of the various market risk categories based upon at least one or more of multiple risk dimensions;
dynamically designating various aggregate combinations of market risks for each of at least one time frames in real time in response to said dynamically assessing within each of the various market risk categories; and
dynamically forecasting possible Bullish Believer or Bearish Believer direction or Neutral Believer direction with an assigned category of risk in response to said dynamically designating the various aggregate combinations of market risks.

2. The method of claim 1, wherein the dynamically assessing within each of the various market risk categories is performed at least partially for either Bullish Believer, Neutral Believer, or Bearish Believer.

3. The method of claim 1, wherein the at least one risk dimension comprises each one of the risk dimensions comprising a Vertical Risk Dimension, a Horizontal Time Risk dimension, a Trend Health Risk dimension, a Dynamic Sectional Price Risk dimension, a Sudden Market Spot Change Risk dimension, a Fundamental Risk dimension, a Special Conditional Risk dimension, and a family and character risk dimension.

4. The method of claim 1, wherein the at least one risk dimension comprises at least one of the risk dimensions comprising a Vertical Risk Dimension, a Horizontal Time Risk dimension, a Trend Health Risk dimension, a Dynamic Sectional Price Risk dimension, a Sudden Market Spot Change Risk dimension, a Fundamental Risk dimension, a Special Conditional Risk dimension, and a family and character risk dimension.

5. The method of claim 1, wherein the at least one risk dimension comprises any combination of the risk dimensions comprising a Vertical Risk Dimension, a Horizontal Time Risk dimension, a Trend Health Risk dimension, a Dynamic Sectional Price Risk dimension, a Sudden Market Spot, Change Risk dimension, a Fundamental Risk dimension, a Special Conditional Risk dimension, and a family and character risk dimension.

6. The method of claim 1, wherein the dynamically forecasting possible Bullish Believer, Neutral Believer, or Bearish Believer direction comprises pin point entries for the possible Bullish Believer, Neutral Believer, or Bearish Believer direction.

7. The method of claim 1, further comprising dynamic risk recognition of the at least one risks that exist that have been dynamically assessed.

8. The method of claim 1, further comprising dynamic risk recognition of multiple risks that exist concurrently that have been dynamically assessed.

9. The method of claim 1, further comprising:
dynamic risk recognition of the at least one risk that has been dynamically assessed; and
confirming at least one risk that has undergone dynamic risk recognition, wherein the dynamically designating various aggregate combinations of market risks is performed at least partially in response to the confirming the at least one risk.

10. The method of claim 1, further comprising:
dynamic risk recognition of the multiple risks concurrently that have been dynamically assessed; and
confirming multiple ones of the at least one risk concurrently that has undergone dynamic risk recognition, wherein the dynamically designating various aggregate combinations of market risks are performed at least partially in response to the confirming multiple ones of the at least one risk.

11. The method of claim 1, further comprising displaying risk balancing.

12. The method of claim 1, further comprising displaying a further risk transition time area.

13. The method of claim 1, wherein the dynamically assessing, dynamically designating, and the dynamically forecasting steps together provide a technical analysis that can be utilized by a trader to simulate judgment similar to a highly skilled, trained trader.

14. The method of claim 1, further comprising dynamically projecting the dynamic forecasting the possible Bullish Believer or Bearish Believer direction with the assigned category of risk to a remote user.

15. The method of claim 1, wherein the dynamically forecasting possible Bullish Believer, Neutral Believer, or Bearish Believer direction comprises a multiple risk confirmation in one or more time frames.

16. A method comprising:
dynamically calculating and displaying a specialized mid pivot of an at least one higher time frame;
dynamically calculating and displaying vertical risk components of an at least one lower time frame; and observing in a real time, the formation of a Halved Hybrid Nozzlelism shape at least partially in response to the relationship between said dynamically calculating and displaying the specialized mid pivot of the at least one higher time frame as taken with respect to said dynamically calculating and displaying the vertical risk components of the at least one lower time frame.

17. The trading method of claim 16, further comprising forecasting earlier highs and earlier lows with risk assessment with risk assignment numbers for Halved Hybrid Nozzlelism.

18. The trading method of claim 16, further comprising forecasting earlier highs and earlier lows for Halved Hybrid Nozzlelism.

19. The method of claim 16, further comprising:
forecasting trend changes, breakouts, retracements, pullbacks, or reversals based at least partially on observing in a real time the formation of at least one Halved Hybrid Nozzlelism phenomenon.

20. The method of claim 16, wherein the formation of Halved Hybrid Nozzlelism shape comprises a Lower Left Halved Hybrid Nozzlelism shape.

21. The method of claim 16, wherein the formation of Halved Hybrid Nozzlelism shape comprises an Upper Left Halved Hybrid Nozzlelism shape.

22. The method of claim 16, wherein the formation of Halved Hybrid Nozzlelism shape comprises a Lower Right Halved Hybrid Nozzlelism shape.

23. The method of claim 16, wherein the formation of Halved Hybrid Nozzlelism shape comprises an Upper Right Halved Hybrid Nozzlelism shape.

24. The method of claim 16, wherein the formation of Halved Hybrid Nozzlelism shape comprises a Partial Halved Hybrid Nozzlelism shape.

25. The method of claim 16, wherein the formation of Halved Hybrid Nozzlelism shape comprises an Double Halved Hybrid Nozzlelism shape.

26. The method of claim 16, wherein the formation of Halved Hybrid Nozzlelism shape comprises an at least one Hybrid Parallelism shape.

27. The method of claim 26, wherein the formation of at least one Hybrid Parallelism shape comprises an at least one Hybrid Parallelism shape for Bullish Believers.

28. The method of claim 26, wherein the formation of at least one Hybrid Parallelism shape comprises an at least one Hybrid Parallelism shape for Bearish Believers.

29. The method of claim 16, wherein the formation of Halved Hybrid Nozzlelism shape creates a confluence.

30. The method of claim 29, wherein the confluence comprises at least one pre Halved Hybrid Nozzlelism confluence.

31. The method of claim 29, wherein the confluence comprises at least one post Halved Hybrid Nozzlelism confluence.

32. The method of claim 16, wherein scalps-swing trading is enabled by at least one type of the Halved Hybrid Nozzlelism shape.

33. The method of claim 16, wherein the formation of Halved Hybrid Nozzlelism shape comprises at least one scheduled event of a dynamically moveable specialized mid pivot.

34. The method of claim 16, wherein the formation of Halved Hybrid Nozzlelism shape comprises at least one unscheduled event of a dynamically moveable specialized mid pivot.

35. The method of claim 16, wherein the formation of Halved Hybrid Nozzlelism shape comprises at least one risk transition time for at least one scheduled event.

36. The method of claim 16, wherein the formation of Halved Hybrid Nozzlelism shape comprises at least one risk transition time for at least one unscheduled event.

37. The method of claim 16, wherein the formation of Halved Hybrid Nozzlelism shape comprises at least one scheduled risk transfer area for at least one scheduled event.

38. The method of claim 16, wherein the formation of Halved Hybrid Nozzlelism shape comprises at least one unscheduled risk transfer area for at least one unscheduled event.

39. The method of claim 16, further comprising development of trend direction with Hybrid Zone lines and Bullish, Neutral or Bearish Trend Development and Recognition with Hybrid Zone lines.

40. A trading method using a multi-dimensional risk analysis system, comprising:
dynamically calculating and displaying a precise timing for at least one super belief bullish pinpoint entries and exits, at least one super belief neutral pinpoint entries and exits, or at least one super belief bearish pinpoint entries and exits based on at least one of a various risk dimensions, which forecasts at least one of a precise targets, forecasts at least one earlier highs and at least one earlier lows, and reduces the number of trading errors, and assesses the developing risks or risk and multi-confirmation or risks, and also forecasts quick recognition combinations of market direction in one or more time frames as they develop.

41. The trading method of claim 40, wherein the dynamically calculating and displaying a precise timing is used to recognize at least one bullish risk.

42. The trading method of claim 40, wherein the dynamically calculating and displaying a precise timing is used to recognize at least one bearish risk.

43. The trading method of claim 40, wherein the dynamically calculating and displaying a precise timing is used to recognize to recognize at least one neutral risk.

44. The trading method of claim 40, as applied to scalp-swing trading method.

45. The trading method of claim 40, as applied to mega scalp-swing trading method.

46. The trading method of claim 40, further comprising forecasting earlier highs and earlier lows with risk assessment with risk assignment numbers.

47. The trading method of claim 40, further comprising forecasting earlier highs and earlier lows with risk assessment with risk assignment numbers for Low Risk Opportunity set ups or Multi Low Risk Opportunity set ups.

48. The trading method of claim 40, wherein the trading method at least partially utilizes a click and go system.

49. A trading method, comprising:
using breakeven analysis using a customized risk control table to determine and limit at least one of a trader generated errors within market trading to indicate the correct amount of trader equity a trader may risk, selecting an amount of margin and number of allowable contracts to be traded considering an exponentially increasing amount of trader equity necessary to repair such at least one trader generated errors.

50. The trading method of claim 49, wherein the trader generated errors comprise at least one equity error.

51. The trading method of claim 49, wherein the trader generated errors comprise at least one margin error.

52. The trading method of claim 49, wherein the trader generated errors comprise at least one maximum allowed contract error.

53. The trading method of claim 49, wherein the using breakeven analysis using a customized risk control table is used for providing at least one trade repair.

54. The trading method of claim 49, wherein the providing at least one trade repair is used to recognize at least one bullish risk.

55. The trading method of claim 49, wherein the providing at least one trade repair is used to recognize at least one bearish risk.

56. The trading method of claim 49, wherein the providing at least one trade repair is used to recognize at least one neutral risk.

57. The trading method of claim 49, comprising using the breakeven analysis to perform mega scalp-swing trading.

58. The trading method of claim 49, comprising using the breakeven analysis to perform portfolio or trade repairs.

59. The trading method of claim 49, comprising using the breakeven analysis to perform develop account size.

60. The trading method of claim 49, comprising using the breakeven analysis to perform an asset tolerance check.

61. The trading method of claim 49, comprising using the breakeven analysis to perform an affordability to lose assets.

62. The trading method of claim 49, wherein the breakeven analysis at least partially comprises using user feed information.

63. The trading method of claim 49, wherein the trader equity includes but is not limited to capital that a trader could lose.

64. The trading method of claim 49, wherein the trader equity includes but is not limited to excess margin a trader could use.

65. The trading method of claim 49, wherein the trader equity includes but is not limited to contracts a trader could purchase or sell.

66. A trading system, comprising:
displaying multidimensional financial information contained within multiple market risk categories that could be used to display at least one dynamic forecast of possible Bullish Believer, Neutral Believer, or Bearish Believer direction with an assigned category of risk.

67. The trading system of claim 66, wherein the breakeven analysis at least partially comprises displaying financial information at least partially forming at least one Halved Hybrid Nozzlelism shape.

68. The trading system of claim 66, wherein the breakeven analysis at least partially comprises displaying financial information comprising at least one customizable Risk Control Table.

69. The trading system of claim 66, wherein the breakeven analysis at least partially comprises displaying financial information recognizes at least one Risk using at least one customizable risk control table.

70. The trading system of claim 66, wherein the forecasting possible Bullish Believer, Neutral Believer, or Bearish Believer direction can be used by a user to recognize colors, symbols, alphabets, number, or lines.

71. The trading system of claim 66, wherein each of the multiple market risk categories comprises at least one market risk dimension, and wherein the at least one risk dimension comprises each one of the risk dimensions comprising a Vertical Risk Dimension, a Horizontal Time Risk dimension, a Trend Health Risk dimension, a Dynamic Sectional Price Risk dimension, a Sudden Market Spot Change Risk dimension, a Fundamental Risk dimension, a Special Conditional Risk dimension, and a family and character risk dimension.

72. The trading system of claim 66, wherein each of the multiple market risk categories comprises at least one market risk dimension, wherein the at least one risk dimension comprises at least one of the risk dimensions comprising a Vertical Risk Dimension, a Horizontal Time Risk dimension, a Trend Health Risk dimension, a Dynamic Sectional Price Risk dimension, a Sudden Market Spot Change Risk dimension, a Fundamental Risk dimension, a Special Conditional Risk dimension, and a family and character risk dimension.

73. The trading system of claim 66, wherein each of the multiple market risk categories comprises at least one market risk dimension, wherein the at least one risk dimension comprises any combination of the risk dimensions comprising a Vertical Risk Dimension, a Horizontal Time Risk dimension, a Trend Health Risk dimension, a Dynamic Sectional Price Risk dimension, a Sudden Market Spot Change Risk dimension, a Fundamental Risk dimension, a Special Conditional Risk dimension, and a family and character risk dimension.

74. The trading system of claim 66, wherein the displaying the multidimensional financial information contained within multiple market risk categories that could be used to display at least one dynamic forecast of possible Bullish Believer, Neutral Believer, or Bearish Believer direction with an assigned category of risk is performed substantially in real time.

75. A computer-based trading system of claim 66 relating to real-time market analysis, further comprising:
at least one market feed computer processor structured and arranged to process at least one real-time market feed to determine real-time market data;
at least one risk factor computer processor structured and arranged to automatically calculate current values of each of a plurality of market risk factors from such real time market data;
at least one analysis computer processor structured and arranged to real-time analyze at least one combination of such market risk factors to quantify at least one market risk;
at least one risk assessing computer processor structured and arranged to assess relevance of each quantity of a plurality of such at least one market risks to determine when to display at least one risk indicator; and
at least one risk indicator.
